(19) United States
(12) Patent Application Publication
(10) Pub. No.: US 2004/0205065 A1
(43) Pub. Date: Oct. 14, 2004

(54) System for creating and maintaining a database of information utilizing user opinions

(76) Inventors: Gregory J. Petras, Phoenix, AZ (US); Jeffrey T. Zywicki, Scottsdale, AZ (US); Flori N. Parham, Chandler, AZ (US); Mark A. Fisher, Scottsdale, AZ (US); Robert R. Martin, Scottsdale, AZ (US); Andrew F. Mason, Cave Creek, AZ (US); Cory Osborn, Phoenix, AZ (US); Lisa J. Cramer, Scottsdale, AZ (US); Craig P. Thompson, Glendale, AZ (US); Norman White, Scottsdale, AZ (US); Gary D. Mellott, Littleton, CO (US); Kimberly A. Cameron, Incline Village, NV (US); Kory Kredit, Chandler, AZ (US); Rachael A. Thomas, Phoenix, AZ (US); Connie Riffel, Mesa, AZ (US); Richard W. Hill, Scottsdale, AZ (US)

Correspondence Address: STONEMAN LAW OFFICES, LTD, 3113 NORTH 3RD STREET, PHOENIX, AZ, 85012, US

(21) Appl. No.: 10/624,345

(22) Filed: Jul. 22, 2003

Related U.S. Application Data
(63) Continuation-in-part of application No. 09/782,873, filed on Feb. 10, 2001.
(60) Provisional application No. 60/181,632, filed on Feb. 10, 2000.
(60) Provisional application No. 60/398,498, filed on Jul. 25, 2002.

(51) Int. Cl. G06F 7/00

(52) U.S. Cl. 707/5

(57) ABSTRACT

A system for automatically creating and maintaining a database of information utilizing user opinions about subjects, particularly exceptional experiences. Described is an Internet system assisting/motivating a population of users interested in information about certain categories of subjects to automatically maintain the database content and to improve the usefulness and quality of the database information without any substantial management by the website owner-manager. The user opinions are primarily in the form of both comments and ratings about which natural-language terms best describe a particular subject, enabling user searches of the subject database to be by way of preferred such descriptive natural-language terms, which terms are further preferred to be evaluative and approving.

Also, a system for automatically creating and maintaining a database of information utilizing user knowledge about sales related subjects. Described is an Internet-based system for assisting/motivating a population of users interested in information about certain categories of sales related subjects to automatically maintain the database content and to improve the usefulness and quality of the database information without any substantial management by the website owner-manager. The user opinions are primarily in the form of both comments and ratings of which sales related subjects best provide assistance in completing a sale.

### CROSS-REFERENCE TO RELATED APPLICATIONS

The present application is a continuation-in-part of my related U.S. Utility application Ser. No. 09/782,873, filed Feb. 10, 2001, entitled “SYSTEM FOR CREATING AND MAINTAINING A DATABASE OF INFORMATION UTILIZING USER OPINIONS”, which claimed priority from my related U.S. provisional patent application Serial No. 60/181,632, filed Feb. 10, 2000, entitled “METHOD AND SYSTEM FOR CREATING AND MAINTAINING A DATABASE OF INFORMATION UTILIZING USER COMMENTS AND OPINIONS”, and is related to my U.S. provisional patent application Serial No. 60/398,494 filed Jul. 24, 2002, entitled “SYSTEM FOR CREATING AND MAINTAINING A DATABASE OF INFORMATION UTILIZING USER EXPERIENCES”, from which this application claims priority, the contents of all of which applications are hereby herein incorporated by reference and are not admitted to be prior art with respect to the present invention by their mention in this cross-reference section.

### BACKGROUND

This invention relates generally to systems for creating, maintaining and using database information. More particularly, it relates to a system for automatically creating and maintaining a database of information utilizing user opinions. Even more particularly, it relates to an Internet system assisting a population of users to automatically maintain the database content and to improve the usefulness and quality of the database information without any substantial management by the website owner-manager.

Recently, a wide range of interactive devices has been developed to provide information to consumers via communications networks. These interactive devices include, for example, computers connected to various computer on-line services, interactive kiosks, interactive television systems and the like. In particular, the popularity of computer on-line services has grown immensely in popularity over the last decade. Computer on-line services are provided by a wide variety of different companies. In general, most computer on-line services are accessed via the Internet. The Internet is a global network of computers. One popular part of the Internet is the World Wide Web, or the “Web.” The World Wide Web contains computers that display graphical and textual information. Computers that provide information on the World Wide Web are typically called “Web sites.” A Web site is defined by an Internet address that has an associated electronic page, often called a “home page.” Generally, a home page is an electronic document that organizes the presentation of text, graphical images, audio and video into a desired display. These Web sites are operated by a wide variety of entities, which are typically called “providers.”

A user may access the Internet via a dedicated high-speed line or by using a personal computer (PC) equipped with a conventional modem. Special interface software, called “browser” software, is installed within the PC. When the user wishes to access the Internet by normal telephone line, an attached modem is automatically instructed to dial the telephone number associated with the local Internet host server. The user can then access information at any address accessible over the Internet. Two well-known web browsers, for example, are the Netscape Navigator browser marketed by Netscape Communications Corporation and the Internet Explorer browser marketed by Microsoft Corporation.

Information exchanged over the Internet is typically encoded in HyperText Mark-up Language (HTML) format. The HTML format is a scripting language that is used to generate the home pages for different content providers. In this setting, a content provider is an individual or company that places information (content) on the Internet so that others can access it. As is well known in the art, the HTML format is a set of conventions for marking different portions of a document so that each portion appears in a distinctive format. For example, the HTML format identifies or “tags” portions of a document to identify different categories of text (e.g., the title, header, body text, etc.). When a web browser accesses an HTML document, the web browser reads the embedded tags in the document so it appears formatted in the specified manner.

An HTML document can also include hyperlinks, which allow a user to move from one document to another document on the Internet. A hyperlink is an underlined or otherwise emphasized portion of text that, when selected using an input device such as a mouse, activates a software connection module which allows the user to jump between documents or pages (i.e., within the same Web site or to other Web sites). Hyperlinks are well known in the art, and have been sometimes referred to as anchors. The act of selecting the hyperlink is often referred to as “clicking on” the hyperlink.

As the popularity of the Internet and the World Wide Web has continued to increase over the years, companies continue to try finding ways to provide useful content and to promote their products and services in a cost-effective manner and to get consumers to visit their Web sites. To that end, computer on-line services often offer subject search services to their users and employ narrative descriptions of their content, user ratings and user comments. Previous examples of such services include epinions.com, deja.com and travelpage.com. These prior systems present a number of limitations and drawbacks to the consumer user of the system. Specifically, a consumer cannot search for a subject based on opinions or ratings of the users of the system. Instead, the search logic is either hierarchical, based on predefined classifications, such as geography, or text based using a search for ambiguous words or phrases contained in the subject's title or description. Users' opinions and ratings are normally not finely detailed nor measurable and are separate and unrelated and are not included in the search processes offered to users. Therefore a user is unable to search for a subject based entirely or partially on the users' opinions or ratings.

Although computer on-line information services allow guests to personalize or customize the information displayed to them on initial entry to the site, such personalization is limited because it does not allow for consideration of the guest's interests and related opinions and ratings of the other users. Rather, the personalization is based on personal preferences in specific, rigid categories of information defined by the information service provider based on the search indexes of the database. As a result, information is presented across a spectrum of subjects that are of interest, but without regard to a user's measures of importance/relevance.

From the perspective of the consumer, the above-described model presents a number of drawbacks. First, highly structured hierarchical search rules force users to search in predetermined ways, and text-based searches rely on ambiguous words or phrases and focus on names or subjects, not concise descriptions and user's evaluations, making identification and selection of the most relevant content (to a particular searcher) difficult. Second, because Internet-based searches are either very rigid or very loosely structured, it is difficult for users to compare similar subjects across the spectrum of their interests. Finally, the quality, freshness and completeness of the database of information must be raised while minimizing costs.

Internet-based on-line information systems also present shortcomings for the system operators and managers. Specifically, they require a high degree of human intervention to maintain. On-line information service providers permit users to comment on and rate subjects within their site and routinely remove those that are out of date or inappropriate either manually or by automated means based on the age of the comment or rating. However, the current methods lack precision because of the ambiguous nature of the ratings and comments. The ambiguity requires a high level of human intervention if the information is to remain current and appropriate.

On-line information service providers use groups or “populations” or “communities” of contributors, i.e., a population of users, to input and maintain the subject content of the database. These communities may be organized geographically or by subject matter expertise. These communities require significant effort and human intervention to manage. On-line information service providers accept content from users and contributors with little or no review before it is posted. Reviews done by humans are usually completed by a limited group who are subject matter experts or geographically close to the submitter. Substantial effort is required to manage this process.

Moreover, prior on-line information systems include incentive systems that have drawbacks. On-line information service providers provide incentives in a variety of forms to encourage contributors to input and maintain subject content. Incentives may also be offered to users of the service. On-line information service providers also employ automated processes to capture, summarize and report the accumulated incentives. The granting of the incentives is based on completion of a limited number of actions that have limited influence on contributors' behavior. There is no limit on the total amount the information service provider is obligated to pay. Each contributor's incentive value is calculated using a rate per action which makes it difficult to increase the value because it increases the total potential obligation and, conversely, lowering the rate per action will be a major disincentive to contributors. Moreover, prior on-line information service providers offer no or limited incentives for users to provide new information, ratings or opinions to the database. Conversely, users' access is not restricted to the information unless it is a fee-based subscription site. Users' behavior is little influenced by the incentives except when attempting to “game” the system and gain unfair or improper rewards.

Additionally, these same shortcomings and challenges also face corporations attempting to gather, store and provide internal information other than traditional factual information such as sales numbers, accounting data or contract dates. In fact, a great deal of informal knowledge similar to opinions exists in many workplace environments. This type of knowledge is very much word-of-mouth based and often very valuable, but not well dispersed through particular groups within the workplace. These challenges exist particularly within sales organizations which are often large and geographically dispersed. This informal knowledge often consists of information such as which sales techniques work and which do not, which products compete best, what the competition is doing, the primary contacts at a company and who is most knowledgeable about a product or other aspect of selling is known by salespersons, sales management and product management. Unfortunately, much of this informal knowledge is not available in an organized and usable form to all the sales, sales support and product support people. This knowledge is created as each person goes about their daily routines, but generally they do not have the tools for easily capturing and classifying it. Similarly, those sales people who need this knowledge do not always know the best sources for it. Frequently, this “real-world” generated knowledge is referred to as “intellectual capital” because it is usually learned through experience and shared informally. This “intellectual capital” clearly represents a form of capital crucial to a company's success which is not readily available to all the people equally. As a result, sales persons lacking this knowledge may be hampered in their performance. Additionally, the informality of the sharing also tends to reduce the accuracy of the knowledge as it is shared among co-workers. Many of the automated sales management systems available today capture the data and information about sales activities such as units sold, total sales value, but do not provide a mechanism for capturing, organizing and sharing “intellectual capital”.

Additionally, initial capture of this “intellectual capital” is sometimes difficult to guide and direct even with training. General incentives and awards programs are helpful in generating overall enthusiasm and participation, but can not influence very precisely the nature and types of information captured. To be effective, the “intellectual capital” that is available must conform closely with the needs of the company the sales staff.

Therefore, there exists a need in the art for an improved system for creating, managing and searching information databases assisting a population of users.

### OBJECTS OF THE INVENTION

Accordingly, it is an object and feature of this invention to provide such a system to develop and maintain content in a database of subjects (e.g., a product, a service, a leisure activity, an experience or a topic), which content can be easily and uniquely searched by users to help them make informed decisions about the database subjects that are particularly relevant to their needs and desires. It is another object and feature of this invention to provide a system for collecting user opinions and/or reviews regarding the database subjects and for utilizing the user opinions and/or reviews to support database searches and more informed decision making about the subjects.

Yet another object and feature of the invention is to enable people worldwide, with diverse backgrounds, educational levels and qualifications to contribute content to the database, and to express opinions or reviews in the form of ratings of database subjects, all in a way that improves the usefulness and quality of the information being added or rated. It is still another object and feature of the invention to reduce the need for centralized control and management of the database content and the contributor community by leveraging the talents, skills, and efforts of the user community to maintain the quality of the database content and the performance of the contributors. It is another object and feature of the present invention to provide a system for recruiting communities of people to create, maintain and provide opinions using Web sites focused on a variety of consumer decision support categories such as leisure experiences, public opinions, products and services.

Yet another object and feature of the invention is to attract users and develop user loyalty, through personal involvement and content contribution, by way of the use of a personal journal and participation in the rewards of the success of the web site. It is another object and feature of the present invention to provide a system to compensate contributors and guests for their efforts in a manner that will ensure a dynamic, comprehensive and accurate database of information for use by guests to the Web sites. It is still another object and feature of the present invention to provide a method and system that motivates guests and contributors to perform highly specific actions that will further the business objectives of the manager of the database.

Another primary object and feature of the present invention is to provide a system for capturing and sharing acquired “intellectual capital” within an organization. “Intellectual capital” is defined as information known by individuals within the organization that is not necessarily taught, but rather learned through experience. The present invention is tailored to capture and share “intellectual capital” particularly for sales. In most cases, “intellectual capital” is highly transitory since it is learned, generally not reduced to writing and usually informally shared. Once a person is no longer associated with the organization, the person's knowledge is also no longer available.

Still further, it is an object and feature of the present invention to provide such a system to increase and improve the effectiveness of individuals and organizations that employ it through effective capture, sharing and constant refreshing of acquired intellectual capital. Through structured sharing, collection and automated maintenance of an organization's intellectual capital, significant profitability benefits can be realized.

Yet another primary object and feature of the present invention is to provide such a system that is designed to capture, maintain and classify “intellectual capital” in a manner that can be easily understood and used by all members of the organization. The system facilitates categorization of the information and manages the information through automated processes requiring very little human intervention to effectively manage vast quantities of information.

Additional objects, features, and advantages of the invention will be set forth in the description that follows and in part will be apparent from the description or may be learned by practice of the invention. The objects, features and advantages of the invention may be realized and obtained by means of the instrumentalities and combinations pointed out in the appended claims.

### SUMMARY OF THE INVENTION

In accordance with a preferred embodiment hereof, this invention provides a system for creating and maintaining information in a database of subjects, available to a population of users, comprising: describing a database subject using a plurality of natural-language terms, each of such plurality of natural-language terms having relevance to the subject according to an involved subset of such population of users; rating the degree of relevance of each of such plurality of natural-language terms to such database subject according to each of such involved subset of such population of users; associating, in such database, such respective natural-language terms and respective degrees of relevance with each such database subject; and computing, for such involved subset of such population of users, in such database, an overall degree of relevance of each of such plurality of natural-language terms to such database subject. Moreover, it provides such a system, further comprising: associating with a particular user a set of particular-user-preferred such natural-language terms from such plurality of natural-language terms; using such particular user's preferred such set of particular-user-preferred such natural-language terms, searching such database for database subjects associated with such set of particular-user-preferred such natural-language terms; determining a set of relevant such database subjects as are correlated with a high aggregate degree of relevance among such respective overall degrees of relevance of such set of respective particular-user-preferred such natural-language terms; and presenting to such particular user information about such relevant database subjects.

Additionally, it provides such a system further comprising: presenting to a particular user information about a particular such database subject and such associated respective relevant natural-language terms with such respective overall degrees of relevance; collecting, from such particular user, such particular user's opinions about respective degrees of relevance to such particular database subject of such respective presented natural-language terms; adding such particular user to such involved subset of such population of users and adding such particular user's opinions to such database; and updating, in association with such particular database subject, in such database, such overall degree of relevance of each of such plurality of natural-language terms associated with such particular database subject. Also, it provides such a system further comprising: presenting to a particular user information about a particular such database subject and such associated respective relevant natural-language terms with such respective overall degrees of relevance; collecting, from such particular user, such particular user's opinions about respective degrees of relevance to such particular database subject of such respective presented natural-language terms; adding such particular user to such involved subset of such population of users and adding such particular user's opinions to such database; and updating, in association with such particular database subject, in such database, such overall degree of relevance of each of such plurality of natural-language terms associated with such particular database subject.

In addition, it provides such a system further comprising: providing a software management system to directly manage such database and such population of users essentially without outside management; and providing for variables in such software management system to be configurable without affecting such direct management operations; wherein such software management system comprises: soliciting of sufficient information from such users for automatic role qualification enhancing software selection and maintenance of a management sub-community; measuring management efforts of each of such management sub-community; queuing of qualified users for a next opening in such management sub-community; setting of goals for each of such management community; and managing a reward system to reward management efforts of each of such management sub-community. And, it provides such a system further comprising: collecting, from each user of such involved subset of such population of users, information about such user's knowledge of and experience with such database subject; assessing, based at least in part upon such information, a relative weight to be given to such user's opinions about such database subject; and for the purposes of computing, for such involved subset of such population of users, in such database, an overall degree of relevance of each of such plurality of natural-language terms to such database subject, applying a respective such relative weight for each respective such user's such rating of such degree of relevance in such manner that a more-knowledgeable such user's such rating counts for more in such “overall” computing than does a less-knowledgeable such user's such rating.

Further, it provides such a system further comprising: determining first such user's role as member or contributor; assigning a multiplier-value based on such first determining; determining second whether such user has personally experienced the subject; assigning a multiplier-value based on such second determining; determining third such user's self-reported qualification to judge such subject; assigning a multiplier-value based on such third determining; determining fourth other users' overall ratings of subjects added by such user; assigning a multiplier-value based on such fourth determining; determining fifth other users' degree of agreements with comments added by such user; assigning a multiplier-value based on such fifth determining; and multiplying together all such multiplier-values to determine such relative weight. Even further, it provides such a system further comprising: rating the relative overall value of each such database subject according to the opinion of each of such involved subset of such population of users; collecting comments about each such database subject according to the opinion of each of such involved subset of such population of users; and associating, in such database, respective such ratings of relative overall value and respective such collected comments with respective such database subjects.

Moreover, it provides such a system further comprising: accumulating, storing, and analyzing all associations, including subject categorizations, of all such overall degrees of relevance of all of such plurality of natural-language terms associated with all such database subjects; determining preferred such natural-language terms, according to such population of users, for selected categories of subjects. Additionally, it provides such a system wherein such determining a set of relevant such database subjects as are correlated with a high aggregate degree of relevance among such respective overall degrees of relevance of such set of respective particular-user-preferred such natural-language terms comprises determining an ordered set of relevant such database subjects as are correlated with a highest aggregate degree of relevance among such respective overall degrees of relevance of such set of respective particular-user-preferred such natural-language terms. Also, it provides such a system wherein such presenting to such particular user information about such relevant database subjects includes presenting to such particular user an ordered set of relevant such database subjects as are correlated with a highest aggregate degree of relevance among such respective overall degrees of relevance of such set of respective particular-user-preferred such natural-language terms.

In accordance with another preferred embodiment hereof, this invention provides an Internet website client-server computer system, for use to determine a level of subject interest for each one of a population of users by capturing other users' (of such population of users) opinions about the degree of relevance of each of a respective set of natural language descriptive terms to each of a respective set of subjects, comprising: a server database system of subjects, each associated with a set of relevant natural-language terms for describing each such subject; wherein each of a respective subset of such terms has been assigned, by each of a subpopulation of such population of users, a degree of relevance with respect to a respective such subject; a client interface system arranged so that such one user may select a set of preferred such natural-language terms which, to such one user, best describe preferred “subjects of interest” to such one user; a server computer processor system connected with such server database system and such client interface system; and a server computer software system, operational with such server computer processor system, arranged to provide search processing using such server database system to: determine an overall, according to such population of users, degree of relevance of each such preferred natural-language term to each such associated subject of such server database system, and determine a set of search-return “subjects of interest” each having at least a specified aggregate degree of relevance considering each such overall degree of relevance of each such preferred natural-language descriptive term to each associated such subject; and return such set of search-return “subjects of interest” to such client interface system of such one user. In addition, it provides such a system wherein such set of search-return “subjects of interest” is ordered according to relative such aggregate degree of relevance.

In accordance with another preferred embodiment hereof, this invention provides a business system, for a developer of web computer systems of the type involving supporting a community of users searching for particular subject information, to achieve additional revenue from customers using such computer systems, comprising the steps of: providing for such computer systems to operate essentially without customer website management; providing for such computer systems to directly motivate and automatically manage the direct collection of sponsor revenue from respective entities desiring to sponsor a respective particular item of such subject information; and charging such customer, for use of such computer systems, an amount comprising a portion of such sponsor revenue. And, it provides such a business system wherein such particular item of such subject information comprises an exceptional user experience, thereby motivating location-based such entities and a product-based such entities to paying for a plurality of sponsorships.

In accordance with another preferred embodiment hereof, this invention provides a business system, for a developer, for use by customers having websites, of web computer systems of the type involving supporting a community of users interacting with a database searching for particular subject information, comprising: providing for such computer systems to comprise software management systems to directly manage such database and such community of users essentially without customer website management; and providing for variables in such software management systems to be configurable by such customer without affecting such direct management operations; wherein such software management systems comprise soliciting of sufficient information from users for automatic role qualification enhancing software selection and maintenance of a management sub-community, measuring management efforts of each of such management sub-community, queuing of qualified users for a next opening in such management sub-community, setting of goals for each of such management community, and managing a reward system to reward management efforts of each of such management sub-community.

In accordance with another preferred embodiment hereof, this invention provides a business system, supplied by a developer, for use by customers having websites comprising web server computer systems of the type involving supporting a community of users, having client computer systems, interacting with a database searching for particular subject information, comprising providing, for website use: computer software means for direct automatic management of such database and such community of users essentially without customer website management; computer software means for permitting such customer to configure a large set of variables in such computer software means for direct automatic management of such database and such community of users without affecting full operation of such direct automatic management; wherein such computer software means for direct automatic management of such database and such community of users essentially without customer website management comprises computer software means for soliciting of sufficient information from such users for automatic role qualification enhancing automatic selection and automatic maintenance of a management sub-community, computer software means for automatically measuring management efforts of each of such management sub-community, computer software means for automatically providing queuing of qualified users for a next opening in such management sub-community, computer software means for automatic setting of goals for each of such management community, and computer software means for automatically managing a reward system to reward management efforts of each of such management sub-community. Further, it provides such a business system, wherein such computer software means for direct automatic management of such database and such community of users essentially without customer website management further comprises: computer software means for describing a database subject using a plurality of natural-language terms, each of such plurality of natural-language terms having relevance to such subject according to an involved subset of such community of users; computer software means for rating the degree of relevance of each of such plurality of natural-language terms to such database subject according to each of such involved subset of such community of users; computer software means for associating, in such database, each respective natural-language term of each such plurality of natural-language terms and such associated respective degree of relevance with each such database subject; and computer software means for computing, for such involved subset of such community of users, in such database, an overall degree of relevance of each of such plurality of natural-language terms to such database subject. Even further, it provides such a business system, wherein such computer software means for direct automatic management of such database and such community of users essentially without customer website management further comprises: computer software means for automatically assisting such management sub-community to solicit subject sponsors; and computer software means for permitting such subject sponsors automatically to send website materials and pay fees. Moreover, it provides such a business system, wherein such computer software means for automatically managing a reward system to reward management efforts of each of such management sub-community comprises: a computer software system for measuring and storing each contribution, including users' comments, to the database of each of such management sub-community; and computer software means for making available to each of such management sub-community a contributor record of how many views other users have made of such contributions, including how many users agreed with such contributor's comments.

Additionally, it provides such a business system wherein such contributor record is associated with the phrase, “lives touched”. Also, it provides such a business system wherein such computer software means for automatically managing a reward system to reward management efforts of each of such management sub-community comprises a computer software system configurable to automatically allocate percentage rewards to a particular one of such management sub-community as a percentage of a settable pool. In addition, it provides such a business system wherein such percentage rewards from such pool may be paid only to a settable percentage of such management sub-community. And, it provides such a business system wherein such computer software means for direct automatic management of such database and such community of users essentially without customer website management further comprises: computer software means for automatically aggregating all user-proposed items for database adds, changes, and deletions into a review queue to which such management sub-community has access; and computer software means for automatically requiring at least one of such management sub-community to review and approve any such item before website publication is implemented.

Further, it provides such a business system, wherein: such review queue is multi-level based essentially on item “aging”; and escalating rewards are offered to at least a set of such management sub-community for disposal of “older” items. Even further, it provides such a business system wherein such computer software means for automatically managing a reward system to reward management efforts of each of such management sub-community comprises a computer software system wherein each of such management community may be motivated to perform highly specific actions to further business objectives of such business system by automatically awarding more or less rewards for specific actions to influence behavior. Moreover, it provides such a business system wherein such computer software means for automatically managing a reward system to reward management efforts of each of such management sub-community may be configured “on the fly”.

In accordance with another preferred embodiment hereof, this invention provides a business system, supplied by a developer, for use by customers having websites comprising web server computer systems of the type involving supporting a community of users, having client computer systems, interacting with a database searching for particular subject information, comprising providing, for website use: computer software means for direct automatic management of such database and such community of users essentially without customer website management; and computer software means for permitting such customer to configure a large set of variables in such computer software means for direct automatic management of such database and such community of users without affecting full operation of such direct automatic management; wherein such computer software means for direct automatic management of such database and such community of users essentially without customer website management comprises computer software means for soliciting of sufficient information from such users for automatic role qualification enhancing automatic selection and automatic maintenance of a management sub-community, computer software means for automatically measuring management efforts of each of such management sub-community, computer software means for automatically providing queing of qualified users for a next opening in such management sub-community, computer software means for automatic setting of goals for each of such management community, computer software means for automatically managing a reward system to reward management efforts of each of such management sub-community, computer software means for automatically assisting such management sub-community to solicit subject sponsors, computer software means for permitting such subject sponsors automatically to send website materials and pay fees, computer software means for automatically aggregating all user-proposed items for database adds, changes, and deletions into a review queue to which such management sub-community has access, and computer software means for automatically requiring at least one of such management sub-community to review and approve any such item before website publication is implemented, wherein such review queue is multi-level based essentially on item “aging”, and escalating rewards are offered to at least a set of such management sub-community for disposal of “older” items, wherein such computer software means for automatically managing a reward system to reward management efforts of each of such management sub-community comprises a computer software system configurable to automatically allocate percentage rewards to a particular one of such management sub-community as a percentage of a settable pool, and wherein such percentage rewards from such pool may be paid only to a settable percentage of such management sub-community.

Additionally, it provides such a business system wherein such computer software means for direct automatic management of such database and such community of users essentially without customer website management further comprises: computer software means for describing a database subject using a plurality of natural-language terms, each of such plurality of natural-language terms having relevance to such subject according to an involved subset of such community of users; computer software means for rating the degree of relevance of each of such plurality of natural-language terms to such database subject according to each of such involved subset of such community of users; computer software means for associating, in such database, each respective natural-language term of each such plurality of natural-language terms and such associated respective degree of relevance with each such database subject; and computer software means for computing, for such involved subset of such community of users, in such database, an overall degree of relevance of each of such plurality of natural-language terms to such database subject.

In accordance with another preferred embodiment hereof, this invention provides a computer system, usable by a large population of Internet users, for creating and maintaining information in a searchable database of defined categories of subjects, comprising, in combination: storage means for storing a large corpus of natural language terms for describing such subjects; relevancy storage means for storing, associated with each such defined category, at least a respective subset of such terms most relevant, according to such population, to such subject within such respective defined category; processing means for updating such relevancy storage means; processing means for presenting to one such user, in association with one such subject, a plurality of such terms most relevant to such subject; interface processing means for assisting such user to choose from such plurality of such presented terms a plurality of such-user-preferred most-relevant such terms to such subject; interface processing means for assisting such user to rate on a predefined scale the relative degree of relevance of each such most-relevant term to such one subject; storage means for storing such respective ratings of such respective most-relevant terms for such respective subject according to each of a subpopulation of such respective users; processing means for computing, for such subpopulation, a pre-selected type of overall degree of relevance to each respective such subject of each respective such most-relevant term; interface processing means for assisting a particular user to base a subject search at least upon a chosen set of particular-user-preferred such natural language terms; processing means for, using such particular user's preferred such set of particular-user-preferred such natural-language terms, searching such database for database subjects associated with such set of particular-user-preferred such natural-language terms; processing means for determining a set of relevant such database subjects as are correlated with a determined specified high aggregate degree of relevance among such respective overall degrees of relevance of such set of respective particular-user-preferred such natural-language terms; and interface processing means for presenting to such particular user information about such determined set of such relevant database subjects which might be of interest to such particular user. Also, it provides such a computer system wherein such predefined scale, for a system for which English is the natural language comprises essentially at least three of the following levels of modifiers: “slight”, “somewhat”, “important”, “very”, “extremely”.

In addition, it provides such a computer system wherein such processing means for computing, for such subpopulation, a pre-selected type of overall degree of relevance to each respective such subject of each respective such most-relevant term comprises: storage means for dating each such user ratings of such degree of relevance of such natural-language term; and processing means for removing such user ratings of more than a selected age from being used in such computing of such overall degree of relevance. And, it provides such a computer system wherein such processing means for updating such relevancy storage means comprises: computer means for determining which of such natural-language terms have been used most in such defined category—as top words; computer means for determining percentage breakdown of top words by first alphabet letter of all such natural-language terms in such defined category; computer means for finding the selected number of such natural-language terms to be displayed in each display process; computer means for, for each set of first-alphabet-letter words and each such selected number, grabbing the specified percentage of top words; and computer means for applying the above four steps once each selected timeframe to update such relevancy storage means. Further, it provides such a computer system wherein such interface processing means for assisting a particular user to base a subject search at least upon a chosen set of particular-user-preferred such natural language terms further comprises: interface processing means for assisting such particular user to select other search options on which to co-base such subject search; wherein such other search options are selected from the class which consists essentially of a defined category of subjects a defined subcategory of subjects a defined location of subjects a defined subject a defined organization name a defined sum of money to spend a defined amount of time to spend.

In accordance with another preferred embodiment hereof, this invention provides an Internet website client-server computer system, for use to determine by e-mail survey a level of subject approval for each one of a population of survey participants by capturing each such participant's opinions about the degree of relevance of each of a respective set of natural language terms to each of a respective set of subjects, comprising: a client interface system arranged so that a survey taker may indicate at least a defined question for the survey, a such set of subjects to be evaluated, a such set of natural-language terms to be rated as to relevancy to each subject, a participant audience, and a time-frame for response; a server computer processor system connected with such client interface system; and a server computer software system, operational with such server computer processor system, arranged to provide survey processing comprising compiling a survey file and survey document in accordance with survey taker input, communicating such survey document to such participant audience, and receiving and tabulating responses. Even further, it provides such a system further comprising displaying survey results at a publicized URL.

Moreover, it provides such systems in which: such subjects consist essentially of exceptional experiences; and such natural-language terms are essentially evaluative. In addition, it provides such systems in which: such subjects consist essentially of exceptional experiences; and such natural-language terms are essentially evaluative and essentially indicate approval.

In accordance with another preferred embodiment hereof, this invention provides an Internet client-server system for assisting at least one group of users having at least one common goal to capture and search, in a single database, offered knowledge, relevant to such at least one common goal, of a plurality of such users for the benefit of at least one of such users, comprising: individually capturing for such database at least one experience of at least some of such plurality; storing in such database such experience; user-searching, using at least one natural-language word, to select at least one desired kind of stored experience; performing such user-searching; and presenting search results. Even further, it provides such an Internet client-server system further comprising searchably capturing for such database at least one item of such knowledge selected from the group consisting essentially of user-advice opinions of experts people who can help miscellaneous such knowledge of users. Moreover, it provides such an Internet client-server system further comprising a substantially automatic website management system. Additionally, it provides such an Internet client-server system further comprising automatically rewarding assisting users for website management assistance. Also, it provides such an Internet client-server system further comprising: providing a software management system to directly manage such database and such population of users essentially without outside management; and providing for variables in such software management system to be configurable without affecting such direct management operations; wherein such software management system comprises measuring management efforts of each of at least one management sub-community, setting goals for each of such management community, and managing a reward system to reward management efforts of each of such management sub-community.

In addition, it provides such an Internet client-server system further comprising searchably capturing for such database such knowledge of users concerning useful knowledge sources outside such group of users. And, it provides such an Internet client-server system further comprising searchably capturing for such database such knowledge of users concerning useful knowledge sources outside such group of users. Further, it provides such an Internet client-server system further comprising: providing at least one capability for at least one user to complete on-line at least one multiple choice poll; and providing at least one reward for such at least one user to completing such at least one multiple choice poll. Even further, it provides such an Internet client-server system wherein: such common goal is sales-oriented,; such group of users comprises sales personnel; and those receiving such benefit comprise sales personnel.

Moreover, it provides such an Internet client-server system wherein such step of user-searching, using at least one natural-language word, to select at least one desired kind of stored knowledge, further comprises: selecting, if any, such at least one kind of stored experience associated with chosen such at least one natural language word; selecting, if any, such at least one kind of stored experience in which the text of such at least one stored experience contains the chosen such at least one natural-language word; selecting, if any, such at least one kind of stored experience in which the category of such at least one stored experience contains the chosen such at least one natural-language word; and selecting, if any, such at least one kind of stored experience in which the title of such at least one stored experience contains the chosen such at least one natural-language word. Additionally, it provides such an Internet client-server system, further comprising automatically managing a reward system to reward efforts of such at least one user.

Also, it provides such an Internet client-server system, further comprising: automatically measuring and storing each experience contribution, including users' comments made by each such at least one user; assigning points to be accumulated for each such experience contribution; automatically accumulating assigned points for each such experience contribution by each such at least one user; automatically reporting such points accumulated for each such experience contribution; defining at least one criteria for awarding prizes based on such accumulated points; and automatically awarding prizes to such at least one user with accumulated points meeting such at least one criteria. In addition, it provides such an Internet client-server system further comprising managing such database and such group of users essentially without customer website management; permitting at least one customer to configure a plurality of variables in such computer software for such managing of such database; automatically setting goals for each such user participating in at least one management community; and automatically managing a reward system to reward management efforts of each of such at least one user of such at least one management community.

And, it provides such an Internet client-server system further comprising: rating the relative overall value of each such at least one item of such experience according to the opinion of each of such involved subset of such population of users; collecting comments about each at least one item of such experience according to the opinion of each of such involved subset of such population of users; and associating, in such database, respective such ratings of relative overall value and respective such collected comments with respective such at least one item of such experience. Further, it provides such an Internet client-server system further comprising automatically accumulating system operation data. Even further, it provides such an Internet client-server system wherein such system operation data comprises: data about compliance with such set of performance goals for each of at least one involved subset of such population of users; data about each type of such stored experience; data about such reward system; and data about interviews of each of such involved subset of such population of users. Moreover, it provides such an Internet client-server system further comprising permitting such at least one user to view successively more detailed levels of such automatically accumulated system operation data. Additionally, it provides such an Internet client-server system further comprising: requesting installation of at least one independent database access module onto the personal computer of such at least one user; permitting selection, using such independent database access module, of at least one category of such knowledge for display by such at least one user; automatically searching, using such at least one independent database access module, such database, without need of a browser, for at least one selected category of such knowledge from such database; and displaying, using such at least one independent database access module, found knowledge from such at least one pre-determined category of such knowledge from such database to such at least one user.

Also, it provides such an Internet client-server system further comprising: displaying continuously at least one selected type of such pre-determined information from at least one pre-determined category of such knowledge from such knowledge stored in such database to such at least one user; and scrolling a display of at least one selected type of such pre-determined information from at least one pre-determined category of such knowledge from such knowledge stored in such database to such at least one user. In addition, it provides such an Internet client-server system further comprising: making specific requests for information from information stored in such database by such at least one user. And, it provides such an Internet client-server system further comprising: receiving at least one request for information from such at least one user; storing such at least one request for information; notifying designated other such at least one user with particular expertise about such at least one request for information; storing such at least one request for information and at least one response by such at least one user with particular expertise as such at least one experience; and notifying such at least one user, requesting information, of such at least one experience containing such at least one request and such at least one response.

In accordance with another preferred embodiment hereof, this invention provides an Internet client-server system for assisting a group of users with at least one common goal to capture and search, in a single database, offered knowledge, relevant to such at least one common goal, of a plurality of such users for the benefit of at least one of such users, comprising: interface means for individually capturing for such database at least one experience of at least some of such plurality; database means for storing such experiences; interface means for user-searching, using at least one natural-language word, to select at least one desired kind of stored experience; processor means for performing such user-searching; and interface means for presenting search results. Further, it provides such an Internet client-server system further comprising computer means for searchably capturing for such database at least one item of such knowledge selected from the group consisting essentially of: user-advice opinions of experts people who can help miscellaneous such knowledge of users. Even further, it provides such an Internet client-server system further comprising computer means for substantially-automatic website managing. Moreover, it provides such an Internet client-server system further comprising computer means for automatically rewarding assisting users for website management assistance. Additionally, it provides such an Internet client-server system further comprising computer means for searchably capturing for such database such knowledge of users concerning useful sources outside such group of users. Also, it provides such an Internet client-server system further comprising computer means for providing at least one capability for at least one user to automatically take a desired survey among a selected subgroup of such users.

In addition, it provides such an Internet client-server system wherein such interface means for user-searching, using at least one natural-language word, to select at least one desired kind of stored experience, further comprises computer means for selecting, if any, such at least one kind of stored experience associated with chosen such at least one natural language word; computer means for selecting, if any, such at least one kind of stored experience in which the text of such at least one stored experience contains the chosen such at least one natural-language word; computer means for selecting, if any, such at least one kind of stored experience in which the category of such at least one stored experience contains the chosen such at least one natural-language word; and computer means for selecting, if any, such at least one kind of stored experience in which the title of such at least one stored experience contains the chosen such at least one natural-language word. And, it provides such an Internet client-server system further comprising computer means for automatically managing a reward system to reward efforts of such at least one user. Further, it provides such an Internet client-server system further comprising: computer means for automatically measuring and storing each experience contribution, including users' comments made by each such at least one user; computer means for assigning points to be accumulated for each such experience contribution; computer means for automatically accumulating assigned points for each such experience contribution by each such at least one user; computer means for automatically reporting such points accumulated for each such experience contribution; computer means for defining at least one criteria for awarding prizes based on such accumulated points; and computer means for automatically awarding prizes to such at least one user with accumulated points meeting such at least one criteria.

Even further, it provides such an Internet client-server system further comprising computer means for managing of such database and such group of users essentially without customer website management; computer means for permitting at least one customer to configure a plurality of variables in such computer software for such managing of such database; computer means for automatically setting goals for each such user participating in at least one management community; and computer means for automatically managing a reward system to reward management efforts of each of such at least one user of such at least one management community. Even further, it provides such an Internet client-server system further comprising: computer means for rating the relative overall value of each such at least one item of such experience according to the opinion of each of such involved subset of such population of users; computer means for collecting comments about each at least one item of such experience according to the opinion of each of such involved subset of such population of users; and computer means for associating, in such database, respective such ratings of relative overall value and respective such collected comments with respective such at least one item of such experience. Even further, it provides such an Internet client-server system further comprising computer means for automatically accumulating system operation data. Even further, it provides such an Internet client-server system wherein such system operation data comprises: data about compliance with such set of performance goals for each of at least one involved subset of such population of users; data about each type of such stored experience; data about such reward system; and data about interviews of each of such involved subset of such population of users. Even further, it provides such an Internet client-server system further comprising computer means for permitting such at least one user to view successively more detailed levels of such automatically accumulated system operation data. Even further, it provides such an Internet client-server system further comprising: computer means for requesting installation of at least one independent database access module onto the personal computer of such at least one user; computer means for permitting selection, using such independent database access module, of at least one category of such knowledge for display by such at least one user; computer means for automatically searching, using such at least one independent database access module, such database, without need of a browser, for at least one selected category of such knowledge from such database; and computer means for displaying, using such at least one independent database access module, found knowledge from such at least one pre-determined category of such knowledge from such database to such at least one user.

Even further, it provides such an Internet client-server system further comprising: computer means for displaying continuously at least one selected type of such pre-determined information from at least one pre-determined category of such knowledge from such knowledge stored in such database to such at least one user; and computer means for scrolling a display of at least one selected type of such pre-determined information from at least one pre-determined category of such knowledge from such knowledge stored in such database to such at least one user. Even further, it provides such an Internet client-server system further comprising: computer means for making specific requests for information from information stored in such database by such at least one user. Even further, it provides such an Internet client-server system further comprising: computer means for receiving at least one request for information from such at least one user; computer means for storing such at least one request for information; computer means for notifying designated other such at least one user with particular expertise about such at least one request for information; computer means for storing such at least one request for information and at least one response by such at least one user with particular expertise as such at least one experience; and computer means for notifying such at least one user, requesting information, of such at least one experience containing such at least one request and such at least one response.

Even further, it provides such Internet client-server systems wherein: such common goal is sales-oriented, such group of users comprises sales personnel; and those receiving such benefit comprise sales personnel.

### GLOSSARY OF GENERAL TERMS AND ACRONYMS

The following terms and acronyms explained below as background and are used throughout the detailed description:

Client-Server. A model of interaction in a distributed system in which a program at one site sends a request to a program at another site and waits for a response. The requesting program is called the “client,” and the program which responds to the request is called the “server.” In the context of the World Wide Web, the client is typically a “Web browser” which runs on a user's computer; the program which responds to Web browser requests at a Web site is commonly referred to as a “Web server.”

Contributor or Managing Member or Correspondent. An individual, who has been determined to be qualified and who has committed to a given level of effort to review and add subjects to the database for which he/she earns points in the contributor's pool of earned points. A contributor also is sometimes referred to as a correspondent or managing member.

Domain Name System (DNS). An Internet service that translates domain names (which are alphabetic identifiers) into IP addresses (which are numeric identifiers for machines on a TCP/IP network).

Experience. This term is used interchangeably with the term “subject” and is intended to have the same definition.

Guest. An individual who registers, utilizes the database information and provides ratings, opinions, comments and feedback. A guest may earn points in the guest pool of earned points or additional access to database content for his/her contributions of ratings, comments, opinions, etc.

HyperText Markup Language (HTML). A standard coding convention and set of codes for attaching presentation and linking attributes to informational content within documents. During a document authoring stage, the HTML codes (referred to as “tags”) are embedded within the informational content of the document. When the Web document (or “HTML document”) is subsequently transferred from a Web server to a Web browser, the codes are interpreted by the Web browser and used to parse and display the document. In addition to specifying how the Web browser is to display the document, HTML tags can be used to create links to other websites and other Web documents (commonly referred to as “hyperlinks”). For more information on HTML, see Ian S. Graham, The HTML Source Book, John Wiley and Sons, Inc., 1995 (ISBN 0471-11894-4).

HyperText Transport Protocol (HTTP). The standard World Wide Web client-server protocol used for the exchange of information (such as HTML documents, and client requests for such documents) between a Web browser and a Web server. HTTP includes a number of different types of messages that can be sent from the client to the server to request different types of server actions. For example, a “GET” message, which has the format GET, causes the server to return the document or file located at the specified Universal Resource Locator (URL).

Internet. A collection of interconnected (public and/or private) networks that are linked together by a set of standard protocols to form a distributed network. While this term is intended to refer to what is now commonly known as the Internet, it is also intended to encompass variations which may be made in the future, including changes and additions to existing standard protocols.

Internet Information Server (IIS). Microsoft Corporation's Web server that runs on Windows NT platforms.

Java. A general purpose programming language developed by Sun Microsystems. Java has a number of features that make the language well-suited for use on the World Wide Web. Small Java applications are called Java applets and can be downloaded from a Web server and run on a personal computer by a Java-compatible Web browser, such as Netscape Navigator or Microsoft Explorer.

Java Servlets. A small Java-based program designed to perform a specific task within a Web server environment. Java Servlets are analogous to Java applets except they are designed to only run on the Web server.

Java Virtual Machine. A set of applications that create a run time environment for executing Java code.

JRun. A server-side extension that allows a Web server to execute Java Servlets for the processing and display of information. JRun is a widely adopted engine for developing and deploying server-side Java applications that use Java Servlets and JavaServer Pages (JSP).

Java Database Connectivity (JDBC). A Java API developed by JavaSoft, a subsidiary of Sun Microsystems of Mountain View, Calif. JDBC enables Java programs to execute SQL statements, which allows Java programs to interact with any SQL-compliant database. Since many relational database management systems (DBMSs) support SQL, and because Java itself runs on most platforms, JDBC makes it possible to write a single database application that can run on different platforms and interact with different database management systems. JDBC is similar to ODBC but is designed specifically for Java programs, whereas ODBC is language-independent.

Open DataBase Connectivity (ODBC). A database access method developed by Microsoft Corporation. ODBC allows an application to access data from a database by translating the application's data queries into commands that the database management system (DBMS) can understand.

Sponsor. A person, organization, or business that agrees to pay the company a monthly fee in return for the opportunity to add additional information about their subjects to the database or the opportunity to provide direct links to the sponsor's own web site.

Subject. Represents the information content that describes a specific product, service, topic, or a leisure or recreational activity contained in the database, preferably an exceptional experience. Each subject entry contains some “profile” information and the descriptive words or terms used to describe and/or rate the experience. As applied to Sales Advice embodiments herein, “Subject” refers to the topic/product/service about which the advice is being given or sought.

Transmission Control Protocol/Internet Protocol (TCP/IP). A standard Internet protocol (or set of protocols) which specifies how two computers exchange data over the Internet. TCP/IP handles issues such as packetization, packet addressing, handshaking and error correction. For more information on TCP/IP, see Volumes I, II and III of Comer and Stevens, Internetworking with TCP/IP, Prentice Hall, Inc., ISBNs 0-13-468505-9 (vol. I), 0-13-125527-4 (vol. II), and 0-13-474222-2 (vol. III).

Uniform Resource Locator (URL). A unique address which fully specifies the location of a file or other resource on the Internet. The general format of a URL is protocol://machine address:port/path/filename. The port specification is optional, and if none is entered by the user, the Web browser defaults to the standard port for whatever service is specified as the protocol. For example, if HTTP is specified as the protocol, the Web browser will use the HTTP default port. The machine address in this example is the domain name for the computer or device on which the file is located.

User. Term used to refer to either guests or contributors, or both, where no distinction of role is required.

World Wide Web (“Web”). Used herein to refer generally to both (1) a distributed collection of interlinked, user-viewable hypertext documents (commonly referred to as “Web documents”, “Web pages”, “electronic pages” or “home pages”) that are accessible via the Internet, and (2) the client and server software components that provide user access to such documents using standardized Internet protocols. Currently, the primary standard protocol for allowing applications to locate and acquire Web documents is the HyperText Transfer Protocol (HTTP), and the electronic pages are encoded using the HyperText Markup Language (HTML). However, the terms “World Wide Web” and “Web” are intended to encompass future markup languages and transport protocols which may be used in place of or in addition to the HyperText Markup Language and the HyperText Transfer Protocol.

### BRIEF DESCRIPTION OF THE DRAWINGS

FIG. 1-A is diagrammatical overview of the Internet communications used in the instant system according to a first described preferred embodiment of the present invention.

FIG. 1-B is diagrammatical overview of the website computer system according to a first described preferred embodiment of the present invention.

FIG. 1-C is diagrammatical overview of the relationship among the website servers and the users according to a first described preferred embodiment of the present invention.

FIG. 2 is a diagrammatical view of a prior art system according to a first described preferred embodiment of the present invention.

FIG. 3 is a diagrammatical view of the instant system according to a first described preferred embodiment of the present invention.

FIG. 4 is a diagrammatical view of the activity database according to a first described preferred embodiment of the present invention.

FIG. 5 is a diagrammatical view of the experience management automation according to a first described preferred embodiment of the present invention.

FIG. 6 is a diagrammatical view of the word management automation according to a first described preferred embodiment of the present invention.

FIG. 7 is a diagrammatical view of reporting management automation according to a first described preferred embodiment of the present invention.

FIG. 8 is a diagrammatical view of the correspondent and member management automation according to a first described preferred embodiment of the present invention.

FIG. 9 is a diagrammatical view of the rewards management automation according to a first described preferred embodiment of the present invention.

FIG. 10 is a diagrammatical view of the sponsorship management automation according to a first described preferred embodiment of the present invention.

FIG. 11 is a diagrammatical view of the sponsorship process according to a first described preferred embodiment of the present invention.

FIG. 12 is a further diagrammatical view illustrating the automated management of sponsorships according to a first described preferred embodiment of the present invention.

FIG. 13 is a diagrammatical view of adding and viewing subjects according to a first described preferred embodiment of the present invention.

FIG. 14 is a diagrammatical view of the weighting of overall subject and descriptive word ratings according to a first described preferred embodiment of the present invention.

FIG. 15 is a diagrammatical view of the e-mail management automation according to a first described preferred embodiment of the present invention.

FIG. 16 is a diagrammatical view of the descriptive word promotion according to a first described preferred embodiment of the present invention.

FIG. 17 is a diagrammatical view of the subject search process according to a first described preferred embodiment of the present invention.

FIG. 18 shows explanatory notes relating to FIG. 17 according to a first described preferred embodiment of the present invention.

FIG. 19 is a diagrammatical view of the preferred survey procedure according to a first described preferred embodiment of the present invention.

FIG. 20 is a diagrammatical view of the preferred instant software system according to a first described preferred embodiment of the present invention.

FIG. 21 is a diagrammatical view of the home page screen according to a first described preferred embodiment of the present invention.

FIG. 22 is a diagrammatical view of the search box screen according to a first described preferred embodiment of the present invention.

FIG. 23 is a diagrammatical view of the category box screen according to a first described preferred embodiment of the present invention.

FIG. 24 is a diagrammatical view of the Terraformer (Configuration and Administration) Module screen according to a first described preferred embodiment of the present invention.

FIG. 25 is a diagrammatical view of the subcategories button screen according to a first described preferred embodiment of the present invention.

FIGS. 26-A and 26-B are diagrammatical views of the member registration screen according to a first described preferred embodiment of the present invention.

FIGS. 27-A and 27-B are diagrammatical views of the correspondent registration screen according to a first described preferred embodiment of the present invention.

FIG. 28 is a diagrammatical view of the correspondent application screen according to a first described preferred embodiment of the present invention.

FIG. 29 is a diagrammatical view of the questions screen according to a first described preferred embodiment of the present invention.

FIG. 30 is a diagrammatical view of the answers screen according to a first described preferred embodiment of the present invention.

FIGS. 31-33 are diagrammatical views of the add-a-subject screens according to a first described preferred embodiment of the present invention.

FIG. 34 is a diagrammatical view of a preferred screen illustrating the minimum and maximum number of descriptive words one wants to display for the user during the process of adding a subject according to a first described preferred embodiment of the present invention.

FIG. 35 is a further diagrammatical view of the descriptive word screen according to a first described preferred embodiment of the present invention.

FIG. 36 is a diagrammatical view of a preferred screen for add-a-subject according to a first described preferred embodiment of the present invention.

FIG. 37 is a diagrammatical view of a screen depicting the configuration of opinion multipliers according to a first described preferred embodiment of the present invention.

FIGS. 38-A and 38-B are diagrammatical views of a screen illustrating the add-a-subject process, showing the words to be rated according to a first described preferred embodiment of the present invention.

FIG. 39 is a diagrammatical view of the add-additional-words screen according to a first described preferred embodiment of the present invention.

FIG. 40 is a diagrammatical view of the comments screen according to a first described preferred embodiment of the present invention.

FIGS. 41-A and 41-B are diagrammatical views of the preview screen according to a first described preferred embodiment of the present invention.

FIG. 42 is a diagrammatical view of the results screen according to a first described preferred embodiment of the present invention.

FIGS. 43-A and 43-B are diagrammatical top views of the subject page screen.

FIG. 44 is a diagrammatical view of the subcategories screen according to a first described preferred embodiment of the present invention.

FIGS. 45-A and 45-B are diagrammatical views of personalized search screens according to a first described preferred embodiment of the present invention.

FIG. 46 is a diagrammatical view of a screen illustrating the descriptive words and/or phrases pre-selected by the client to appear with a category according to a first described preferred embodiment of the present invention.

FIG. 47 is a diagrammatical view of a box in the lower left-hand corner of the subject page screen, offering the opportunity to sponsor the subject according to a first described preferred embodiment of the present invention.

FIGS. 48-A and 48-B are diagrammatical views of the screen returned to begin to get the desired information from the sponsor according to a first described preferred embodiment of the present invention.

FIGS. 49-A through 49-D are diagrammatical views of screens illustrating the next sponsorship screens to receive information according to a first described preferred embodiment of the present invention.

FIG. 50 is a diagrammatical view of the sponsor section headers screen according to a first described preferred embodiment of the present invention.

FIGS. 51-A through 51-C are diagrammatical top-to-bottom views of the newly sponsored page screen according to a first described preferred embodiment of the present invention.

FIG. 52 is a diagrammatical view of the payment information screen according to a first described preferred embodiment of the present invention.

FIG. 53 is a diagrammatical view of the screen illustrating the confirmation of sponsorship according to a first described preferred embodiment of the present invention.

FIGS. 54-A and 54-B are top-to-bottom diagrammatical views of the subject-just-sponsored screen according to a first described preferred embodiment of the present invention.

FIGS. 55-A and 55-B are diagrammatical views illustrating the screen where a registered user may add opinions to an existing subject's rating and reviewing according to a first described preferred embodiment of the present invention.

FIG. 56 is a diagrammatical view of the improvement screen according to a first described preferred embodiment of the present invention.

FIGS. 57-A and 57-B are diagrammatical views of the screen illustrating the various elements comprising each “MyPage” according to a first described preferred embodiment of the present invention.

FIG. 58 is a diagrammatical view of the screen illustrating the “My Contributions” box according to a first described preferred embodiment of the present invention.

FIG. 59 is a diagrammatical view of the “Subjects Added” screen according to a first described preferred embodiment of the present invention.

FIG. 60 is a diagrammatical view of the screen illustrating the “Lives Touched” box according to a first described preferred embodiment of the present invention.

FIG. 61 is a diagrammatical view of the comments screen according to a first described preferred embodiment of the present invention.

FIG. 62 is a further diagrammatical view of the comments screen according to a first described preferred embodiment of the present invention.

FIG. 63 is a diagrammatical view of the screen illustrating a sample page for “Subjects Awaiting Approval” according to a first described preferred embodiment of the present invention.

FIG. 64 is a diagrammatical view showing a rejected subjects screen according to a first described preferred embodiment of the present invention.

FIG. 65 is a diagrammatical view of the “To Do List” screen according to a first described preferred embodiment of the present invention.

FIG. 66 is a diagrammatical view of the “Notify organizations for Subjects added” screen according to a first described preferred embodiment of the present invention.

FIG. 67 is a diagrammatical view of the screen illustrating the sending an email to an organization according to a first described preferred embodiment of the present invention.

FIG. 68 is a diagrammatical view of the screen showing details of the subjects added according to a first described preferred embodiment of the present invention.

FIG. 69 is a diagrammatical view of the screen illustrating further details of an added subject awaiting review according to a first described preferred embodiment of the present invention.

FIG. 70 is a diagrammatical view illustrating a reviewing improvements screen according to a first described preferred embodiment of the present invention.

FIGS. 71-A and 71-B are diagrammatical views of a screen wherein the correspondent can review improvements according to a first described preferred embodiment of the present invention.

FIG. 72 is a diagrammatical view of the process of deleting subjects from the screen according to a first described preferred embodiment of the present invention.

FIG. 73 is a diagrammatical view of the screen illustrating the subject that's recommended for deletion according to a first described preferred embodiment of the present invention.

FIG. 74 is a diagrammatical view of a screen illustrating “My Favorite Subjects” box according to a first described preferred embodiment of the present invention.

FIG. 75 is a diagrammatical view of a screen illustrating “My Interests” box according to a first described preferred embodiment of the present invention.

FIG. 76 is a diagrammatical view of a screen illustrating “My Organization” box according to a first described preferred embodiment of the present invention.

FIG. 77 is a diagrammatical view of a screen illustrating “My Rewards” box according to a first described preferred embodiment of the present invention.

FIG. 78 is a diagrammatical view of a screen illustrating points earned according to a first described preferred embodiment of the present invention.

FIG. 79 is a diagrammatical view of a screen illustrating the subjects added in an area according to a first described preferred embodiment of the present invention.

FIG. 80 is a diagrammatical view of the “Account Balance” screen according to a first described preferred embodiment of the present invention.

FIG. 81 is a diagrammatical view of a screen illustrating cash out according to a first described preferred embodiment of the present invention.

FIG. 82 is a diagrammatical view of the screen for “Tell a Friend” according to a first described preferred embodiment of the present invention.

FIG. 83 is a diagrammatical view of the “Rate other comments” screen according to a first described preferred embodiment of the present invention.

FIG. 84 is a diagrammatical view of the add-a-comment screen according to a first described preferred embodiment of the present invention.

FIG. 85 is a diagrammatical view of a screen illustrating the configuration of points per action according to a first described preferred embodiment of the present invention.

FIG. 86 is a diagrammatical view of a screen illustrating the configuration of contests.

FIG. 87 is a diagrammatical view of a screen illustrating the configuration of category display according to a first described preferred embodiment of the present invention.

FIG. 88 is a diagrammatical view of a screen illustrating the configuration of regions according to a first described preferred embodiment of the present invention.

FIG. 89 is a diagrammatical view of a screen illustrating the process of editing the name of an existing region according to a first described preferred embodiment of the present invention.

FIG. 90 is a diagrammatical view of a screen illustrating the configuration of age groups in Terraformer (Configuration and Administration) Module according to a first described preferred embodiment of the present invention.

FIG. 91 is a diagrammatical view of a screen illustrating the configuration of bonus points in Terraformer (Configuration and Administration) Module according to a first described preferred embodiment of the present invention.

FIG. 92 is a diagrammatical view of a screen illustrating the configuration of point goals and opinion multipliers in Terraformer (Configuration and Administration) Module according to a first described preferred embodiment of the present invention.

FIG. 93 is a diagrammatical view of a screen illustrating the configuration of feedback subjects in Terraformer (Configuration and Administration) Module according to a first described preferred embodiment of the present invention.

FIG. 94 is a diagrammatical view of a screen illustrating the configuration of sponsorship fees in Terraformer (Configuration and Administration) Module according to a first described preferred embodiment of the present invention.

FIGS. 95-A and 95-B are diagrammatical views of a screen illustrating how to create and manage surveys with the survey tool according to a first described preferred embodiment of the present invention.

FIGS. 96-A and 96-B are diagrammatical views of the “Create a Survey” screen according to a first described preferred embodiment of the present invention.

FIG. 97 is a diagrammatical view of a screen illustrating further survey elements according to a first described preferred embodiment of the present invention.

FIGS. 98-A and 98-B are diagrammatical views of a screen illustrating response and results in connection with a survey according to a first described preferred embodiment of the present invention.

FIG. 99 is a diagrammatical view of a screen illustrating the survey area text-customization process according to a first described preferred embodiment of the present invention.

FIG. 100 is a diagrammatical view of a screen illustrating the custom text fields for use at survey completion according to a first described preferred embodiment of the present invention.

FIG. 101 is a diagrammatical view of a screen illustrating the “Congratulations” page following a survey according to a first described preferred embodiment of the present invention.

FIG. 102 is a diagrammatical view of a screen illustrating the “User Account History” page according to a first described preferred embodiment of the present invention.

FIG. 103 is a diagrammatical view of a preferred business method according to a second described preferred embodiment of the present invention.

FIG. 104 is diagrammatical view of a preferred business method for implementing the system for a licensee according to a second described preferred embodiment of the present invention.

FIG. 105 is schematic view of the processes for using Advice Spy according to a second described preferred embodiment of the present invention.

FIG. 106 is schematic view of the search methods used when using keyword search according to a second described preferred embodiment of the present invention.

FIG. 107 illustrates a sample preferred Login screen according to a second described preferred embodiment of the present invention.

FIG. 108 is a preferred screen display for helping a user log in to the system according to a second described preferred embodiment of the present invention.

FIG. 109 illustrates a sample preferred screen displayed after logging out of the system according to a second described preferred embodiment of the present invention.

FIG. 110A and FIG. 110B illustrate a sample preferred home page according to a second described preferred embodiment of the present invention.

FIG. 111 demonstrates the Browse by Category screen according to a second described preferred embodiment of the present invention.

FIG. 112 is a sample preferred Keyword Search Results screen according to a second described preferred embodiment of the present invention.

FIG. 113 is a sample preferred Search Results—Matches Found screen according to a second described preferred embodiment of the present invention.

FIG. 114 is a sample preferred Search Results—No Matches Found screen according to a second described preferred embodiment of the present invention.

FIG. 115 is a sample preferred Refine Search screen according to a second described preferred embodiment of the present invention.

FIG. 116 is a sample preferred Expert Search Results screen according to a second described preferred embodiment of the present invention.

FIG. 117 is a sample preferred Browse Experts screen according to a second described preferred embodiment of the present invention.

FIG. 118A and FIG. 118B present a sample preferred Sales Advice screen providing information about particular experience according to a second described preferred embodiment of the present invention.

FIG. 119 is a sample preferred Sales Advice Sales Cycle Usage Breakdown screen according to a second described preferred embodiment of the present invention.

FIG. 120 is a sample preferred Sales Advice—Individual screen providing information about a particular person in the database according to a second described preferred embodiment of the present invention.

FIG. 121 is a sample preferred Sales Advice Attachments screen according to a second described preferred embodiment of the present invention.

FIG. 122A and FIG. 122B present sample preferred Comments screen for a selected Sale Advice entry according to a second described preferred embodiment of the present invention.

FIG. 123 is a sample preferred rating points award screen for an action taken according to a second described preferred embodiment of the present invention.

FIG. 124 is a sample preferred Collective Feedback summarizing the nature of other's feedback about selected Sales Advice screen according to a second described preferred embodiment of the present invention.

FIG. 125 is a sample preferred Add Comments screen which allows a user to add his/her own comments about a selected Sales Advice according to a second described preferred embodiment of the present invention.

FIG. 126A, FIG. 126B and FIG. 126C present a sample preferred Add Sales Advice Step 1 of 3 screen according to a second described preferred embodiment of the present invention.

FIG. 127A and FIG. 127B present sample preferred Add Sales Advice Step 2 of 3 screen according to a second described preferred embodiment of the present invention.

FIG. 128A and FIG. 128B illustrate a sample preferred Add Sales Advice Step 3 of 3 Preview screen according to a second described preferred embodiment of the present invention.

FIG. 129A and FIG. 129B present a sample preferred Add Sales Advice Step 3 of 3 Add screen according to a second described preferred embodiment of the present invention.

FIG. 130 is a sample preferred Add Sales Advice Thank You screen when no additional approval is required according to a second described preferred embodiment of the present invention.

FIG. 131A and FIG. 131B illustrate a sample preferred Add External Expert screen according to a second described preferred embodiment of the present invention.

FIG. 132A and FIG. 132B illustrate a sample preferred Add Internal Expert screen according to a second described preferred embodiment of the present invention.

FIG. 133A and FIG. 133B is a sample preferred My Page screen.

FIG. 134A and FIG. 134B present a sample preferred My Page—Sales Advice Added screen which provides a summary of Sales Advice added by the user according to a second described preferred embodiment of the present invention.

FIG. 135A and FIG. 135B is a sample preferred My Profile—Edit screen which allows users to update their profile according to a second described preferred embodiment of the present invention.

FIG. 136 is a sample preferred My Page—Review Queue—Q&A screen which is used to begin the process of reviewing and answering submitted Q&A entries.

FIG. 137A and FIG. 137B illustrate a sample preferred Q&A Review Respond Step 1 screen according to a second described preferred embodiment of the present invention.

FIG. 138A and FIG. 138B is a sample preferred Q&A Review and Respond Step 2 screen according to a second described preferred embodiment of the present invention.

FIG. 139 is a sample preferred Q&A Review and Respond Step 3 screen according to a second described preferred embodiment of the present invention.

FIG. 140A and FIG. 140B present a sample preferred Q&A Review and Respond Completion screen according to a second described preferred embodiment of the present invention.

FIG. 141 is a sample preferred Q&A question entry screen for entering and editing questions to be submitted according to a second described preferred embodiment of the present invention.

FIG. 142 is a sample preferred Q&A Question Possible Matches screen which indicates other submitted questions which may match the current question according to a second described preferred embodiment of the present invention.

FIG. 143 is a sample preferred Q&A Question Submission Complete screen indicating the question has been successfully submitted according to a second described preferred embodiment of the present invention.

FIG. 144 is a sample preferred Info Need screen which provides users a method for inputting suggestions regarding additional database content according to a second described preferred embodiment of the present invention.

FIG. 145 is a sample preferred Info Need Submission Complete screen which confirms acceptance of the submitted Info Need according to a second described preferred embodiment of the present invention.

FIG. 146 is a sample preferred Info Need List screen which displays submitted Info Needs and user's agreement according to a second described preferred embodiment of the present invention.

FIG. 147 is a sample preferred Awards & Standings screen which displays a user's overall standing in all awards and promotions programs according to a second described preferred embodiment of the present invention.

FIG. 148 is a sample preferred Awards & Standings Winners screen presenting the winners for a particular promotion according to a second described preferred embodiment of the present invention.

FIG. 149 is a sample preferred Awards & Standings Promotion Details screen for a particular promotion according to a second described preferred embodiment of the present invention.

FIG. 150 is a sample preferred Awards & Standings Promotions screen summarizing current and past promotions according to a second described preferred embodiment of the present invention.

FIG. 151 is a sample preferred Awards & Standings Point Club screen summarizing the current point clubs and points leaders according to a second described preferred embodiment of the present invention.

FIG. 152A and FIG. 152B present a sample preferred Point Club Set Up and edit screen according to a second described preferred embodiment of the present invention.

FIG. 153 is a sample preferred Point Club Set Up Completion screen according to a second described preferred embodiment of the present invention.

FIG. 154 is a sample preferred My Points screen summarizing what actions have been taken and their related points for a user according to a second described preferred embodiment of the present invention.

FIG. 155 is a sample preferred My Rank Total Points screen which provides a summary of a user's total points and how the user compares to other users according to a second described preferred embodiment of the present invention.

FIG. 156 is a sample preferred My Rank Sales Advice Added screen summary of a user's total points and how the user compares to other users for a specific action such as adding Sales Advice according to a second described preferred embodiment of the present invention.

FIG. 157 is a sample preferred Promotion Set up Step 1 screen for establishing a new promotion according to a second described preferred embodiment of the present invention.

FIG. 158A and FIG. 158B present a sample preferred Contest/Promotion Set up Qualifications (Step 2) screen for establishing a new promotion according to a second described preferred embodiment of the present invention.

FIG. 159A and FIG. 159B illustrate a sample preferred Promotion Set up Sweepstakes Qualifications (Step 2) screen for sweepstakes type of promotions according to a second described preferred embodiment of the present invention.

FIG. 160A and FIG. 160B is a sample preferred Promotion Set up Award Type (Step 3) screen which describes the awards to be offered for a particular promotion according to a second described preferred embodiment of the present invention.

FIG. 161 is a sample preferred Promotion Set up Date Set Up (Step 4) screen which sets the effective dates for a particular promotion according to a second described preferred embodiment of the present invention.

FIG. 162A and FIG. 162B illustrate a sample preferred Promotion Set up Preview (Step 5) screen according to a second described preferred embodiment of the present invention.

FIG. 163 is a sample preferred Promotion Set Up complete screen which confirms successful completion of a particular promotion according to a second described preferred embodiment of the present invention.

FIG. 164 is a sample preferred Points & Rank screen providing an overview of a user's overall points and rank and standing in various points clubs according to a second described preferred embodiment of the present invention.

FIG. 165 is a sample preferred Your Points & Rank screen displaying a users earned awards in various points clubs according to a second described preferred embodiment of the present invention.

FIG. 166 is a sample preferred Advice Spy starting point from the mypage screen (FIG. 133A and FIG. 133B) according to a second described preferred embodiment of the present invention.

FIG. 167 is a sample preferred Advice Spy login and initial set up screen according to a second described preferred embodiment of the present invention.

FIG. 168 is a sample preferred Advice Spy overview screen according to a second described preferred embodiment of the present invention.

FIG. 169 is a sample preferred Advice Spy My Interests summary with links to the main site screen according to a second described preferred embodiment of the present invention.

FIG. 170 is a sample preferred Advice Spy Promotions Summary and links screen to the main site according to a second described preferred embodiment of the present invention.

FIG. 171 is an example preferred general preferences screen according to a second described preferred embodiment of the present invention.

FIG. 172 is an example preferred alerts preferences screen according to a second described preferred embodiment of the present invention.

FIG. 173 is an example preferred ticker preferences screen according to a second described preferred embodiment of the present invention.

Reporting Drill Down according to a second described preferred embodiment of the present invention

FIG. 174 is an example preferred My Reports section of the mypage screen (FIG. 133A and FIG. 133B) according to a second described preferred embodiment of the present invention.

FIG. 175 is an example preferred listing of reports a users is authorized to access according to a second described preferred embodiment of the present invention.

FIG. 176 is an example preferred screen presenting the reporting options which are user selectable according to a second described preferred embodiment of the present invention.

FIG. 177 is an example preferred screen displaying the highest level report summary for a selected report according to a second described preferred embodiment of the present invention.

FIG. 178 is an example preferred screen presenting the next level of detail for a selected report according to a second described preferred embodiment of the present invention.

FIG. 179 is an example preferred screen providing detail user profile information from a selected report according to a second described preferred embodiment of the present invention.

FIG. 180 is an example preferred screen providing a third level of detail for a selected report according to a second described preferred embodiment of the present invention.

FIG. 181 is an example preferred screen providing a fourth level of detail for a selected report according to a second described preferred embodiment of the present invention.

FIG. 182A and FIG. 182B illustrate a preferred screen for adding and editing alerts presented to users on login according to a second described preferred embodiment of the present invention.

FIG. 183A and FIG. 183B illustrate a preferred screen for setting up bonus points according to a second described preferred embodiment of the present invention.

FIG. 184 illustrates a preferred screen for previewing a bonus points set up according to a second described preferred embodiment of the present invention.

FIG. 185 illustrates a preferred screen providing confirmation of bonus point set up according to a second described preferred embodiment of the present invention.

FIG. 186A and FIG. 186B illustrate a preferred screen for setting up custom emails and the desired distribution according to a second described preferred embodiment of the present invention.

FIG. 187 illustrates a preferred screen for adding and editing the executive spotlight section on the home page (FIG. 110A and FIG. 110B) according to a second described preferred embodiment of the present invention.

FIG. 188 illustrates a preferred screen for setting up and editing the functional areas used in the system according to a second described preferred embodiment of the present invention.

FIG. 189 illustrates a preferred screen for presenting an overview of the functional areas and their characteristics according to a second described preferred embodiment of the present invention.

FIG. 190 illustrates a preferred screen for assisting in setting authorized access to categories for each functional area according to a second described preferred embodiment of the present invention.

FIG. 191 is a sample preferred screen for presenting user with exceptions to the authorized category access for a functional area according to a second described preferred embodiment of the present invention.

FIG. 192 is a sample preferred screen for displaying a summary of authorizations for actions by category for a functional area according to a second described preferred embodiment of the present invention.

FIG. 193 is a sample preferred screen for setting up user level authorizations for access to various administrative functions according to a second described preferred embodiment of the present invention.

FIG. 194 is a sample preferred screen for setting report area authorizations by functional area according to a second described preferred embodiment of the present invention.

FIG. 195 is a sample preferred screen for setting which functional areas have authorizations to view user profiles to according to a second described preferred embodiment of the present invention.

FIG. 196 is a sample preferred screen used to define the preferred keywords used to describe experts according to a second described preferred embodiment of the present invention.

FIG. 197A and FIG. 197B illustrate a sample preferred screen for setting up an introductory message for first time users according to a second described preferred embodiment of the present invention.

FIG. 198A and FIG. 198B present sample preferred screen for adding and editing the news and notes section of the home page (FIG. 110A and FIG. 110B) according to a second described preferred embodiment of the present invention.

FIG. 199A and FIG. 199B illustrate a sample preferred screen for setting up and editing points clubs according to a second described preferred embodiment of the present invention.

FIG. 200A and FIG. 200B illustrate sample preferred screen setting up and managing the polling section of the home page (FIG. 110A and FIG. 110B) according to a second described preferred embodiment of the present invention.

FIG. 201 is a sample preferred screen for setting up and editing the basic system information according to a second described preferred embodiment of the present invention.

FIG. 202A and FIG. 202B illustrate a sample preferred screen for setting and editing the various system configuration values that control much of the automation of the system according to a second described preferred embodiment of the present invention.

FIG. 203 is a sample preferred screen for basic point values associated with user actions in the system according to a second described preferred embodiment of the present invention.

FIG. 204A and FIG. 204B illustrate a sample preferred screen for adding and editing basic user information and key attributes according to a second described preferred embodiment of the present invention.

### DETAILED DESCRIPTION OF BEST MODE AND

### PREFERRED EMBODIMENTS OF THE INVENTION

Reference will now be made in more detail to best mode and preferred embodiments of the systems of the invention as illustrated in the accompanying drawings, in which like numerals refer to like parts throughout the several views.

It is specially noted, in connection with the herein first described preferred embodiment, that the instant system can measurably capture the opinions, including the evaluative approval opinions, of a population, or subpopulation, of users, by asking users to rate the degree of relevancy of such term to the subject. In that manner, a user who is looking for a tasty (i.e., taste approved by the user), beautifully served (service and/or look of the plate approved by the user) dessert may use those natural-language terms in a search and find desserts that other users (hopefully like the searcher) have rated as desserts to which tasty and beautifully served were considered to be highly relevant. Further, in setting such relevancies, the user is given by the preferred embodiment of the instant system a discrete choice of, preferably, five levels of relevancy, to which can be applied numbers (like 1 through 5), and such ratings, used by a large population, can be “averaged” to obtain an overall rating for that term to that subject. Further, in entering into the instant subject database the relevancy ratings of each of the subpopulation of rating users, distinctions are preferably made as to the level of trust to be given to a particular user's rating; and the instant system uses, again, measurable for assigning a “weight” to be given to that particular opinion when it is “averaged” and saved as an overall rating. Further, when a user uses such natural-language terms to search for subjects, the instant search engine finds those subjects having a high aggregate rating, considering all of the terms and/or other search options, e.g., an average of the overall ratings of the several, say, terms entered by the user in searching. Further, since, in normal word-of-mouth conversations among people, they often try to give and get approval-evaluation information by using such terms, the site operator will have a data “goldmine” about user's favorite such terms to use in favorably discussing the categories of subjects of such website; and such analyzed data will have a ready market at least in the advertising community.

It is also especially noted that, in order to help sell such systems to website operators, the developer should, in the software system design, preferably limit the operator's labor of management and other responsibilities and create automatic income—from which the developer may be paid well. The instant system, in the specific manners described herein, is a preferred embodiment of such a system, needing essentially no operator management—the software itself motivates and rewards the user community sufficiently to keep them doing the sorts of duties otherwise befalling an operator.

In this detailed description, presented first, along with some hardware information, will be on overall look at the systems of the preferred embodiment and the functional interaction among the parties and the system parts, in conjunction with diagrammatic charts. Then the detailed operation of the preferred embodiment will be presented in conjunction with screen diagrams. The various levels and kinds of descriptions herein are intended to be read in conjunction with each other in understanding the details of the described preferred embodiment of the invention.

Preferred First Described System Details

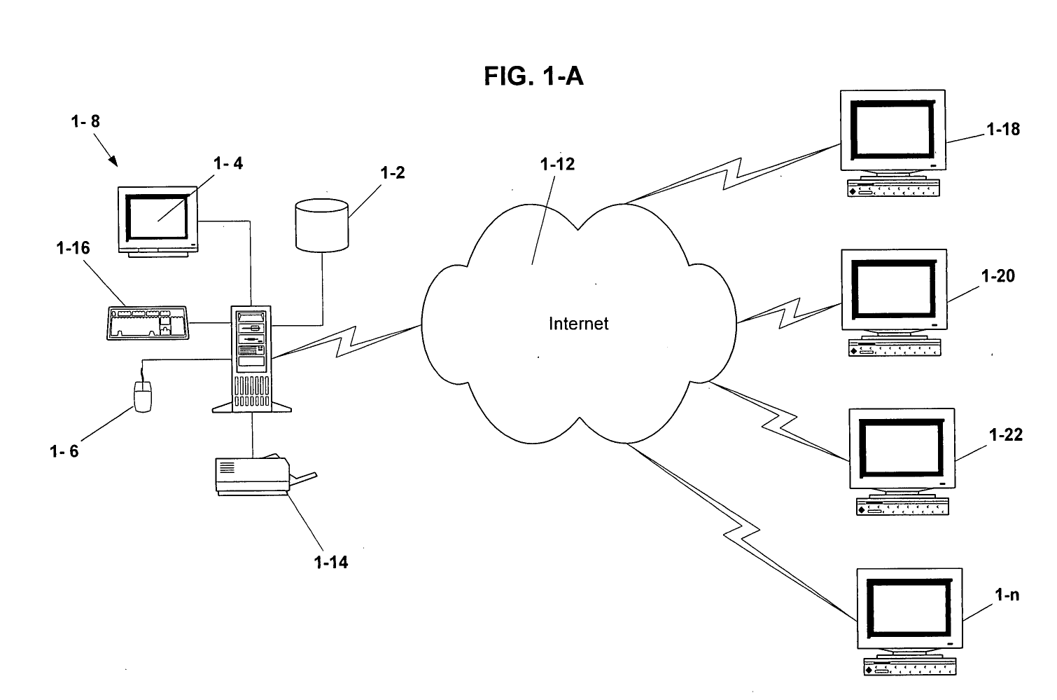

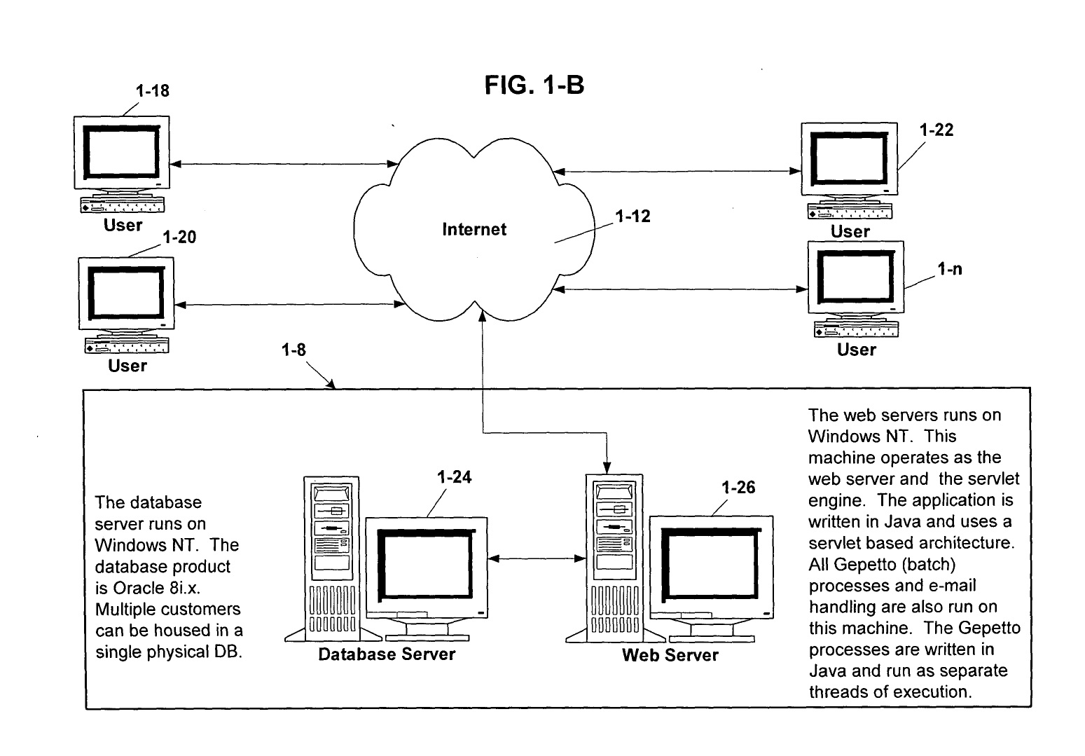

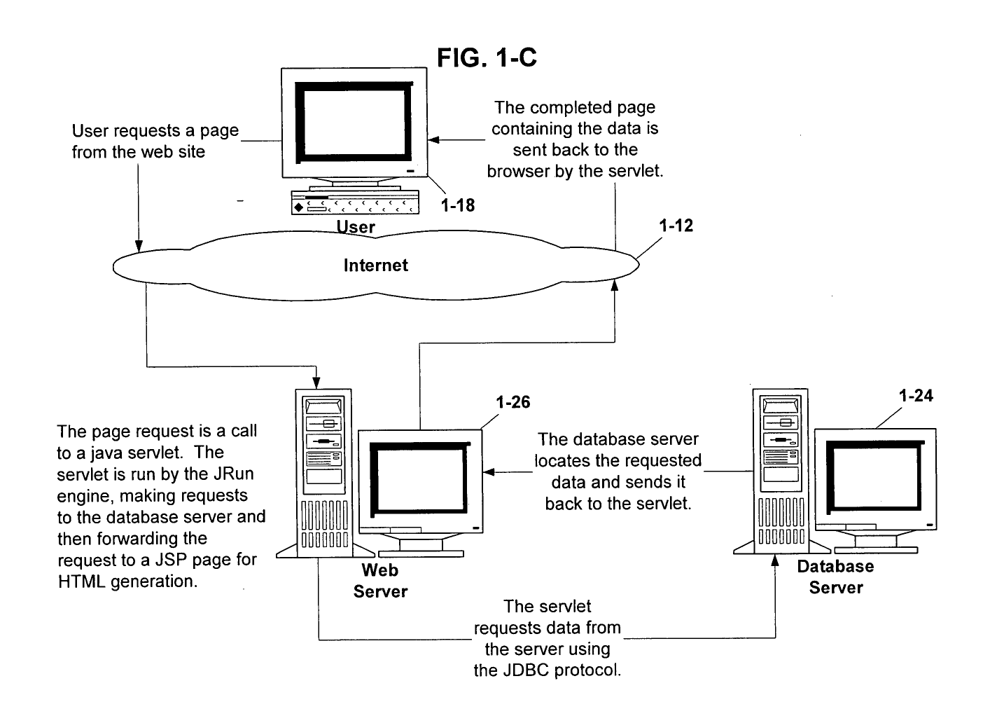

Referring now to FIG. 1-A, an overview of a preferred embodiment of the present invention is shown. The present invention preferably comprises a computer system 1-8. The computer system 1-8 comprises input and output devices as is well known in the art. For example, the computer system 1-8 preferably comprises a display screen or monitor 1-4, a keyboard 1-16, a printer 1-14, a mouse 1-6, etc. The computer system 1-8 further preferably comprises a database 1-2 for storage of the data and software comprising preferred embodiments of the present invention. The computer system 1-8 is preferably connected to the Internet 1-12 that serves as the presently preferred communications medium. The Internet 1-12, as previously discussed, comprises a global network of networks and computers, public and private. The Internet 1-12 is the preferable connection method by the users 1-18, 1-20, 1-22 and 1-n in preferred embodiments of the present invention.

Referring now to FIG. 1-B, the computer system 1-8 is shown in more detail. The computer system 1-8 in a preferred embodiment comprises a database server 1-24 and a web server 1-26. The database server 1-24 preferably runs in a Windows NT environment and preferably utilizes Oracle 8.x as the database engine. The database server 1-24 preferably processes all Gepetto (batch) processes and email. Preferably all Gepetto processes are written in C++ and run as separate execution threads. The web server 1-26 also preferably runs in a Windows NT environment. The web server 1-26 operates as the web server and the servlet engine. Preferably the web server software is written in JAVA.

Referring to FIG. 1-C, a simplified functional diagram of a preferred embodiment of the present invention is shown. This figure shows the preferred relationships between a user 1-18 (exemplary of any number of users 1-18, 1-20, 1-22, 1-n), the internet 1-12, the web server 1-26 and the database server 1-24. As shown, a user 1-18 requests a page from the web site of the present invention. The user 1-18 is preferably connected via the internet 1-12, and the web page request initiates a call to a Java servlet. The servlet is run by the Jrun engine which makes at least one request to the database server 1-24, via the web server 1-26, and generates an HTML page for transmission to the user 1-18 following the database server's completion of the servlet's request and transmission of the requested data back to the web server 1-26. The web server 1-26 transmits the completed HTML page containing the data requested by the user 1-18 through the Internet 1-12 to the user 1-18.

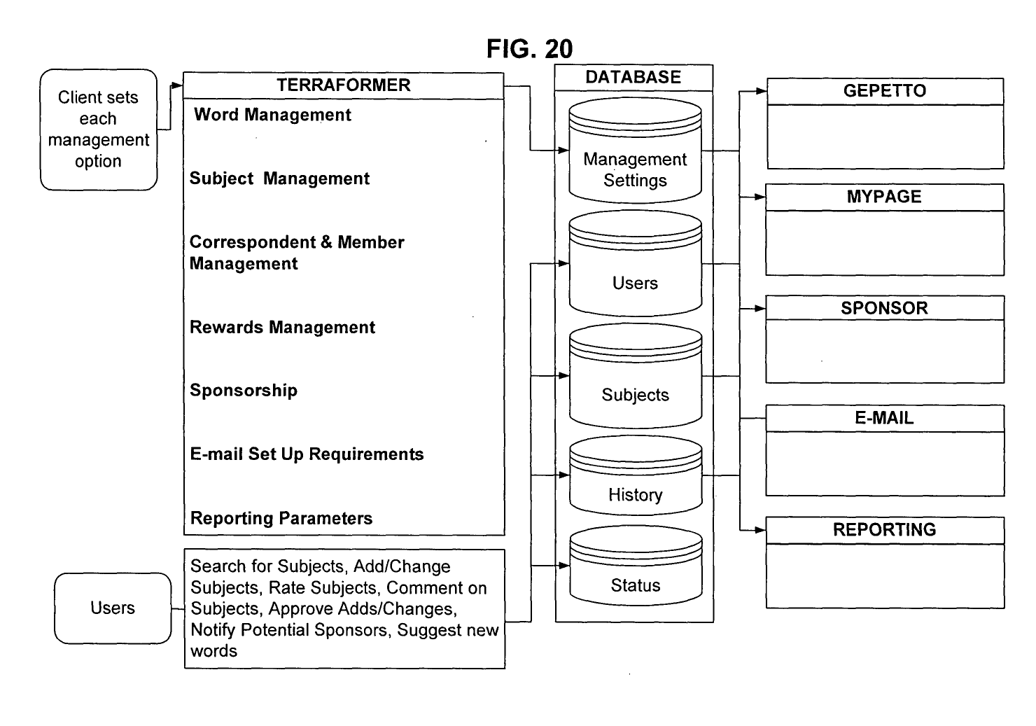

Referring briefly to FIG. 20, a high level functional diagram of the process flows and functions in a first described preferred embodiment of the present invention is shown. Shown herein is that the client sets each management option for the Terraformer (Configuration and Administration) Module, used herein refer to the subsystem of the instant overall system used by customers (website owners) to configure the instant system as preferred by such customer. The Terraformer (Configuration and Administration) Module preferably comprises the following modules which will be explained in greater detail herein below: Word Management, Subject Management, Correspondent & Member Management, Rewards Management, Sponsorship, E-Mail Set Up Requirements, and Reporting Parameters. The Terraformer (Configuration and Administration) Modules are coupled to the database tables. The database tables preferably comprise the following modules that will also be explained in greater detail herein below: Management Settings, Users, Subjects, History, and Status. Also shown is that the users may perform certain tasks or otherwise exercise functions, preferably comprising: Search for subjects, Add/Change Subjects, Rate Subjects, Comment on Subjects, Approve Adds/Changes, Notify Potential Sponsors, and Suggest new words. Further preferably linked to the Database are the main modules or functions: GEPETTO, MYPAGE, SPONSOR, E-MAIL, AND REPORTING.

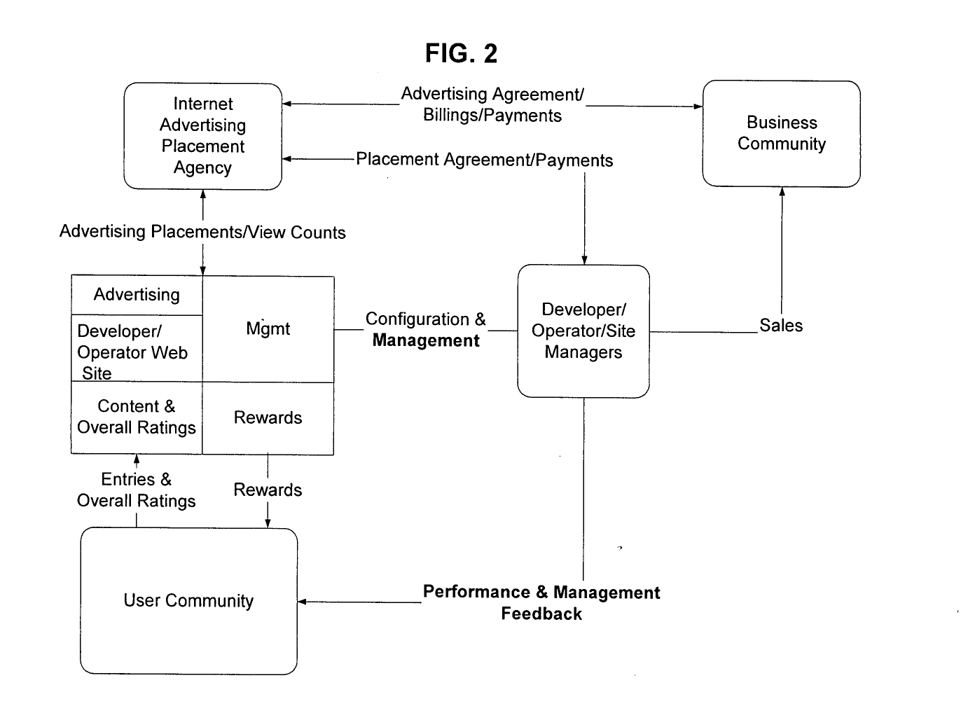

Referring now to FIG. 2, an overview of the prior art comprising an Internet Website serving a community of users to find subjects is shown. The prior art features a plurality of parties comprising an Internet Advertising Placement Agency, the Business Community, the User Community, and the Developer/Operator/Site Managers that interact or have the following relationships between them, with respect to each other and the centrally-located website software, as shown in FIG. 2 and summarized in Table 1 below.

TABLE 1

| | Function(s) - | |
|---|---|---|
| | Relationships to Other | |
| Party | Parties | Party |
| Internet Advertising | Advertising/Billings/ | Business Community |
| Placement Agency | Payments. | |
| | Placement | Developer/Operator/Site |
| | Agreement/Payments | Managers |
| Business Community | Sales | Developer/Operator/Site |
| | | Managers |
| Developer/Operator/ | Performance and | User Community |
| Site Managers | Management Feedback | |

Furthermore, in addition to the above, certain parties have direct responsibility for the Website control and content, and in fact must exercise those functions to maintain the operation of the Website and the interactions with the parties. The prior art Website example comprises components and associated programming of: Advertising, Content & Overall Ratings, Management, & Rewards under the control operation and management of the Developer/Operator. Each of these areas requires input or control from one of the parties. For example: the Internet Advertising Placement Agency is responsible for the Website Advertising Placements/View Counts affecting the Website content and programming; the user community is responsible for Entries & Overall Ratings into the Website, and receives Rewards distributed from the Website; and the Developer/Operator/Site Managers are directly responsible for the Configuration and Management of the Website. It should be noted that in general these functions are not automatic. The parties, in particular the Developer/Operator/Site Managers, must exercise essentially day-to-day control and management of the Website to assure that the users receive awards, the advertising content and placement is correct, the entries and overall ratings are valid, etc. Also, the Developer/Operator/Site Managers must interact directly with the user community to give Performance and Management Feedback.

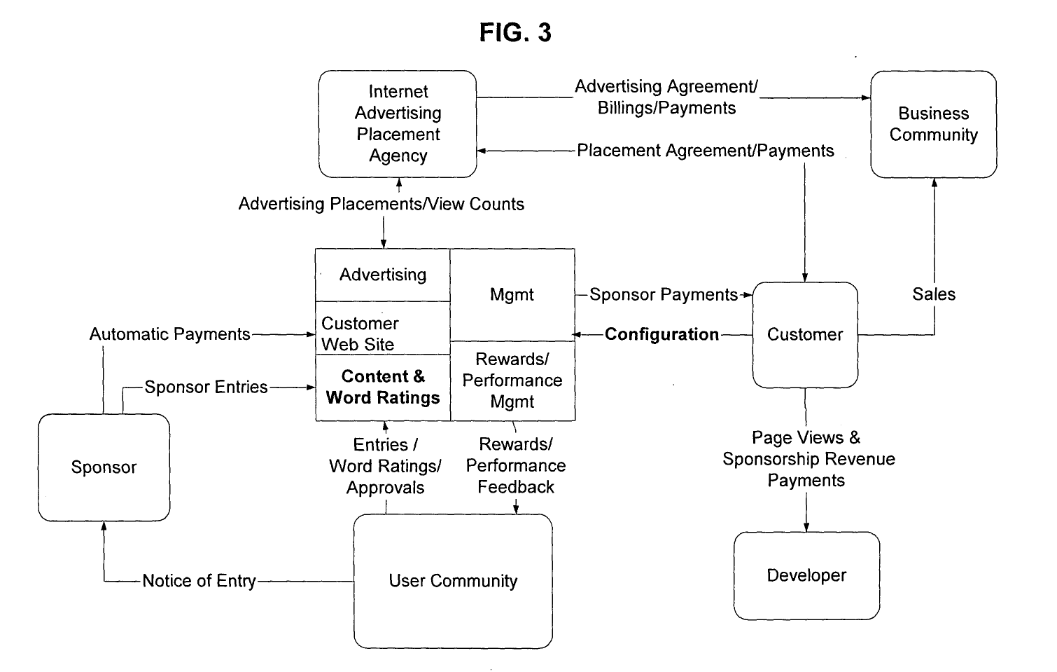

Referring now to FIG. 3, a first described preferred embodiment of the present invention, the instant system is shown (and will herein be sometimes referred to as the WOM(TM) system or a word-of-mouth system. First described preferred embodiments of the present invention contrast in very important ways from the prior art. Again, embodiments of the present invention feature a plurality of parties comprising an Internet Advertising Placement Agency, the Business Community, and the User Community. However, rather than a Developer/Operator/Site Manager, as in the prior art, who is tasked with direct management of the website, embodiments of the present invention comprise a Customer, a Developer and Sponsor(s). These parties interact or have the following relationships between them as shown in FIG. 3 and summarized in Table 2 below.

TABLE 2

| | Function(s) - | |
|---|---|---|
| | Relationships to Other | |
| Party | Parties | Party |
| Internet Advertising | Advertising/Billings/ | Business Community |
| Placement Agency | Payments. | |
| | Placement | Customer |
| | Agreement/Payments | |
| Business Community | Sales | Customer |
| Customer | Page Views & | Developer |
| | Sponsorship Revenue | |
| | Payments | |
| User Community | Notice of Entry | Sponsor |

As shown, the prior art model in which the Operator/Site Managers had responsibility for Management of the Website and for Performance and Management Feedback to the User community has been eliminated. Embodiments of the present invention essentially do not have, nor require, an Operator/Site Manager party and their associated functions. Embodiments of the present invention comprise a Customer responsible only for the Website configuration as opposed to both configuration and management. Also, the customer now owns the Website instead of the Developer/Operator/Site Managers thus providing a lower cost solution to Website operation. The customer, in a preferred embodiment, forwards Page Views payments and Sponsorship payment sharing to a Developer who preferably need no longer have essential management functions.

As shown on FIG. 3, the Website preferably comprises components and associated programming of: Advertising, Content & Word Ratings (as opposed to Overall “star” Ratings), Management, & Rewards/Performance Management. As shown, many differences between the prior art and preferred embodiments of the present invention are present. The Website interaction between the User Community and the Website now comprises not only rewards but also performance feedback. Also, the User Community now provides to the Website not merely Entries and Overall Ratings, but instead Entries and Word (i.e., again, what is sometimes herein referred to as natural-language term, preferably evaluative, preferably approving) Ratings/Approvals. Furthermore, as will be explained in more detail, embodiments of the present invention preferably comprise another party—Sponsors. The Sponsors receive notice of entry from the User Community, and in turn provide automatically-set-up (by the website software) payments to the Website and Sponsor Entries into the Website. Additionally, Sponsor Payments are automatically sent to the Customer. Key features in preferred embodiments of the present invention are preferably that the Website essentially does not require Management by a Developer/Operator/Site Manager, and that the software of the Website performs management functions automatically. Also, the Website automatically interacts with the User Community to establish Content and natural-language term (herein sometimes called “Word”) Ratings of relevance to a subject.

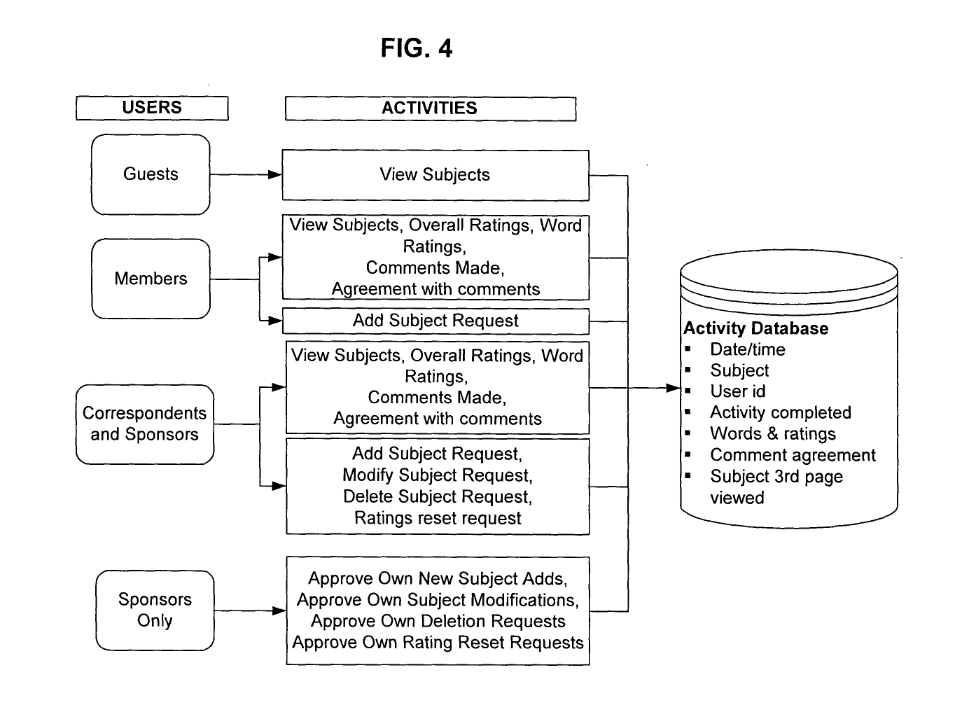

Referring to FIG. 4, an overview functional diagram of the Activity Database of the main Database 1-2 (see FIGS. 1-A, 1-C, and 20) is shown. As shown, the Activity Database preferably comprises Activities performed by Users that cause data additions/changes to the Activity Database. The Users comprise: Guests, Members, Correspondents (also called Contributors herein) and Sponsors. The Users may take various actions or interact preferably as follows: Guests may View Subjects. In contrast, Members may View: Experiences, Overall Ratings, Word Ratings, Comments Made, and Agreement with comments. Also, Members may submit Add Subject Requests. Another class of Users, the Correspondents and Sponsors may also preferably View: Experiences, Overall Ratings, Word Ratings, Comments Made, and Agreement with comments. Furthermore, Correspondents and Sponsors may preferably submit Add Subject Requests, Modify Subject Requests, Delete Subject Requests, and submit Ratings Reset Requests. [It is noted that “Overall Ratings” has been used in these cases to refer to ratings of, e.g., 1 to 5 “stars” for the subject as a whole. When, in the instant preferred system, the natural-language term ratings of degree of relevance of each user are “averaged” (preferably “weighted” as herein after described) for a large number of users, this application refers to that “average” as an “overall” degree of relevance rating—i.e., not the same thing as the prior art Overall “star-type” rating; and the context hereof will make clear which use is intended.]

Additionally, Sponsors only preferably possess the additional privileges that allow them to: do Approve their Own New Subject Adds, Approve their Own Subject Modifications, and Approve their Own Subject Deletion Requests, and submit Approve their Own Rating Reset Requests. The activities by the Users may preferably be reflected in the Activity Database fields. The Activity Database fields preferably comprise: Date/time, Subject, User ID, Activity completed, Words & ratings, Comment agreement, and Subject 3rd page viewed fields.

Referring to FIG. 5, a high level functional diagram of the Experience Management Automation software is shown. The core of the Experience Management Automation software is preferably comprised within the Terraformer (Configuration and Administration) Module. The Terraformer (Configuration and Administration) Module performs Experience Management that preferably comprises the activities of allowing the Customer to: Set word deletion rating threshold; Set subject deletion overall rating threshold, number of months, & minimum rating count; Set ratings removal aging criteria; and Set use of local and national approval queues and time frame for approvals to move between them, or just national queues. For each of these activities, the customer preferably initially evaluates and sets each of these configuration and management options that are comprised within the Terraformer (Configuration and Administration) Module as desired. The Experience Management settings are preferably placed into the WOM Database where they affect and are stored in the Web Site Configuration & Management Settings table.

Users may interact with the Experience Management Automation software and perform activities that: Search for Subjects, Add/Change Subjects, Rate Subjects, Comment on Subjects, Approve Adds/Changes, Notify Potential New Sponsors, and Suggest New words. These activities affect the WOM Database tables: Correspondents, Members & Sponsors; Subjects (Content); Activity History; and Application Status.

The WOM database tables' content and/or changes are preferably input to the Gepetto Module which will preferably: Remove subjects with overall ratings below threshold; Remove subjects with poor word ratings (optional); Calculate each members weighting value for ratings; Remove old ratings and recalculate rating; Remove old comments, and Generate most used word descriptive word lists. The WOM database tables content and/or changes are also preferably input to the MyPage Reporting Module which will assist implementation of the working of Approval Queues for adds, updates, deletions and potential sponsor notification.

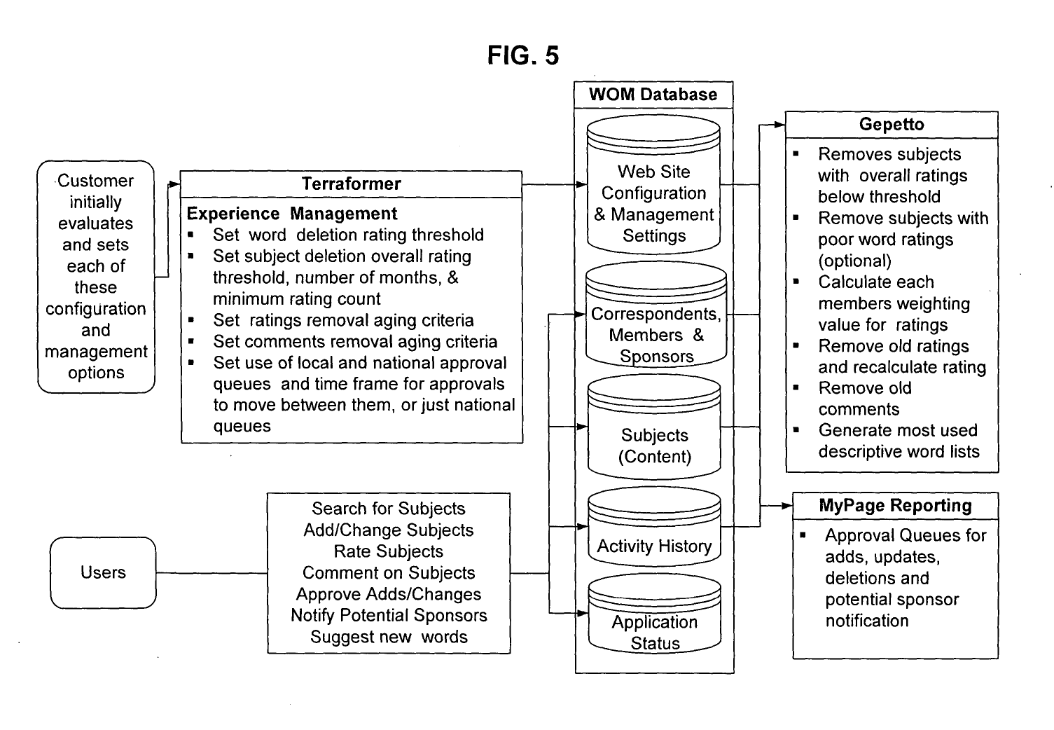

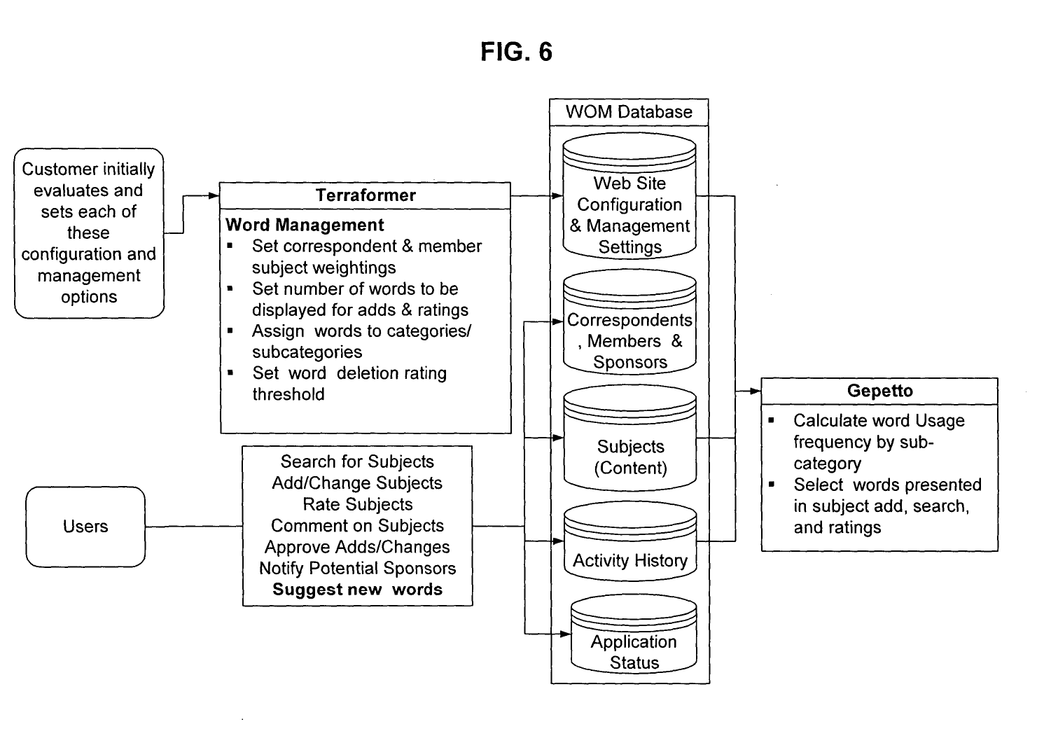

Referring to FIG. 6, a high level functional diagram of the Word Management Automation software is shown. The core of the Word Management Automation software is preferably comprised within the Terraformer (Configuration and Administration) Module. The Terraformer (Configuration and Administration) Module performs Word Management that preferably comprises the activities of allowing the Customer to: Set correspondent & member subject weightings; Set number of words to be displayed for adds & ratings; Assign words to categories/subcategories; and Set word deletion rating threshold. For each of these activities, the customer preferably initially evaluates and sets each of these configuration and management options that are comprised within the Terraformer (Configuration and Administration) Module as desired. The Word Management settings are preferably placed into the WOM Database where they affect and are stored in the Web Site Configuration & Management Settings table.

Users may interact with the Word Management Automation software and preferably perform activities that: Search for Subjects, Add/Change Subjects, Rate Subjects, Comment on Subjects, Approve Adds/Changes, Notify Potential New Sponsors, and Suggest New Words. These activities affect the WOM Database tables: Correspondents, Members & Sponsors; Subjects (Content); Activity History; and Application Status. The WOM database tables content and/or changes are preferably input to the Gepetto Module which will preferably: Calculate Word Usage frequency by sub-category; and Select Words presented in subject add, search, and ratings.

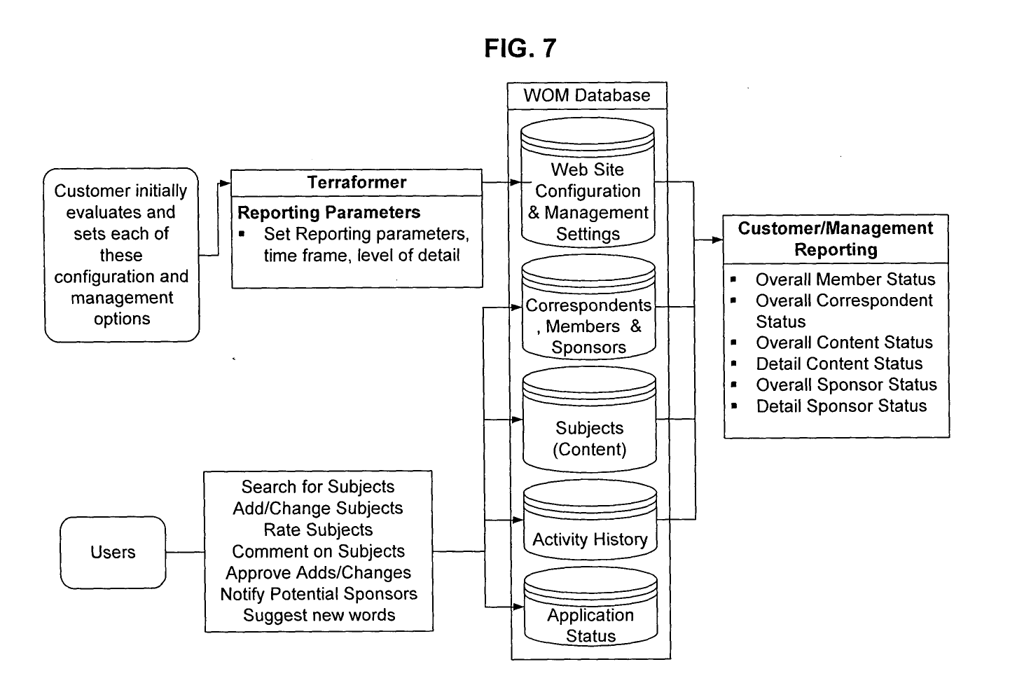

Referring to FIG. 7, a high level functional diagram of the Reporting Management Automation software is shown. The core of the Reporting Management Automation software is preferably comprised within the Terraformer (Configuration and Administration) Module. The Terraformer (Configuration and Administration) Module comprises Reporting Parameters that preferably comprises the activity of allowing the Customer to Set Reporting parameters, time frame and level of detail. The customer preferably initially evaluates and sets the configuration and management options for the Reporting Parameters that are comprised within the Terraformer (Configuration and Administration) Module as desired. The Reporting Management settings are preferably placed into the WOM Database where they affect and are stored in the Web Site Configuration & Management Settings table.

Users may interact with the Reporting Management Automation software and preferably perform activities that: Search for Subjects, Add/Change Subjects, Rate Subjects, Comment on Subjects, Approve Adds/Changes, Notify Potential New Sponsors, and Suggest New words. These activities affect the WOM Database tables: Correspondents, Members & Sponsors; Subjects (Content); Activity History; and Application Status. The WOM database tables content and/or changes are preferably input to the Customer/Management Reporting module which will perform the functions of providing reporting for: Overall Member Status; Overall Correspondent Status; Overall Content Status; Detail Content Status; Overall Sponsor Status; and Detail Sponsor Status.

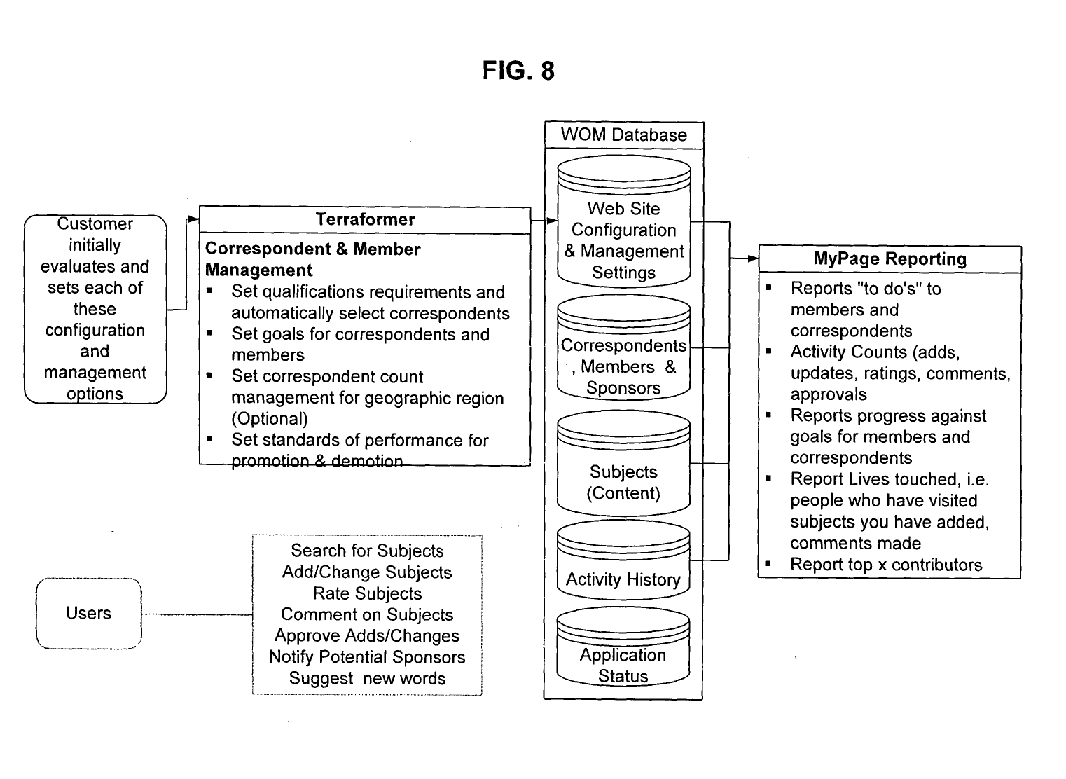

Referring to FIG. 8, a high level functional diagram of the Correspondent & Member Management Automation software is shown. The core of the Correspondent & Member Management Automation software is preferably comprised within the Terraformer (Configuration and Administration) Module. The Terraformer (Configuration and Administration) Module comprises Correspondent & Member Management that comprises preferably activities to: Set qualifications requirements and automatically select correspondents; Set goals for correspondents and members; Set correspondent count management for geographic region (Optional); and Set standards of performance for promotion & demotion. The customer initially evaluates and sets the configuration and management options for the Correspondent & Member Management that are comprised within the Terraformer (Configuration and Administration) Module as desired. The Correspondent & Member Management settings are placed into the WOM Database where they preferably affect and are stored in the Web Site Configuration & Management Settings table.

Users may interact with the Correspondent & Member Management Automation software and perform activities that preferably: Search for Subjects, Add/Change Subjects, Rate Subjects, Comment on Subjects, Approve Adds/Changes, Notify Potential New Sponsors, and Suggest New words. These activities affect the WOM Database tables: Correspondents, Members & Sponsors; Subjects (Content); Activity History; and Application Status. The WOM database tables content and/or changes are preferably input to the MyPage Reporting module which provides information to the Correspondents and Members preferably comprising: Reports “to do's” to members and correspondents; Activity Counts (adds, updates, ratings, comments, approvals; Reports progress against goals for members and correspondents; Report Lives touched, i.e. people who have visited subjects you have added, and their comments made; and Report top “x” number of contributors.

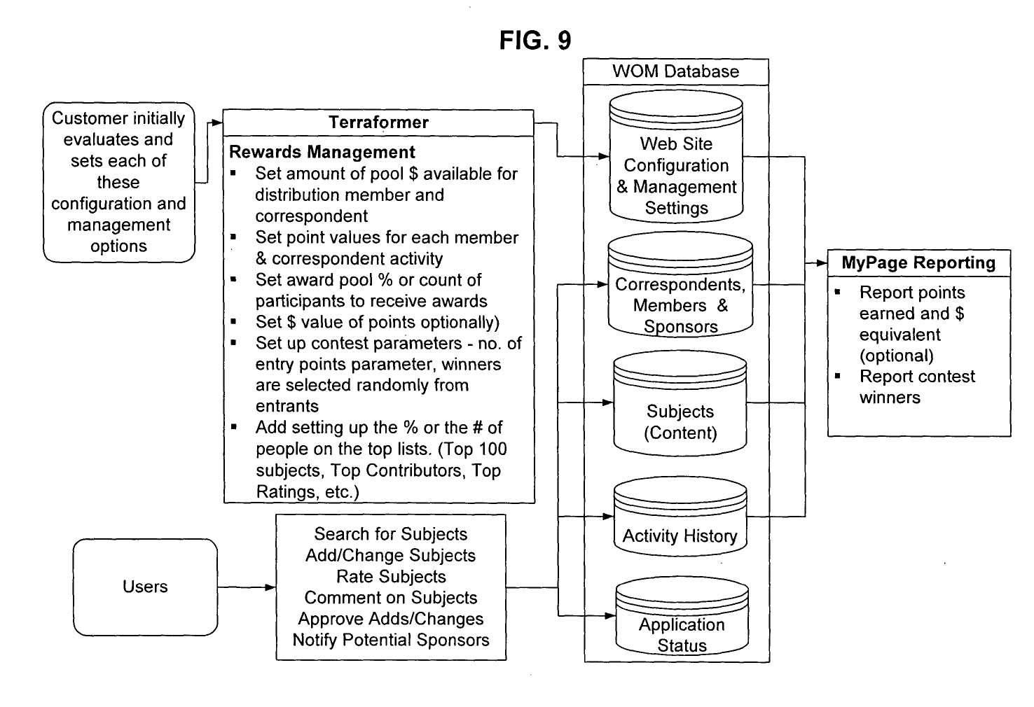

Referring to FIG. 9, a high level functional diagram of the Rewards Management Automation software is shown. The core of the Rewards Management Automation software is preferably comprised within the Terraformer (Configuration and Administration) Module. The Terraformer (Configuration and Administration) Module comprises the Rewards Management software that comprises, preferably, activities to: Set amount of the pool $ available for distribution to member and correspondent; Set point values for each member & correspondent activity; Set award pool percentage (%) or count of participants to receive awards; Set dollar ($) value of points (optionally); Set up contest parameters e.g.: Number of entry points parameter, winners are selected randomly from the entrants, etc.; and set the setting of the % or the number (#) of people on the top lists (Top 100 subjects, top Contributors, Top Ratings, etc.). The customer initially evaluates and sets the configuration and management options for the Rewards Management that are comprised within the Terraformer (Configuration and Administration) Module as desired. The Rewards Management settings are placed into the WOM Database where they preferably affect and are stored in the Web Site Configuration & Management Settings table.

Users may interact with the Rewards Management Automation software and perform activities that preferably: Search for Subjects, Add/Change Subjects, Rate Subjects, Comment on Subjects, Approve Adds/Changes, and Notify Potential New Sponsors. These activities affect the WOM Database tables: Correspondents, Members & Sponsors; Subjects (Content); Activity History; and Application Status. The WOM database tables content and/or changes are preferably input to the MyPage Reporting module which provides information preferably comprising: Report points earned and $ equivalent (optional); and Report contest winners.

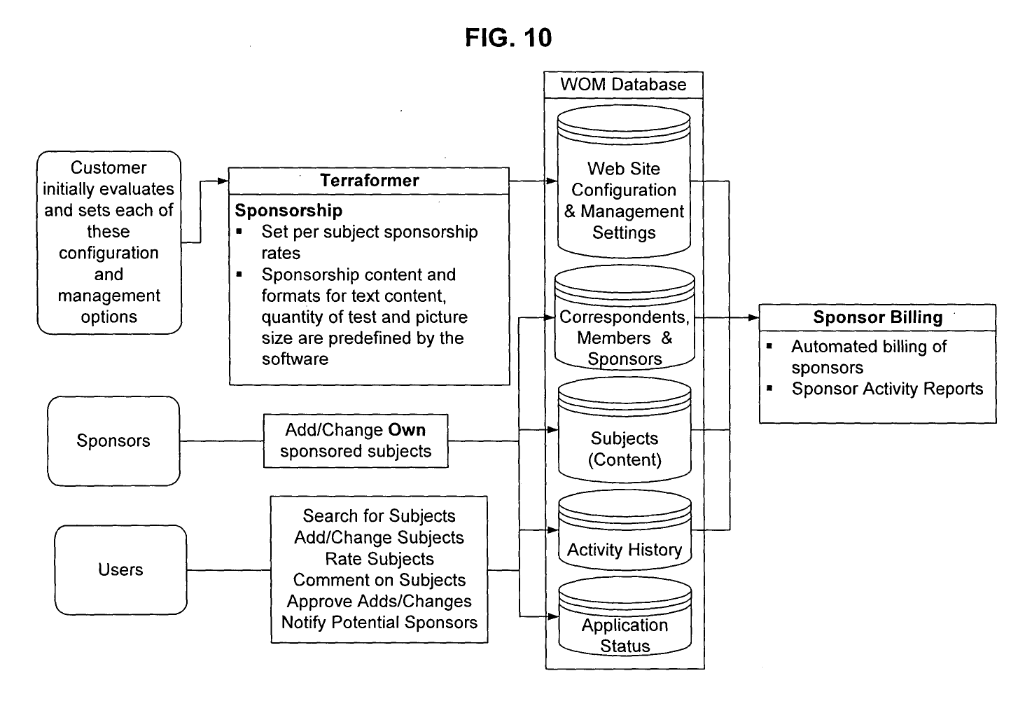

Referring to FIG. 10, a high level functional diagram of the Sponsorship Management Automation software is shown. The core of the Sponsorship Management Automation software is preferably comprised within the Terraformer (Configuration and Administration) Module. The Terraformer (Configuration and Administration) Module comprises the Sponsorship software that comprises, preferably, activities to Set per experience sponsorship rates. The Sponsorship content and formats for text content, quantity of text and picture size are preferably predefined by the software. The customer initially evaluates and sets the configuration and management options for the Sponsorship Management that is comprised within the Terraformer (Configuration and Administration) Module as desired. The Sponsorship Management settings are placed into the WOM Database where they preferably affect and are stored in the Web Site Configuration & Management Settings table.

Users may interact with the Sponsorship Management Automation software and perform activities that preferably: Search for Subjects, Add/Change Subjects, Rate Subjects, Comment on Subjects, Approve Adds/Changes, and Notify Potential New Sponsors. These activities affect the WOM Database tables: Correspondents, Members & Sponsors; Subjects (Content); Activity History; and Application Status. The WOM database tables content and/or changes are preferably input to the Sponsor Billing module which preferably provides functions comprising the automated billing of Sponsors and Sponsor activity reports.

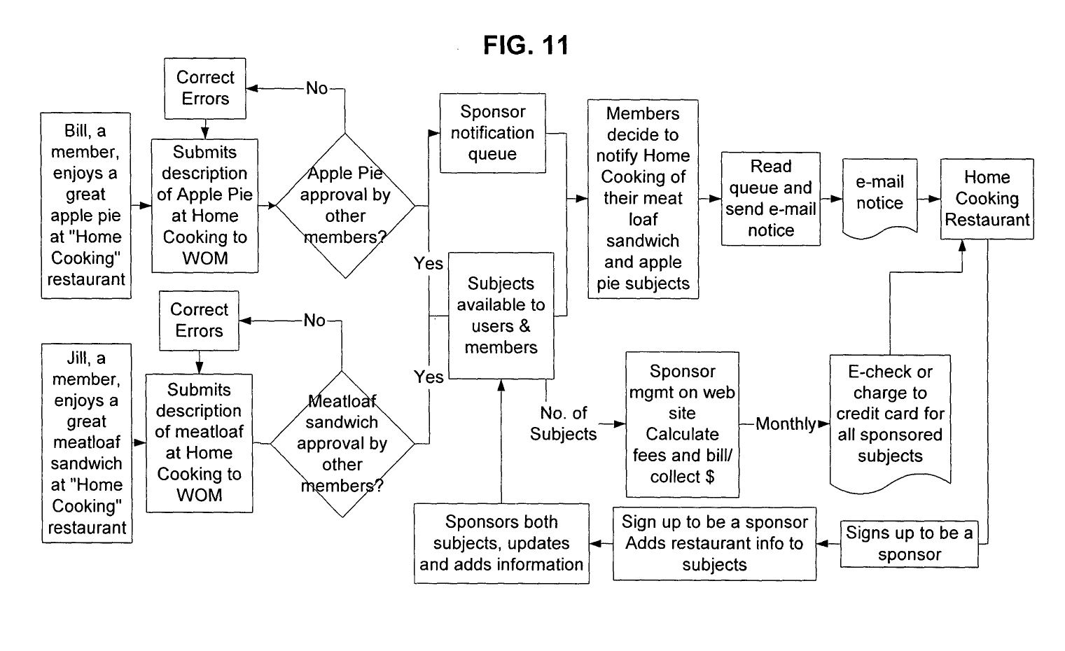

Referring to FIG. 11, a diagrammatical view of sponsorship depicting two example Sponsorship flows is shown. As shown, Bill, a member, enjoys a great apple pie at “Home Cooking” restaurant. Bill desires to share this wonderful experience. Therefore, Bill submits a description of the Apple Pie at Home Cooking to WOM. The description of the Apple Pie is available on WOM for Approval of the Apple Pie by other members. If the members do not approve the Apple Pie description submission, then the Apple Pie description is returned to Bill for correction of the errors. Following approval of the Apple Pie description by the members, the Apple Pie description is preferably submitted to the Sponsor notification queue, and preferably is also made available under the Subjects available to the users and members.

With reference to the Sponsor notification queue, the members may decide to Notify the Home Cooking restaurant of their apple pie subject, and any other pending subject for the Home Cooking Restaurant. A Correspondent will preferably read the queue and preferably send an e-mail notice to the Home Cooking Restaurant. The Home Cooking Restaurant may now decide if they choose to Sign up to be a sponsor. If the Home Cooking Restaurant chooses to Sign up to be a Sponsor, they may now add restaurant information to the Subject data that initiated the Sponsor notification i.e. the “great apple pie”.

The Sponsorship process may be repeated as often as desired. For example, Jill, a member, enjoys a great meatloaf sandwich at “Home Cooking” restaurant. Jill desires to share this wonderful experience. Therefore, Jill submits a description of the Meatloaf sandwich at Home Cooking to WOM. The description of the Meatloaf sandwich is available on WOM for Approval of the Meatloaf sandwich by other members. If the members do not approve the Meatloaf sandwich description submission, then the Meatloaf sandwich description is returned to Jill for correction of the errors. Following approval of the Meatloaf sandwich description by the members, the Meatloaf sandwich description is preferably submitted to the Sponsor notification queue (as was the great apple pie), and preferably is also made available under the Subjects available to the users and members.

Once in the Sponsor notification queue, the members may decide to Notify the Home Cooking restaurant again, this time concerning their Meatloaf sandwich subject, and any other pending subject for the Home Cooking Restaurant. Correspondents will preferably read the queue and preferably send an e-mail notice to the Home Cooking Restaurant. The Home Cooking Restaurant may now decide if they choose to Sign up to be a sponsor of the Meatloaf sandwich. If the Home Cooking Restaurant chooses to again Sign up to be a Sponsor, they may now add restaurant information to the Subject data that initiated the Sponsor notification, i.e. the “great meatloaf sandwich”. The Home Cooking restaurant may also update any other subjects they have such as the “great apple pie”.

The Sponsored information on the great apple pie and meatloaf sandwich subjects, including any updates is preferably then made available to users and members. The total number of Subjects sponsored is input to the Sponsor Management software on the Website which generates the fees due from the Home Cooking restaurant and bills the Home Cooking restaurant, preferably on a monthly basis, in order to collect the money due. The Home Cooking restaurant, once billed, may pay for their sponsorship, preferably using an E-check or by charging a credit card for all sponsored subjects.

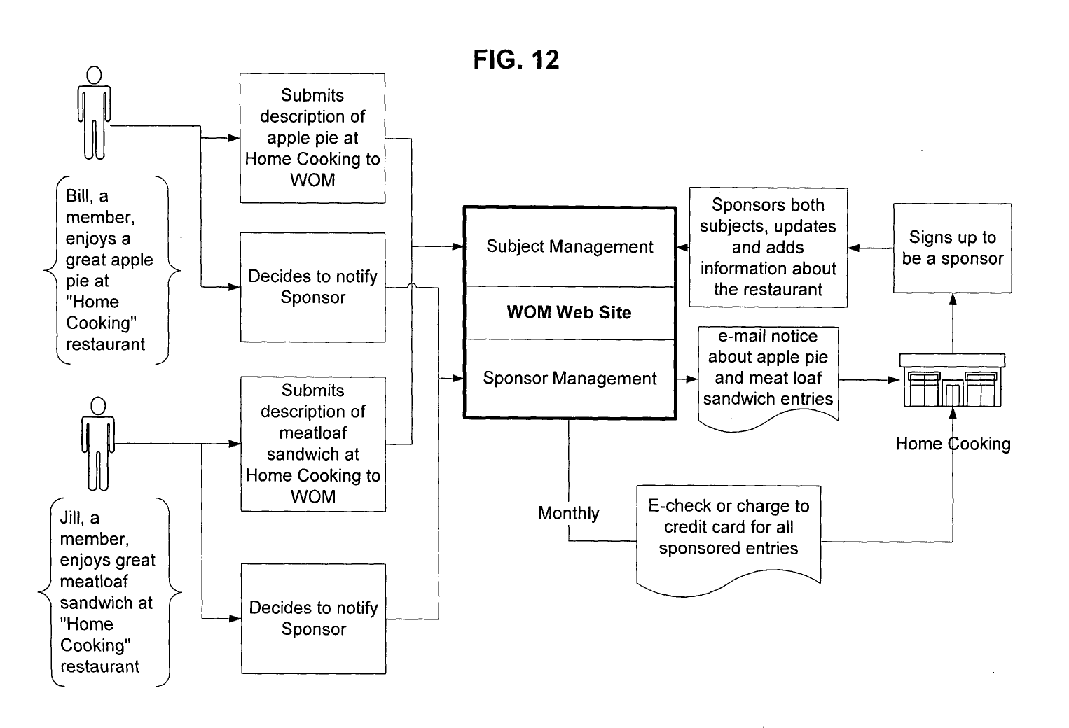

Referring to FIG. 12, a further diagrammatical view of the sponsorship process of FIG. 11 is shown. The process described in reference to FIG. 11 embodies an important feature of the present invention. As shown, the Subject Management and Sponsor Management did not require the intervention of a Developer/Operator/Site Managers as shown in the prior art of FIG. 2. Rather, in this preferred embodiment of the present invention, the WOM Website software automatically processed the E-mail notice(s) regarding sponsorship of the apple pie and meatloaf sandwich entries. The WOM Website software further automatically processed the Subject updates, information additions, etc., and also automatically processed the billing and payment by E-check or credit card for the sponsored entries by the Home Cooking restaurant.

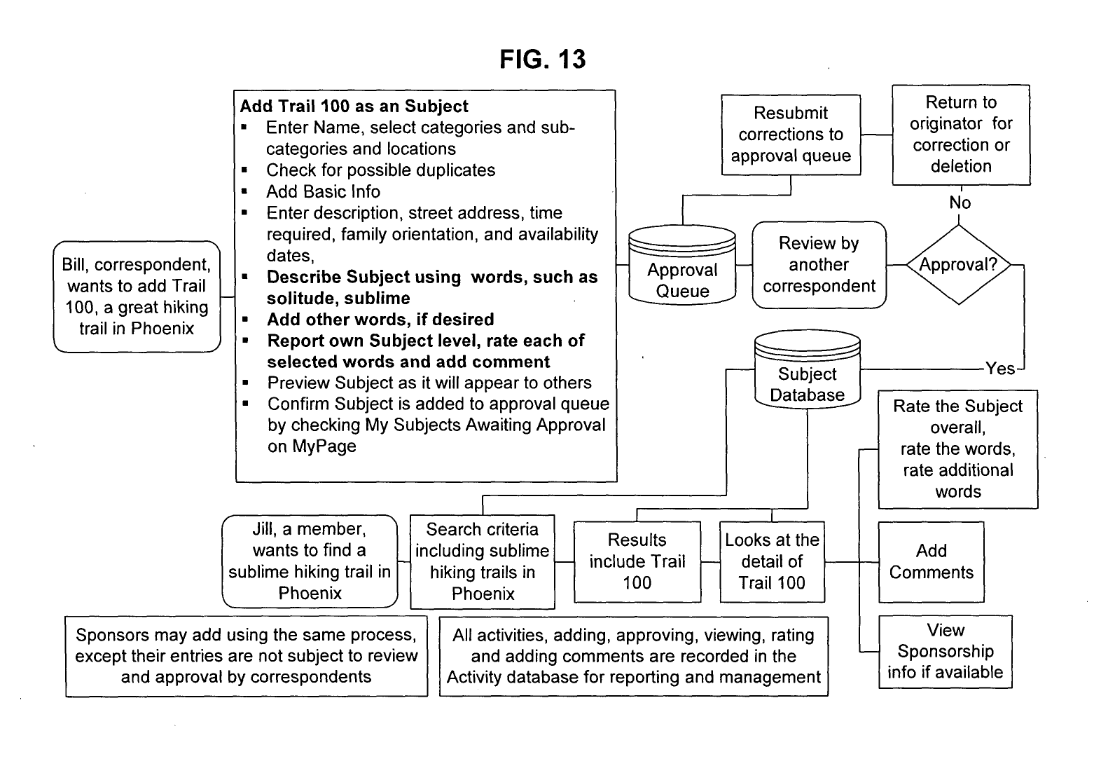

Referring to FIG. 13, a diagrammatical view of the process of adding and viewing subjects is shown. In this example Bill, a correspondent, wants to add Trail 100, a great hiking trail in Phoenix to the Subjects. After accessing the WOM Website, Bill Adds Trail 100 as a Subject. Bill will be presented with screens by the WOM software that will preferably allow Bill to:

Enter the subject Name, select categories and subcategories and location;

Check for possible duplicates;

Add Basic Information;

Enter a description, street address, time required, family orientation, and availability dates;

Describe the Subject using words, such as for example: solitude, sublime, etc;

Add other words as desired;

Report his own Subject experience level, rate each of the selected words and add comments as desired;

Preview the Subject as it will appear to others on the WOM Website;

Confirm the Subject is added to approval queue by checking the MySubjects Awaiting Approval on MyPage.

The Subject is then preferably placed into the Approval Queue for Review by another correspondent(s). If the reviewing correspondent(s) do not grant Approval of the Subject, the Subject submission is returned to the Originator, Bill, for correction or deletion. Following correction by the Originator, Bill, the Subject Submission is again preferably placed into the Approval Queue for review by another correspondent(s). Following a grant of Approval by the reviewing Correspondent(s), the submitted and approved Subject is placed into the Subject Database. It should be noted that, preferably, Sponsors may add Subjects using the same process, except that their entries are not subjected to review and approval by correspondents.

Now consider a member desiring to view a Subject. For example, Jill, a member, wants to find a hiking trail in Phoenix. Jill may access the WOM Website from a computer and submit search criteria including “sublime” hiking trails in Phoenix. The search is run in the Subject Database and the results returned to Jill at her computer for viewing. The results will include the Trail 100 as Bill had used the word “Sublime” when describing the Subject. Jill may now choose to look at the detail concerning Trail 100. Jill may further preferably choose to: Rate the Subject overall, rate the words, and/or rate additional words; Add comments; or View Sponsorship information if such is available.

The WOM Website software will also function such that all activities, adding, approving, viewing, rating and adding comments are recorded in the Activity database for reporting and management.

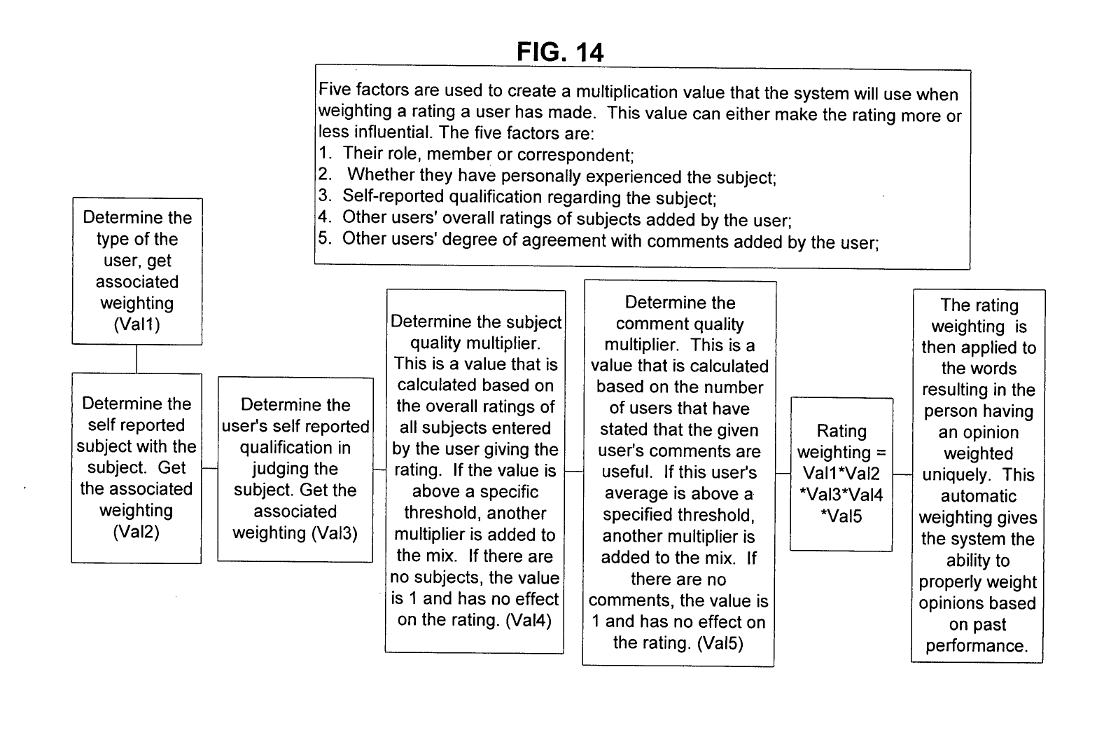

Referring now to FIG. 14, a diagrammatical view of the weighting of overall subject and descriptive word ratings is shown. Five factors are used to create a multiplication value that the system will use when weighting a “degree of relevancy” rating which a user has made. This value can either make the rating more or less influential. The five factors are:

1. Their role, member or correspondent;

2. Whether they have personally experienced the subject;

3. Self-reported qualification regarding the subject;

4. Other users' overall ratings of subjects added by the user; and

5. Other users' degree of agreement with comments added by the user.

The process of the weighting of overall subject and descriptive word (i.e., as noted, natural-language terms, preferably evaluative, preferably approving) degree-of-relevancy ratings preferably comprises the following steps:

1) Determine the type of the user, get the associated weighting value (Val1);

2) Determine the self reported subject with the subject. And, get the associated weighting value (Val2);

3) Determine the user's self reported qualification in judging the subject. And, get the associated weighting value (Val3);

4) Determine the subject quality multiplier value (Val4).

This is a value that is calculated based on the overall ratings of all subjects entered by the user giving the rating. If the value is above a specific threshold, another multiplier is preferably added to the mix. If there are no subjects, preferably the value is 1 and has no effect on the rating.

5) Determine the comment quality multiplier value (val5).

This is a value that is calculated based on the number (i.e., percentage) of users that have stated that the given user's comments are useful. If this user's such average (i.e., percentage) is above a specified threshold, preferably another multiplier is added to the mix. If there are no comments, preferably the value is 1 and has no effect on the rating.

6) The Rating weighting is calculated by multiplying the values i.e. Rating weighting Val1*val2*val3*val4*val5

7) The rating weighting is then applied to the degree-of-relevancy opinions resulting in the user/person having an opinion weighted uniquely. This preferred automatic weighting gives the system the ability to properly weight opinions based on past performance.

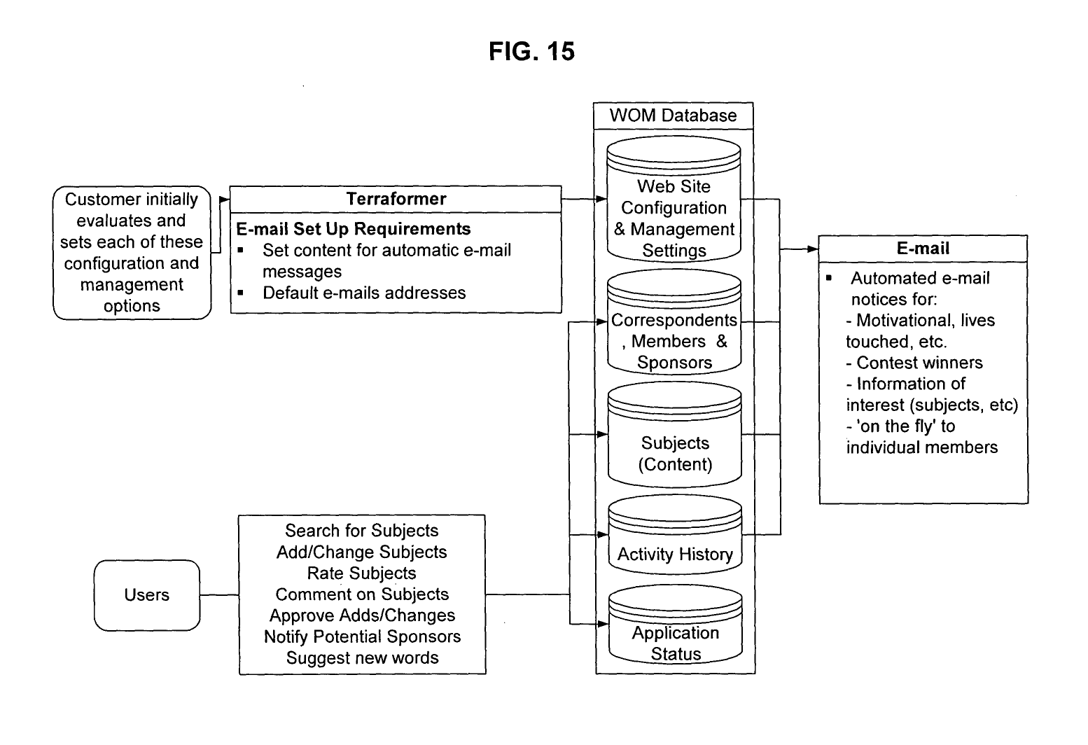

Referring to FIG. 15, a high level functional diagram of the E-mail Management Automation software is shown. The core of the E-mail Management Automation software is preferably comprised within the Terraformer (Configuration and Administration) Module. The Terraformer (Configuration and Administration) Module performs E-mail Management that preferably comprises the E-mail Set Up Requirements activities of allowing the Customer to: Set content for automatic e-mail messages, and Set Default e-mails addresses. For each of these activities, the customer preferably initially evaluates and sets each of these configuration and management options that are comprised within the Terraformer (Configuration and Administration) Module as desired. The E-mail Management settings are preferably placed into the WOM Database where they affect and are stored in the Web Site Configuration & Management Settings table.

Users may interact with the E-mail Management Automation software and preferably perform activities that: Search for Subjects, Add/Change Subjects, Rate Subjects, Comment on Subjects, Approve Adds/Changes, Notify Potential New Sponsors, and Suggest New Words. These activities affect the WOM Database tables: Correspondents, Members & Sponsors; Subjects (Content); Activity History; and Application Status. The WOM database tables content and/or changes are preferably input to the E-mail Module which will preferably provide for Automated e-mail notices comprising: Motivational emails of lives touched, etc.; Contest Winners; Information of Interest (Subjects, etc.); and ‘On the fly’ emails to individual members.

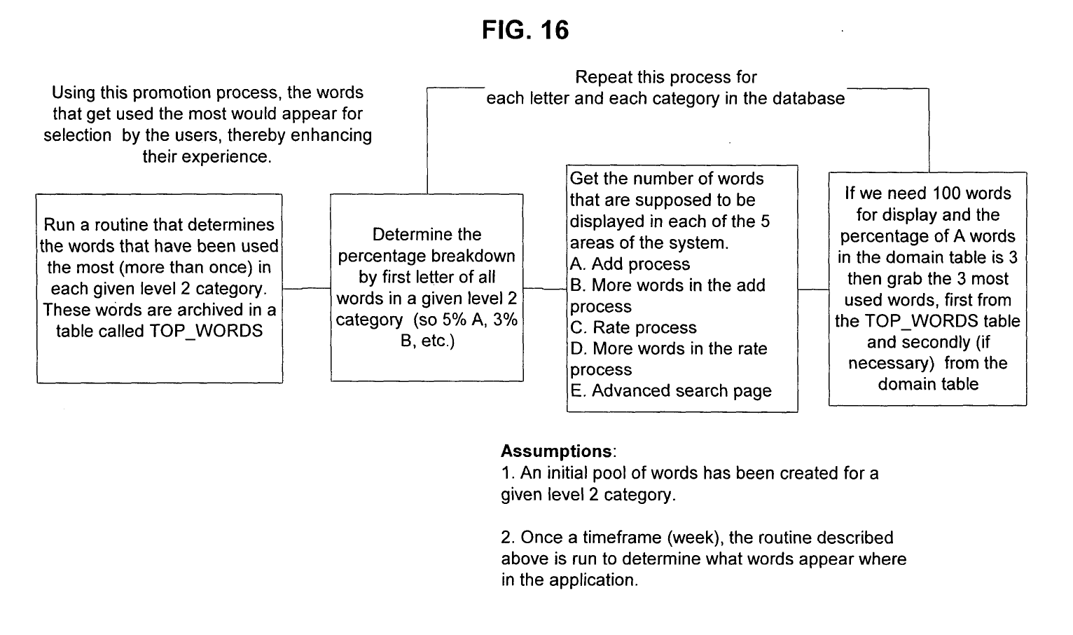

Referring to FIG. 16, a diagrammatical view of the descriptive word promotion functional flow is shown. By virtue of the WOM Website software having used this promotion process, the words that get used the most would appear for selection by the users, thereby enhancing their experience. The descriptive word promotion software preferably comprises the following steps:

1) Run a routine that determines the words that have been used the most (more than once) in each given level 2 category. These words are archived in a table called TOP_WORDS;

2) Determine the percentage breakdown by first letter of all words in a given level 2 category (e.g. 5% A, 3% B, etc.)

3) Get the number of words that are supposed to be displayed in each of the five areas of the system where such lists are displayed.

Add process

More words in the add process

Rate process

More words in the rate process

Advanced search page

Note: If we need 100 words for display and the percentage of A words in the domain table is 3% then grab the 3 most used words, first from the TOP_WORDS table and secondly (if necessary) from the domain table.

The descriptive word promotion software will preferably repeat this process for each letter and each category in the database. The descriptive word promotion software preferably has certain assumptions programmed into it, preferably comprising: 1. An initial pool of words has been created for a given level 2 category; and 2. Once each timeframe (preferably per week), the routine described above is run to determine what words appear where in the application.

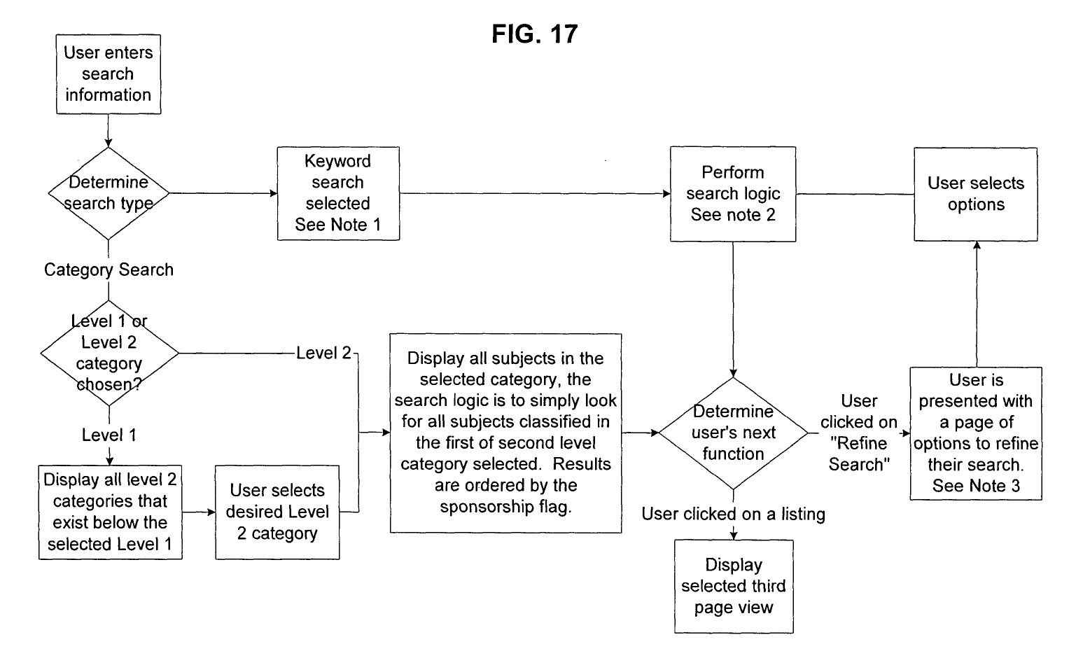

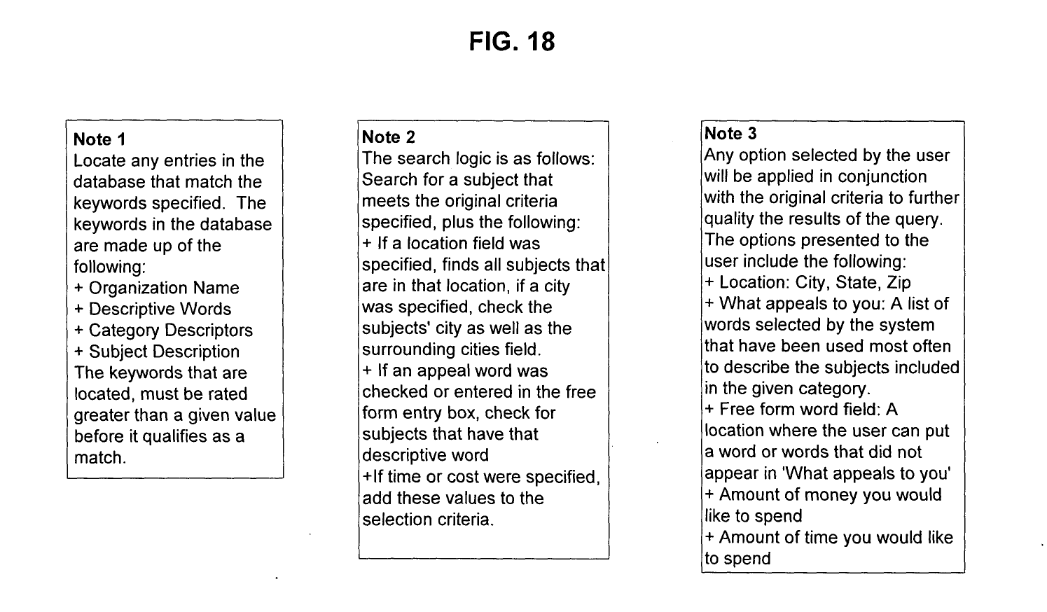

Referring now to FIG. 17, a flow chart of the preferred flow for a subject search is shown. Notes applicable to FIG. 17 are shown in FIG. 18. The subject search flow shown on FIG. 17 is as follows: A User enters information to search on. The software will determine the search type. If the software determines that a Keyword search is selected, then the procedure of Note 1 is preferably performed.

The Note 1 procedure preferably comprises the steps of:

1) Locate any entries in the database that match the keywords specified. The keywords in the database are made up of the following:

a) Organization Name

b) Descriptive Words

c) Category Descriptors

d) Subject Description

2) The keywords located must be rated greater than a given value before it qualifies as a match.

Following the Keyword search selected procedure, the software next Performs the search logic procedure step as explained in Note 2. The Note 2 procedure preferably comprises the steps of:

1) The search logic is as follows: Search for a subject that meets the original criteria specified, plus the following:

2) If a location field was specified, finds all subjects that are in that location. If a city was specified, check the subjects' cities field.

3) If an appeal word was checked or entered in the free form entry box, check for subjects that have that descriptive word. If time or cost were specified, add these values to the selection criteria.

The software next determines the user's next function. If the user clicked on ‘Refine Search’, the User is presented with page of options to refine their search as explained in Note 3. The Note 3 procedure preferably comprises the steps of:

1) Any option selected by the user will be applied in conjunction with the original criteria to further qualify the results of the query. The options presented to the user include the following:

a) Location: City, State, Zip.

b) What appeals to you: A list of words selected by the system that have been used most often to describe the subjects included in the given category.

c) Free form word field: A location where the user can put a word or words that did not appear in ‘What appeals to you’.

d) Amount of money you would like to spend.

e) Amount of time you would like to spend.

Following the option presentation of the option selections, and the User selection of any desired options and the software performs the search Logic Step as previously explained.

If the user clicked on a listing, then the software will Display the selected 3^{rd} page view to the user.

Returning now to the beginning, where the software will determine the search type, if a category search is selected, the software will ask whether a level 1 or a level 2 category was chosen. If a Level 1 was chosen then the software will Display all level 2 categories that exist below the selected level 1. The user will then select the desired level 2, after which the software will Display all subjects in the selected category. The search logic is simply to look for all subjects classified in the 1st or 2nd level category selected, and the results are ordered by the sponsorship flag. Following the Display of all subjects in the selected category, the software will next determine the user's next function as already explained. If, however, a level 2 was directly chosen following the selection of a Category search, then the software will go directly to the Display of all subjects in the selected category step, the determine users next function, etc. as previously explained.

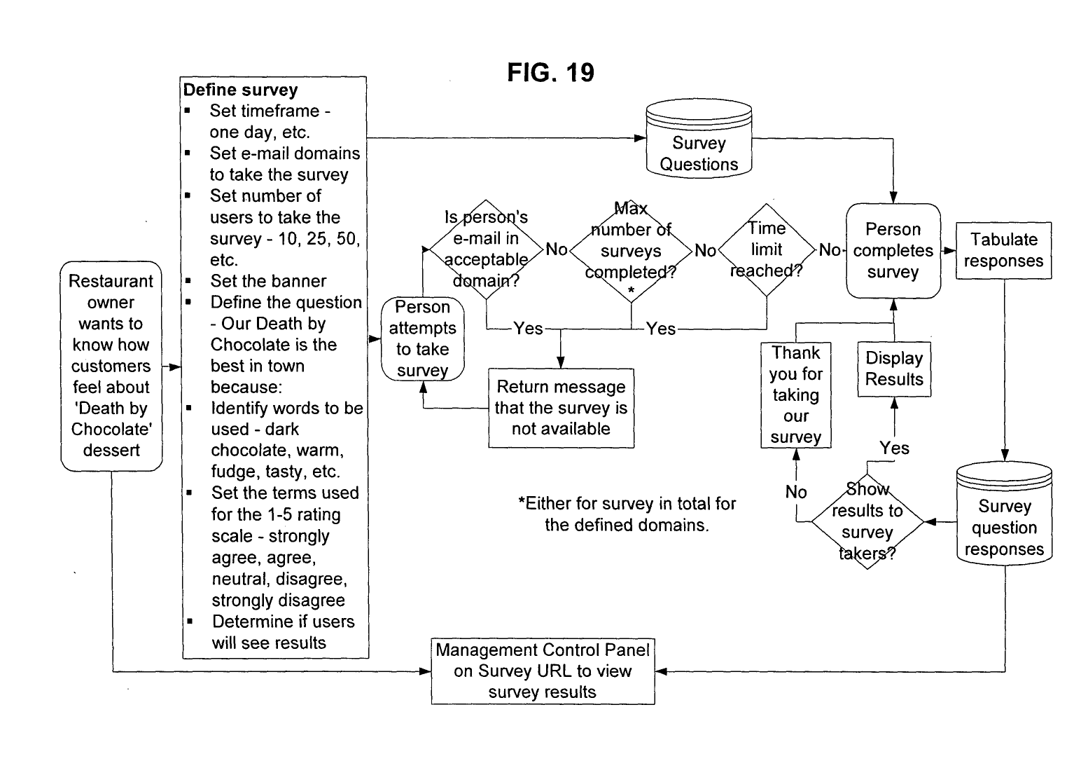

Referring now to FIG. 19, a flow chart of the preferred flow for a survey is shown. In an example survey, for example, a restaurant owner wants to know how customers feel about their ‘Death by Chocolate’ Dessert. The restaurant owner will first define a desired survey. For example, in this example, the restaurant owner will define a survey to comprise the following questions or parameters:

1) Set timeframe—one day, etc.;

2) Set e-mail domains to take the survey;

3) Set number of users to take the survey—10, 25, 50, etc.;

4) Set the banner;

5) Define the question—[e.g., Our Death by Chocolate is the best in town because: ______];

6) Identify words to be used in response to the survey, e.g.—dark chocolate, warm, fudge, tasty, etc.;

7) Set the terms used for the 1-5 rating scale e.g.—strongly agree, agree, neutral, disagree, strongly disagree; and

8) Determine if users will see results.

The survey definition will then be placed into the Survey Questions database. A person will next attempt to take the survey. The software will ask is the person's e-mail in an acceptable domain? If the answer is no, the person attempting to take the survey will receive a return message that the survey is not available. The person may try again if they have another e-mail domain that might be acceptable. If the answer is yes, the software will next ask has the “Maximum number of surveys been completed?”. (either for the survey in total or for that defined domain). If the answer is yes, the person attempting to take the survey will receive a return message that the survey is not available. If the answer is no, the software will next ask has the time limit on administering the survey been reached? If the answer is yes, the person attempting to take the survey will receive a return message that the survey is not available. If the answer is no, the person will complete the survey available in the Survey Questions database.

Following the survey, the software will tabulate the survey responses and place them in the Survey question response database. The survey results will be sent to the Management Control Panel on the Survey URL to enable the restaurant owner to view the survey results. The software will next determine if the restaurant owner desired to show the survey results to the person taking the survey. If this was not desired, the person taking the survey will be thanked for taking the survey, and the survey process will be complete. If it was desired, the software will display the survey results to the person taking the survey after which the survey process will be complete.

In the preferred embodiment, the database 1-2 includes the following tables:

Domain Tables: These tables contain the required reference information used to ensure accuracy and consistency of the subject content, guest and contributor information. And (see FIG. 20) these tables are part of management settings.

Application Status Tables: These tables contain information necessary to manage user interactions such as the “state” or status of each active guest or contributor. Status information includes information such as user id, the last screen used, current screen in use, and start of the current session. See FIG. 20 under “Status”.

System Tables: These tables contain the parameters required to control the behavior of the system. Information in these tables gives the system to make decisions regarding certain actions. An example is the length of time a nominated subject will be exclusively available to contributors in a postal code. And (see FIG. 20) these tables are part of management settings.

User Tables: The user tables contain all data relevant to registered users of the system. Information includes demographic, system role points earned, points goals, personal preferences, book marked subjects of personal interest. See FIG. 20 under “Users”.

Subject Tables: The subject tables contain all information collected about a subject. For example, all data describing the subject, location of the subject, guest ratings, guest comments, etc. are included here. See FIG. 20 under “Subject”.

History Tables. The history tables contain all information collected about user activities, page views, etc. See FIG. 20 under “History”.

FIG. 20, just referred to, is a high level functional diagram of the process flows and functions in a preferred embodiment of the present invention, previously described, here for referral use in the below detailed review (after the below overview) of the system operation with reference to selected preferred screens of the system.

First Described Preferred System Operational Overview

Preferred embodiments of the systems of this invention give everyone, without exception, the ability to publish opinions on the Web, and create an easy-to-access database of those opinions. The primary unit of measure in the instant systems is the Subject. A Subject is preferably an exceptional experience of any kind—a succulent steak, cozy campsite, neighborhood sports bar, inexpensive discount store, beautiful golf course, friendly hairstylist, inspiring karate instructor, etc. Web users add their favorite Subjects to a site and, in so doing, create a database of Subjects that all users can access.

When adding Subjects to a site, users first enter some basic information about it: location, cost, time needed to experience it, and a short description. Users then choose from a list of pre-selected Descriptive Words (often called herein natural-language terms, preferably evaluative and preferably approving of the subject) that describes their Subject. Thousands of Descriptive Words are pre-loaded in the instant system. Some examples are: “tasty, romantic, friendly service, great value, extravagant, beautiful views, challenging, crowded,” etc. In addition to choosing from the pre-selected list, users may also add their own Descriptive Words to describe Subjects. After doing so, the newly added words become part of the master database that all future site visitors can use.

After selecting some Descriptive Words, users then rate the importance of each of those words. Example: (Extremely tasty, very challenging, somewhat good service, etc.). Those ratings are given a numerical value (5 for “extremely,” 4 for “very,” etc.), and those numerical values are displayed with the rest of the Subject information. The user then types a text comment (as short or long as desired) about the Subject, and the process is complete. With such Descriptive Word systems, users aren't required to spend time writing paragraph after paragraph to add their favorite experiences to the database. Instead, they can describe their Subject in seconds using Descriptive Words, rendering the process of giving opinions as easy as a few mouse clicks. And by immediately adding a user's own Descriptive Words to the master database, the instant system provides a way for users to build the content and raise the quality of the site every time they use it.

Furthermore, the search function provided by the instant system grafts a supremely easy-to-use interface onto a complex database-search process. When the average Web search engine does “full-text” searches—that is, looks through every piece of text for words that match the user's request—the result is often thousands of unrelated Web pages and meaningless phone-book listings. The instant searches are different: they're fast and accurate because the technology searches only specific, defined data fields, weeding out results the user doesn't want.

Once the database is populated with a critical mass of Subjects, then users will enjoy the unique benefits of a search according to the instant system. If you search for a “deli” using Word of Mouth technology, you'll find a deli—not a Web page about the “delicate ecosystem of the spotted owl” or a phone listing for “Delilah Jackson” in Toledo. And you'll find a deli in your neighborhood: just type in your ZIP code and the radius you'd like to search (e.g. two miles, five miles, etc.), and you'll find results near you. Importantly, you can type in keywords to locate a “romantic Italian restaurant with great seafood” (instead of all the Italian restaurants in a given city), and receive a list that includes only romantic Italian restaurants with great seafood (as rated by other users). You also get data that shows just how closely each option matches with each specific keyword you entered, making it easier to find the appropriate subject matter.

Another feature of the instant system that gives it such broad appeal is its adaptability. Most features—from the interface to the rewards system—are customizable by the client, making the system as useful to an international daily newspaper as it is to a monthly specialty magazine. Clients/customers may define their own content categories, contests, incentive programs, content-quality standards, sponsorship pricing models, site behavior and more. The set of variables enables the creation of a “word-of-mouth” resource that can lend itself to any geographic- or topic-focused Web site.

Further, using a system of completely automated, highly integrated content sponsorships, advertisers can buy sponsorships with the instant system using only their computer and a credit card—no sales force is necessary. And such sponsorships are the most attractive on the Web, preferably allowing advertisers to add contact information, links, 10 photographs and 10 paragraphs of extensive information about their businesses in just a few clicks. Because of this, advertisers not only create revenue for the site, but content as well.

When contributors to a large-scale Web community go unchecked, the site will eventually fall victim to online bullies and pranksters. To combat this, Word of Mouth software has a reliable content-review process based on membership status. There are three types of registered users: Members, Managing Members and Sponsors. Members have basic site-use privileges. Managing Members enjoy content-editing and approval powers in addition to contribution privileges. Sponsors pay a monthly premium (per Subject) to add customized information to certain Subjects, and have the same privileges as regular Members (but do not have the content-editing powers of Managing Members). All Subjects added—with the exception of sponsored Subjects, whose quality is naturally high because sponsors pay for these Subjects as marketing tools—are reviewed and approved by a Managing Member before publication. This review process ensures that there are no “nonsense” Subjects in the database—that is, Subjects composed of randomly typed characters or nonsense words. The review process does not discriminate against the tastes of Members, and Subjects are not to be rejected because their opinions differ from those of the Managing Member responsible for approving/rejecting them.

While they are lowest in the hierarchy, Members can still add Subjects, Comments and Ratings; however, every Subject added by a Member must be approved by a Managing Member before it becomes available for viewing by other site users. A Managing Member is a volunteer community leader who has applied and been accepted for this role by the client. Subjects entered by a Managing Member must be approved by another Managing Member before they may be viewed by other users. Subjects added by Sponsors are exempt from the content-review process. Their Subjects are immediately added to the database upon entry. This content-review process allows no one (except Sponsors) to make content available to the public without the approval of a site-sanctioned community leader (Managing Member).

The instant system uses an extensive and easily customizable rewards program to motivate users to make great contributions to their online community. Users are compensated with points for performing each of many actions that build a strong online community: adding content to the site, enriching existing content with comments and ratings, recruiting other members and helping to generate sponsorship revenue. The points a user earns for each action is determined by the client: therefore, a site can easily target and improve specific areas of their system site by offering premium point values for actions in those areas. A site can also use three separate point-earning structures for each member type (Member, Managing Member and Sponsor), enabling the implementation of different incentives for each user type. Points are redeemable for cash, prizes or contest entries (depending on a client's wishes). And a percentage of sponsorship revenue can be shared with top-performing Managing Members, giving these volunteer leaders incentive to build the community.

When it comes to credibility, all users are not created equal. That's why the instant system contains a system of assigning higher credibility to users who deserve it, rendering a more accurate and reliable dataset. Ratings multipliers can be assigned based upon:

User type (Member, Managing Member, Sponsor)

Opinion popularity (percentage of others who agree with user comments)

Subject popularity (percentage of Subjects rated highly by other users)

Qualification to rate a Subject (Self-selected: Very, Somewhat or Slightly)

Experience with a Subject (Have Experienced or Have Not Experienced)

These five ratings multipliers are combined into one final multiplier that determines the credibility of each registered user. Each of these multipliers is optional: clients may use all or none of them on their site.

Typically, the instant system requires only one part-time employee to keep a Web community running smoothly, thanks to the extensive system of automated processes that are constantly running “behind the scenes.” Among these processes are:

Deleting outdated and poor-quality content

Sending invitations to prospective Managing Members

Calculating and aggregating a site's content and usage statistics

Distributing activity points, awards and bonuses

Awarding contest entries and determining winners

The instant system allows people to spread word-of-mouth over the Internet the same way they do in everyday life—only faster, easier, and without geographic boundaries. Harnessing the power of Descriptive Words (preferably evaluative, preferably approval-type) that everyone uses; people can share and compare their exceptional experiences across all walks of life in a matter of minutes. How does it work? Web site users enter their favorite “Subjects” on the Web site. A Subject is any exceptional experience worth sharing with the online community: a great steak, a cozy campsite, a fun sports bar, an inexpensive discount store, a beautiful golf course, etc. During the process of adding a Subject to the site, users will be asked to enter specific information about it: the location, price, time needed, etc. They'll also be asked to use Descriptive Words to describe their Subject. Users may choose from hundreds of pre-selected Descriptive Words, or add their own. These words—the natural language terms that everyday people use to describe the things they like—will be stored in a database that all users can search. Some examples of Descriptive Words are: cozy, scenic, delicious, wonderful, inviting, intimate, romantic, etc.

Users will also be asked to Rate their Descriptive Words and leave Comments about their Subjects. Rating Descriptive Words requires the user to enter the degree to which he/she agrees with the word: e.g., extremely cozy, very cozy, slightly cozy, etc. A Comment is simply a short overall evaluation of the Subject. Once a Subject is approved for public viewing (by a Correspondent, one of your online community leaders), any user can add his/her ratings to it. Users can rate the Descriptive Words for each Subject, and add Descriptive Words of their own. They can also leave Comments on other Subjects, and rate the Comments of other users as useful or not useful. All Subjects on the site are collected in a database, and the users can search that database by keyword or Category of Subjects (all of which are initially created by the client) to find exceptional things they want to experience.

How may these systems be used to make money? Using a completely automated sponsorship system, advertisers can buy sponsorships of a site's Subjects using only their computer and a credit card. No sales force is necessary. And instant-system sponsorships are the most attractive on the Web, allowing advertisers to add photographs, links and extensive information about their business in just a few clicks. Because of this, advertisers not only create revenue, but content as well. Why will users participate? Because there's a rich reward system built into the software that enables system to reward them with points for each of more than a dozen community-building actions. Users can be rewarded with cash with no out-of-pocket costs by allocating a percentage of sponsorship revenue (20 percent is recommended) toward user rewards. Users may keep track of their points by using MyPage, the personalized page for each user that tracks favorite Subjects, rewards earned, newly added content and other items of interest for each user.

As noted, a most attractive feature of the instant system is its adaptability. Nearly every feature—from the interface to the rewards system—is customizable by the client, making the system as useful to an international daily newspaper as it is to a monthly specialty magazine. Clients create their own categories, subcategories, contests, incentive programs, news releases and pricing models. Clients may customize the site by configuring it using Terraformer (Configuration and Administration) Module, the system's Web-based administrative program that allows a client to easily customize dozens of elements on the site.

First Described Preferred System Screens and Operation Details

Following are discussions of the most important screens that users will see and explanations of the details of all actions a user will perform on the site with the instant system and the details of how to customize the technology for the site using a wide variety of configurable variables.

A typical-type navigation bar preferably appears at the top of every page on the site. The links, however, work as follows:

Add a Subject: Links to the Add a Subject page

MyPage: If a registered user is logged in, this link takes the user to his/her MyPage. If user is not registered—or if a registered user is not logged in—this link takes him/her to a logon page.

Tell A Friend: Links to the “Tell a Friend” page.

Feedback: Links to feedback form.

Help: Links to FAQs.

These links are preferably mirrored in the page footer, described as follows. Like the navigation bar, the footer is a standard element of all pages on the site. The links on the top row of the footer mirror the links in the navigation bar described above. The links on the bottom row of the footer work as follows:

About us: Links to the instant system “About Us” page.

Privacy Policy: Links to the instant system privacy policy.

Terms of Use: Links to the instant system terms of use page.

A Log In/Log Out graphic appears in the top right corner of every page on the site. If user is unregistered or simply not logged in, the graphic Log In will appear. If user is logged in, the graphic Log Out will appear. The Log In/Log Out graphic is a fixed element on all pages.

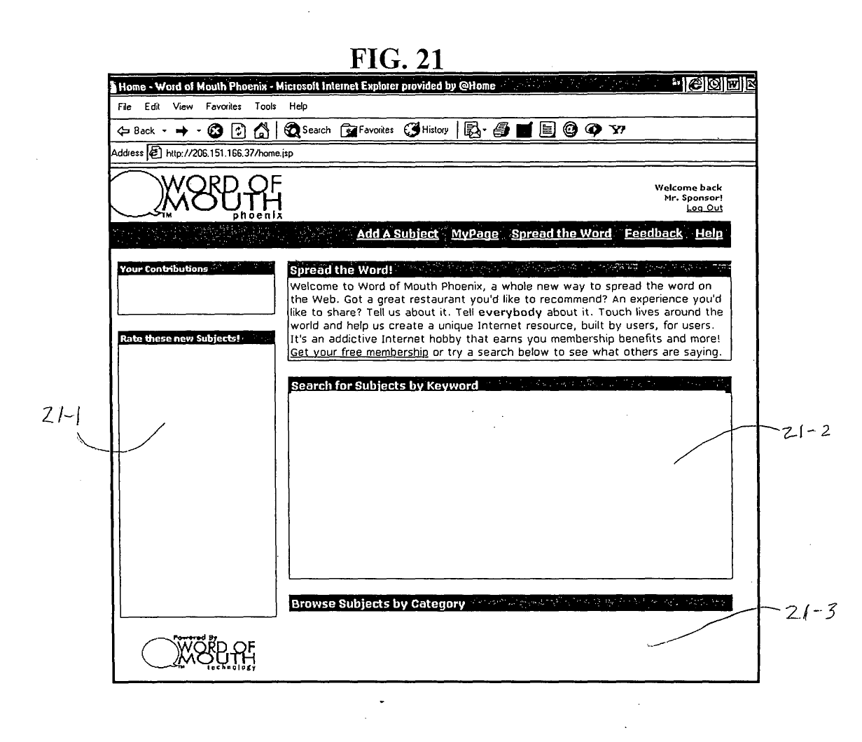

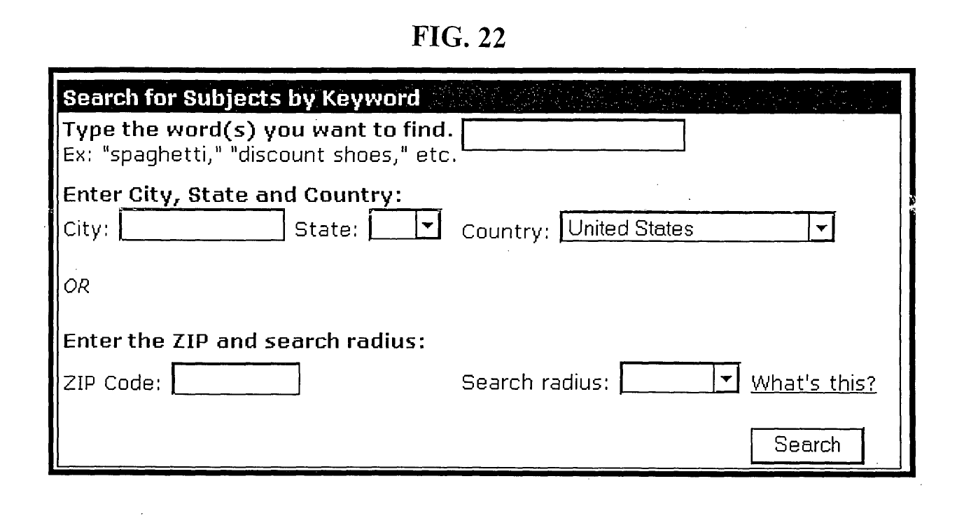

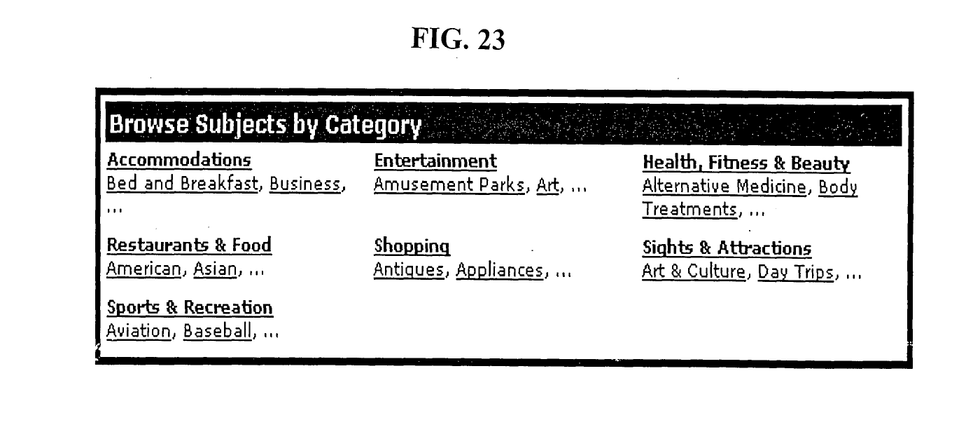

The home page will preferably look basically as shown by FIG. 21. The box 21-1 on the left side of the home page preferably lists the 10 Subjects that have been recently approved by Correspondents and has links to the 100 most recently approved Subjects. The number of new Subjects displayed is fixed at 10 to conserve space on the home page. The search box 21-2 is shown in FIG. 22 and its location is preferably fixed at the top right side of the home page. Each field in the search box is preferably fixed. The category box 21-3 is shown in FIG. 23. Listed in this box are each category (in bold) and two subcategories beneath it. The client may configure this by defining the categories and deciding which of those categories are displayed on the home page (they need not be all displayed if not wanted). Note: Two subcategories display under each category on the home page. This number is fixed.

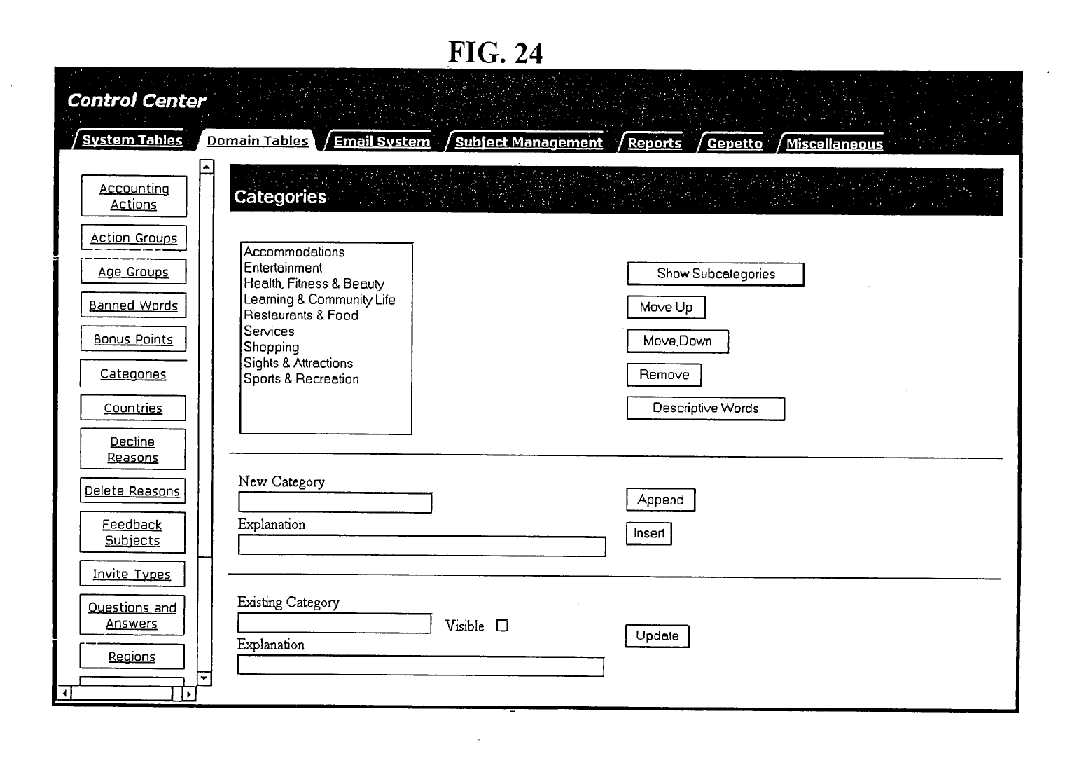

With reference now to FIG. 24, the “Terraformer (Configuration and Administration) Module” screen permitting the client to configure the software, to configure the Category box in Terraformer (Configuration and Administration) Module, click “Domain Tables” on the top navigation bar and “Categories” on the left navigation bar (see following example). The following is a description of how categories, subcategories and words can be preconfigured to meet needs. FIG. 24 illustrates Terraformer (Configuration and Administration) Module's top and left navigation bars. The first tab that must be selected is in the top navigation bar. In this example, one would click “Domain Tables” in the top navigation bar. The proper categories will then appear in the left-hand navigation bar. When they appear, click “Categories,” and the proper content will appear in the right-hand frame. The full screen of content for “Categories” is shown. Note: In Terraformer (Configuration and Administration) Module, you must always make your selection from the top navigation bar first. After making the proper selection from the top bar, the correct links will appear on the left. To add a new category, type its name in the “New Category” box. Type an explanation (for internal use) in the “Explanation” box. Then click “Append.” After that, the new category will appear in the listing above.

To make a category visible or invisible on the home page, or to edit the title of an existing category, or to edit the explanation of an existing category, click on that category in the category listing box. Its title and description will then appear in the “Existing Category” section at the bottom of the page. Click the “Visible” box if the client wants the category to be visible; if not, uncheck the box. To make changes to the name or explanation of the category, edit the name and/or explanation for the category. When finished, click “Update” to execute the changes. To remove a category, click on the name of the category to be removed in the category listing box. Then click the “Remove” button at right. To shift the order in which categories appear, click on the name of a category to be shifted. Then click “Move up” or “Move down” in accordance with where one would like the category to appear. Repeat for each category until the desired order is achieved. The default order of appearance is alphabetical.

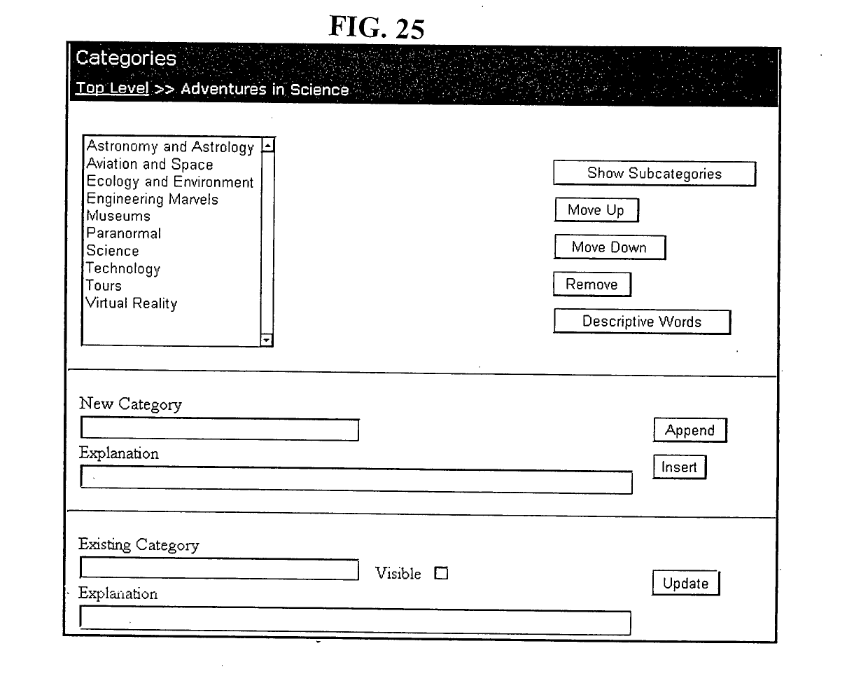

To create and edit subcategories under a specific category, click on that category in the category display box. Then click the “Show Subcategories” button at right. A screen like the illustration of FIG. 25 will return. To add a new subcategory, type its name in the “New Category” box, and type an explanation of the subcategory (for internal use) in the “Explanation” box. Then click “Append.” To edit a subcategory, click on it in the subcategory display box, and its title and description will appear in the “Existing Category” and “Explanation” boxes at the bottom of the page. Make the desired changes to its visibility status, category name and explanation, then click “Update.”

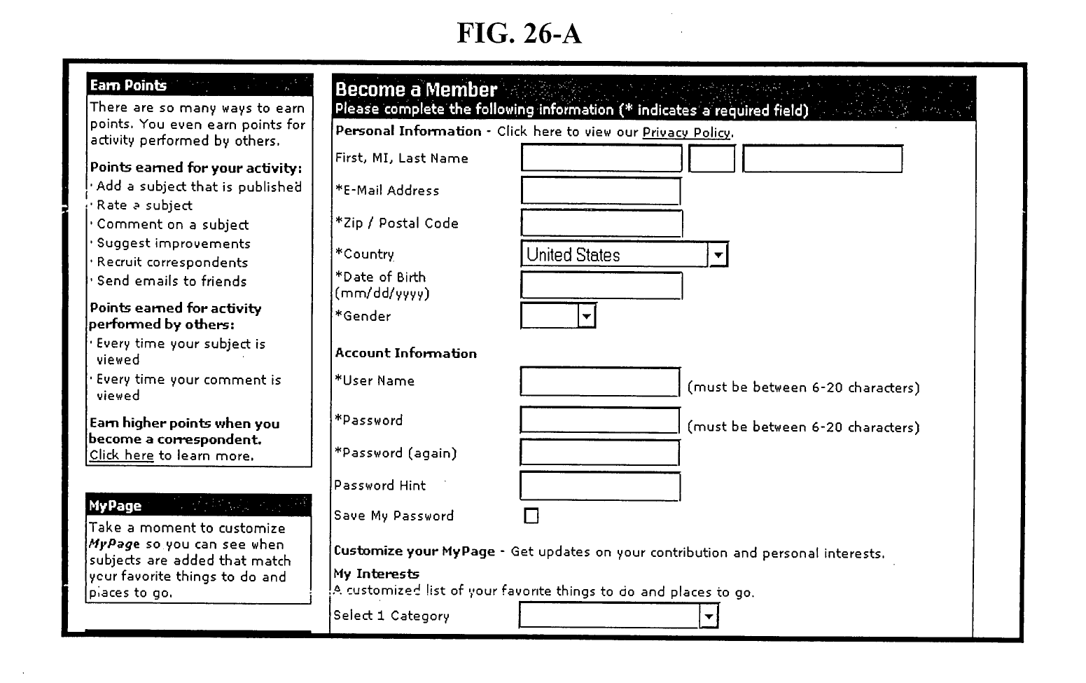

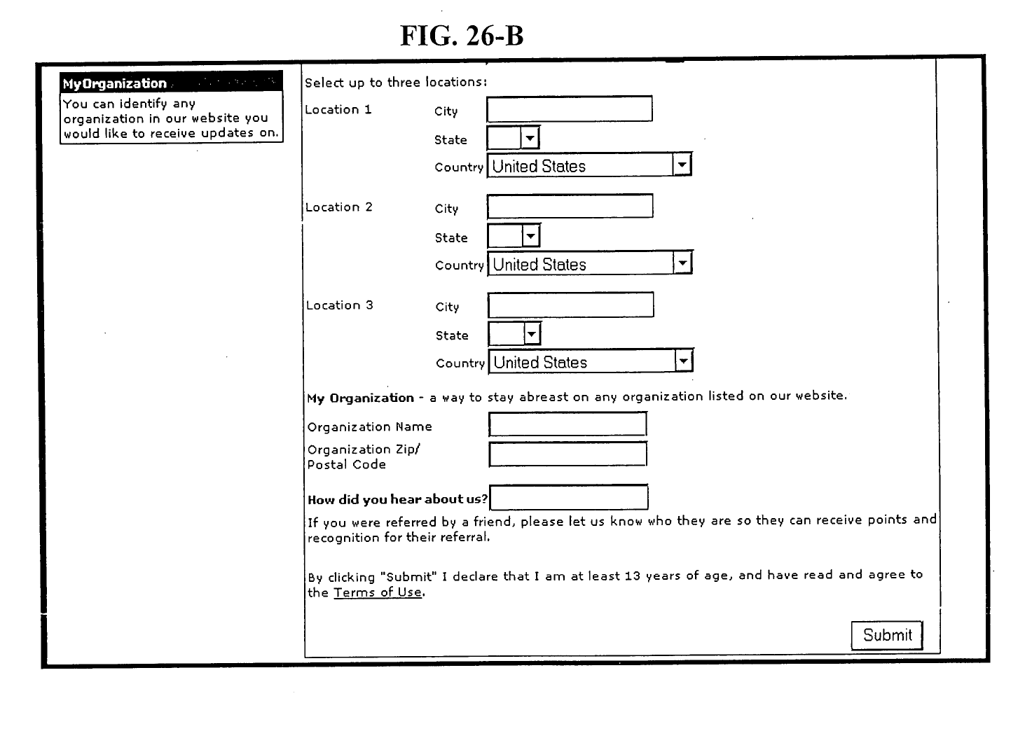

The Log In/Registration procedures are typical of what is well-known in the art. If the user is already registered, he/she types the username and password into the proper fields and clicks the “Log in” button. If the user is unregistered, he/she clicks the “Join Now” or “Sign up now . . . ” link, and gets a screen, for Member Registration, like the illustrations of FIGS. 26A-B. The user must fill out each field with an asterisk; all other information is optional. After entering personal information and a username and password, the user may fill out further information about his/her interests, in order to customize his/her personal page (MyPage) on the site. Optional information includes personal interests, locations and organization the user wishes to track. From this page, a user may also apply to be a Correspondent by clicking the link to the application on the left side of the page (highlighted above).

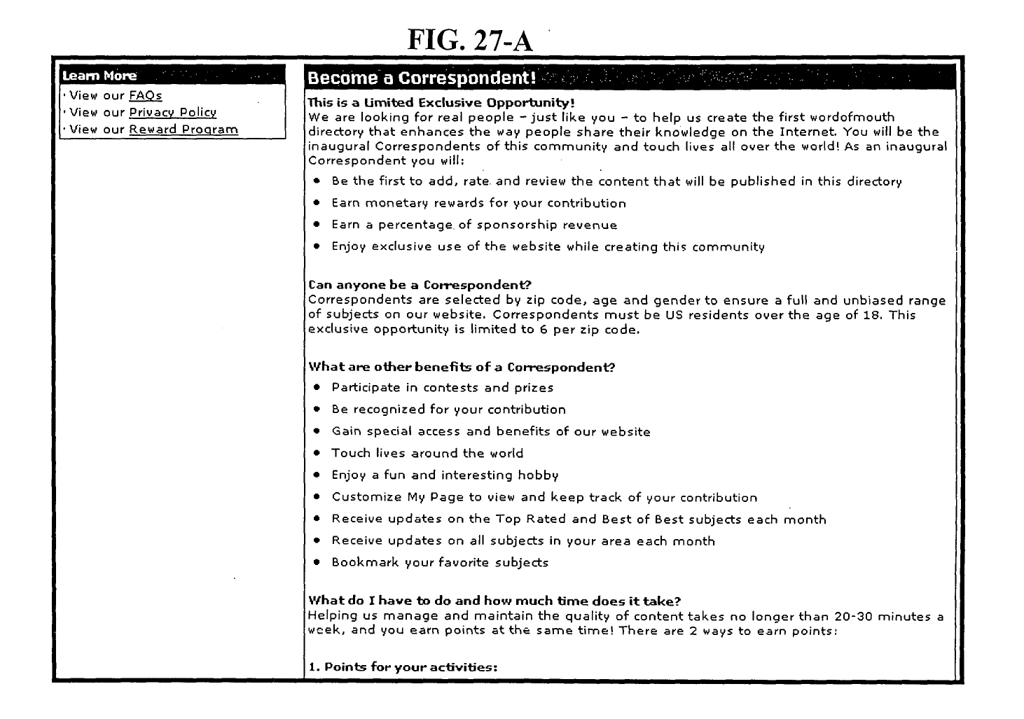

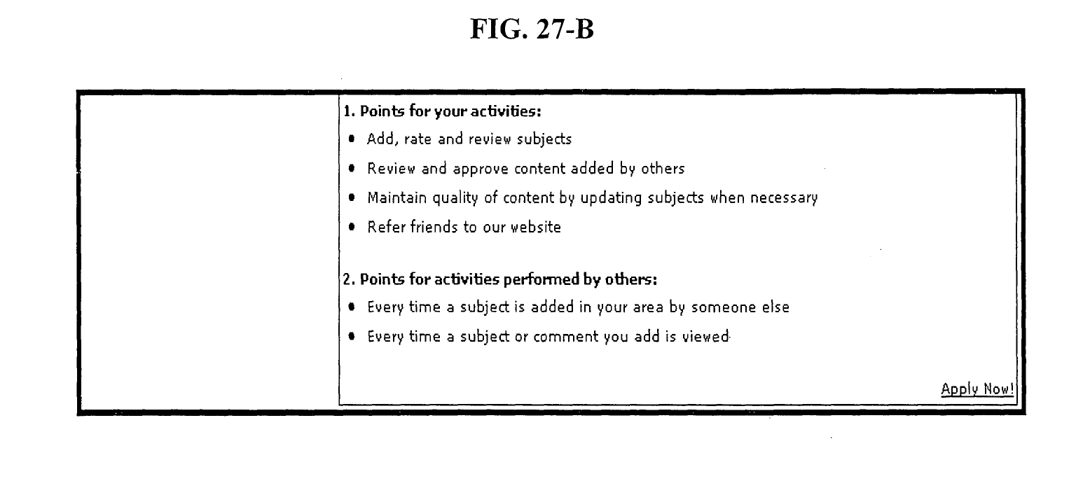

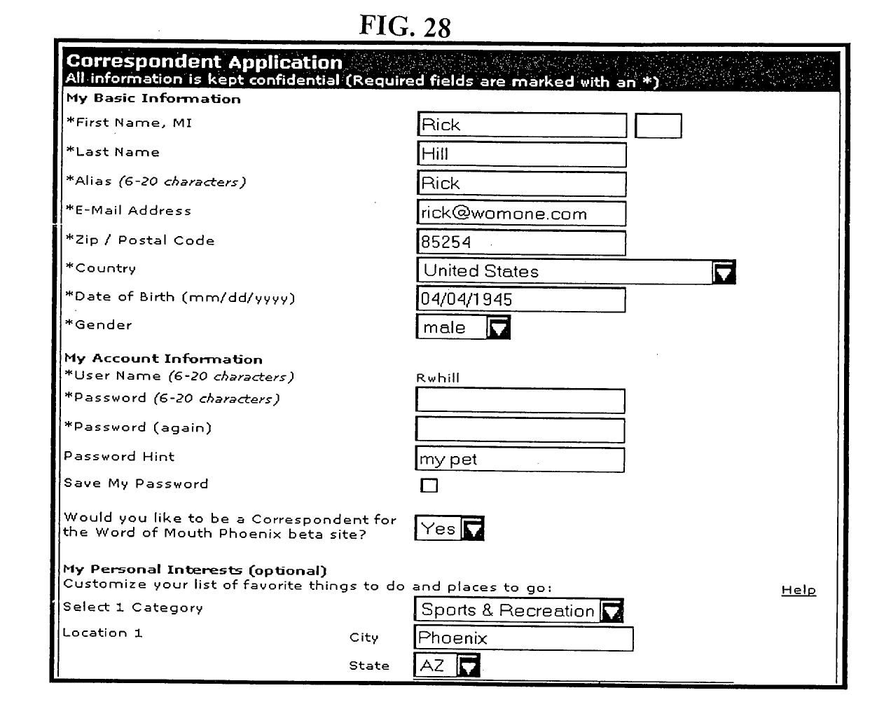

Clicking the link will return a screen, for Correspondent Registration, like the illustrations of FIGS. 27A-B. This screen provides details of the advantages and responsibilities of becoming a Correspondent. From here, the user clicks the “Apply Now” link at the bottom right corner of the screen and goes to the following page, illustrated in FIG. 28. The Correspondent application is essentially the same as the Member application, but it contains questions in the “My Account Information” section that the Member application does not include. These questions and their answers are scripted by the client. Each answer is assigned a point value (by the client). When the applicant answers all the questions, his/her numerical score is tabulated and must meet the minimum acceptable score (established by the client) to become a Correspondent.

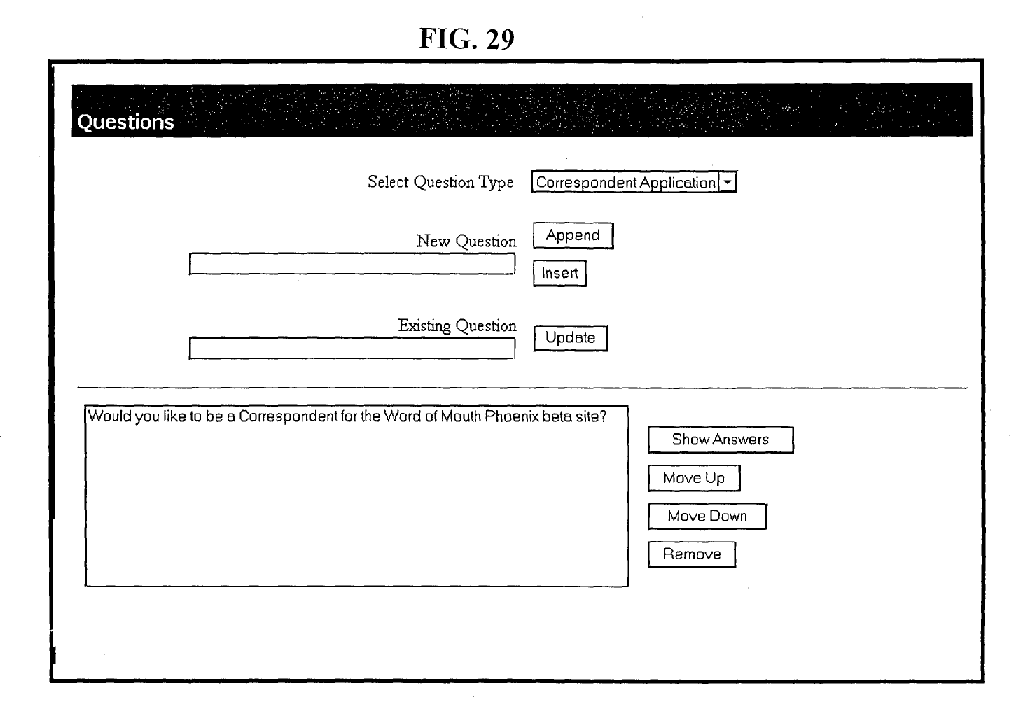

A client may configure this area using Terraformer (Configuration and Administration) Module. To configure questions to the Correspondent, select “Domain Tables” on the top navigation bar and “Questions and Answers” from the left navigation bar. A screen like that illustrated in FIG. 29 will appear. In the first dropdown box, select the type of question for adding/editing/removing, e.g., a question on the Correspondent application. To add a new question, type the text into the “New Question” field, the click “Append.” To remove an existing question, select it from the list on the left and click “Remove.” To edit an existing question, select it from the list on the left. Its title will then appear in the “Existing Question” field. Edit it, then click “Update” (the “Add” button will change to say “Update” instead). To change the order of the questions, click on the name of a question you'd like to move. Then click “Move Up” or “Move Down” until it's in the desired position. Repeat this process with the other questions until the desired order is achieved.

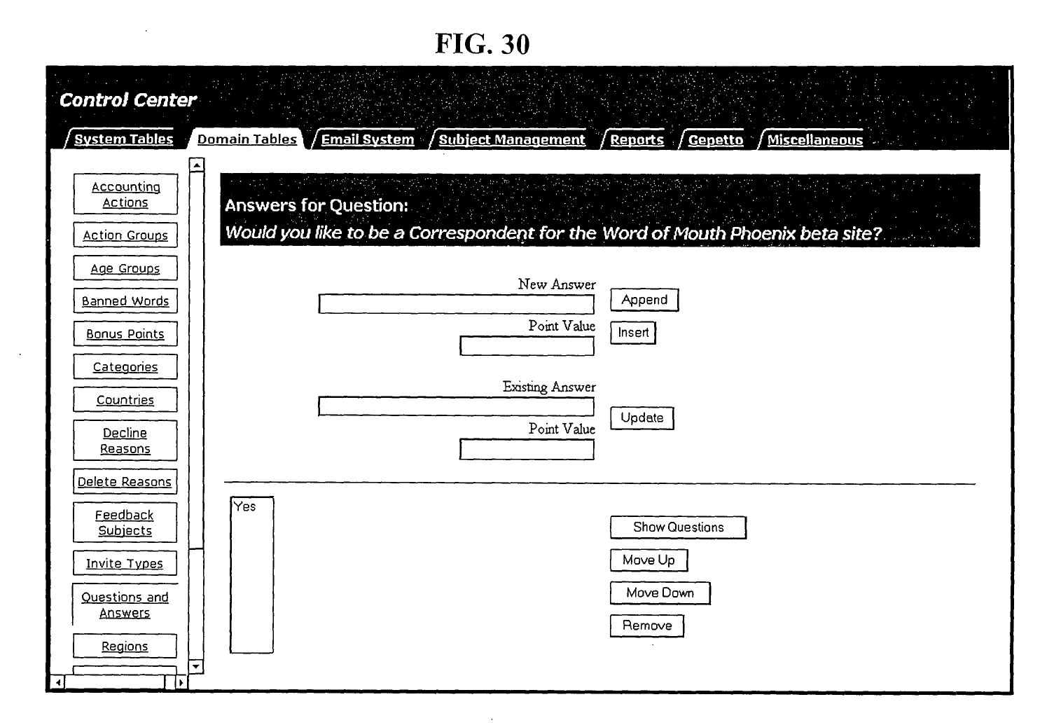

To configure Answers, from the Questions screen, click on the question for which you would like to formulate answers. Then click the “Show Answers” button at right. A screen like that illustrated in FIG. 30 will appear. To add a new answer, type the text into the “New Answer” field and its point value into the “Point Value” field, the click “Append.” To remove an existing answer, select it from the list on the bottom left and click “Remove.” To edit an existing answer, select it from the list on the bottom left. Its title will then appear in the “Existing Answer” field. Edit its name and point value, then click “Update.” To change the order of the answers in the box, click on an answer you'd like to move. Then click “Move Up” or “Move Down” until it's in the desired position. Repeat this process with the other answers until the desired order is achieved.

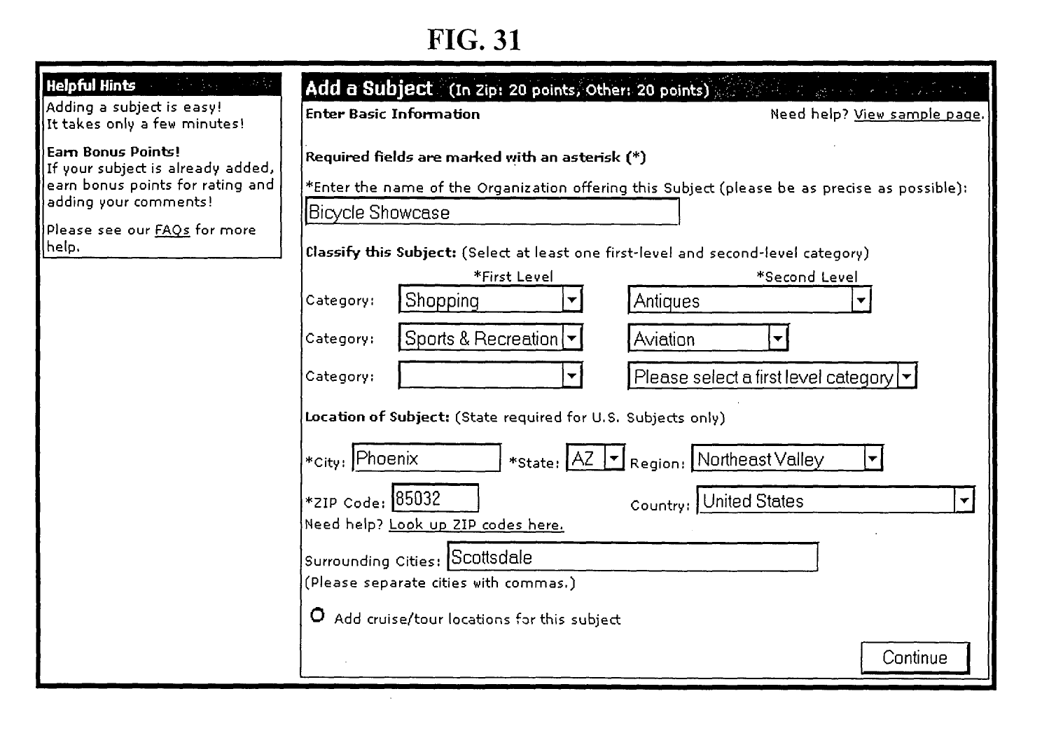

FIGS. 31, 32, and 33 illustrate the three pages used to Add a Subject. The first step in the user's process of adding a Subject is the page of FIG. 31, where he/she must enter some basic information, as shown. The user enters the name of the organization that provided the experience: e.g., Morton's Steak House, Samantha's Health Spa, etc. This is a required field and preferably not configurable by the client. Next, the user must select at least one category and subcategory. These categories are configurable, and the process for configuring them is later described. Once the category is selected (at left), the relevant subcategories appear on the right.

The three category and subcategory boxes themselves are not configurable; they are preferably fixed items on this page. The user must enter a city, state and ZIP code for each U.S. Subject (state or ZIP code is not required for non-U.S. Subjects.). Region, country and surrounding cities are optional. It is recommended that users enter surrounding cities in order to make the Subject more widely available to other users. For example, if User Bob enters a Phoenix restaurant and enters Glendale, Scottsdale and Tempe as surrounding cities, then users who search for any of the four cities—Phoenix, Glendale, Scottsdale or Tempe—will see the restaurant Bob entered. The client can configure the Region and Country fields and may also choose the default countries and regions. In the Terraformer (Configuration and Administration) Module screen, click the “Domain Tables” tab on the top navigation bar. Then click “Regions” on the left navigation bar. A Regions screen will appear; and from the “Select Region Type,” the client may select the area to break into regions: Country or State. If adding a new region, ignore the “Select Region” box. Type the name of the new region into the “Region” box and click “Add.” If editing the name of an existing region, select it from the “Select Region Type” box. Its name will then appear next to the “Region” field, where you one can edit it. If removing an existing region, select it from the box. Its name will then appear next to the “Region” field. Then click “Remove.”

To configure Countries in Terraformer (Configuration and Administration) Module, click “Domain Tables” on the top navigation bar and “Countries” on the left navigation bar to get a Countries screen. If you adding a new country, type its name in the “Country Name” field and click “Add.” If editing the name of an existing country, the “Add” button will say “Edit” instead. Select the country name to be edited from the “Select Country Name” dropdown box, after which the text will appear in the “Country Name” field. Edit the text to specifications, then click “Edit.”

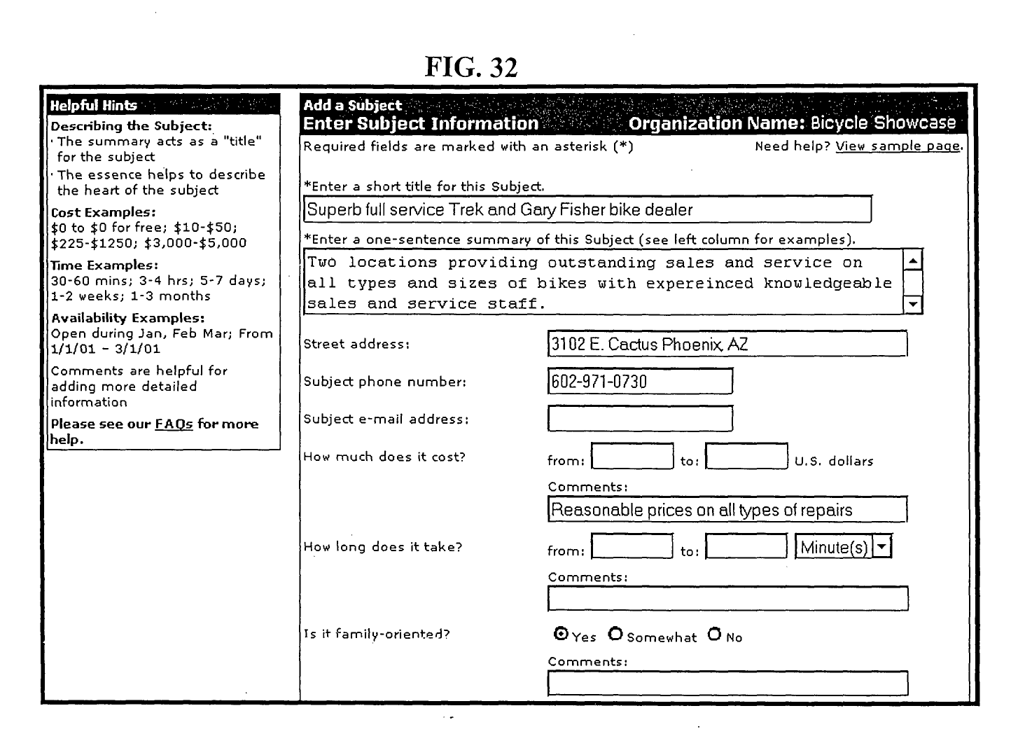

With respect to FIG. 32, illustrating the second page of Add a Subject, the user must enter a short summary title for his/her Subject. This title will be the headline on the Subject page. It will also be the linked text that appears when the Subject is called up in search results. The user must also enter a one-sentence summary of the Subject. This description will appear underneath the linked text in search results. It will also be prominent on the Subject page. These two fields are preferably fixed. Address, phone number and email address are optional fields. Cost and time are also optional fields; however, these fields may be searched by other users in the Personalized Search area. The Comments box under each range allows the user to clarify his/her comments. For example, if the user enters $100-$150 as a price range for Caesar's Palace hotel in Las Vegas, he/she may specify in the Comment box that “This is for the cheapest rooms. The nicest rooms are in the $400-$500 range.” This information will appear on the Subject page, above the Comments. Two more optional fields are “Family-oriented” and “Availability.” Comment boxes are provided for further explanation. These fields are fixed.

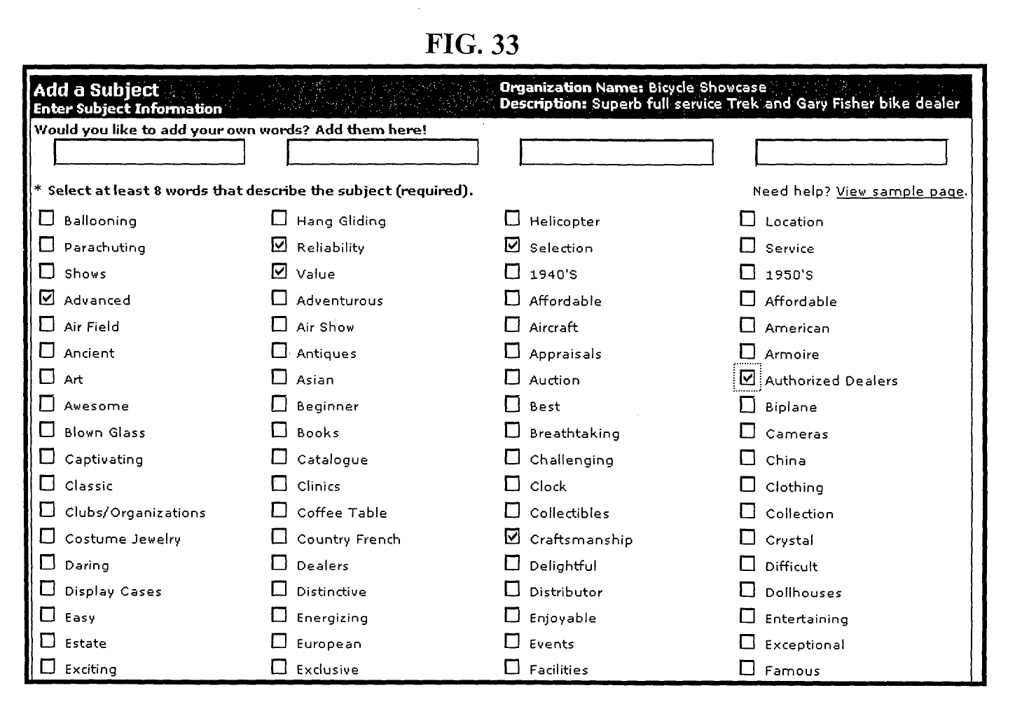

FIG. 33 illustrates the preferred third page of the Add a Subject process. It is where the user will determine the Descriptive Words to associate with his/her Subject. The Descriptive Word system is the fastest and easiest way to rate Subjects with the instant system. Instead of making users start with a blank slate, the software automatically presents them with words other users have chosen to describe the same thing. In an example, User Andy has chosen to give his opinion about a restaurant called “Mr. Sushi.” After learning that Andy's Subject is classified under “Restaurants,” the software generates a list of Descriptive Words that is relevant to the “Restaurants” category. This list is a combination of words that are preloaded in the software, and words that previous users have used to describe other restaurants. In this example, Andy can then check the words he thinks are appropriate for his review, and, in the spaces below, add his own. Andy has added “large portions” and “fast service” as his own Descriptive Words. The next time a user reviews a restaurant, “large portions” and “fast service” will be part of that user's list of pre-selected Descriptive Words. By adding his review of Mr. Sushi, Andy has not only contributed content to the Web site, but also made the contribution process easier for future users by adding to the list of pre-selected Descriptive Words for the “Restaurants” category.

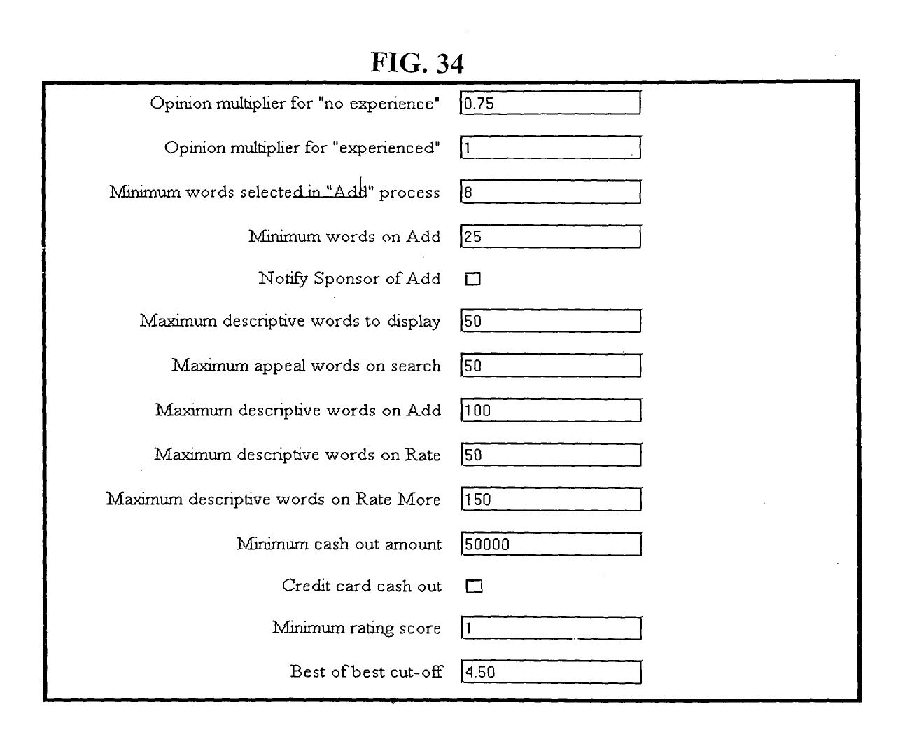

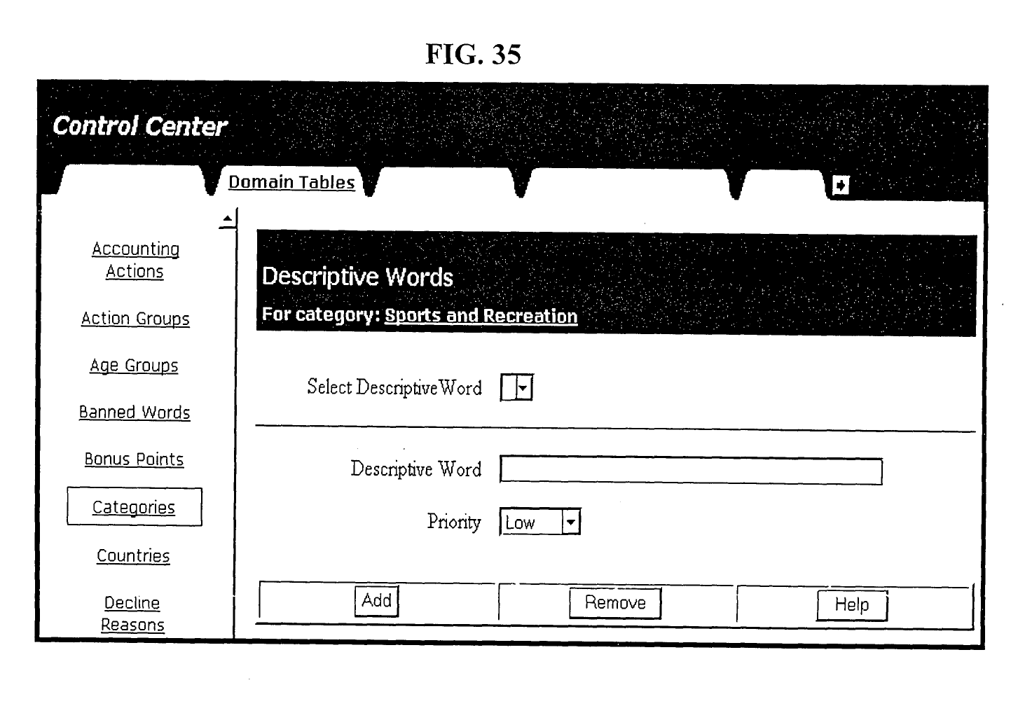

The client can configure this; it can decide how many words are displayed at this point in the add process and also decide which words show up by designating certain words to appear for certain categories. In Terraformer (Configuration and Administration) Module, click the “System Tables” tab on the top navigation bar and “System Parameters” in the left navigation bar. FIG. 34 illustrates a preferred screen which is shown. One types in the minimum and maximum number of Descriptive Words one wants to display for the user during the process of adding a Subject. When finished, scroll to the bottom of the page and click “Update.” To set which words display for this category, click (in Terraformer (Configuration and Administration) Module) the “Domain Tables” tab on the top navigation bar and the “Categories” tab on the left navigation bar. A screen like that illustrated in FIG. 35 will appear. Type in the descriptive word to be added for this category and then click “Add”. To edit a descriptive word from a category, use this screen as well. Select a descriptive word from the dropdown box. When you do this, the “Add” button will change to an “Update” button. Select the word, make the proper changes and click “Update.” To remove a descriptive word from a category, use this screen as well. Select a descriptive word from the dropdown box, then click “Remove.”

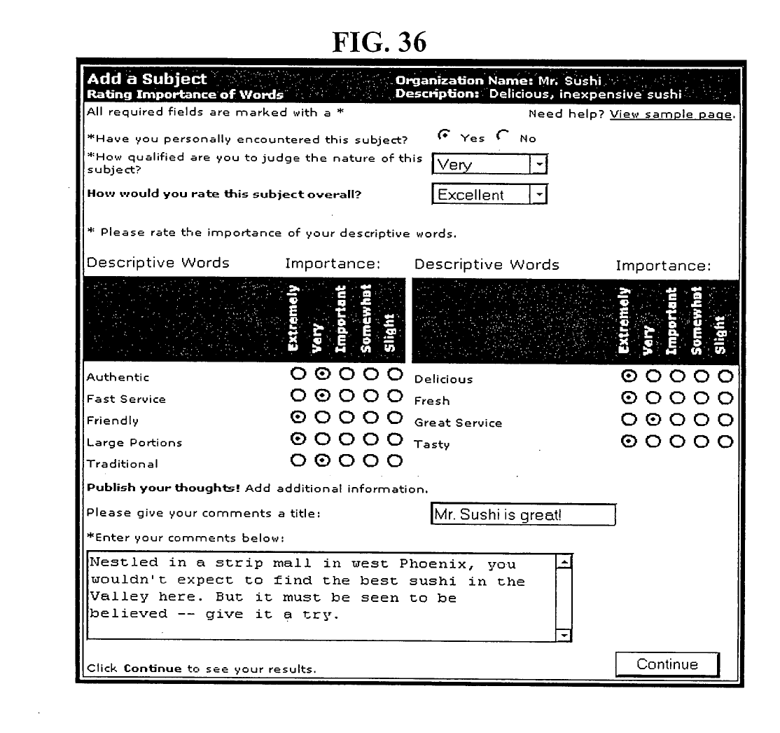

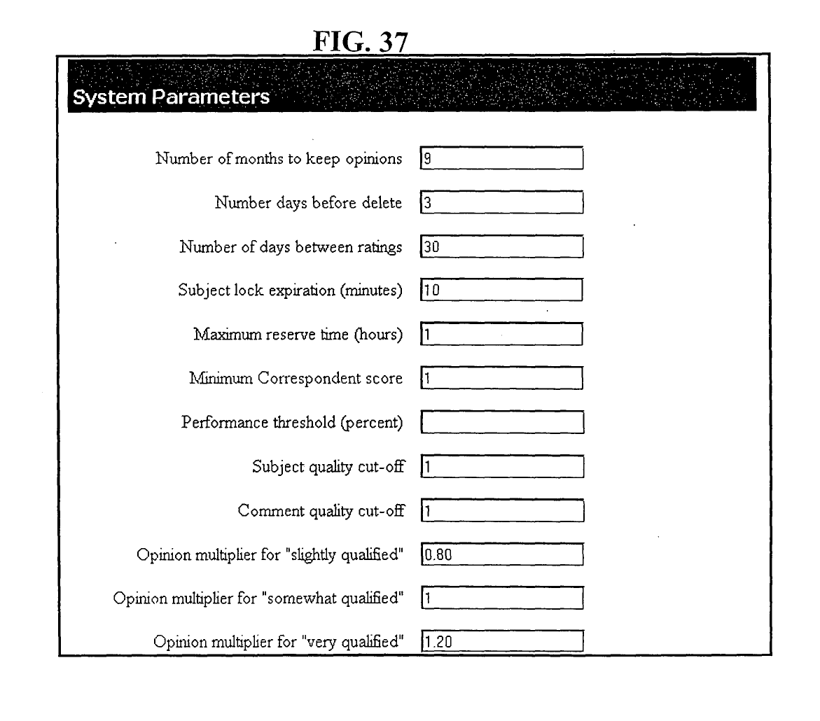

FIG. 36 illustrates a preferred screen for Add a Subject, page 4. The required user steps and the configuration information for page 4 of the Add a Subject process is illustrated as follows. The user must answer whether they have experienced the Subject themselves, and how qualified they feel to rate it. These fields are required. The top two fields are a part of the credibility system that is built into the software. The client can assign credibility multipliers for both of these fields, based on how the user answers each question. To configure opinion multipliers, in Terraformer (Configuration and Administration) Module, click the “System Tables” tab on the top navigation bar, then click the “System Parameters” tab on the left navigation bar. A screen like that illustrated in FIG. 37 will return. The bottom two fields—“no experience” and “experienced”—refer to the user's answer to the first question of whether he/she has experienced the Subject. People who answer “no” receive the no experience multiplier; people who answer “yes” receive the “experienced” multiplier. Using example settings, the opinion of a person who answers “yes” might be counted five times as much as that of a person who answers “no.” The top three fields—the opinion multipliers for “slightly qualified,” “somewhat qualified” and “very qualified”—refer to the answer to the second question of how qualified the user feels to rate this Subject. The client may enter a chosen value for each multiplier, then scroll to the bottom of the page and click “Update.”

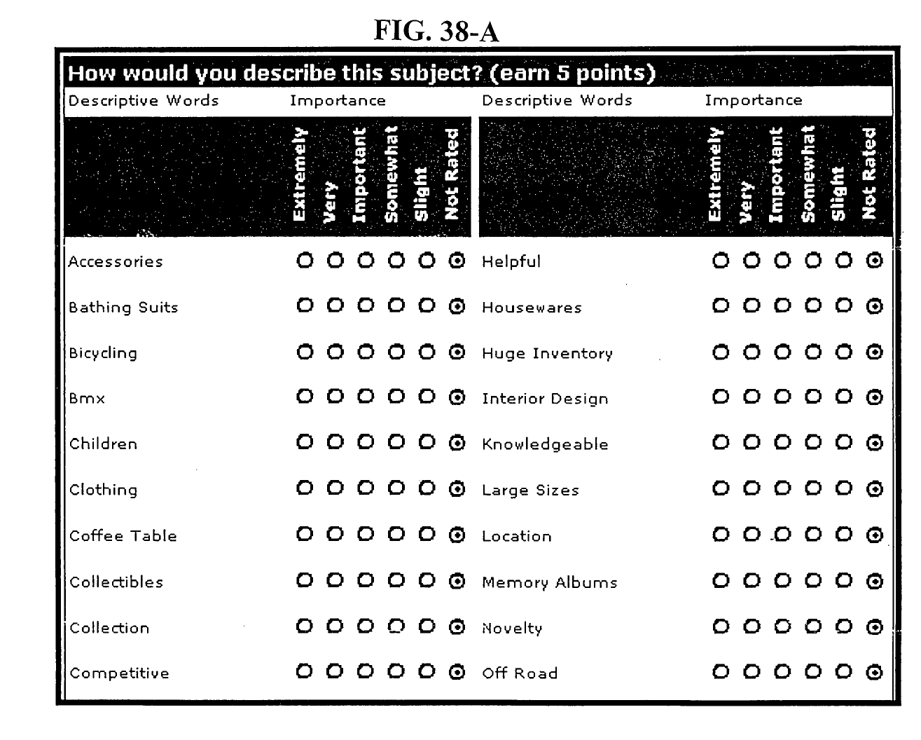

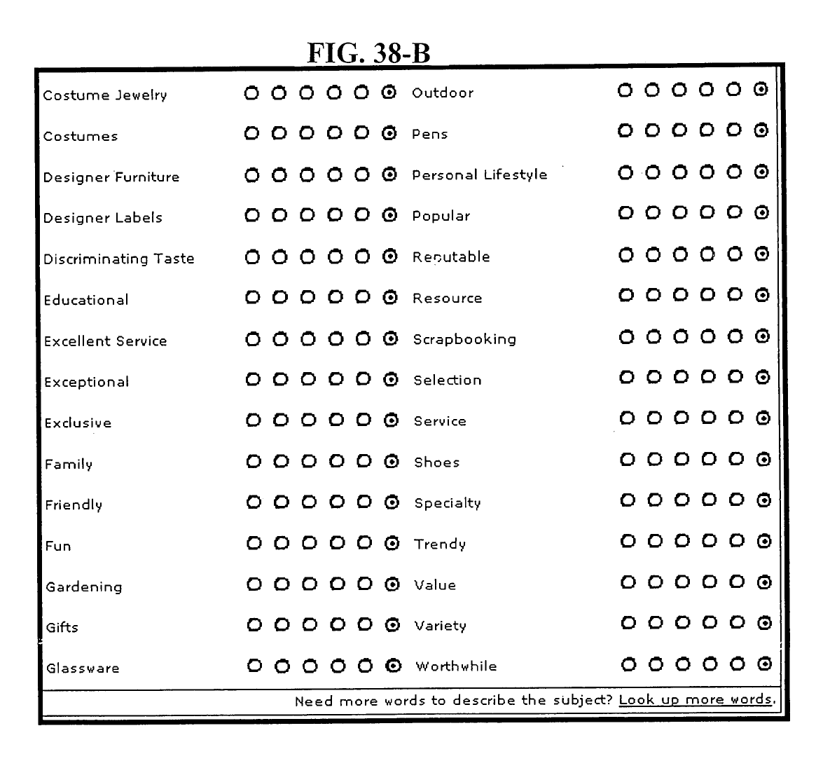

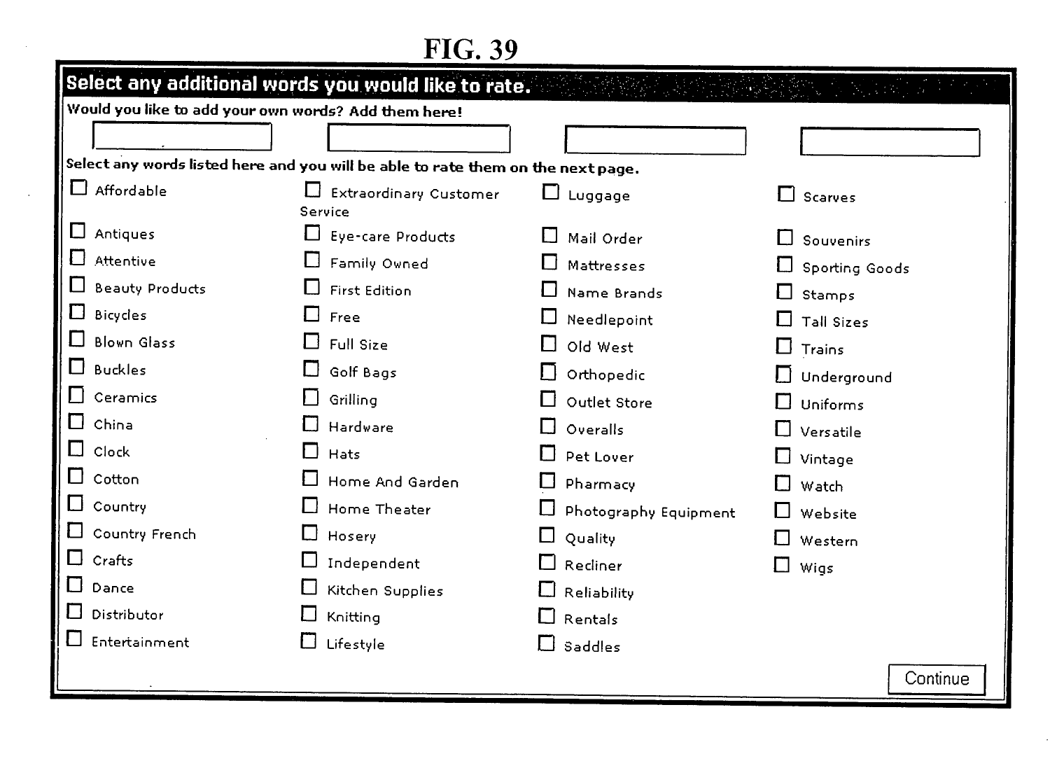

Returning to the Add a Subject process, reference is made to FIGS. 38A and 38B, showing words to be rated. Next, the user rates the Descriptive Words that appear on the page. The words that appear here are all of the words that the user checked and/or added on the previous screen. The user may rate some or all of these words. This screen is not configurable. The number of words that appear here depends on how many the user checked and added on the previous screen. If a user would like to choose more pre-selected words, he/she can click the “more words” link, and get a screen showing more words to rate. He/she can rate as many of the words as is desired, and then click “Continue” at the bottom of the page. To add his/her own words, the user clicks the “add additional words” link (from the original keyword-rating page) and gets a box like that illustrated in FIG. 39. After adding words, the user clicks continue and is taken back to the ratings and comments page.

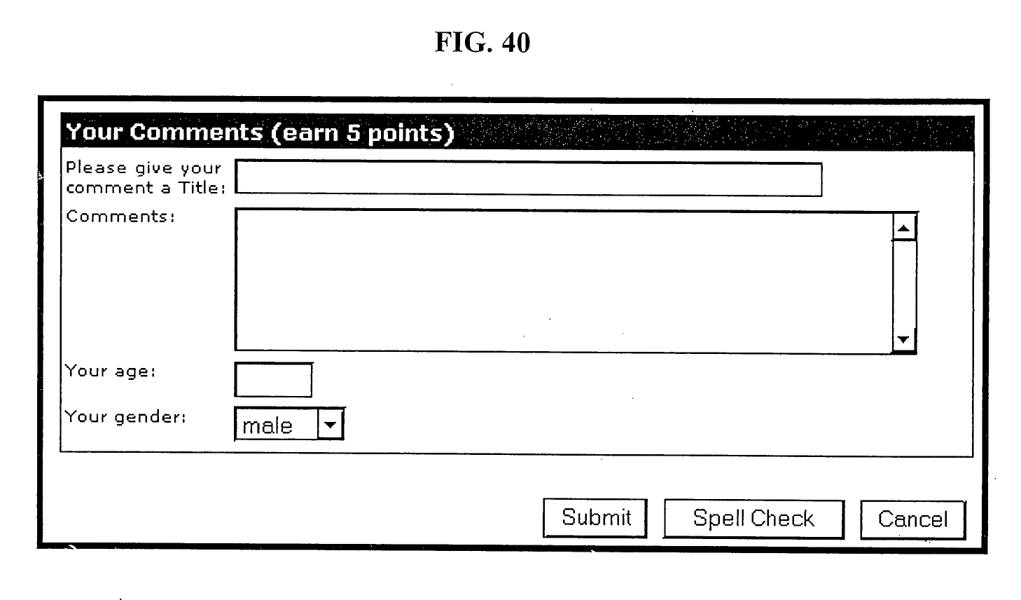

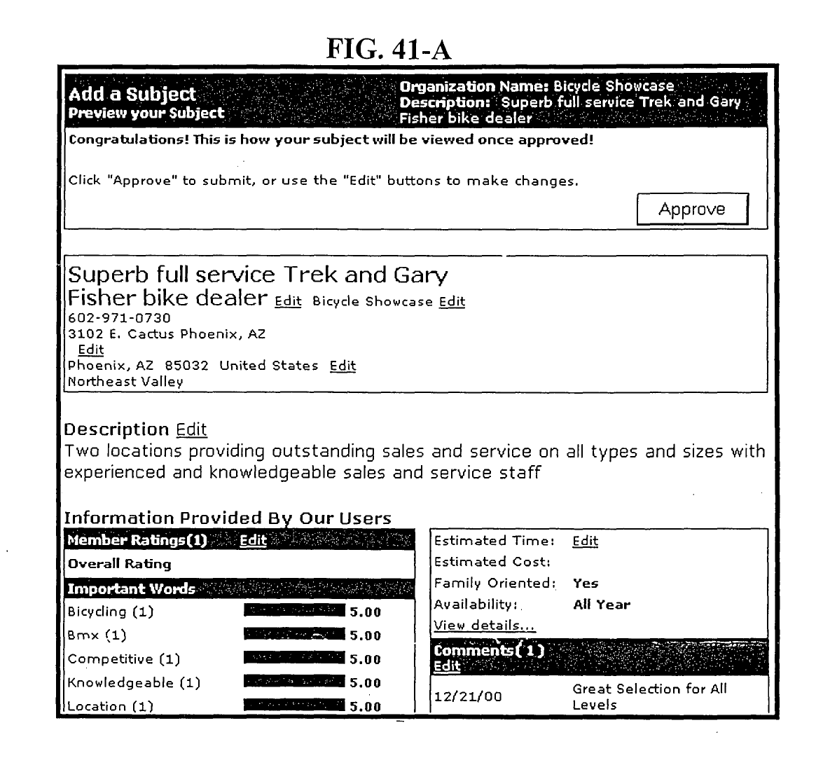

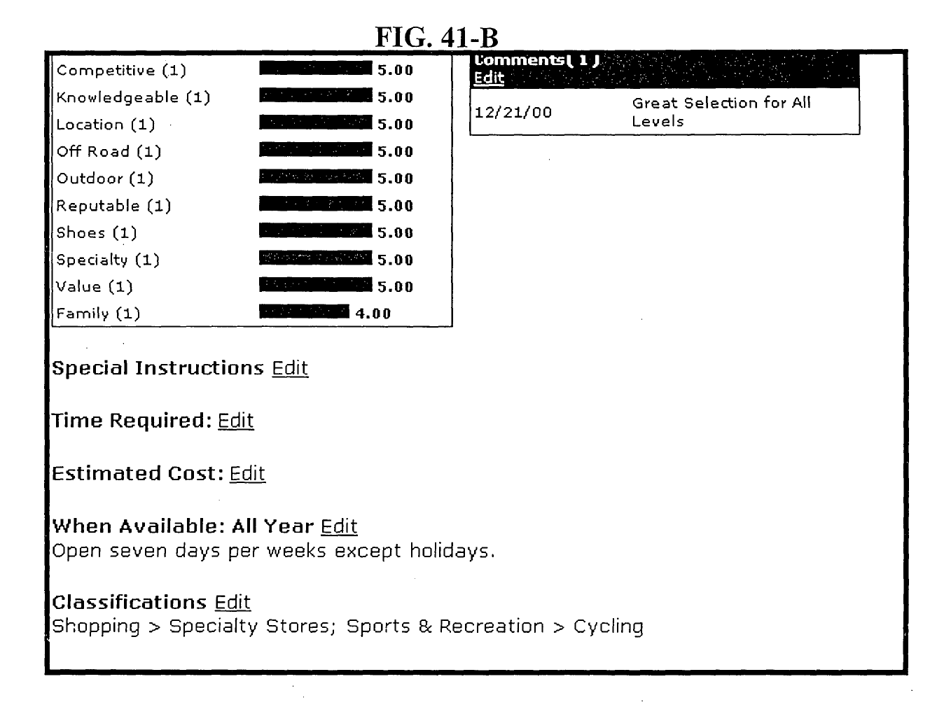

FIG. 40 illustrates that, finally, a user may leave comments. Adding age and gender is optional; and the Comments field is fixed. Once the user has filled out all the necessary information, he/she will click “submit” and get a preview of the Subject. The preview screen is shown by FIGS. 41A and 41B. Once the user has reviewed this preview screen for accuracy, he/she clicks “Approve” if all the information is correct. If changes need to be made, the user clicks “Edit” in the area which needs to be edited. After the incorrect information has been edited, the user is returned to the preview page, and must click “Approve.” It is noted that once the Subject is approved by the user who enters it, it is not immediately viewable by the public. This means that it will not immediately show up in search results. All Subjects must be approved by a Correspondent before they are available to the public. The only exception to this rule is for Subjects entered by a Sponsor. These Subjects do not require a Correspondent's review and approval, and are immediately viewable by the public once they are entered.

The most common reason for a site visitor to use the instant system will be to find something exceptional. It could be an exceptional dessert, scenic drive, campsite, family fun park, martini, or hundreds of other possibilities. There are two ways to find things using the instant system: searching by keyword and searching by category. The search box illustrated in FIG. 22 and previously discussed is the most prominent element on the home page of the instant system. If a user already has a good idea of what he/she is looking for, then searching by keyword is likely the quickest way to find the desired Subject(s). The user must type in at least one of the following to perform this type of search:

A keyword or phrase

A city name

A state abbreviation

A ZIP code and search radius (from the center of that ZIP code)

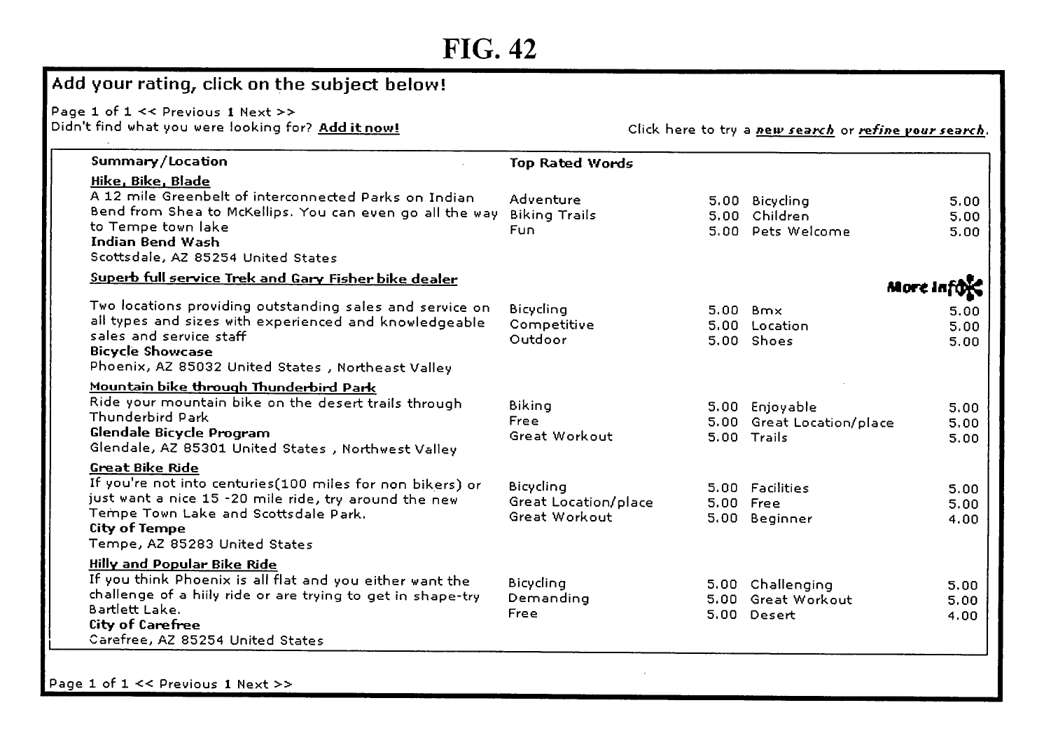

These fields are fixed. The more information the user enters, the more specific the results will be. When User Bob types in the required information and clicks “Search,” the software looks for that information in the appropriate fields of the database (e.g., City, State, ZIP code, Subject Title, Descriptive Words, etc.), a results screen like that illustrated by FIG. 42 returns. The title of each result will be linked to its Subject page, and the summary and location will be listed under that link. The right and middle columns list the Subject's cost, the time required to experience it and the highest-rated keywords associated with it. The “Sponsored” icon in the far right column indicates that a particular Subject has been sponsored by an advertiser. These Subjects will likely contain more information than a typical Subject, because the advertiser has had the opportunity to add extra links, photos and text. They also receive priority listing in category searches (not in keyword searches). Preferably a listing of “Best of Best” subjects will be shown the far left column, indicating that a particular Subject has been rated high enough to receive the “Best of Best” distinction. Note: Only Correspondents, preferably, can see the “Best” icon on a search results page.

This page can be configured by the client, who may decide how many search results come up on each page and also decide how high a Subject must score to be given the “Best of Best” distinction. To configuring search results, click (in Terraformer (Configuration and Administration) Module) the “System Tables” tab on the top navigation bar and the “System Parameters” tab on the left navigation bar. Scroll to the bottom of the screen (previously described). In the top field, type in the maximum number of total search results that one wants users to be able to retrieve when users perform a search on the site. In the second field, specify the number of search results per page that the client would like the user to see. When finished, click “Update” at the bottom of the page. To configure Best of Best, in the “Best of Best cutoff” field, enter the number you would like to designate as the minimum average rating a Subject must receive in order to receive the distinction “Best of Best.” The range for this number is between 0.01 (lowest) and 5.0 (highest, a perfect score). All Subjects with an average rating higher than the one you select will be considered Best of Best. When finished, click “update” at the bottom of the page.

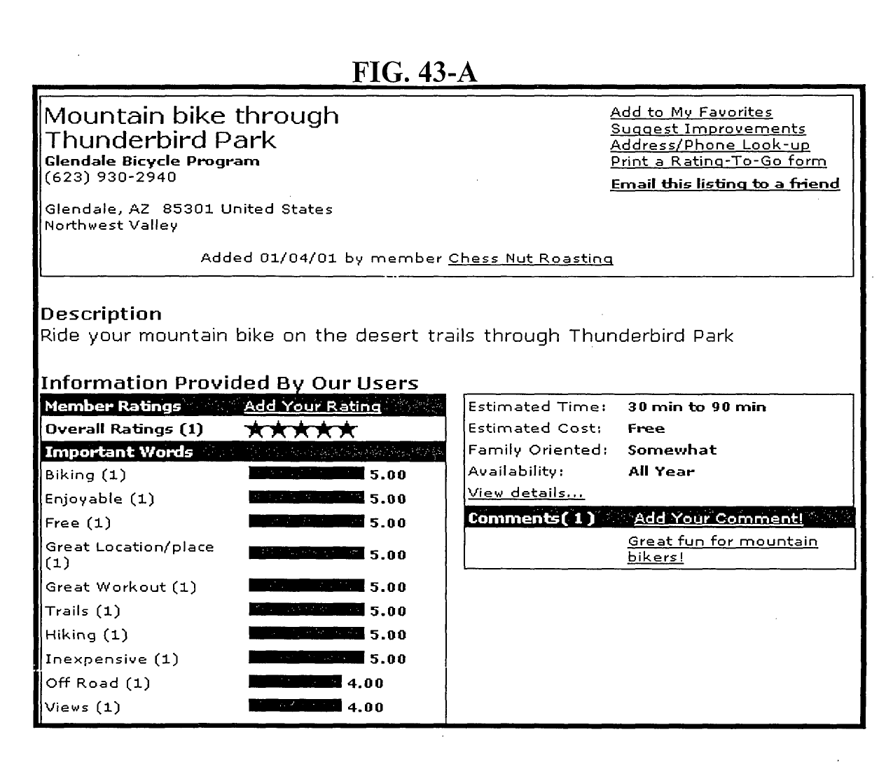

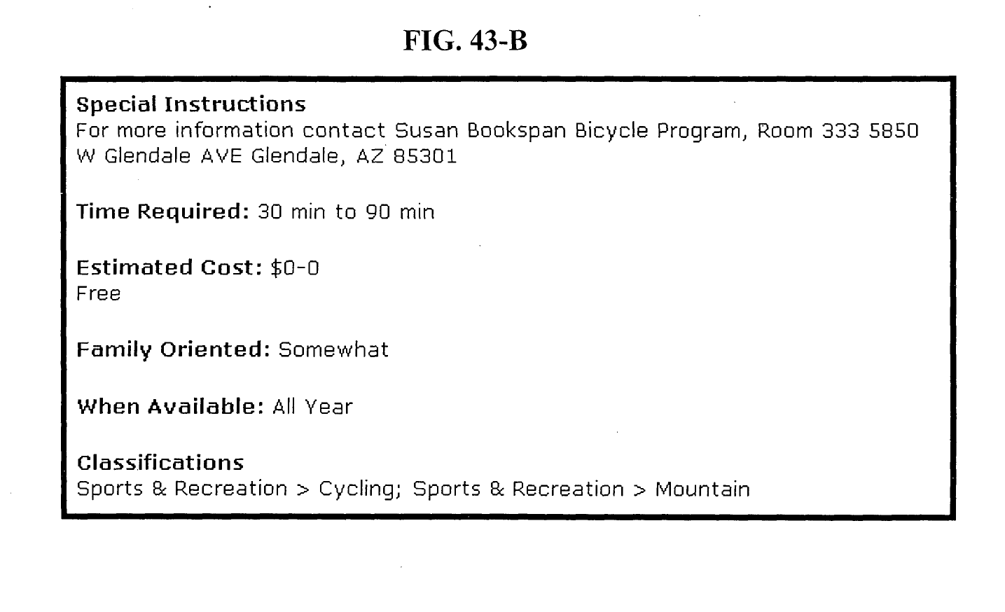

When a user gets the search results as above described, after clicking on a Subject title, the user is taken to that review's Subject page, like the example illustrated in FIG. 43A (top of the screen and 43B (bottom of the screen). The Subject page is the central building block of the online community. It contains a summary of all information about each Subject: Descriptive Word ratings, comments, price, availability and contact information. In parentheses next to each Descriptive Word is the number of times users have chosen that word to describe the Subject at hand. To the right of the number in parentheses is a horizontal bar and boldfaced number indicating the average rating given to each Descriptive Word on a 1-5 scale (1 is “not rated, 5 is “extremely”). In parentheses next to the “Member Ratings” text is the number of members who have given this Subject an overall star rating (displayed on the following line). The number of stars to the right of the “Overall Rating” text is the average overall star rating users have given to this Subject. In parentheses next to “Comments” is the number of comments that have been left by users about this Subject. In the top left corner of the page is the “Overall Rating” box, in which users can give a Subject an overall rating from 1-5. The home page left border also has, as noted, a Member and Correspondent recruitment box, with links to the registration area and a “Spread Word of Mouth” box that links to the “Tell A Friend” page, and also a link that allows users to notify an advertiser about other Subjects he/she might want to add. The Subject page is also the springboard by which many users will get involved in the community by adding their opinions about existing Subjects.

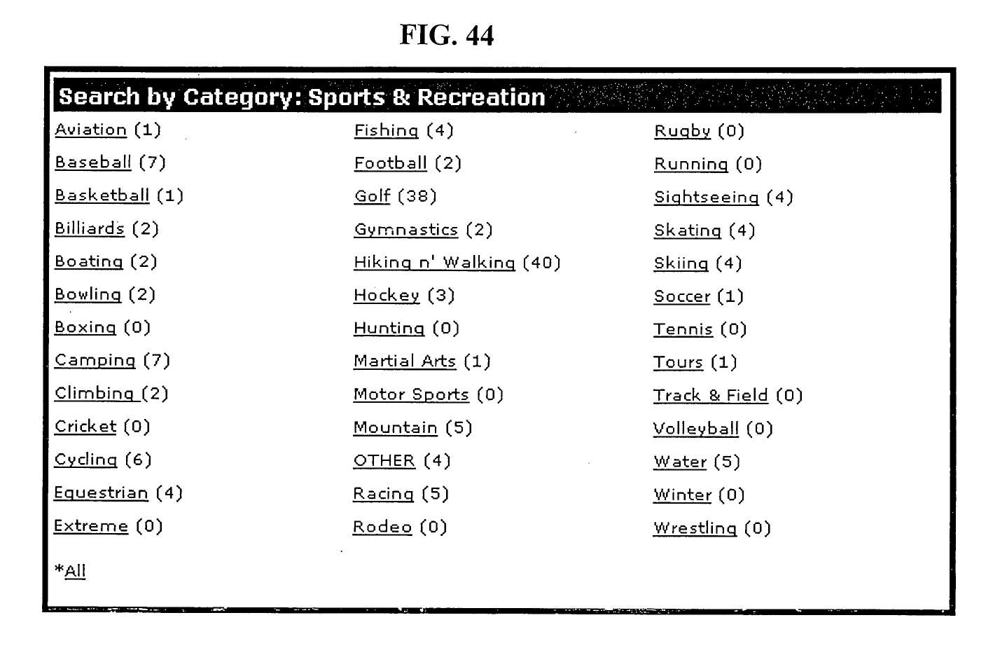

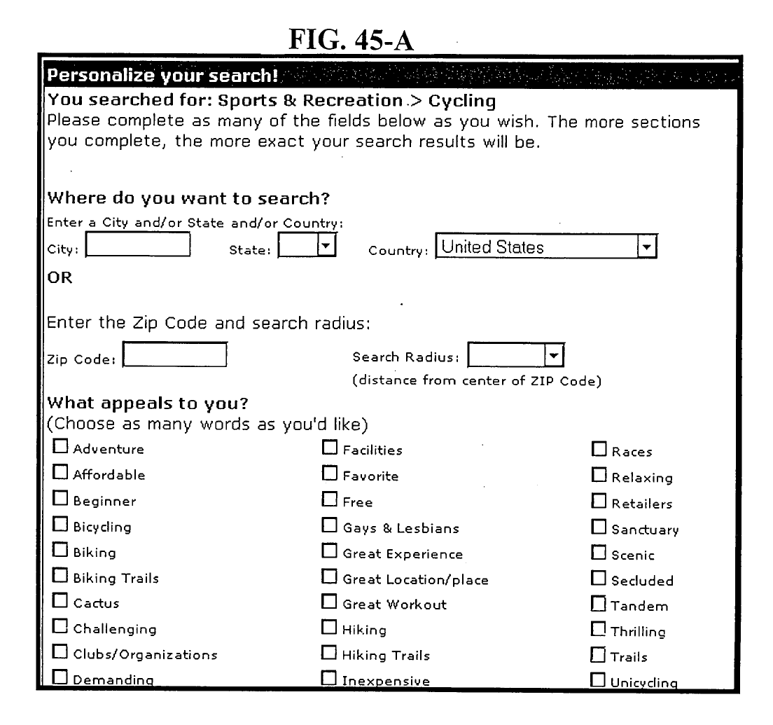

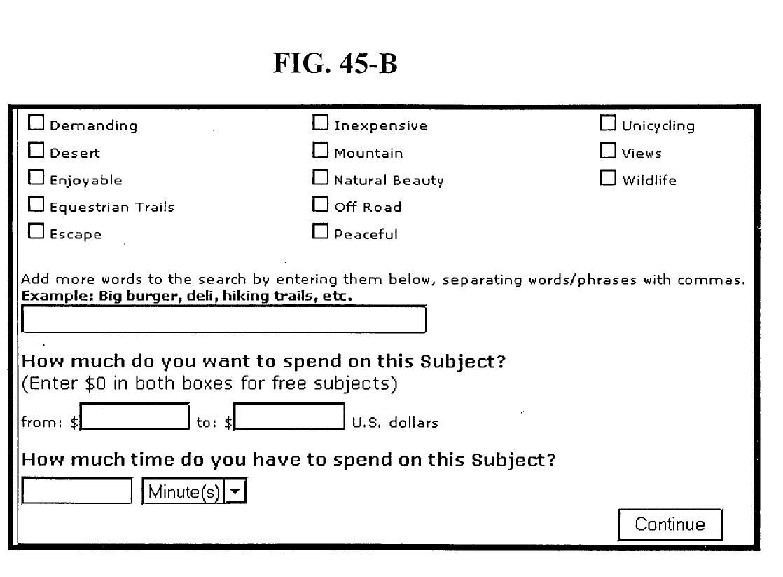

Instead of searching all of a Web site's Subjects by keyword, a user also has the option of first selecting a category to search. A client-specified number of categories appear on the home page: the default categories of the preferred instant system are Accommodations, Community Services, Entertainment, Fitness and Beauty, Learning Opportunities, Restaurants, Shopping, Sightseeing and Attractions, and Sports and Recreation. When a user chooses the desired category to search and clicks the link, a screen list of subcategories appears like that illustrated by FIG. 44. In parentheses next to each subcategory is the current number of reviews in that subcategory. To further customize the search, a user must either: a) click a subcategory (e.g., to search only American restaurants) or b) click “All” at the bottom of the page (e.g., to search all restaurants). After clicking on the chosen link, the user is taken to the screens illustrated by FIGS. 45A and 45B, where the user may further personalize the search. Here the user may further refine the search by specifying location. The user has two choices for searching by location. He/she must either: a) enter a city, state and country or b) enter a ZIP code and search radius from that ZIP code. Note: When a user requests a search based on ZIP code radius, that radius is calculated from the center of the ZIP code, not the user's home address. Choosing a larger radius, then, will likely bring back more useful results.

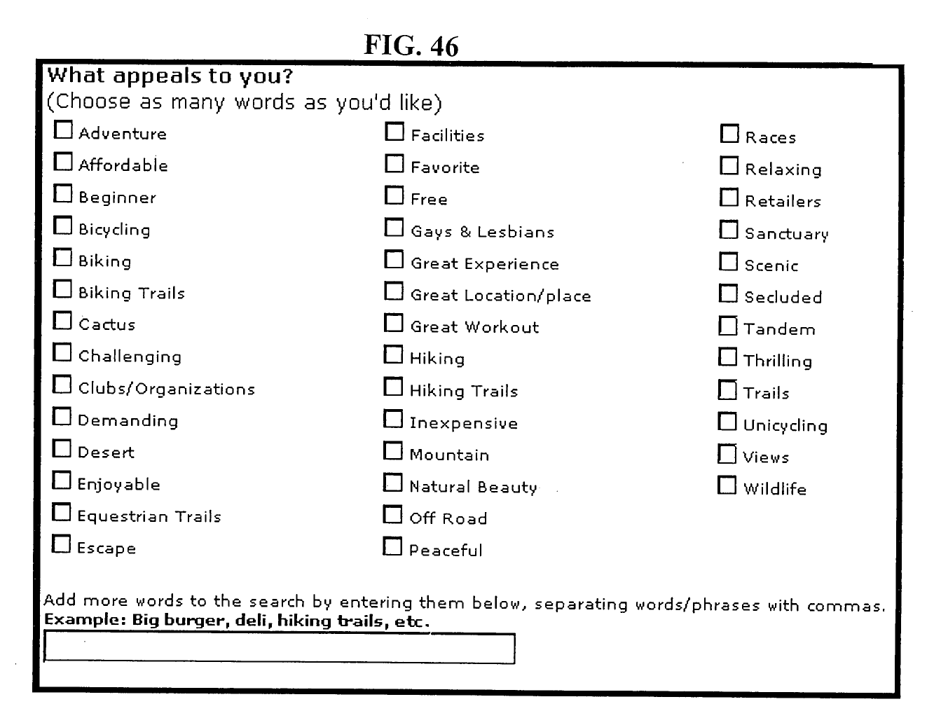

FIG. 46 illustrates the Descriptive Words and/or phrases pre-selected (by the client) to appear with this category. The user may check the boxes that are appropriate to his/her search, or add new words in the box provided. The client may configure this and decide the words—and the number of words—that appear here for every subcategory by using the Terraformer (Configuration and Administration) Module screen (as discussed herein) and going to the categories screen and then the subcategories screen. In the display box, click the name of the subcategory to which you'd like to add Descriptive Words. Then click the “Descriptive Words” button at right. A screen like that shown in FIG. 35 will appear. To add Descriptive Words to a subcategory: In the “Descriptive Word” field, type in the word you'd like to add, then click the “Add” button (Make sure the “Select Descriptive Word” dropdown box is blank). To edit or remove existing Descriptive Words in a subcategory: Select the chosen word from the “Select Descriptive Word” dropdown box. To remove it, click the “Remove” button. To edit it, edit the text that appears in the “Descriptive Word” box, then click “Update.”

In the top two fields shown in FIG. 45B, the user enters the minimum and maximum amount of money he/she wants to spend on the Subject he/she is searching for. In the final field, the user selects the amount of time he/she has to spend experiencing a Subject. These fields are both optional; users need not fill them in if they choose not to. The more information a user enters, the more specific the results. When the user types in the required information and clicks “Search,” the software looks for that information in the appropriate fields of the database, and a results screen as previously discussed returns (see FIG. 42 for a sample). The title of each result is linked to its Subject page, and the summary and location info will be listed under that link. The right and middle columns list cost, time required and the highest-rated keywords. After clicking on the Subject title that interests him/her, the user is taken to the Subject page (see FIGS. 43A-B for a sample).

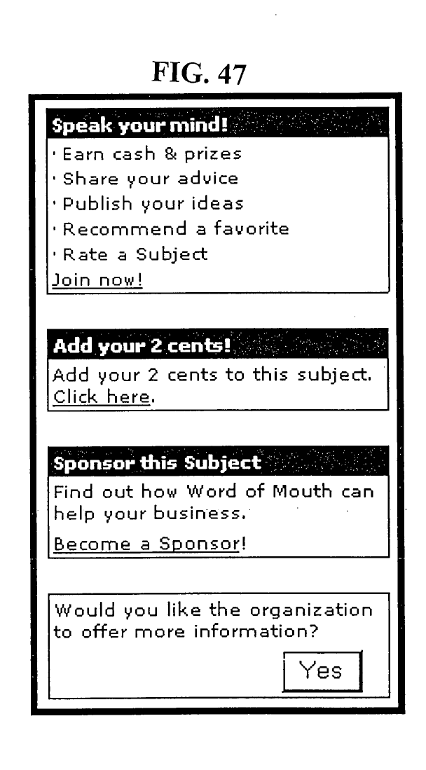

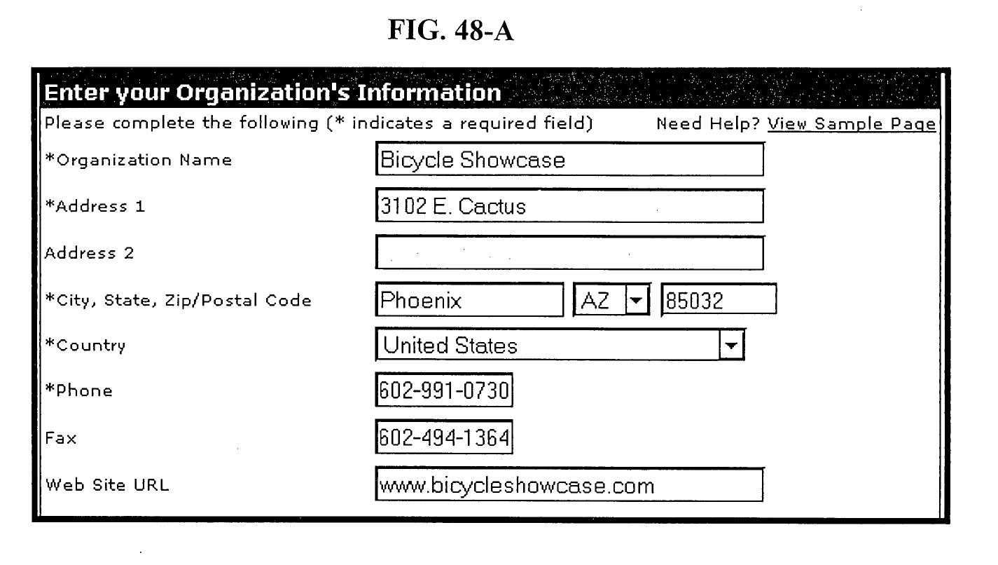

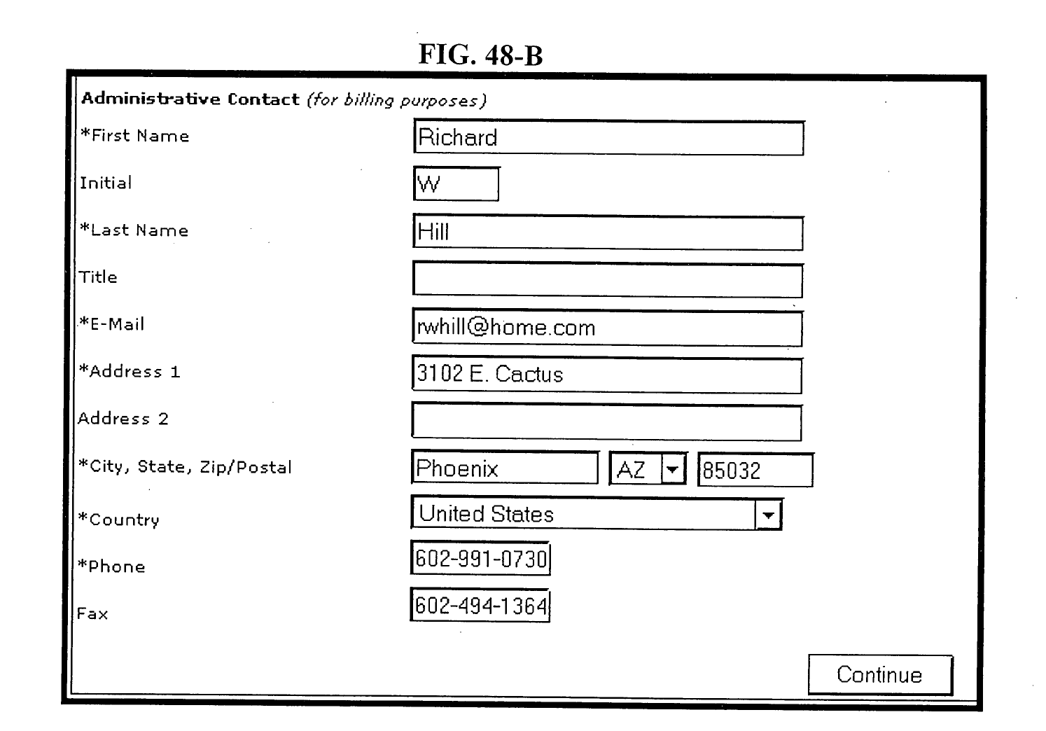

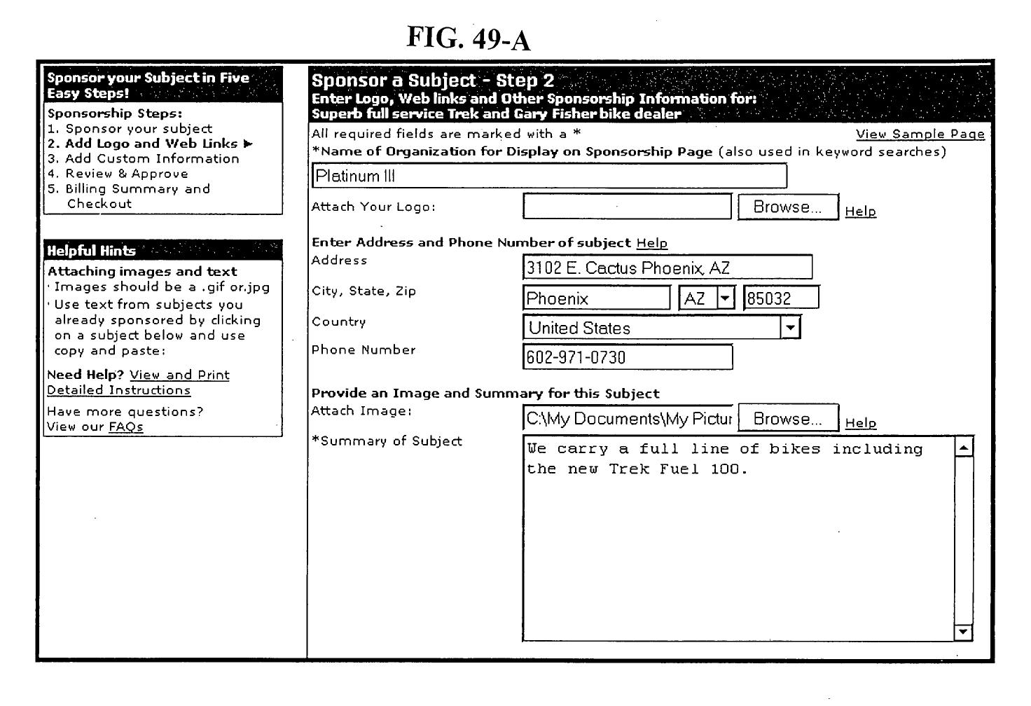

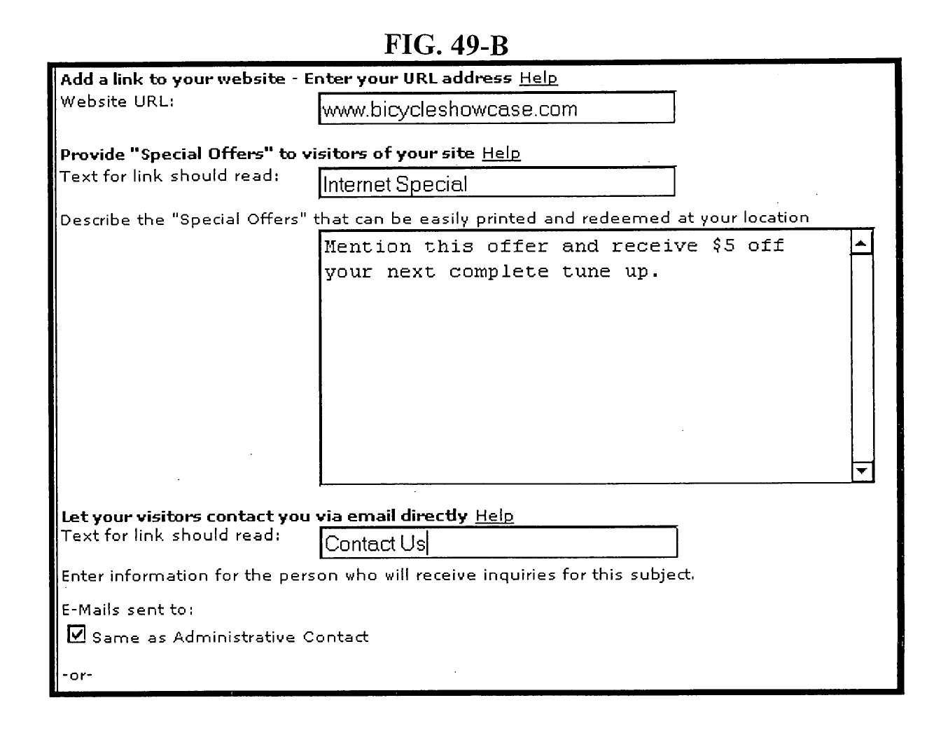

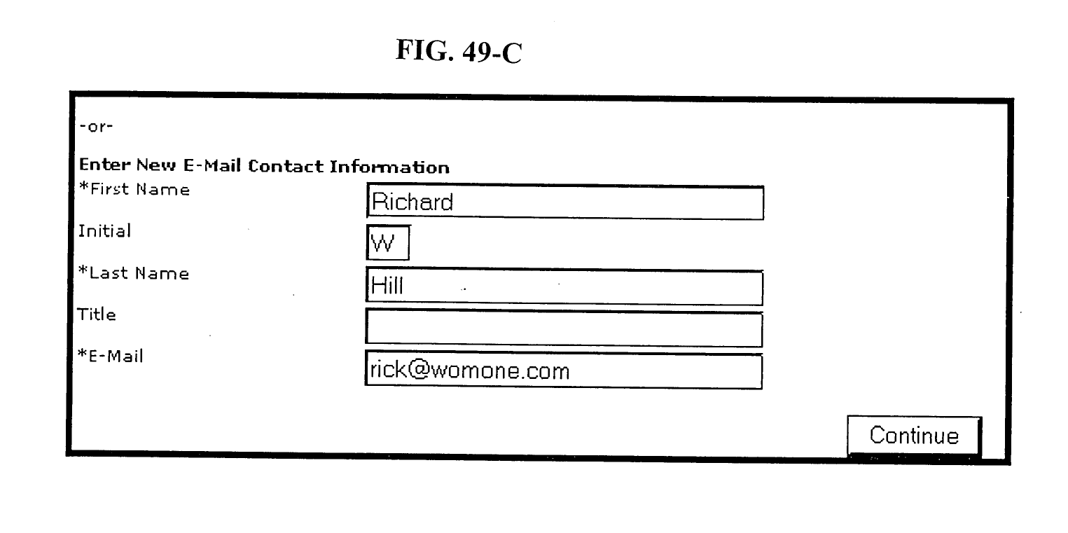

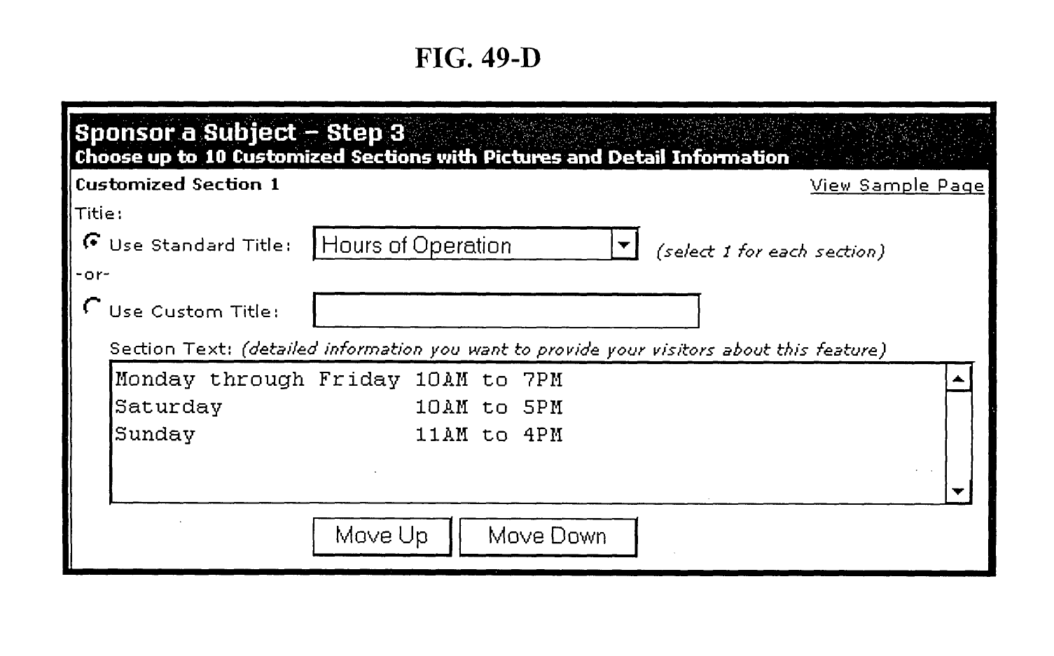

FIG. 47 illustrates a box in the lower left hand corner of the Subject page, offering the opportunity to sponsor the Subject. A potential advertiser simply clicks “Sponsor now!” to begin the process. FIGS. 48A and 48B illustrate the screen returned to begin to get the desired information from a Sponsor. The sponsor enters the name, address and contact information for both the business itself and the person who will be the administrative contact for the account. These fields are fixed. FIGS. 49A-D show the next screens to receive information. At this stage, the Sponsor adds a business logo, email address, Web site URL and links to company Web site. By clicking the “Browse” button, a Sponsor can quickly upload each desired photo straight from their computer. If one needs help with any element of the page, one simply clicks the “Help” link next to that element. These fields are fixed. Here (see FIG. 49D) the Sponsor can add up to 10 paragraphs of information about the business, each with a customized heading and photograph. Customized headings can be selected from those provided in the drop-down boxes, or a Sponsor may enter its own. By clicking the “Browse” button, it can quickly upload each desired photo straight from it's desktop. These are fixed fields, but the client can configure the pre-selected choices in the “Use Standard Title” dropdown box.

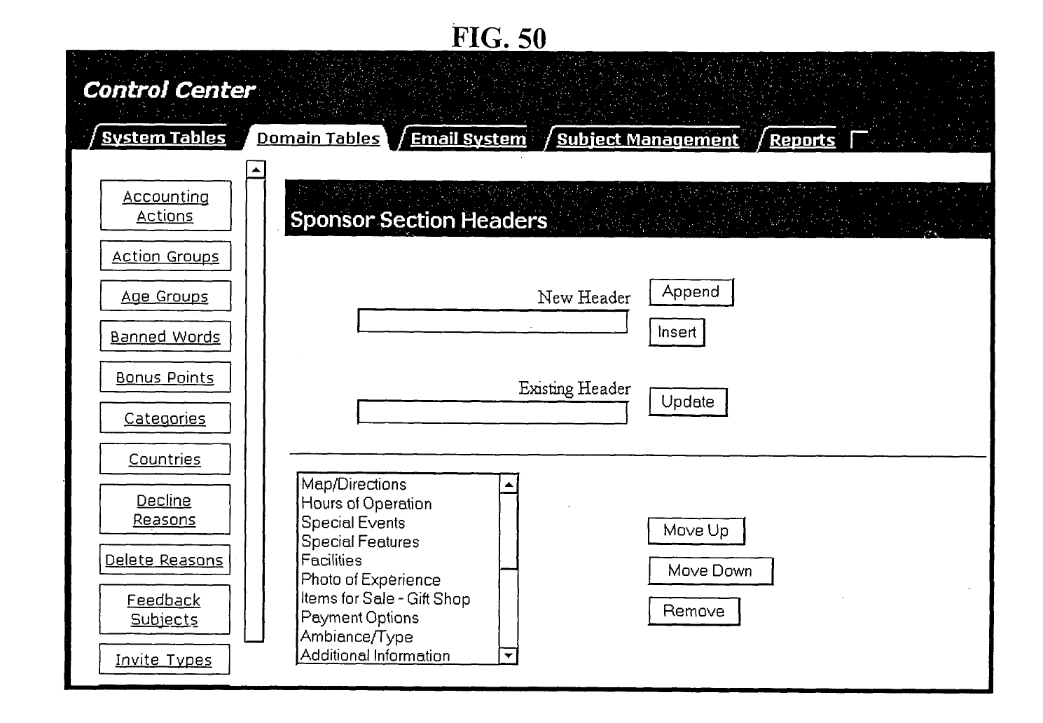

To configure sponsor section headers, in Terraformer (Configuration and Administration) Module, select “Domain Tables” on the top navigation bar and “Sponsor Section Headers” from the left navigation bar. A screen like the one illustrated by FIG. 50 will appear. If the client would like to enter a new header to be included in the sponsor's dropdown box, type its name under “New Header” and click “Append.” If the client would like to modify the name of an existing header, click on its name in the box at left. Its name will then appear under “Existing Header.” Edit the name as wished, then click “Update.”

After adding the sponsor headings, they'll appear in the box shown in FIG. 50. To change the order of their listing, click on the name of a heading you'd like to move. Then click “Move Up” or “Move Down” until it's in the desired position. Repeat this process with the other headings until the desired order is achieved.

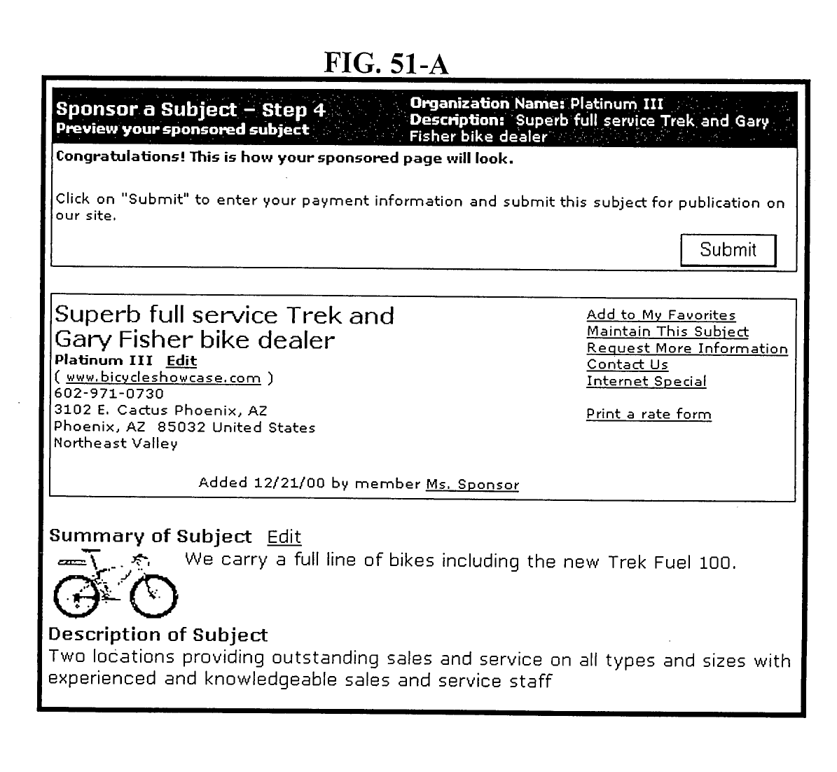

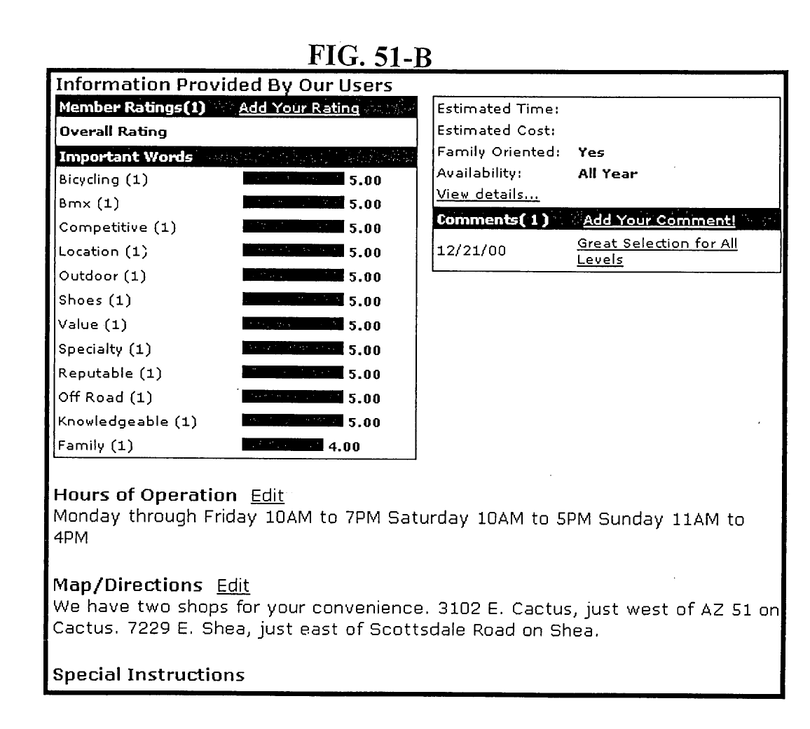

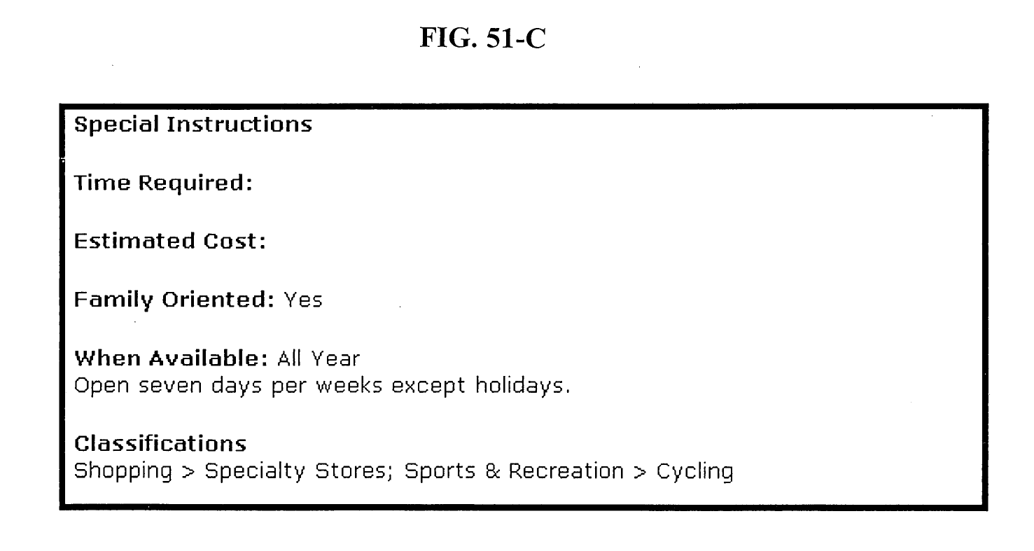

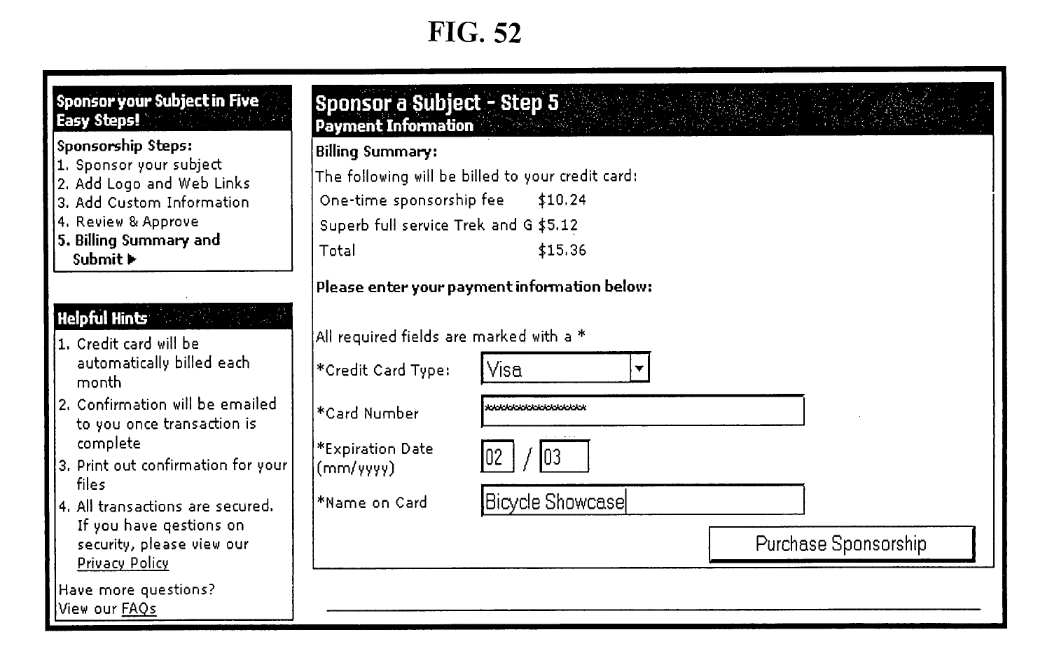

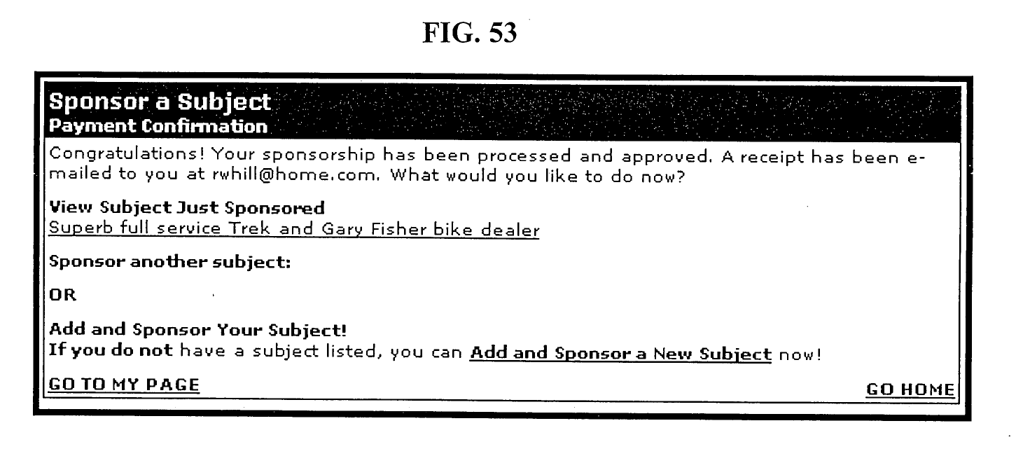

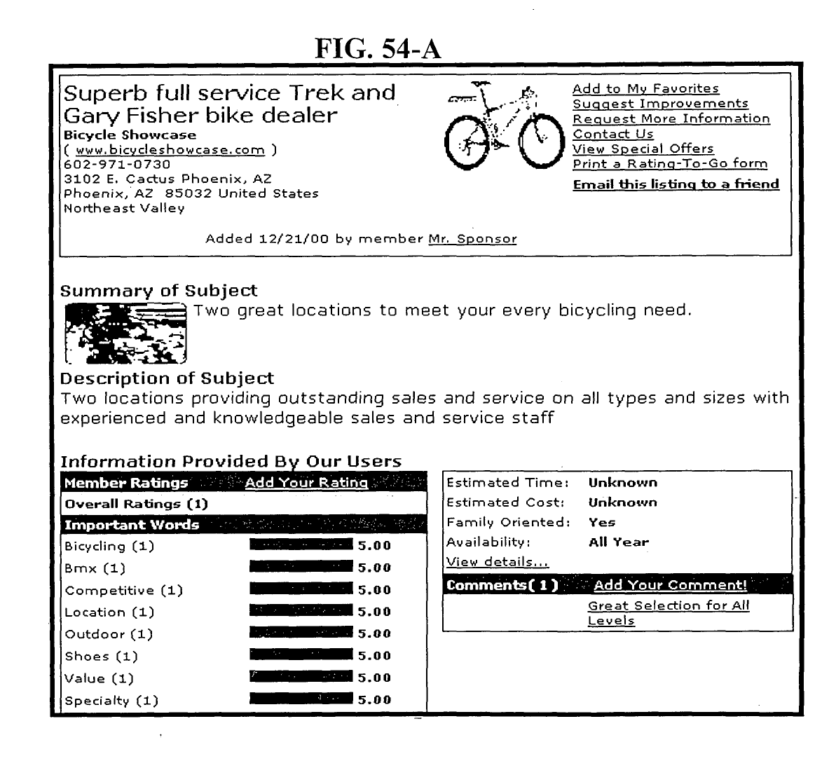

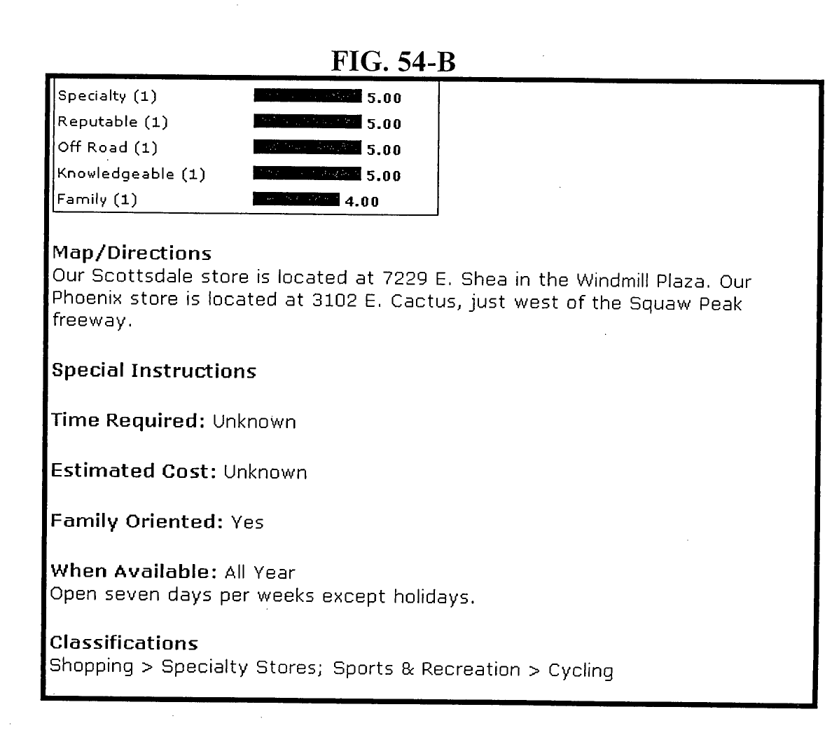

After entering any custom text and uploading any photos, the Sponsor previews the newly sponsored page on the screen illustrated, from top to bottom in FIGS. 51A-C. If there are mistakes, click “Edit” in the area with the mistakes and fix them. If there are no mistakes, click “Approve,” and move on to adding credit card information—the final step in the sponsorship process. FIG. 52 illustrates the screen with payment information. After approving how the sponsored Subject will look, the Sponsor enters credit card information and clicks “Purchase Sponsorship.” Once the credit card information is processed, the sponsorship is confirmed by the return of the screen illustrated in FIG. 53 and the process is complete. Tony can immediately view his newly sponsored Subject by clicking the link under “View Subject Just Sponsored.” The sponsored Subject, which is immediately available to Web site users because it does not require Correspondent approval, looks like the screen shown in FIGS. 54A-B, the first illustration showing the top half of the page, and the second showing the bottom half. As shown, a sponsored Subject prominently features the Sponsor's customized information and photographs. In the heading are links to “View Special Offers” and “Contact Organization”—information that the advertiser entered on the first sponsorship screen. The top paragraph is the Sponsor's summary, with its chosen image. Below the ratings and comments are any other photos and customized paragraphs.

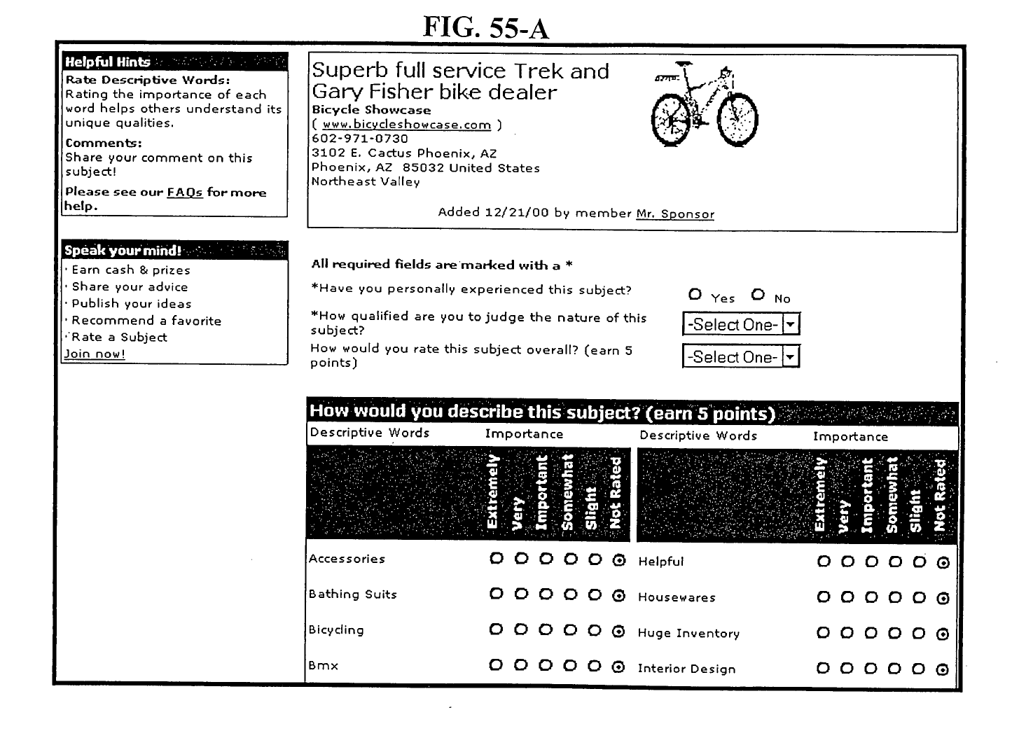

Users will find that some of their favorite Subjects have already been entered by other users. FIGS. 55A-B illustrate the screen where users may add their opinions to existing Subjects rating and reviewing. From any Subject page, a registered user can click the “Add Your Rating” or “Add Your Comments” links to reach the Rate and Review page (see FIGS. 55A-B). Note: This is the same page as page 4 of the Add a Subject process. The process of rating and reviewing an existing Subject follows exactly the same procedure as outlined in Step 4 of the Add a Subject process. After comments have been added and Descriptive Words have been rated, a screen returns showing that the entry information has been added to MyPage and thanking the user for doing the rating, after which the user may return to the Subject he/she just rated, or use the top navigation bar to go elsewhere on the site.

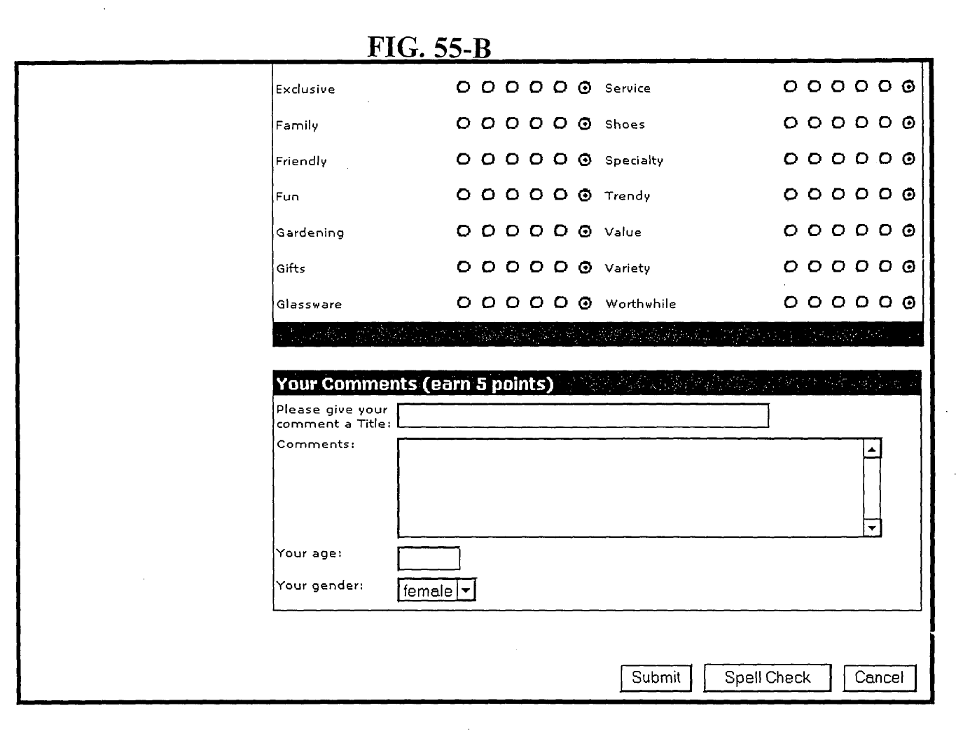

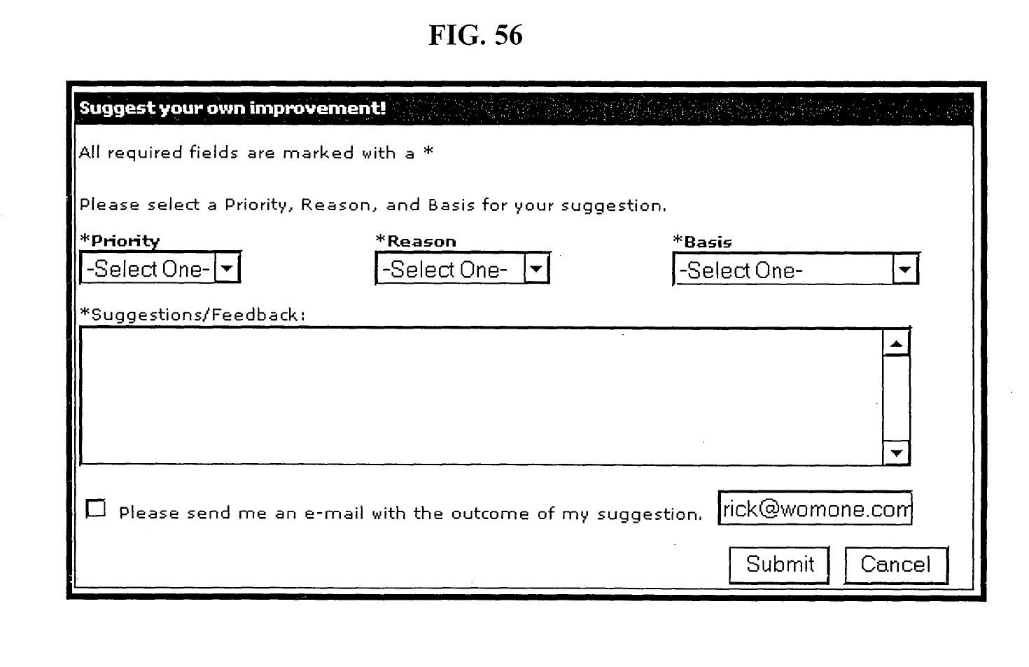

A quick way for the user to earn points is to give a subject an overall star rating. The overall rating box is located in the top left corner of a Subject page. The user simply selects the “star” rating he/she chooses to give, then clicks the “Submit” button. If the user finds inaccurate or outdated information, he/she can immediately suggest an improvement via the “Improve this Subject” box at the bottom left corner of each Subject page. Clicking on that link leads to the page illustrated by FIG. 56. The user first reviews the improvements suggested by other users. The user then chooses a priority for his/her change, a reason that the current information and how he/she knows the information needs to be changed (“Basis”). After typing in the specifics of the improvement that needs to be made, the user clicks the box if he/she wants to be notified of the outcome of the suggestion. If so, he/she enters an email address. When finished, the user clicks “Submit” to send the changes. The suggestion is then sent to a Correspondent who will review it and either make or reject the change.

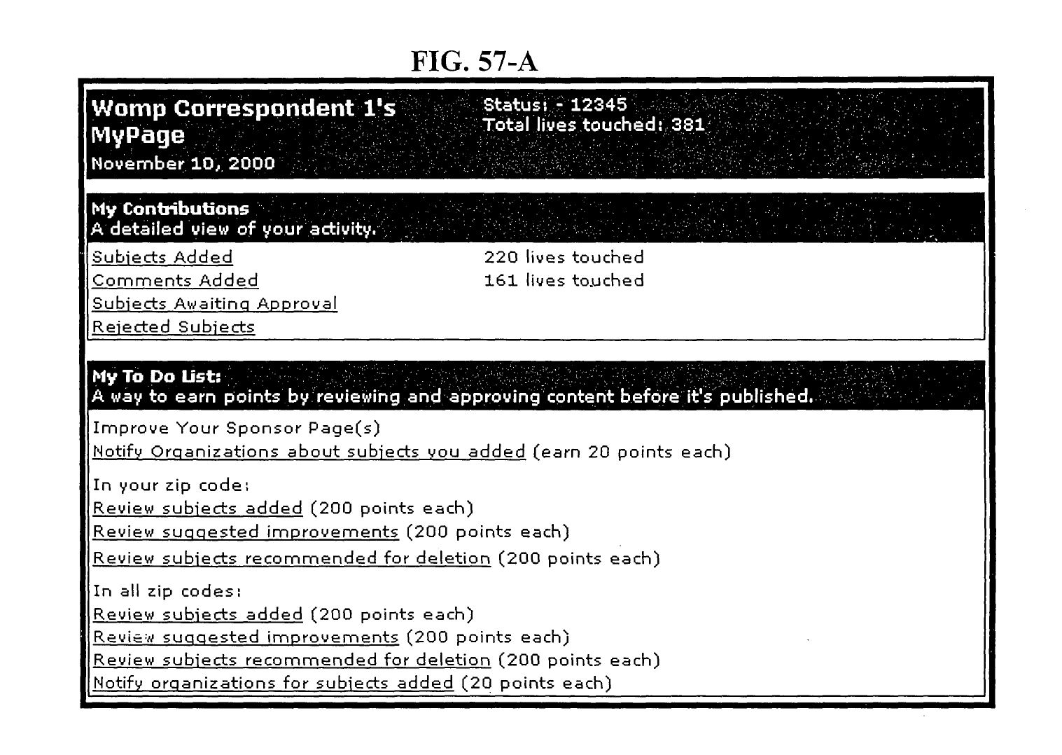

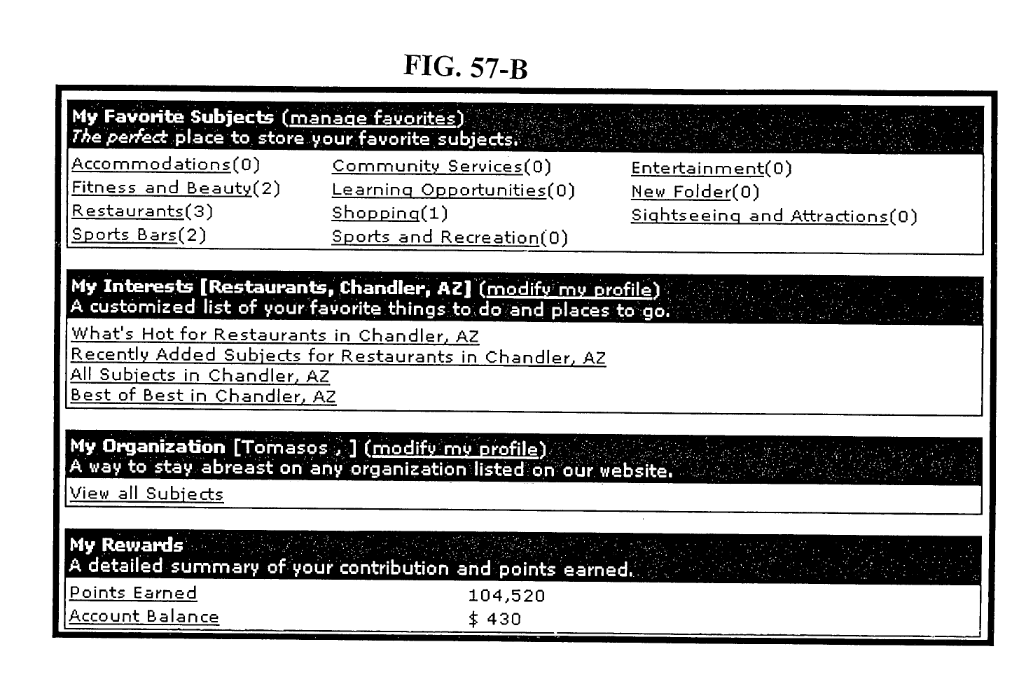

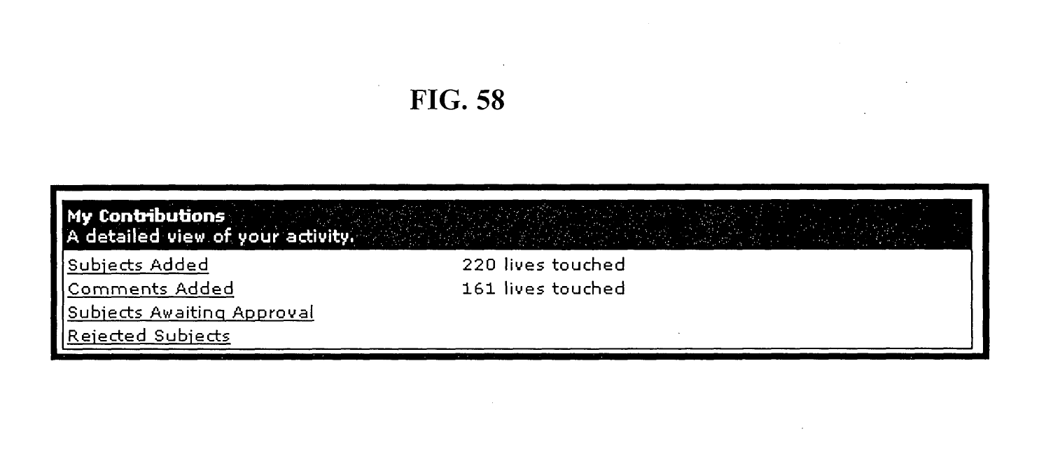

With so many ways to earn points, how can users keep track of how many points they've earned, and what they've done to earn them? For exactly this reason, there's MyPage—the page where users can track not only the points they've earned, but all the contributions they've made to their community, and their favorite things they've found along the way. A variety of elements comprise each MyPage, the screen illustrated in FIGS. 57A-B. FIG. 58 shows the My Contributions box. As the heading states, “My Contributions” is a detailed view of a user's activity on the site. The user can click on “Subjects Added” to view a list of all the Subject he/she has added to the site. He/she can do the same for “Comments Added.” Across from the “Subjects Added” and “Comments Added” links are figures indicating “Lives Touched.” A user gets credit for a life touched every time another user views Subjects or Comments that he/she has entered. The example above indicates that this user's Subjects have been received 220 page views, and his/her comments have received 161 page views.

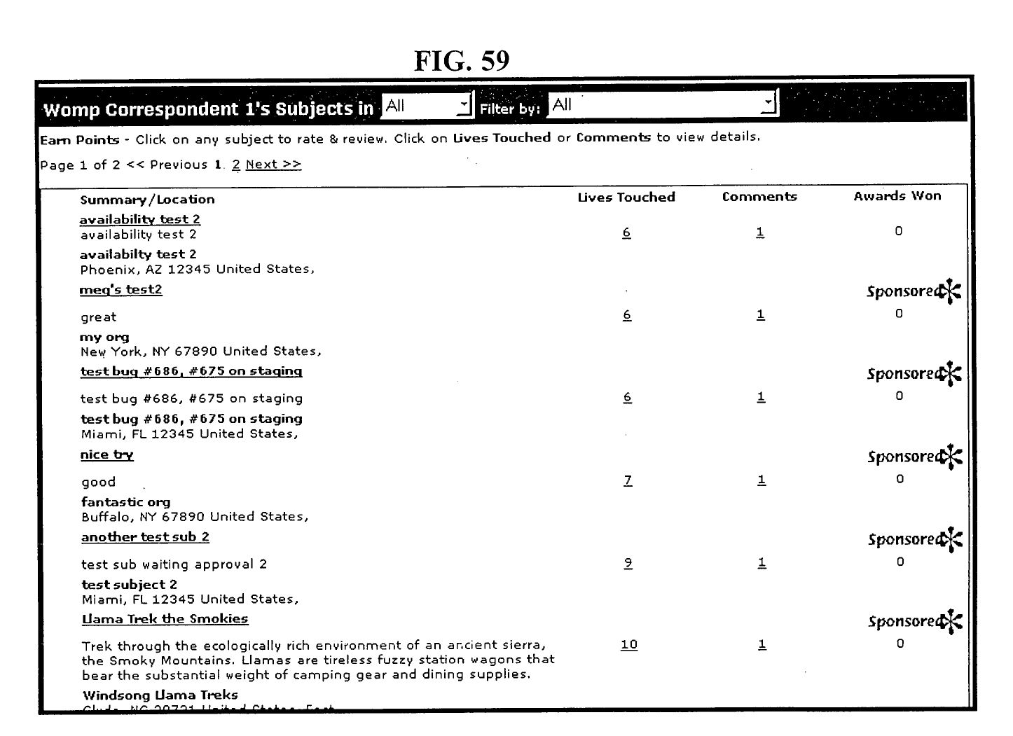

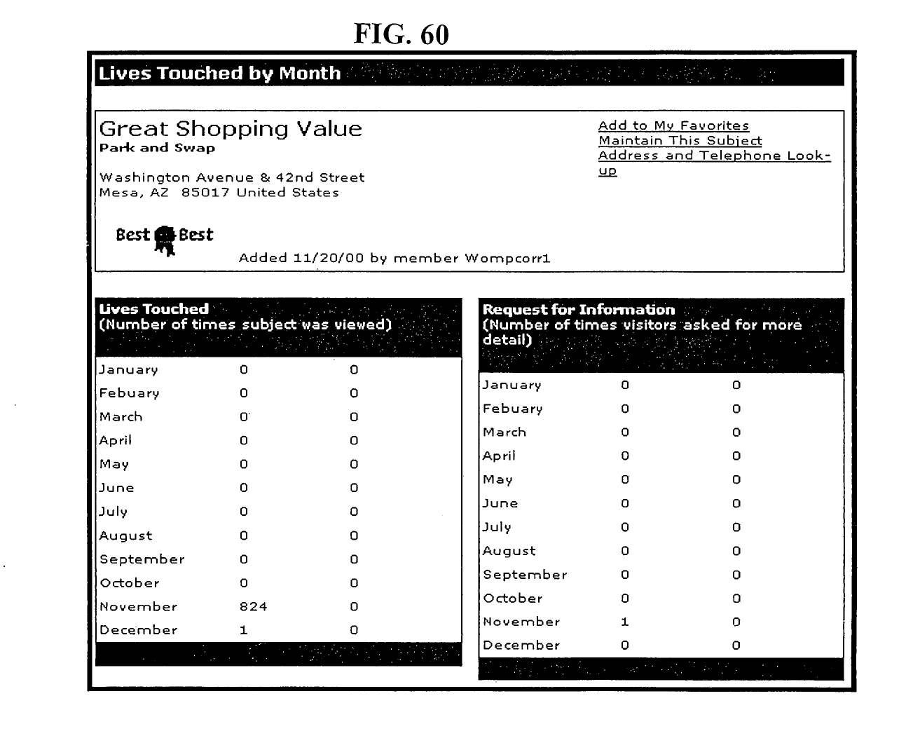

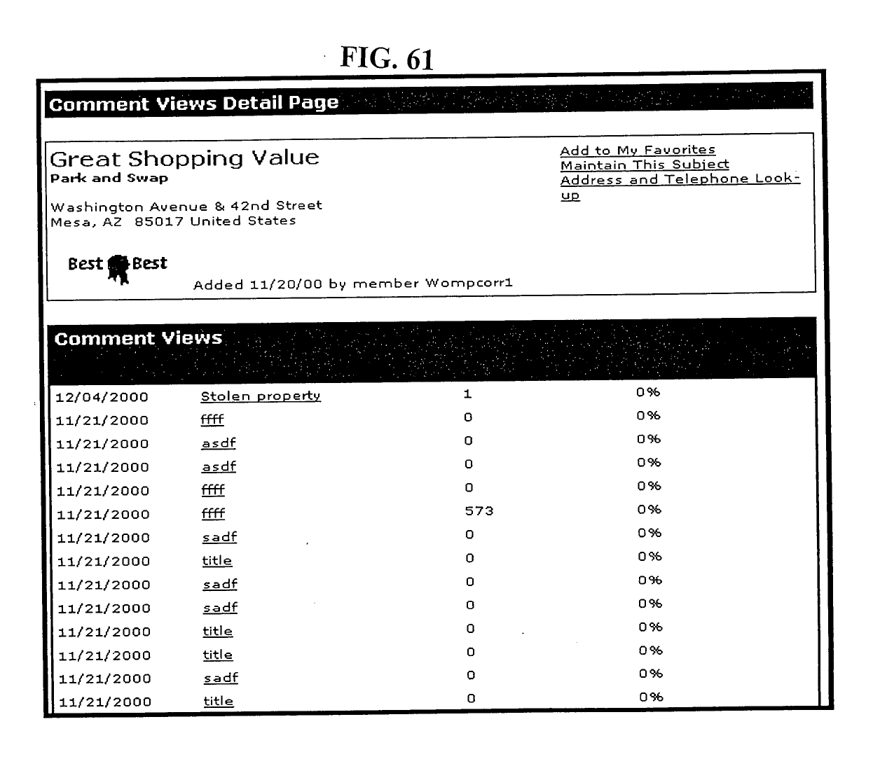

Clicking the link for “Subjects Added” will return a page like the one illustrated in FIG. 59. Each Subject this user has added is displayed here, along with the number of Lives Touched by each Subject and the number of Comments that other users have left for each Subject. Using the dropdown menus at the top of the page, the user can list these Subjects by location and category. Clicking the numbered link under the Lives Touched column yields a screen like the one illustrated in FIG. 60. The “Lives Touched” box lists how many times this Subject was viewed during the last 12 months. The “Request for Information” box lists how many times another user requested more information about this Subject viewing it. Clicking on the numbered link under the “Comments” column returns a screen like the one illustrated in FIG. 61. Each row contains the date each comment was added, the comment's name, the number of lives touched by the comment and the percent of other visitors who agreed with the comment.

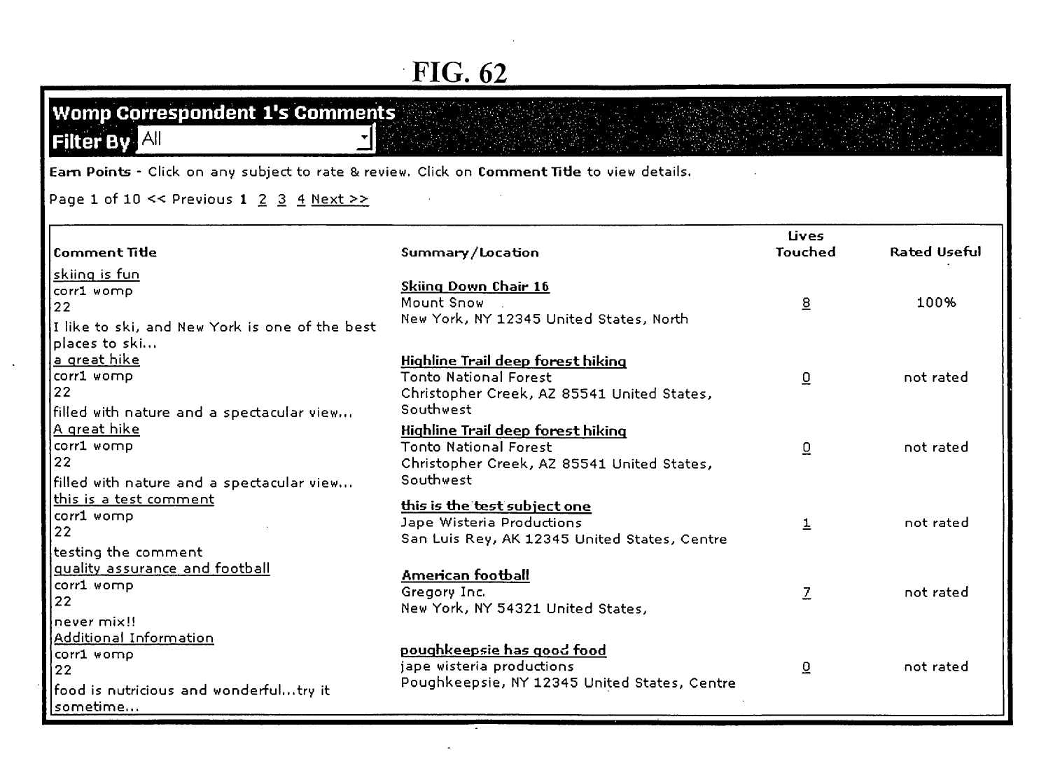

From the “My Contributions” box on MyPage, clicking the link for “Comments Added” will return a page like the one illustrated in FIG. 62. Listed in the left column of this page are all the Comments this user has entered. In the center column is each Subject to which the Comment in the left column refers, and the third column lists the number of Lives Touched by each Comment (that is, how many page views each comment has received). The far right column lists the percentage of times that the Comment has been rated useful by other users. Example: The top comment on the screen above has been rated “Useful” by 100 percent of users who have chosen to rate the comment as “Useful” or “Not Useful.” None of the other comments has been rated.

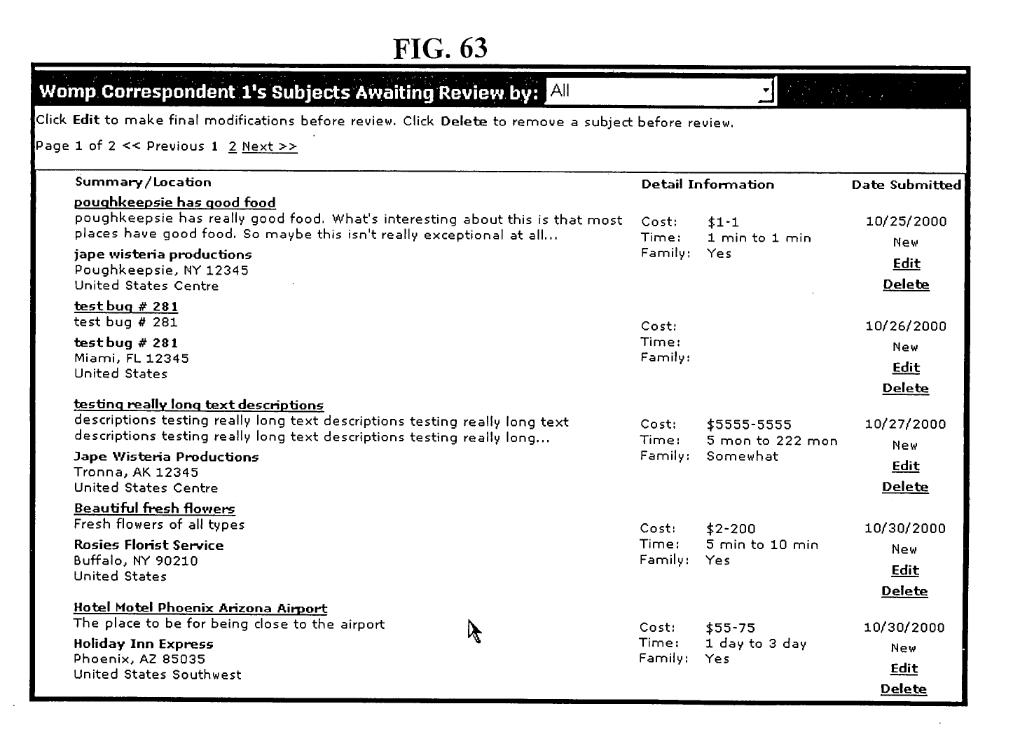

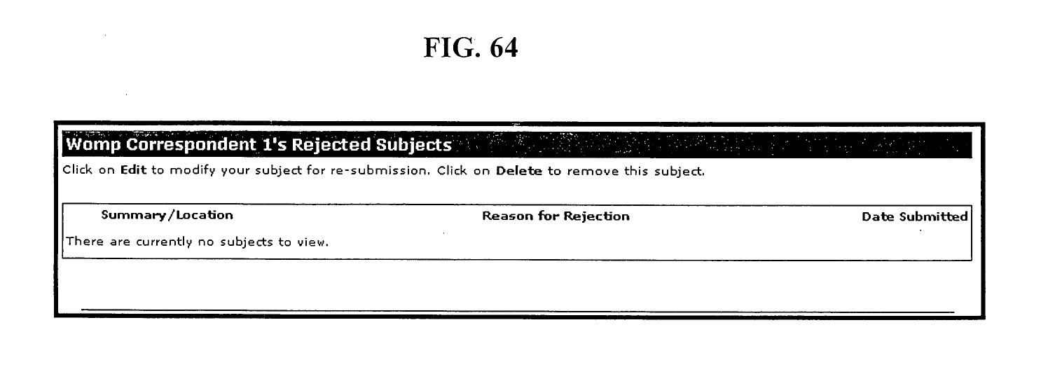

The next link in the “My Contributions” box is “Subjects Awaiting Approval.” These are Subjects that the user has added, but have not been approved by a Correspondent and have therefore not been seen by any other users (hence, no number is listed in the “Lives Touched” column). FIG. 63 shows a sample page for “Subjects Awaiting Approval.” In the left column are the Subjects the user has submitted, and the center column holds more information about each Subject. In the right column are the date each Subject was submitted, and a link that allows the Correspondent to edit or delete information in their review. The final link displays each of the user's Subjects which were submitted for review but rejected by a Correspondent. These links display on a page like that of FIG. 64. This user has no rejected subjects. If a user has rejected Subjects, the title and information of that Subject will appear on the left, the Correspondent's reason for rejection will appear in the center and the date the Subject was submitted will be on the right.

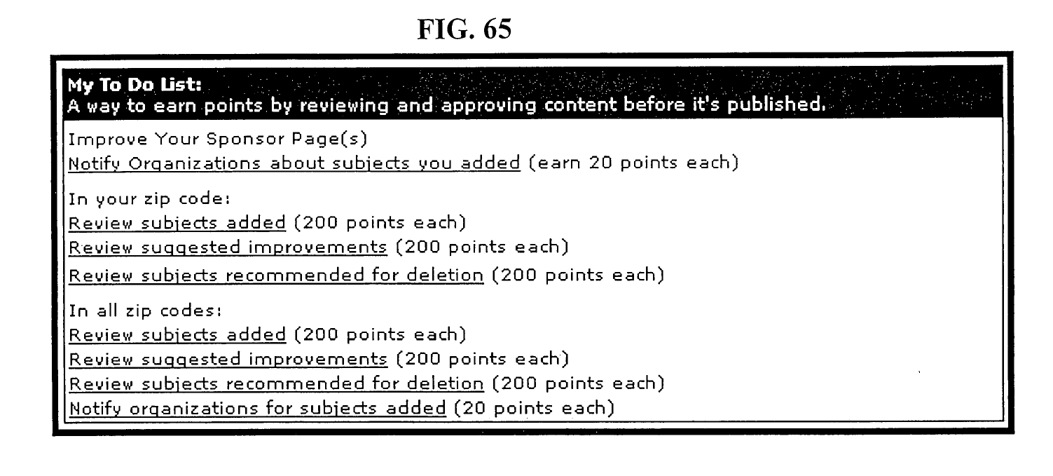

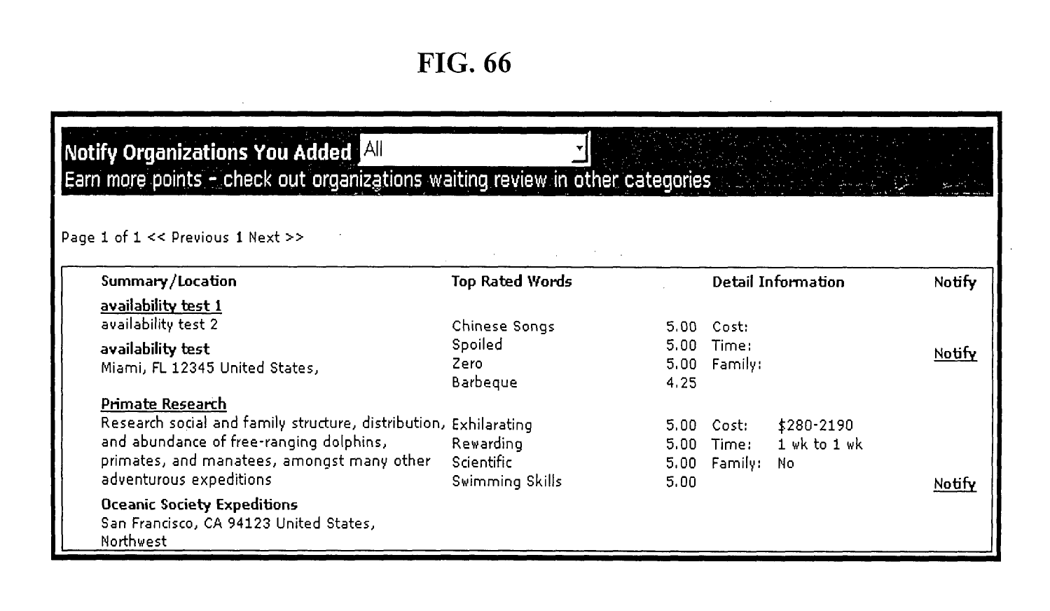

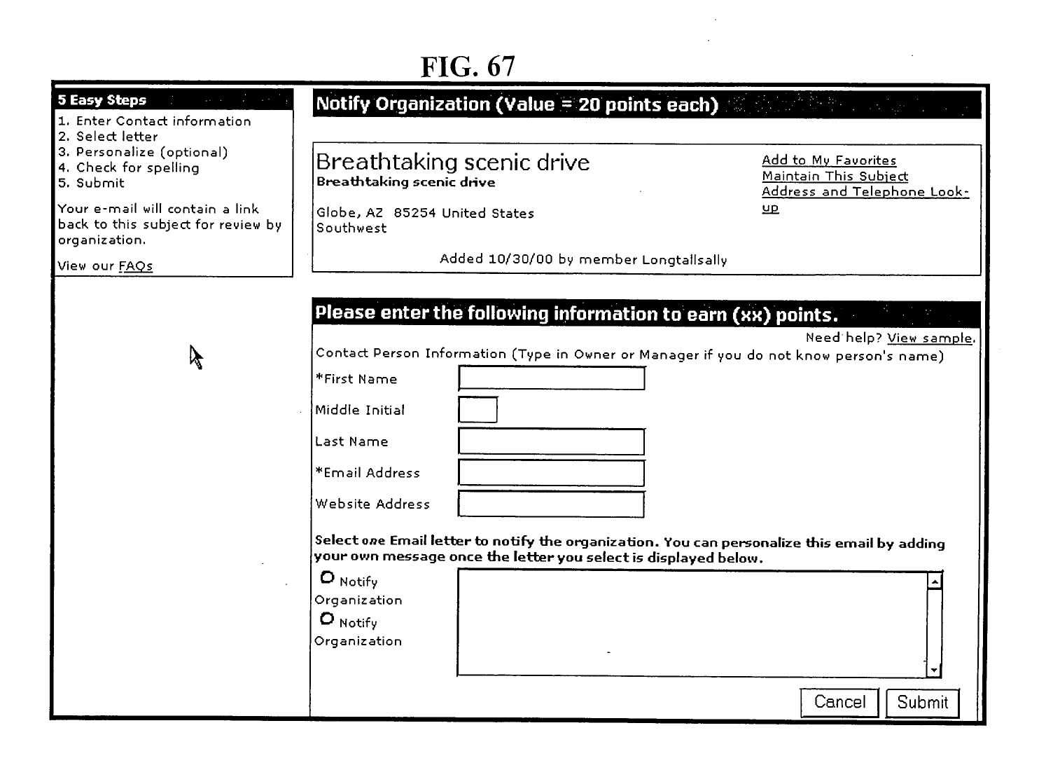

FIG. 65 illustrates the To Do List screen. Only Correspondents have a To Do list: it is the collection of administrative actions that a Correspondent can do to monitor the site's content and earn the points for doing so. The top link, “Notify Organizations about Subjects you added,” allows the Correspondent to contact organizations about Subjects they've added that advertisers might want to sponsor. The bottom link, “Notify organizations for Subjects added,” links to the same process, but for all recently added Subjects in his/her ZIP code—not just the Subjects added by the Correspondent him/herself. FIG. 66 is a sample screen for this process. Information about each Subject is displayed in the first, second and third columns. In the right column, the user clicks “Notify” to send email to a potential advertiser. That screen looks like the screen illustrated in FIG. 67. The user types in the required information—only a first name and an email address—for the recipient, and clicks “Submit.” The email is then sent to the advertiser.

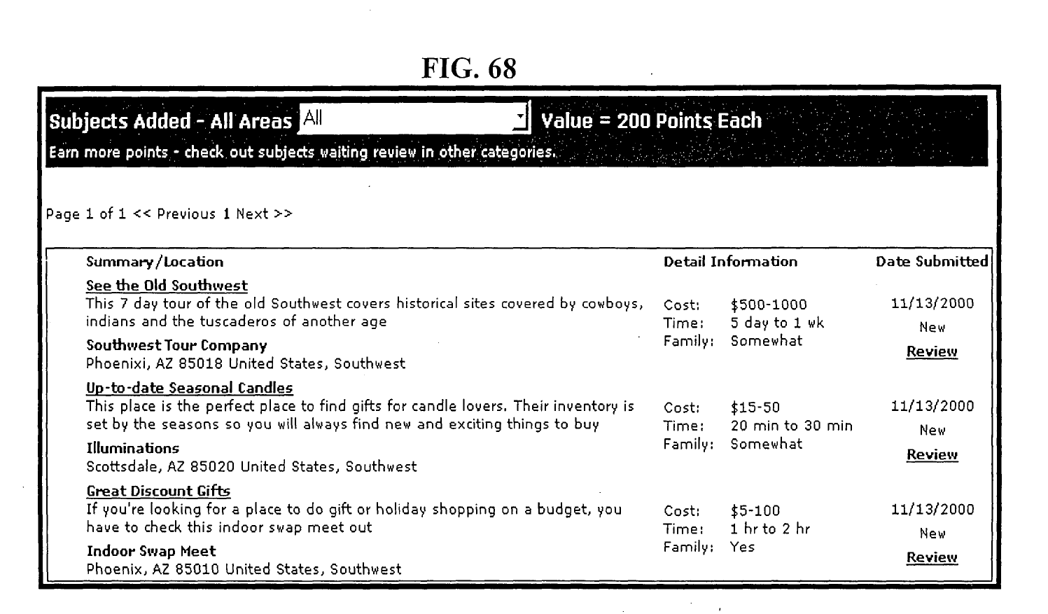

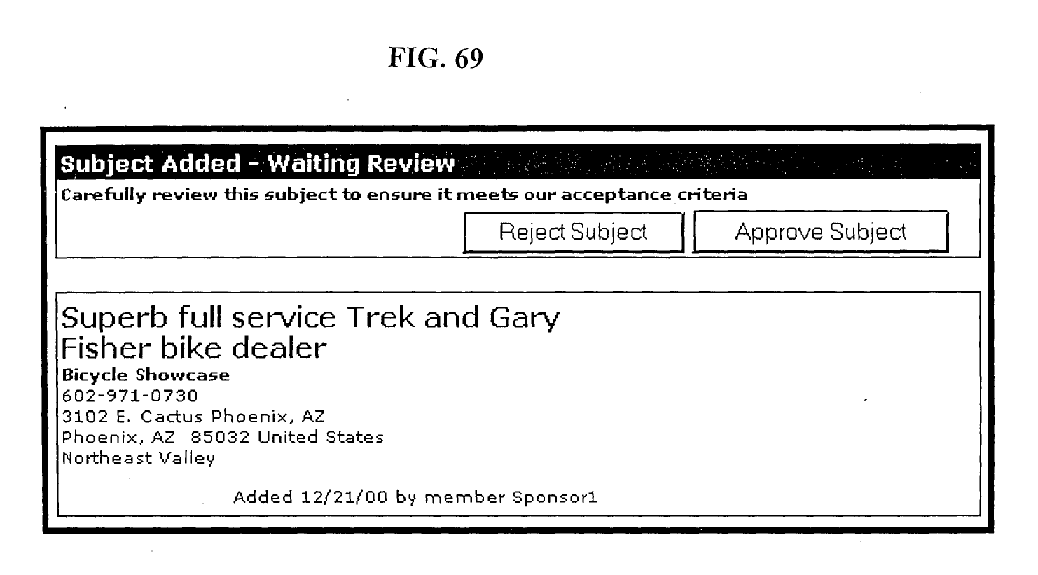

There are two links to the Review Subjects Added process under “My To Do List”—one for Subjects in the Correspondent's home ZIP code and one for Subjects outside of that ZIP code. The process used for those links is the same, and is outlined as follows. By clicking either “Review Subjects Added” link, a Correspondent gets a screen like that of FIG. 68. From the list of recently added Subjects, a Correspondent clicks “Review” in the right column to view and approve/reject each Subject. After clicking the appropriate choice, a page like that of FIG. 69 appears (also showing all the other details of the Subject. After carefully reviewing the information for appropriateness and accuracy, the Correspondent clicks either “Reject Subject” or “Approved Subject.” The process is then finished, and the Correspondent is taken back to the list of Subjects that are still waiting for approval.

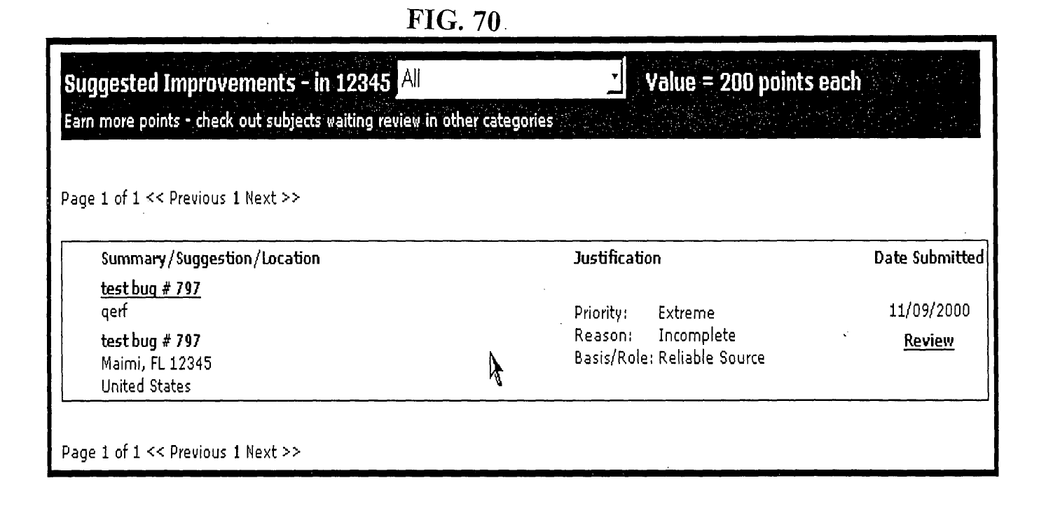

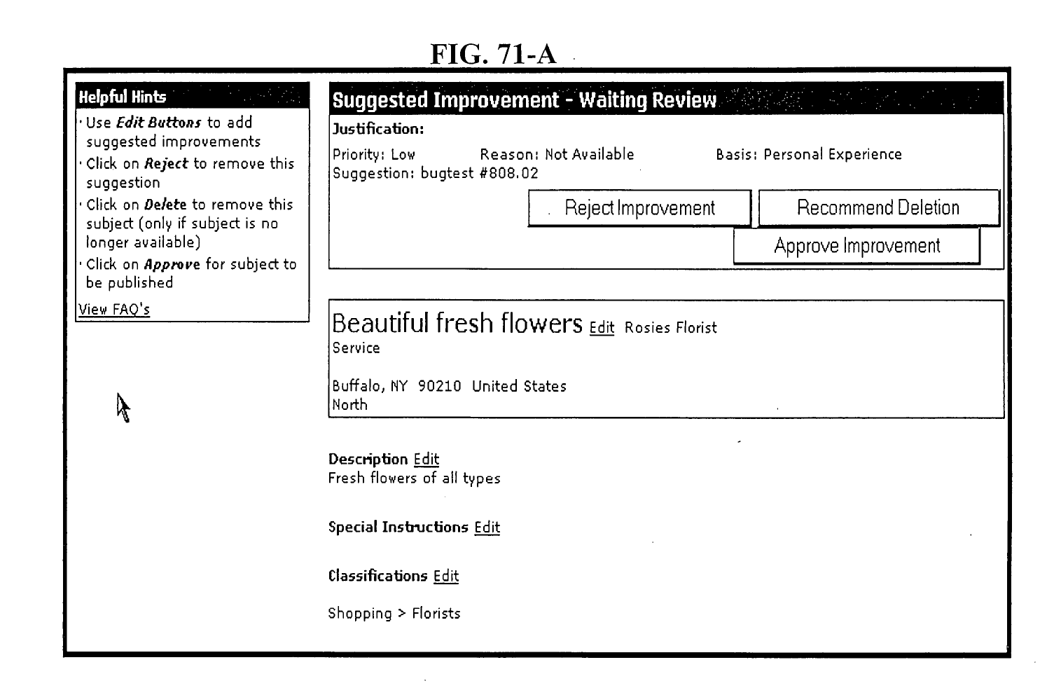

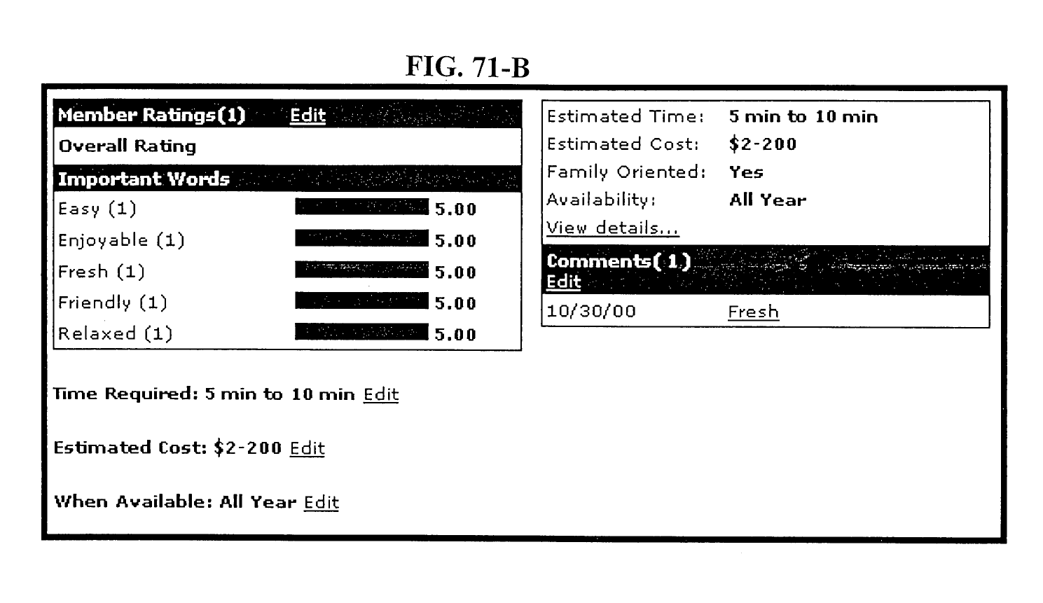

Correspondents not only approve and reject Subjects; they also review and make accuracy improvements to existing Subjects at the request of other users. By clicking the “Review Suggested Improvements” link (in or outside of home ZIP code), the Correspondent begins the process of reviewing improvements on the screen illustrated by FIG. 70. In the above example, only one suggestion for improvement is on the Correspondent's to-do list. The Subject needing improvement is in the left column. In the center column are the priority, reason and basis that the user chose for suggesting this improvement, and the right column lists the date the suggestion was entered. By clicking “Review” under that date, the Correspondent can review the suggestion on a screen like that of FIGS. 71A-B. The details of the user's suggestion will appear in the box at the top of the page. Below this box is all the information about the Subject in question. By clicking the appropriate box, the Correspondent may: a) approve the suggested improvement; b) reject the suggested improvement;, or c) delete the Subject altogether. After clicking the appropriate button, the process is then finished, and the Correspondent is taken back to the list of suggested improvements that are still waiting for approval.

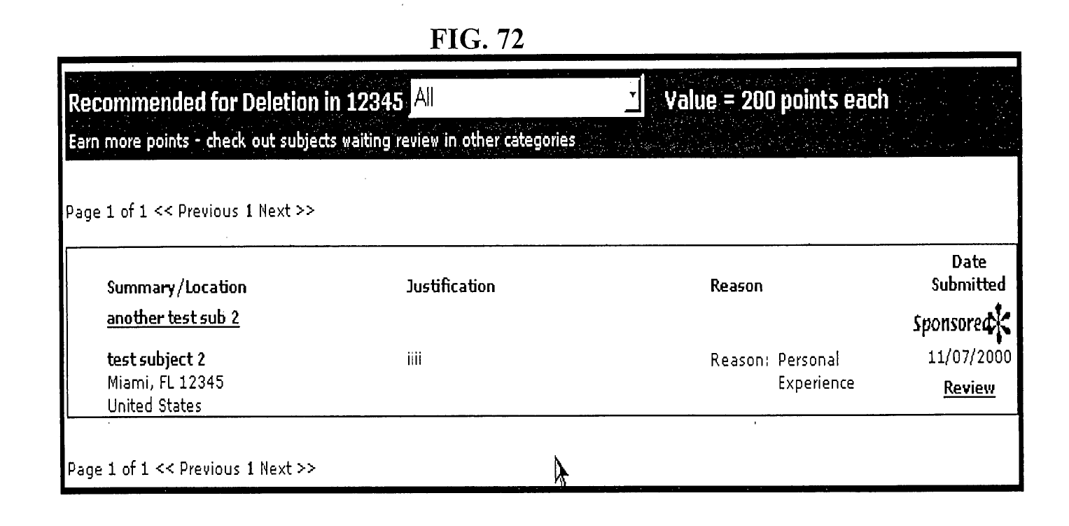

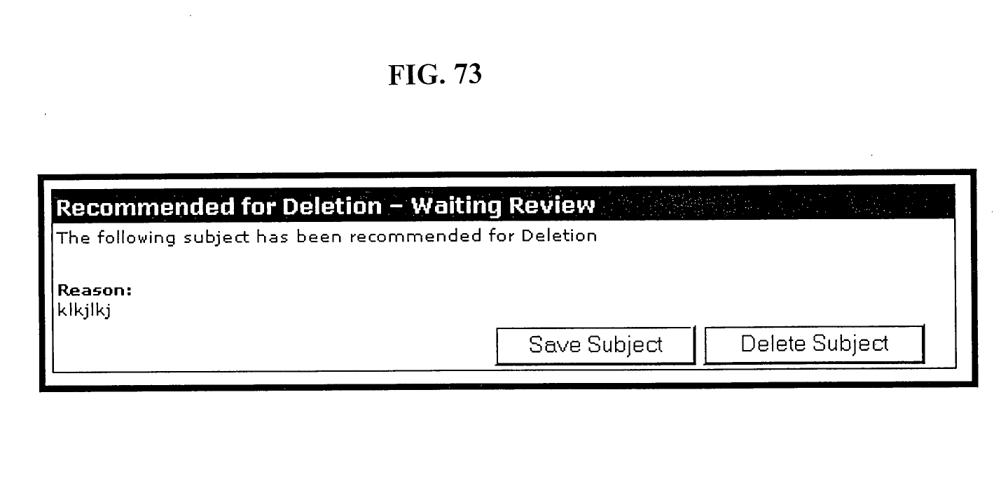

The process of deleting Subjects is much the same as the process of approving and rejecting them. Clicking the “Review Subjects Marked for Deletion” link brings back a list of such Subjects, like the one on the screen of FIG. 72. To review the Subject that's recommended for deletion, the Correspondent clicks “Review” and gets a screen like that of FIG. 73 (also containing all the details about the Subject). Upon reviewing the Subject, the Correspondent clicks “Delete Subject” or “Save Subject” based on his/her recommendation.

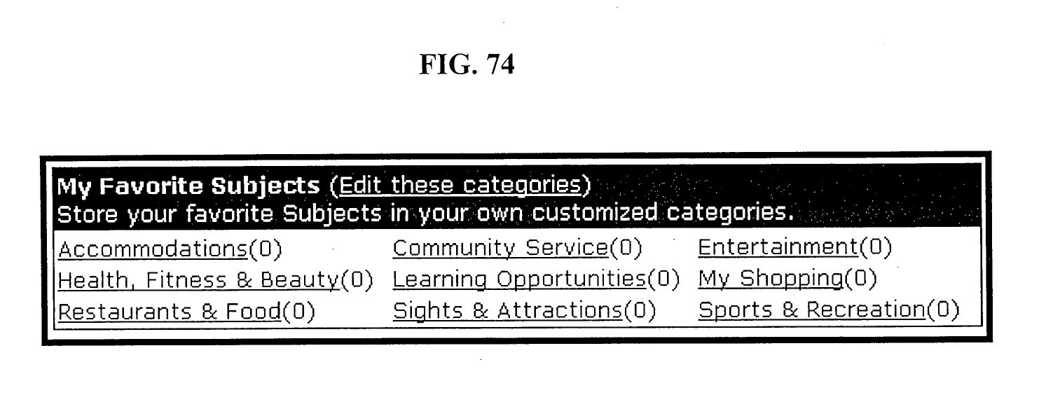

The “My Favorite Subjects” box (see FIG. 74, for example) is where users store the best things they've discovered on the site. As a default, each top-level category has a folder inside this box, until the user decides to customize it. In parentheses next to each folder name is a number that indicates how many Subjects are currently in that particular folder. To customize the folders on this page, the user clicks on “manage favorites” and gets a screen listing the name of each current folder is listed, and next to each folder name is a link to either rename or delete the folder (As a default, the initial folders will mirror the first-level categories). The user nay rename or delete a folder or add a new folder.

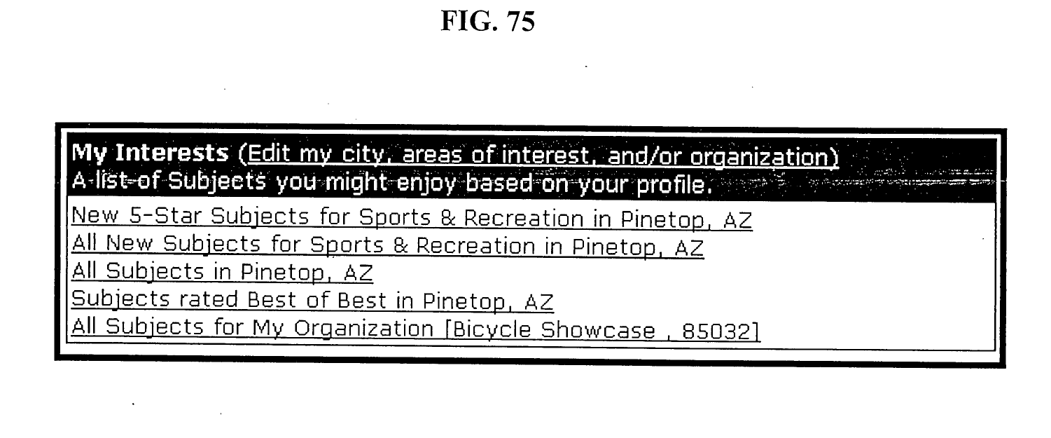

The “My Interests” box, illustrated by FIG. 75, is created using the information in a user's profile. Each entry in the box links to Subjects that are likely to interest the user based on his/her stated interests and geographic location. These links will return Subjects of such special interests, e.g., Recently Added Subjects in (user-selected town): All Subjects in (user-selected town): Best of Best in (user-selected town).

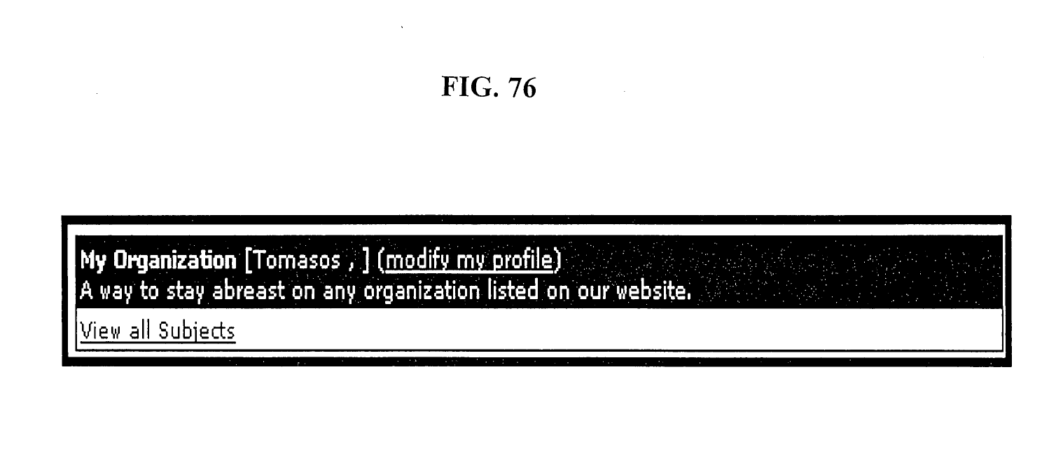

The “My Organization” box, illustrated by FIG. 76, allows a user to track Subjects that refer to certain businesses and organizations. In the above example, the user has chosen to track Tomaso's restaurant; however, there are currently no Subjects on the site that refer to Tomaso's. If another user decides to rate, for example, the five-cheese lasagna at Tomaso's, that Subject will appear in the My Organization box.

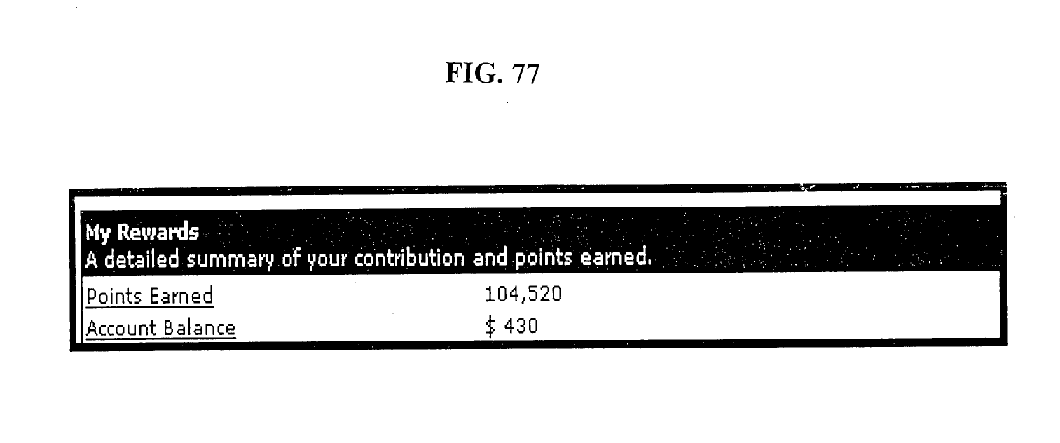

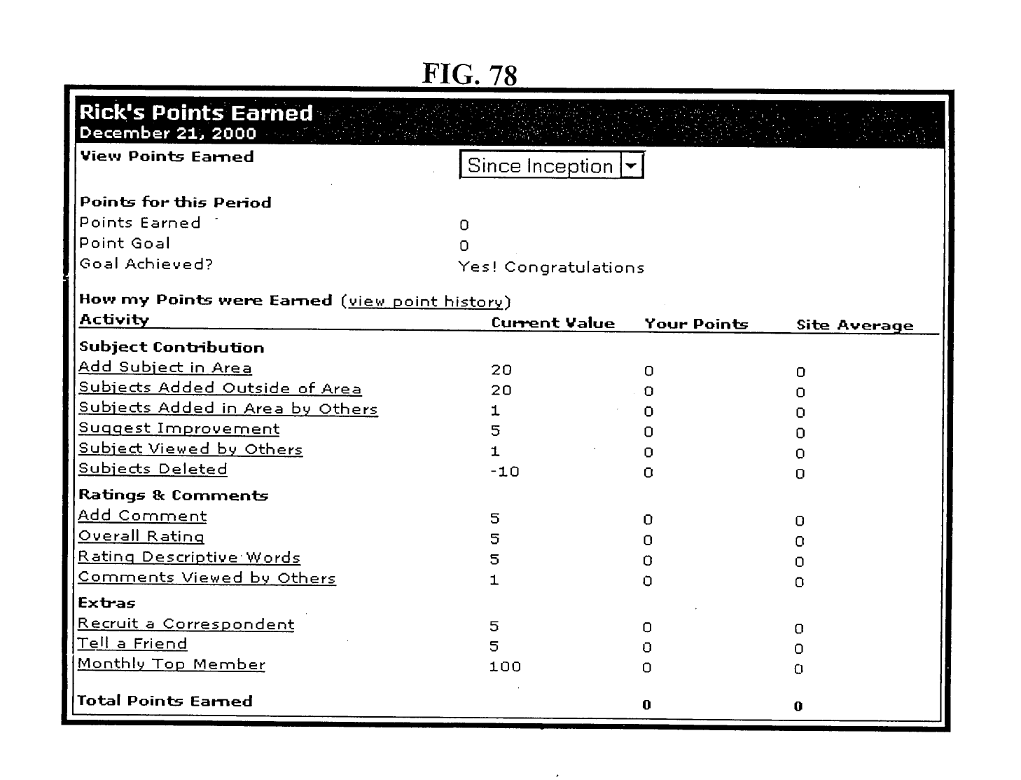

The “My Rewards” box, illustrated by FIG. 77, is a user's link to all the points he/she has earned, and the money into which those points translate. By clicking the “Points Earned” link, the user sees a screen like that of FIG. 78. In the left column are listed all actions that a user can perform that will earn points. The second column is the point value per action for each of those actions. The third column is the number of points the user has received by performing that particular action. The fourth column, “Site Average,” is the number of points that the average site user gains per month via the same action. Using this figure, he/she can compare their monthly activity and earnings with other site users. From the dropdown menu reading “from inception,” the user can choose to view points earned: a) since the inception of his/her account; b) during the current month, or c) during the past month. The “Goal Achieved” row lists how many points a user is expected to earn during the selected time period, and the adjacent entry indicates whether he/she has attained that goal.

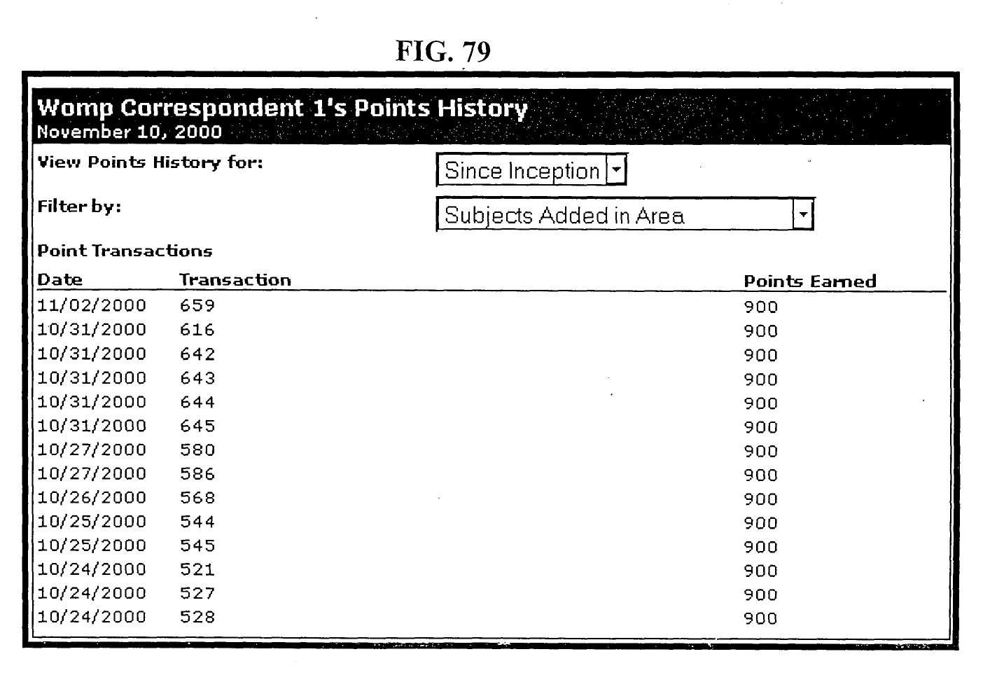

By clicking any of the links in the left column, the user can see a breakdown of how he/she earned points via each particular action. Example: If the user wants to see how many points he/she has earned by adding Subjects in his/her area, he/she clicks “Subjects Added in Area” and gets a screen like the one shown by FIG. 79. This screen lists the date, transaction number and points earned for every Subject this user has added in his/her area. To see how many points have been earned via other actions, a user can a) go back to the previous page and click the appropriate link, or b) on the current page, select a different action from the dropdown box across from the text reading “Filter by.” In the example above, the user is viewing points since the user became a registered user. This is indicated by the top dropdown box that reads “Since Inception.” To change the date from which to display points earned, a user must simply choose a different selection from that dropdown box: e.g., “This Month,” “Last Month.”

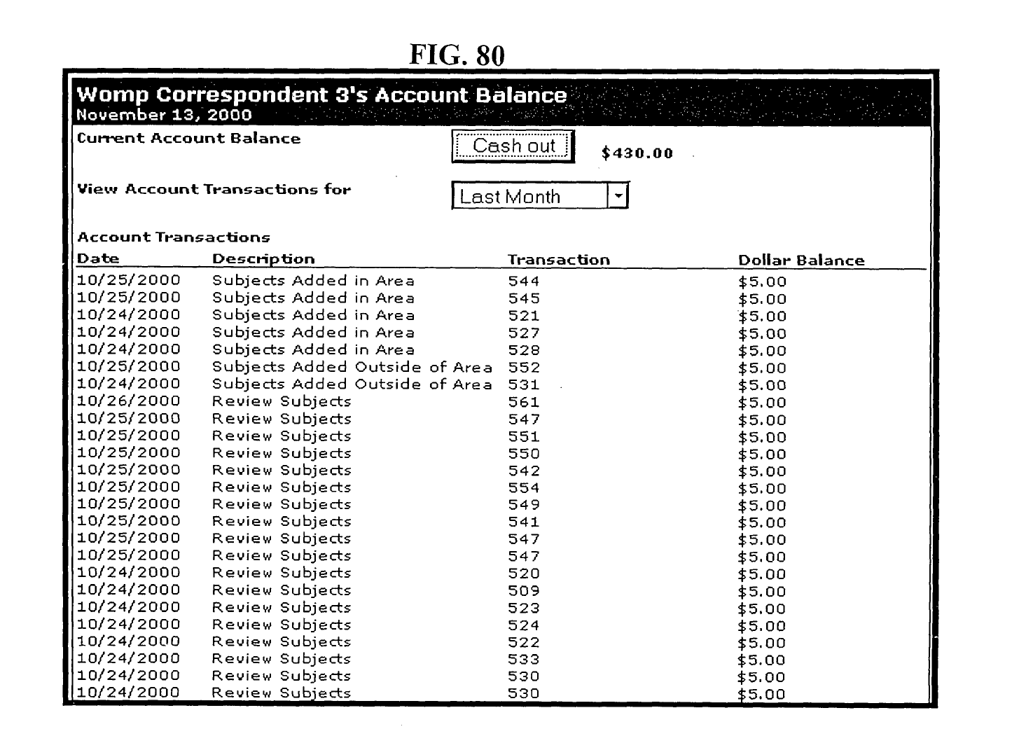

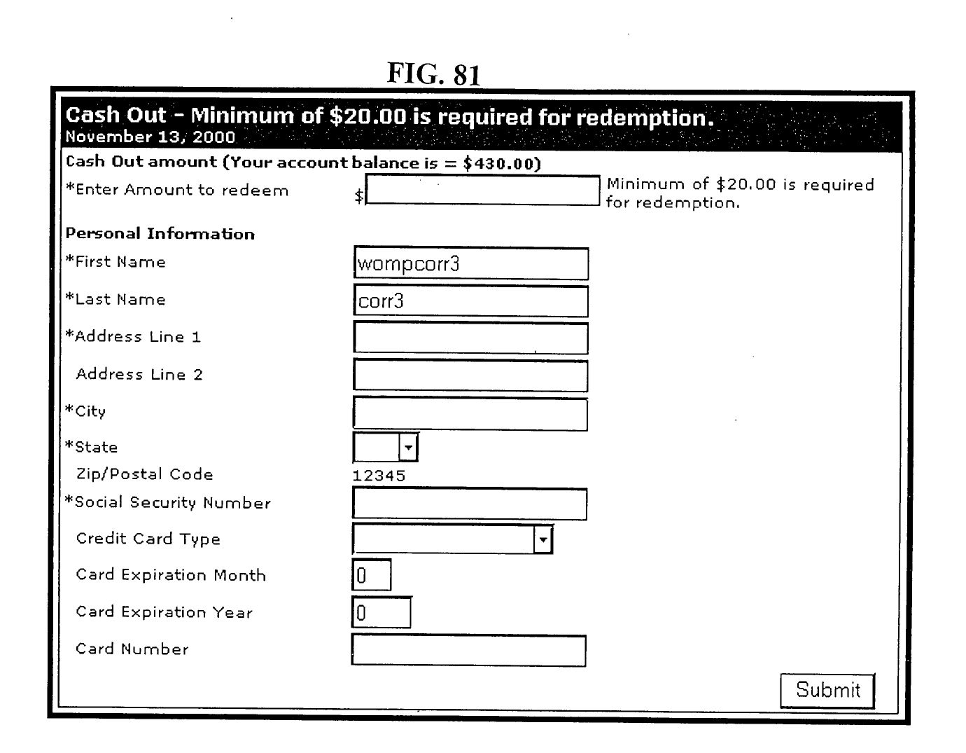

By clicking the “Account Balance” link, the user can view the monetary value of his/her accumulated points. The “Account Balance” screen appears as shown by FIG. 80. Listed on the Account Balance page are the date of each point-earning action, a description of that action, its transaction number and the dollars earned for it. Atop the page is the total Current Account Balance. Next to the balance will be a button that says “Cash Out.” By clicking that button, the user is taken to a screen like that shown in FIG. 81. After filling in the appropriate information, the user clicks “Submit,” and his/her cash-out is processed, and the credit card is credited. The client can configure this, and decide the amount of money a user must accumulate before being allowed to cash out, by, in Terraformer (Configuration and Administration) Module, clicking the “System Tables” tab on the top navigation bar, then clicking the “System Parameters” tab on the left navigation bar. Scroll until you reach the “Minimum cash out amount” field. In this field, enter the minimum dollar amount your users must attain before being allowed to cash out. When finished, click “Update” at the bottom of the screen.

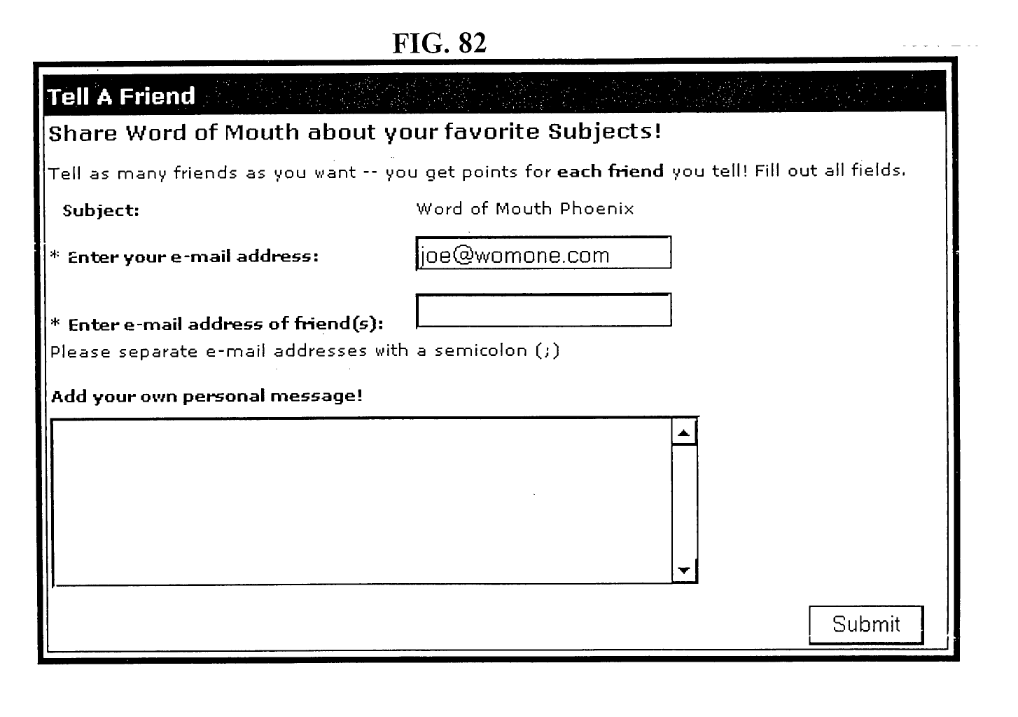

FIG. 82 illustrates the screen for Tell a Friend, the quick way that users can spread word of this system to people they know. This page is always accessible by the green navigation bar at the top of every page. To notify a friend, a user must simply: Type a Subject, then Enter his/her email address and the email address of the recipient(s), then Type the message and click “Submit”.

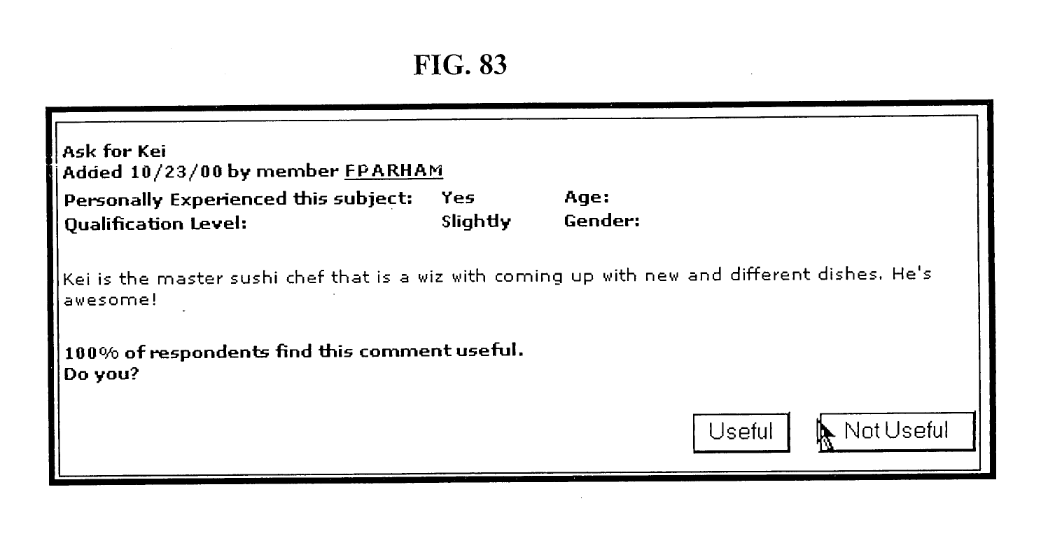

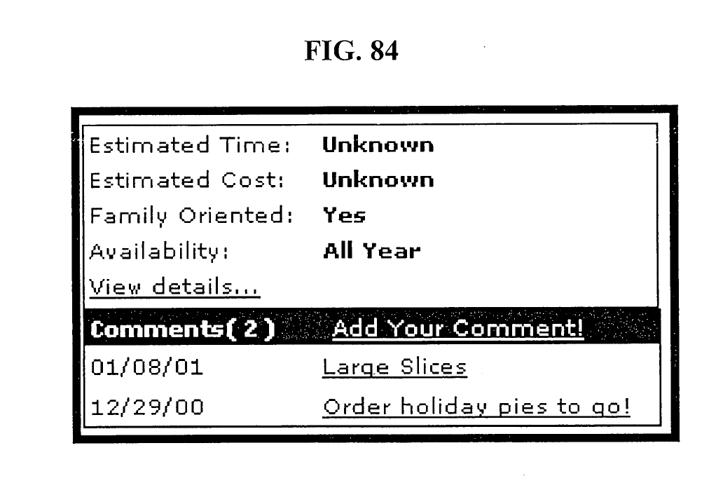

FIG. 83 illustrates the Rate other comments screen. Users can read all the comments left by other users about any Subject. These comments are accessible from any Subject page. If the user finds this comment useful, he/she clicks the “Useful” button; if not, he/she clicks the “Not Useful” button. A user may add a comment by clicking where shown in FIG. 84.

These ratings are one piece of a system that determines the credibility of the user who entered the comment. Users who leave comments that are popular with others will be given a higher credibility rating; users whose comments are unpopular will be given lower credibility. Note: Users may not rate their own comments.

As to the Roles and Rewards processes of the instant system; there are four types of users accommodated by the instant system, and each has a unique set of privileges and rewards. The four user types are:

Guests (unregistered users)

Privileges

Guests can: Search the site, view Subjects, comments and ratings, use Tell-a-Friend

Guests cannot: Earn points, start a MyPage

Responsibilities

Guests have no site responsibilities.

Members—Registration is required before a user can become a Member. Members have all the privileges of guests. In addition:

Privileges

Members can: Earn points for a limited number of actions, Add Subjects, ratings and comments, Suggest Improvements, Start a MyPage, and participate in contests.

Members cannot: Approve Subjects for publication, See “Best of Best” icons on search results pages, Make accuracy improvements to existing Subjects.

Correspondents—Correspondents are the users with the highest status. With the increased status comes more earning opportunities—and more responsibilities. Correspondents have all the privileges of guests and Members. In addition:

Privileges

Correspondents can: Earn points for a wider variety of actions, Earn more points than Members (for the same actions), Approve Subjects for publication, See “Best of Best” icons on search results pages, Make accuracy improvements to existing Subjects, Delete un-sponsored Subjects (recommend only), Enter exclusive contests

Correspondents cannot: Approve their own Subject for publication, Delete sponsored Subjects

Responsibilities

Correspondents are responsible for meeting their monthly point goal, and for many administrative actions relating to the upkeep of the site. Correspondents:

Approve newly added Subjects, Make accuracy improvements to existing Subjects, Delete inappropriate Subjects, Notify businesses about un-sponsored Subjects. [In return for performing these responsibilities, they are compensated for a wider variety of actions than members. They also earn higher point values than Members for performing basic actions on the site.]

Sponsors—Sponsors are advertisers who have paid to sponsor a Subject(s). They enjoy all the privileges that Members enjoy. In addition:

Privileges

Sponsors can: Publish sponsored Subjects without a Correspondent's approval, Add extensive customized text, photos and links to their Subjects

Sponsors cannot: Approve Subjects for publication, See “Best of Best” icons on search results pages, Make accuracy improvements to existing Subjects

A client can assign point and values—customized by role—for each action, including:

Adding a Subject in home ZIP code

Adding a Subject outside home ZIP code

Suggesting Improvements and Deletions

Giving a Subject an overall rating

Adding Comments

Rating Descriptive Words

Telling a friend

Recruiting Correspondents

No Action Required

(Points awarded when Member's Subject or Comments are read by another user)

(Points awarded when another user adds a Subject in Member's ZIP code)

Approving a Subject for publication (Correspondents only)

Maintaining a Subject (fixing outdated/wrong information) (Correspondents only)

Notifying a potential sponsor about an un-sponsored Subject (Correspondents only)

Monthly bonus programs

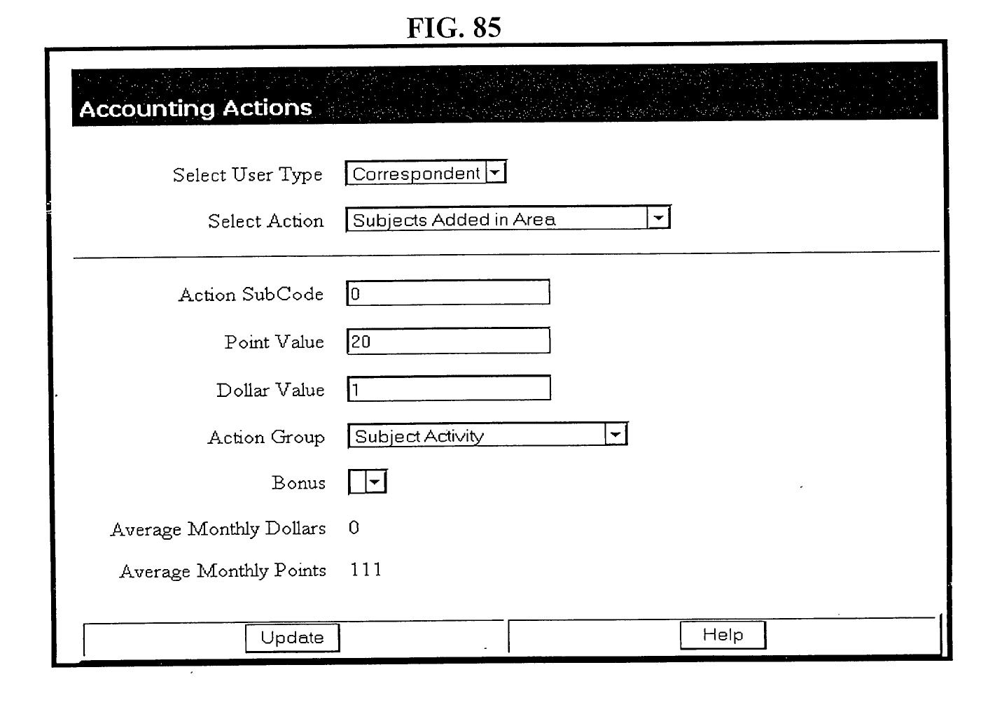

For the client to configure points per action, in Terraformer (Configuration and Administration) Module, click the “Domain Tables” tab on the top navigation bar and the “Accounting Actions” tab on the left navigation bar. In the right frame, a screen like that of FIG. 85 will appear. The top set of fields are the “Select User Type” and “Select Action” fields. Because the points the client will award will vary based on a user's role, one must specify the action itself (in the Select Action dropdown box) and the user type for whom one is assigning the point value (in the Select User Type dropdown box). In the example shown, one is assigning the number of points a Correspondent will receive every time he/she adds a Subject in his/her ZIP code. After choosing from each field, proceed to the fields shown as follows: Point Value and Dollar Value. In the appropriate field, type in the point and dollar value the client wishes to assign to this action. When finished, click the “Update” button at the bottom of the page. The client may then choose another user type and/or action from the top menus and repeat the process until all actions have been assigned for each user type.

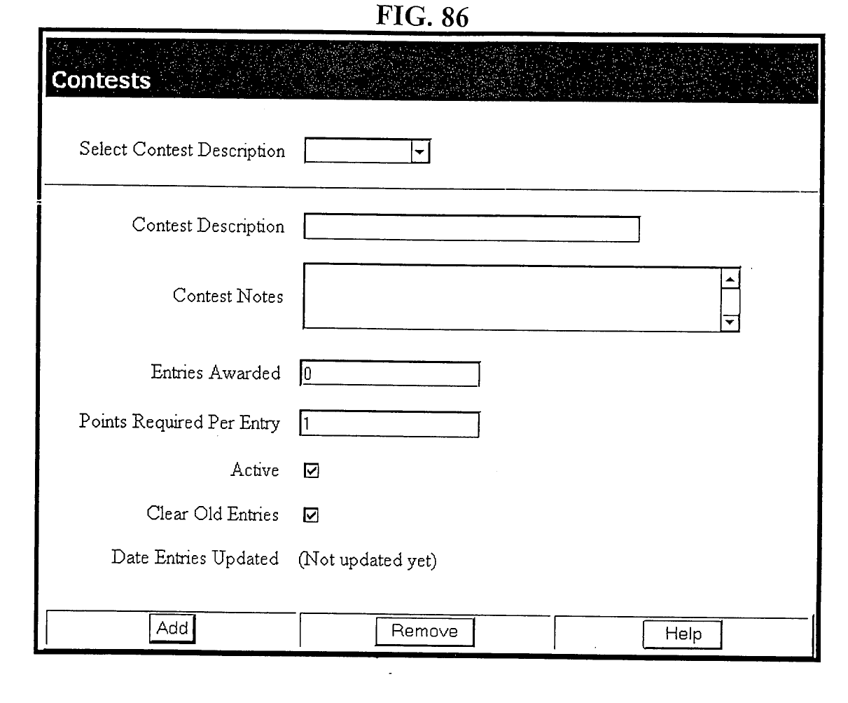

Assigning a dollar value to points is one way of rewarding users; another way is to award them one entry in special contests for every specified amount of points they earn. Example: For each 1,000 points a user earns in a month, he/she receives one entry in a contest to win $500. Consequently, if a user earns 7,000 points that month, he/she will be entered in the contest seven times. The client may configure contests as follows. In Terraformer (Configuration and Administration) Module, click the “System Tables” tab on the top navigation bar and the “Contests” tab on the left navigation bar. Then the screen like that of FIG. 86 will appear. If the client is setting up a new contest: the existing contests will be listed in the top dropdown box, “Select Contest Description.” If setting up a first contest, the client can ignore this dropdown box. The next field is “Contest Description.” In this field, enter a name for the contest. In the “Contest Notes” field, enter any notes you'd like to associate with this contest (for internal use only). In the “Entries Awarded” field, specify how many will be awarded your users per number of points achieved (specify that number of points in the next field). Example: If the client would like to give one entry per 1,000 points, enter the number “1” in this field. In the “Points Awarded” field, enter how many points are required of users to accumulate before being awarded a contest entry. Example: If the client would like to award an entry per 1,000 points, enter the number “1000” in this field. Note: The above two fields are directly related to each other. When the user achieves the point total you specify in “Points Awarded,” he/she will receive the number of entries you specify in “Entries Awarded.” Example 2: If we'd like to award 3 entries per 2,000 points earned, enter “3” in the “Entries Awarded” field and “2000” in the “Points Awarded” field. Check the “Active” box to activate the contest; leave it unchecked if one does not want the contest to begin immediately. Check the “Clear Old Entries” box if one wants entries from the previous month to be discarded and start the contest anew every month; leave this box unchecked if one wants a contest's entries to accumulate for longer than a month. When each of these fields is filled in, click “Update” to create the contest. If modifying an existing contest, select the contest wanted to be modified from the “Select Contest Description” menu, make the changes in the appropriate fields that follow, then click “Update.”

It's easy for users to send feedback. By clicking the “Feedback” link in the navigation bar at the top of any page, a feedback screen is returned. To send their comments, users must simply select a topic, type their message in the “Your Comments” box and click “Submit.”

When it comes to credibility, all users are not created equal. Some Correspondents will be conscientious above and beyond requirements; others may do sloppy, inaccurate work in a race to earn the most points. To neutralize this, the instant system contains a system of assigning higher credibility to those users who deserve it, rendering a more accurate and reliable dataset. 1) Ratings multipliers can be given to each user type, and the multipliers are selected by each client by using Terraformer (Configuration and Administration) Module. Example: A Correspondent's opinion may count twice as much as a Member's opinion. 2) The weight of a user's opinions increases with the popularity of his/her reviews. Example: If 65 percent of users agree with Correspondent Marcia's reviews, then the client assigns her a multiplier of two: Her opinions now count double the weight of average users' opinions. If 85 percent of users agree with her reviews, the client gives her a multiplier of three, tripling her influence. Conversely, if only 20 percent of users agree with Marcia, she can receive a multiplier of 0.5, making her opinions count half as much as average users. Multiplier values and percentages are selected by each client. 3) The weight of a user's opinion increases with his/her propensity to add high-quality Subject to the database. Example: If a user adds 10 Subjects to the database in April, and the average overall rating of those Subjects (combined) is above 4.0, the user receives a multiplier of two. 4) Finally, for each Subject he/she enters, a user is asked to select his/her level of expertise on the given Subject. Users are first asked if they have experienced the Subject before, then are asked whether they feel slightly, somewhat or very qualified to rate the Subject. Using these three criteria for credibility, sites can automatically reward those users that the community at large believes to be valuable and credible. In the same way, they can decrease the weighting for users with whom very few others agree.

Most ways in which the client can configure the instant system have been covered in the previous pages. Collected as follows, however, are all of the different variables that clients may configure, and reasons clients may choose to do so. Content may be controlled. The instant system works well across many different audiences because it allows detailed customization of each site. Whether one runs an international daily newspaper or a small, monthly trade publication, the software gives one the ability to create an exceptionally personal look and feel. One may create a list of categories, and define which will be shown on the home page. Why would use this feature? To give the site an appropriate feel, by location or subject matter, and give prime exposure to the most important categories. Example: Outdoor Life magazine might choose to have six categories displayed on its home page—Biking, Camping, Climbing, Hiking, Rafting and Skiing. Or, Outdoor Life may choose to have 18 categories—and only display these six major ones on the home page.

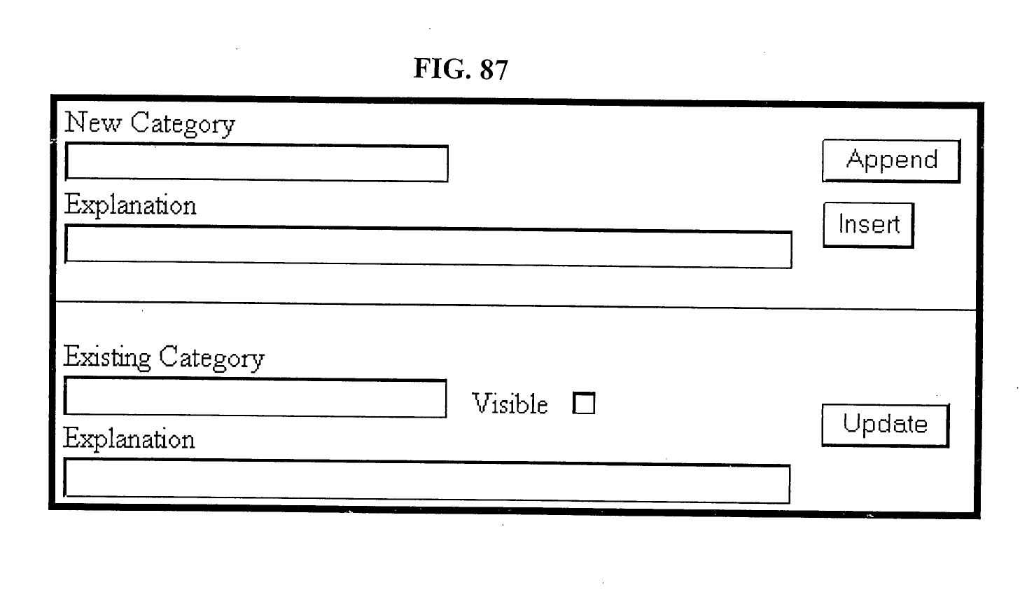

One may configure category display. Note that in Terraformer (Configuration and Administration) Module, one must always make one's selection from the top navigation bar first. After making the proper selection from the top bar, the correct links will appear on the left. FIG. 87 illustrates the screen to add a new category. To add a new category, type its name in the “New Category” box. Type an explanation (for internal use) in the “Explanation” box. Then click “Append.” After that, the new category will appear in the listing. To make a category visible or invisible on the home page, or to edit the title of an existing category, or to edit the explanation of an existing category, click on that category in the category listing box. Its title and description will then appear in the “Existing Category” section at the bottom of the page. Click the “Visible” box if you want the category to be visible; if not, uncheck the box. To make changes to the name or explanation of the category, edit the name and/or explanation for the category. When finished, click “Update” to execute changes. To remove a category, click on the name of the category you want to remove in the category listing box. Then click the “Remove” button at right. To shift the order in which categories appear, click on the name of a category you want to shift. Then click “Move up” or “Move down” in accordance with where the category to should appear. Repeat for each category until the desired order is achieved. The default order of appearance is alphabetical.

One may create a list of subcategories for each category. Why use this feature? To further define specific sub-areas of each category. Example: Outdoor Life might have the following subcategories under the Category “Biking”: Bikes, Bike Shops, Clothing and Gear, Cycling Events, Mountain Trails, Urban Trails. To configure subcategories, the client may, in Terraformer (Configuration and Administration) Module, click “Domain Tables” on the top navigation bar and “Categories” on the left navigation bar. To create and edit subcategories under a specific category, click on that category in the category display box. Then click the “Show Subcategories” button at right. To add a new subcategory, type its name in the “New Category” box, and type an explanation of the subcategory (for your internal use) in the “Explanation” box. Then click “Append.” To edit a subcategory, click on it in the subcategory display box, and its title and description will appear in the “Existing Category” and “Explanation” boxes at the bottom of the page. Make the changes desired to its visibility status, category name and explanation, then click “Update.”

The client may associate Descriptive Words with categories and subcategories. Why use this feature? To create a very fluid user experience for your visitors. Pre-defining words that are pertinent to each category and subcategory provides a ready-made set of relevant criteria by which users can add and rate Subjects quickly and easily. Example: For Outdoor Life's “Mountain Trails” subcategory, some of the predefined Descriptive Words might be: rocky, trail condition, scenery, danger, congestion, difficulty, wildlife, etc. the client may also configure associations for categories, subcategories and words. In the display box for subcategories, click the name of the subcategory to which to add Descriptive Words. Then click the “Descriptive Words” button at right. To add Descriptive Words to a subcategory: In the “Descriptive Word” field, type in the word to add, then click the “Add” button (Make sure the “Select Descriptive Word” dropdown box is blank). To edit or remove existing Descriptive Words in a subcategory: Select the chosen word from the “Select Descriptive Word” dropdown box. To remove it, click the “Remove” button. To edit it, edit the text that appears in the “Descriptive Word” box, then click “Update.”

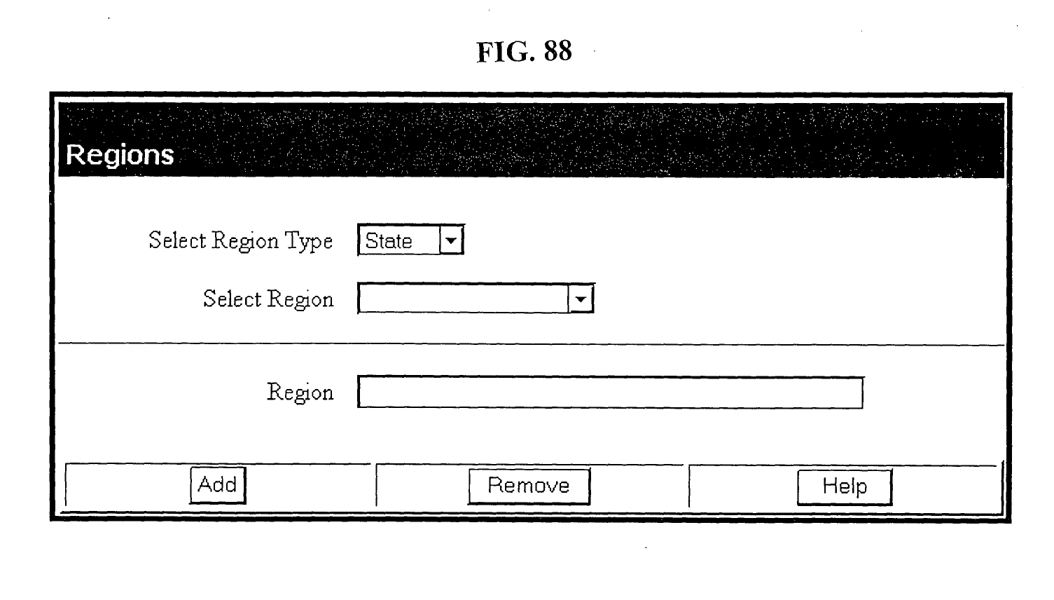

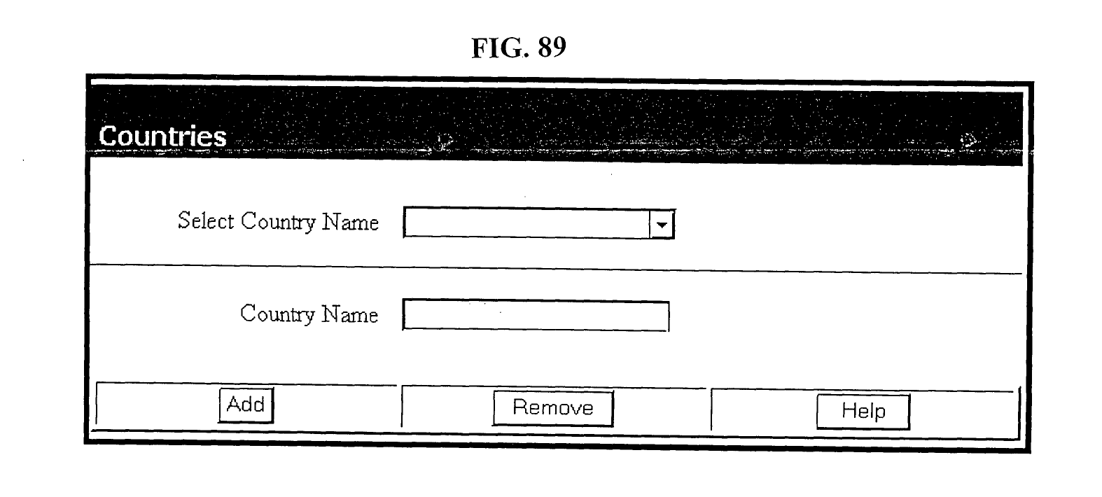

The client may determine how many Descriptive Words a user must choose when adding a Subject. Why use this feature? To ensure that requirements match the audience. Example: If the audience is highly educated, one may feel safe in requiring them to enter more words. If the audience is less educated, has a shorter attention span or has very little time, requiring fewer words is a better option. One may also configure the number of Descriptive Words a user must choose in the appropriate Terraformer (Configuration and Administration) Module field. In this field, type the minimum number of words you want to require a user to enter when he/she is adding a Subject. When finished, click “Update” at the bottom of the page. One may also determine how many pre-selected words appear when a user adds/rates a Subject, to speed/simplify the process of adding/rating a Subject. Example: The more words that appear automatically, the more likely a user will select some of them (instead of taking time to generate his/her own Descriptive Words). And one may configure pre-selected words in Terraformer (Configuration and Administration) Module in the appropriate field. In this field, type the minimum number of pre-selected words you want to appear when a user is adding a Subject. When finished, click “Update” at the bottom of the page. In a similar way, for appropriate ends, one may determine minimum rating score required for keywords to appear, determine minimum ranking a Descriptive Word must have in order to be displayed with a Subject, configure minimum ranking for Descriptive Words, determine when to expire ratings in the database, configure ratings expirations, determine how long a user must wait before rating the same experience again, configure a user waiting period between rating same experience, determine how high a Subject must rank to be labeled “Best of the Best”, configure “Best of Best” [Example: In the “Best of Best cutoff” field, enter the number you would like to designate as the minimum average rating a Subject must receive in order to receive the distinction “Best of Best.” The range for this number is between 0.01 (lowest) and 5.0 (highest, a perfect score). All Subjects with an average rating higher than the one you select will be considered Best of Best. When finished, click “update” at the bottom of the page], determine weighting of opinions based on a user's credibility and contributions, determine maximum number of search results, and results per page, configure search results (i.e., type in the maximum number of total search results that one wants users to be able to retrieve when they perform a search on the site. And specify the number of search results per page that one would like the user to see. When finished, click “Update”), create a list of banned words to ensure that inappropriate language does not appear on the site, and define regions and countries to define/limit the countries from which users may add and search for Subjects. For example, North American Skiing magazine may want to limit all ski-slope reviews to the United States, Canada and Mexico only. To configure regions, click, in Terraformer (Configuration and Administration) Module, the “Domain Tables” tab on the top navigation bar. Then click “Regions” on the left navigation bar. A screen like that shown by FIG. 88 will appear. From the “Select Region Type,” select the area to break into regions: Country or State. If adding a new region, ignore the “Select Region” box. Type the name of the new region into the “Region” box and click “Add.” If editing the name of an existing region, select it from the “Select Region Type” box. Its name will then appear next to the “Region” field, where one can edit it. If removing an existing region, select it from this box. Its name will then appear next to the “Region” field. Then click “Remove.” FIG. 89 illustrates a similar screen from Terraformer (Configuration and Administration) Module. If adding a new country, type its name in the “Country Name” field and click “Add.” If editing the name of an existing country, the “Add” button will say “Edit” instead. Select the country name one wants to edit from the “Select Country Name” dropdown box, after which the text will appear in the “Country Name” field. Edit the text to specifications, then click “Edit.”

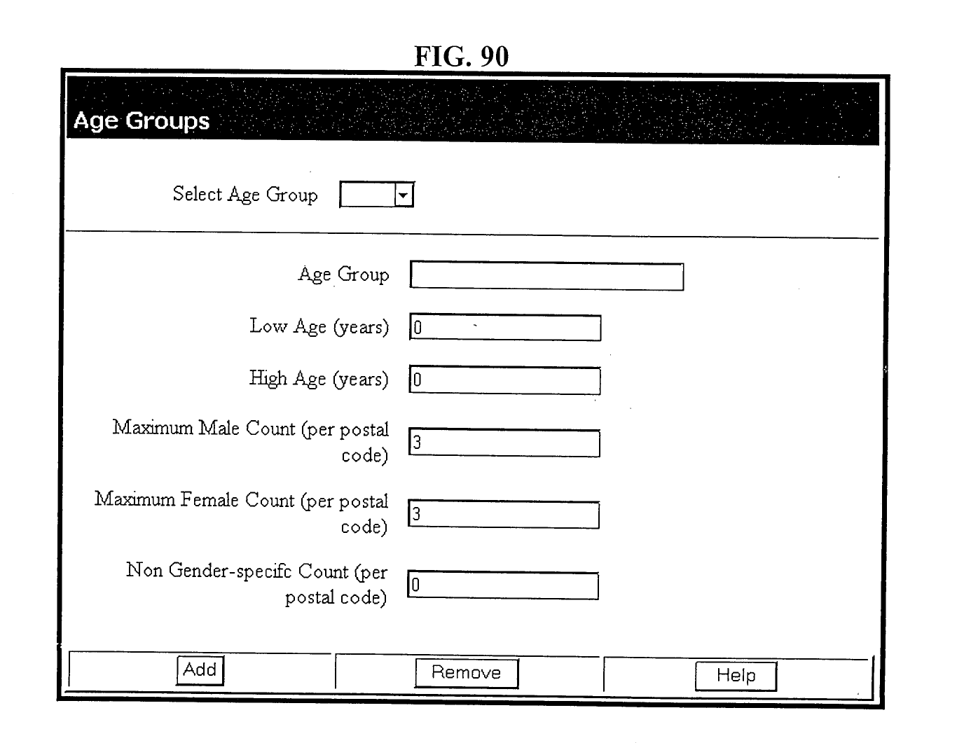

The client will normally wish to recruit, reward and recognize users. The instant system provides a complete system to recruit, reward and recognize outstanding members of a vibrant online community. The configurable variables that follow put the power of customization in the client's hands. One may recruit by defining age groups to track and subdivide this demographic in a way that best meets needs. One may define/limit contributions for each gender (per ZIP code) to define the “exclusivity” of being a correspondent in a way that best meets needs. One may limit the number of men and women per ZIP code as strictly as one likes, or not at all. To configure age groups in Terraformer (Configuration and Administration) Module on an appropriate screen, like that shown in FIG. 90, to add an age group, type a title for the age group into the “Age Group” field. For this new age group, enter the low age (e.g., 18) and high age (e.g., 35) for it. In the following three fields, you have two choices: a) Enter the maximum number of males and females in this age group that one would like to allow in one's Correspondent pool per ZIP code, or b) Enter the number of people (not gender-specific) from each ZIP code that one would like to include in one's Correspondent pool. To finish creating this age group, click “Add.” To remove an existing age group, select it from the “Select Age Group” dropdown box at the top and click “Remove.” To edit an existing age group, select it from the “Select Age Group” dropdown box at the top. Its age and gender-count information will then appear in the fields below it. Edit these fields as necessary and click “Update” (the “Add” button will change to “Update”).

To configure rewards, the client will use the Terraformer (Configuration and Administration) Module screen of Accounting Actions to assign point and dollar values per action (customized by membership type (Member, Correspondent, Sponsor), including: Adding a Subject in home ZIP code, Adding a Subject outside home ZIP code, Adding a Comment, Suggesting Improvements and Deletions, Rating others' Comments, Giving a Subject an overall rating (1 to 5 stars), Rating Descriptive Words, Telling a friend, Recruiting Correspondents, including in areas where no user action is required: Points awarded when Member's Subject or Comments are read by another user, Points awarded when another user adds a Subject in Member's ZIP code, Approving a Subject for publication (Correspondents only), Maintaining a Subject (fixing outdated/wrong information) (Correspondents only), Notifying a potential sponsor about an un-sponsored Subject (Correspondents only), Monthly bonus programs.

If one is in the early stages of building a critical mass of Subjects, one may want to assign high point values for adding Subjects, adding comments and adding words. If one has reached a critical mass of content and now wants to focus on growing audience, one may want to assign high point values to actions such as referring other members and notifying sponsors. To configure points per action, one goes to the appropriate screen in Terraformer (Configuration and Administration) Module to the fields of “Select User Type” and “Select Action”. Because the points one awards will vary based on a user's role, one must specify the action itself (in the Select Action dropdown box) and the user type for whom one is assigning the point value (in the Select User Type dropdown box).

The client may determine how many points a correspondent must score during a specified time period to remain in good standing to make sure that the people rewarded for building and maintaining the online community are holding up their end of the bargain. If a correspondent isn't meeting the minimum activity standards set, it's likely that another correspondent-in-waiting will do so. The client may determine minimum dollar amount users must accumulate before being allowed to cash out to cut down on the resources required to accommodate payouts. The higher the dollar amount a user must attain before being paid, the fewer requests for payment. To configure minimum cash-out amount, in Terraformer (Configuration and Administration) Module, in the appropriate field, enter the minimum dollar amount users must attain before being allowed to cash out. When finished, click “Update” at the bottom of the screen.

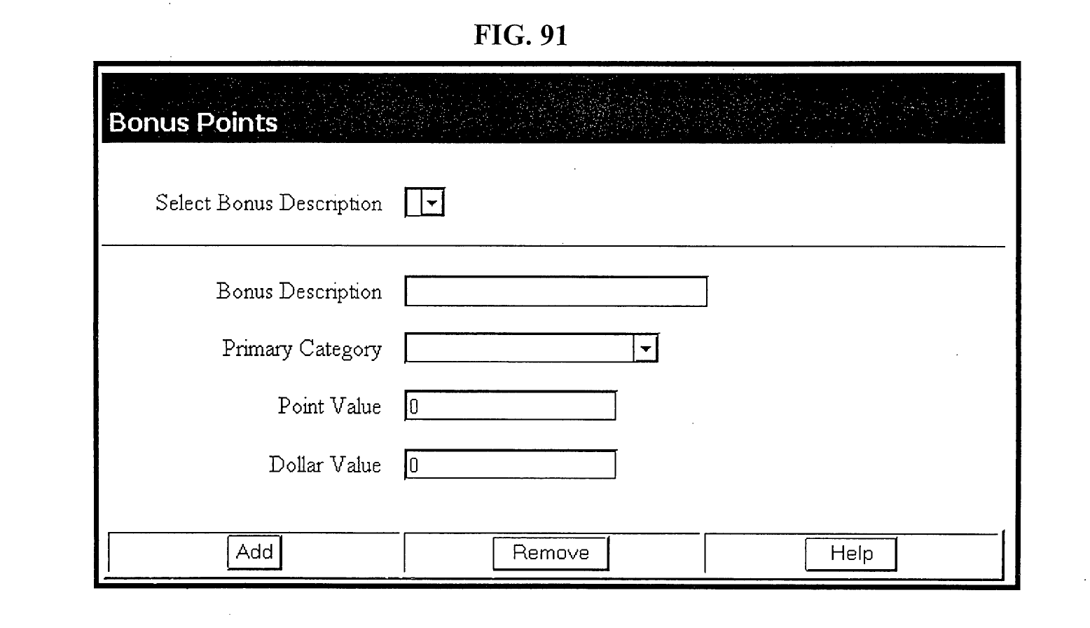

The client may add “bonus points” to certain categories to further target areas of the site that require further development. Example: If Learning Experiences has more than enough entries but Restaurants has very few, it may make sense to give users bonus points for every restaurant they enter over a given period of time. To configure bonus points, in Terraformer (Configuration and Administration) Module, select “Domain Tables” on the top navigation bar and “Bonus Points” from the left navigation bar. A screen like that shown by FIG. 91 will appear. To add a bonus, type a title for the bonus into the “Bonus Description” field. From the “Primary Category” dropdown box, select the category that is most appropriate for this bonus. Insert the point and dollar values to award for this action and click “Add.” To remove an existing bonus, select it from the “Select Bonus Description” dropdown box at the top and click “Remove.” To edit an existing bonus, select it from the “Select Bonus Description” dropdown box at the top. Its title will then appear in the “Bonus Description” field, and the category, points and dollars associated with it will also appear in their respective fields. Edit as necessary and click “Update” (the “Add” button will change to “Update”).

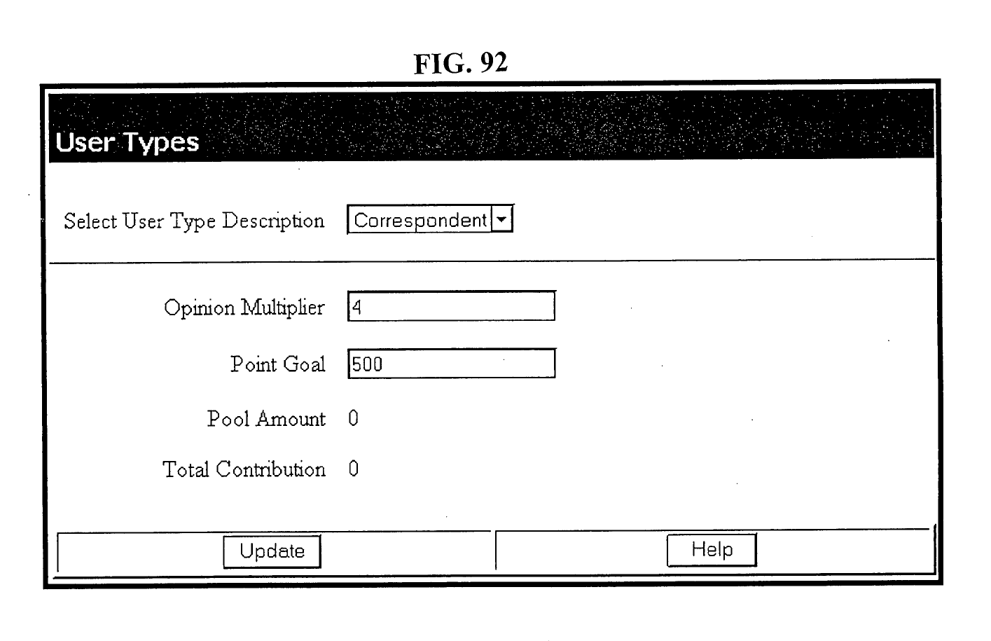

The client may create point goals and opinion multipliers for each user type to give proper incentive to each member type. Example: Correspondents will enjoy more rewards and privileges than members; because of that, one will likely require more community-building activity from them. To configure point goals and opinion multipliers, in Terraformer (Configuration and Administration) Module, select “Domain Tables” on the top navigation bar and “User Types” from the left navigation bar. A screen like that of FIG. 92 will appear. From the “Select User Type Description” dropdown box at the top of the page, select the user type for whom one would like to determine a monthly point goal and opinion multiplier. In the “Opinion Multiplier” field, enter the appropriate weighting for the selected user type. Example: A multiplier of 3 for a Correspondent would make a Correspondent's opinions worth three times that of a Member. When finished, click “Update.”

In the “Point Goal” field, enter the monthly point total that you expect each user type to accumulate. When finished, click “Update.”

The client may create rewards for each user type to allow each member type a chance to earn rewards. Example: If you choose to reward your top 10 contributors, those 10 will probably all be correspondents (correspondents are the most active contributors and will naturally aggregate more points than other users). This feature allows you to designate a reward for each user type: e.g., Top 10 Correspondents, Top 10 Members, etc. And the client may allocate a percentage of sponsorship revenue to user rewards; this is an easy way to automatically allocate a pool of money for user rewards. This is an alternative to setting aside a specific dollar amount for the same purpose. And the client may decide the number or percentage of users that may share in special rewards to configure the distribution of rewards. Example: A smaller site with fewer users may choose to reward its most active 50 users with a special reward. A high-volume site may choose to reward by percentage (e.g., the most active 5 percent of users). This works because every month, the instant system's software runs an automated process that identifies the top contributors—by percentage or real number— and generates a list of them. The client may configure this in Terraformer (Configuration and Administration) Module in the appropriate screen in the “Top N Count Value” field, by entering the number (N) of top contributors that will share in special rewards for the site: e.g., 100 for Top 100, 50 for Top 50, etc., or in the “Top N Percent Value” field, enter the percentage of top contributors that will share in special rewards: e.g., 10 for top 10 percent; 50 for top 50 percent, etc.

The clients, as has been discussed, may set up and configure contests. An automated process sifts through the entries (on demand) and determines a winner(s). The client may select as many winners as is desired.

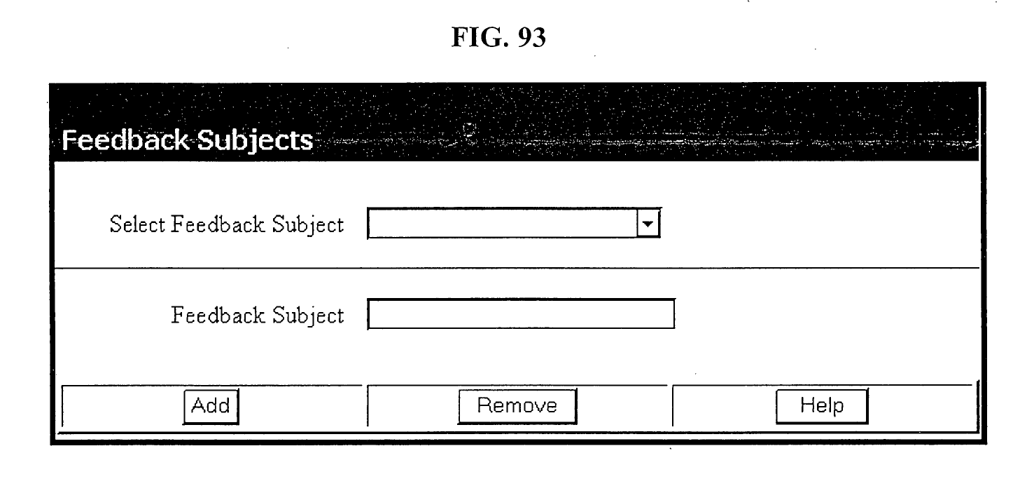

The client may configure audience communication. Creating predefined questions and topics for users enables them to more easily communicate with the site about what they like and dislike about the site. The instant system allows the client to define pre-selected feedback Subjects to help speed and simplify the user's process for communicating. To configure feedback Subjects, in Terraformer (Configuration and Administration) Module, select “Domain Tables” on the top navigation bar and “Feedback Subjects” from the left navigation bar. A screen like that shown in FIG. 93 will appear. To add a new feedback subject, type the text into the “Feedback Subject” field and then click “Add.” To remove an existing feedback subject, select it from the “Select Feedback Subject” dropdown box at the top and click “Remove.” To edit an existing feedback subject, select it from the “Select Feedback Subject” dropdown box at the top. Its title will then appear in the “Feedback Subject” field. Edit as necessary and click “Update” (the “Add” button will change to “Update”).

As shown earlier, the client may define questions to ask prospective correspondents. Different sites will want different qualities from their correspondents. The clients define what questions correspondents must answer and the possible responses, and decide how they must score in order to meet client standards. These are, as discussed, configured in Terraformer (Configuration and Administration) Module. Similarly, the client may configure Correspondent Answers and create decline reasons—predefined reasons for a user to decline the client's offer to become a correspondent or a member. Why this feature? To aggregate the most common showstopper issues for potential correspondents and members, and to use that aggregated data to reshape the client approach to recruiting them.

The instant system helps generate revenue by offering advertisers a completely automated way to appear on the site. The instant technology enables advertisers to create and enhance a fully detailed page for their business, and here's how the client can help: by creating predefined section headers for sponsor pages to make it faster and easier for sponsors to create their own customized pages, and thereby make it easier to sell sponsorships. Examples of section headers could include: Our Menu, Our Facilities, Our Customers, Our Hours, Our Specialties, Our Products, Our Employees, Our Coupons, Our Weekly Specials, etc. Section may be configured in Terraformer (Configuration and Administration) Module in the appropriate screen.

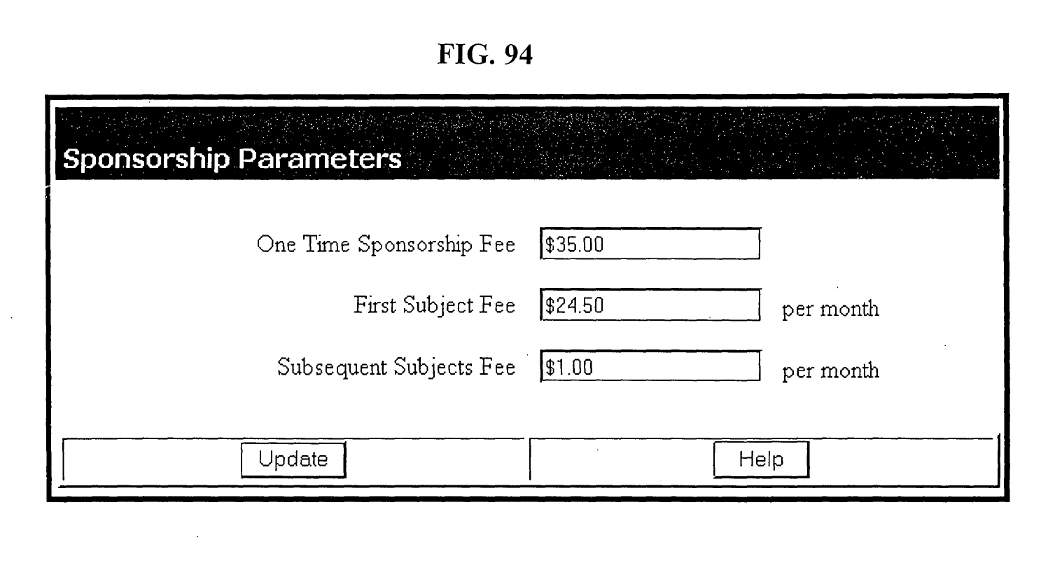

The client may configure/display address and phone of non-sponsored Subjects to give businesses incentive to sponsor Subjects. And the client may determine setup and sponsorship fees. Reasonable fees for sponsorship depend on a number of factors: market size, competition, saturation, etc. Each site can tailor these rates to their own business situation. To configure sponsorship fees, in Terraformer (Configuration and Administration) Module, click the “System Tables” tab on the top navigation bar and the “Sponsorship Parameters” tab on the left navigation bar. A screen like that of FIG. 94 appears. These three fields determine sponsorship pricing. The top field is the initial sponsorship fee. The second field is the fee for the first month of sponsorship, and the third field is the fee for each subsequent month. Enter the amount in each of the fields that one wants to charge for sponsorships, then click “Update.”

In addition to having the ability to see a site's total number of users, Subjects, ratings and comments at any time, the following management reports are also available to clients: Member Counts, Member Demographics, Member Rewards Pool Status, Contributions by Members, Correspondents Counts, Regions, Demographics, Performances, Content Reports, Sponsor Reports, Feedback Reports, etc.

Underlying the instant system is an intricate system of automated processes that documents the Web site's activity and keeps it updated and running smoothly. What follows is a list of the processes that run at scheduled intervals for each site. It does Correspondent invitation. Using the correspondent-recruitment application and email created by the client, this process sifts through all registered users in the database and sends an invitation to potential correspondents based on their application score and available openings. Example: Member Bob lives in the 90210 ZIP code. There is an opening for a correspondent in the 90210 ZIP code, so this process sends Member Bob an e-mail inviting him to become a correspondent. It does a Waiting List. If there are no openings in a potential Correspondent's ZIP code, he/she immediately becomes a Member, and his/her name is added to a Correspondent waiting list. When a Correspondent position opens up, the process sends the Member an email inviting him/her to become a Correspondent. It does Invitation cleanup. The process looks at all the correspondent invitations that have not been answered by a certain (client-specified) period of time, and deletes them. It does User purge. This process looks at the usage patterns of all registered users and deletes the ones who have not returned to your site in the client-specified amount of time. It does Correspondent missed goals. Using the client-configured goals for each member type, this process evaluates each registered user's goals, awards points and sends an email reminder to those users who did not reach their goals. It does Demotion. This process finds users who have not met their performance goals for consecutive months, and demotes them. Note: A client may choose to de-activate this option and elect not to demote users.

It also does Old Subject Purge. Using the “dates available” field, this process finds events that have expired and deletes them from the site. Example: Two weeks after a Bette Midler concert—after giving users an ample (client-selected) amount of time to comment on the show—the process would delete the concert from the site. It does Poor Subject purge. This process works in the same way as the “Old experience purge,” but it deletes a Subject based on its average rating instead of its date. It does Ratings purge. This process removes ratings entered before a client-specified date. It does Sponsor payment notification. This process generates a report on the revenue from all sponsored Subjects. It does Top words update. This process examines all Descriptive Words used to describe the Subjects in your database and generates a list of the top 100 words used in each Category. These words may be used as the pre-selected Descriptive Words during the add process as well as in the rating process.

The automatic process also does Average accounting points. This process reviews all user activity from the past month and generates an average number of points per action per user type. Example: In September, the average Member earned 1200 points by adding Subjects, 400 points by rating comments, and 300 points by rating Descriptive Words. The average Correspondent earned 1500 points by adding Subjects, 600 points by rating comments and 500 points by rating Descriptive Words. It does Bookmark summary. This process tracks the number of times that each Subject was bookmarked by a user. It does Top 100 Subjects. Every month, this process generates a list of the 100 highest-rated Subjects for each category. The top 10 are added to the home page, with a link to the list of 100. It does Monthly awards. Per the client's criteria, this process identifies the top performers that will share in special awards for the given month. It does Correspondent, Member and Sponsor reports. This process generates regular emails (at client-selected intervals) to each member type in order to recruit, manage and motivate. Emails will contain a link back to the Web site or MyPage. It does Correspondent recruitment bonuses. This process finds all the new registered users who were recommended by another user, and accepted as a correspondent. Reward bonus points are given to the referrers upon acceptance. It does National pool flags. This process ensures that Subjects added by members are approved by correspondents in a timely fashion. After a Subject has been waiting for approval by a correspondent in a specific ZIP code for a certain (client-specified) amount of time, the Subject then becomes available for review by all other correspondents. Example: Member George has reviewed a restaurant in Correspondent Gracie's ZIP code. For the next three days, Correspondent Gracie has sole authority to approve Member George's new Subject. After three days, if Correspondent Gracie has not approved or rejected George's restaurant review, then the review becomes available for approval to any Correspondent.

It also does Purge old comments. This process removes comments that are beyond a certain age (e.g., 30 days, 6 months, etc.). It does Real-time Subject-page views. The process adds up all Subject-page views over a given time period. It does Real-time information requests. This process counts the number of times that users have clicked “get more information” about a Subject. Why use this feature? To sway potential advertisers toward a sponsorship. A potential advertiser may be more likely to sponsor a Subjects if she knows that dozens of your Web site users were looking for information about her business. It does Batch reporting. This process reports a summary of the processes that ran on the previous day.

The instant system includes a Survey tool that allows a user to create a survey for any audience in just three easy steps. It also allows many customized options. Using this survey tool, the user can determine:

Who may respond to the survey

How many times each participant may respond

Who may see the results, and when they may see them

Which questions participants must answer

Whether a user may leave comments after taking the survey

A specific start and end date for the survey

A maximum number of total responses to the survey

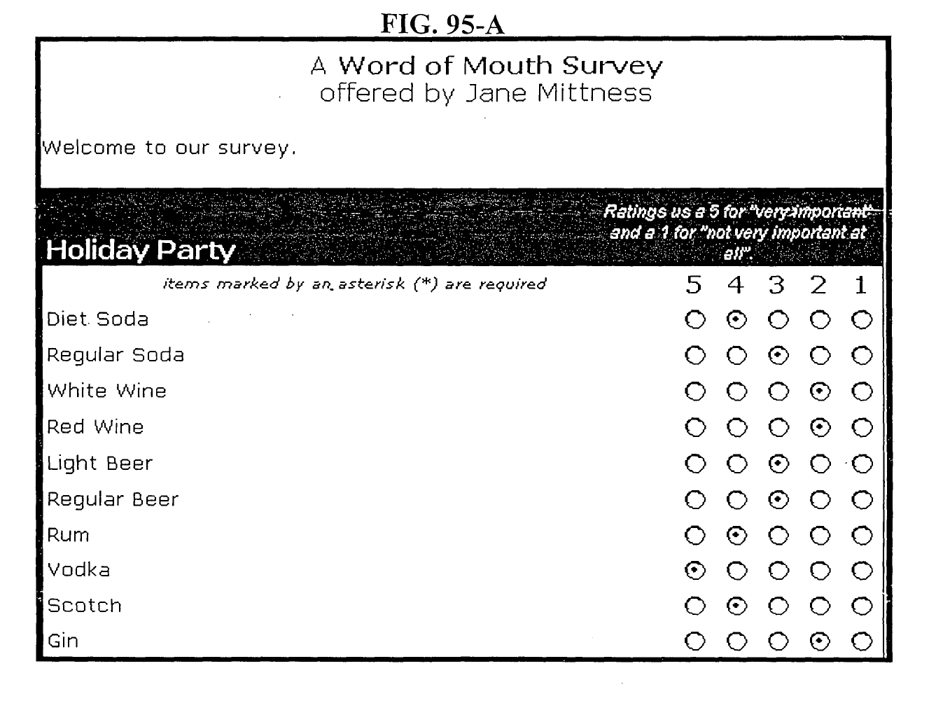

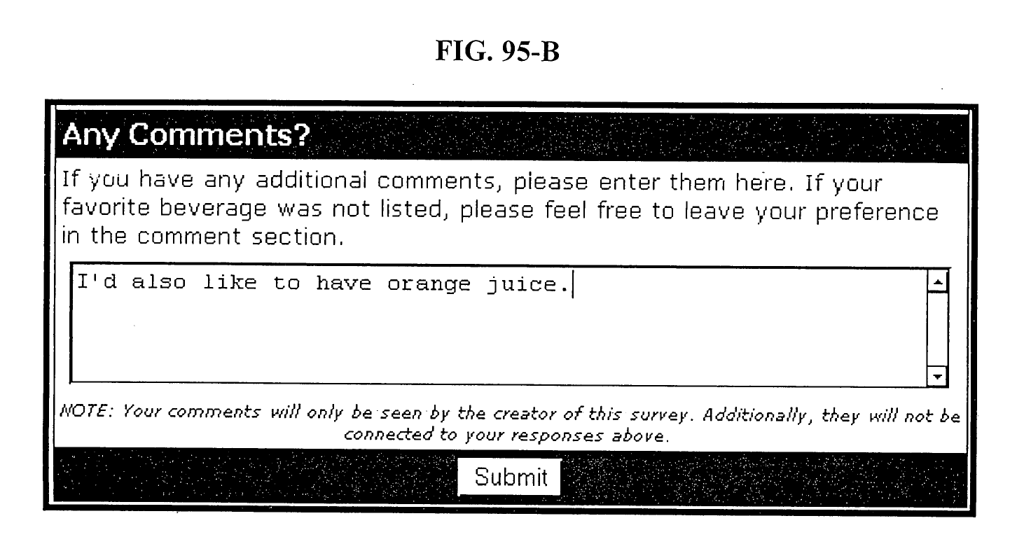

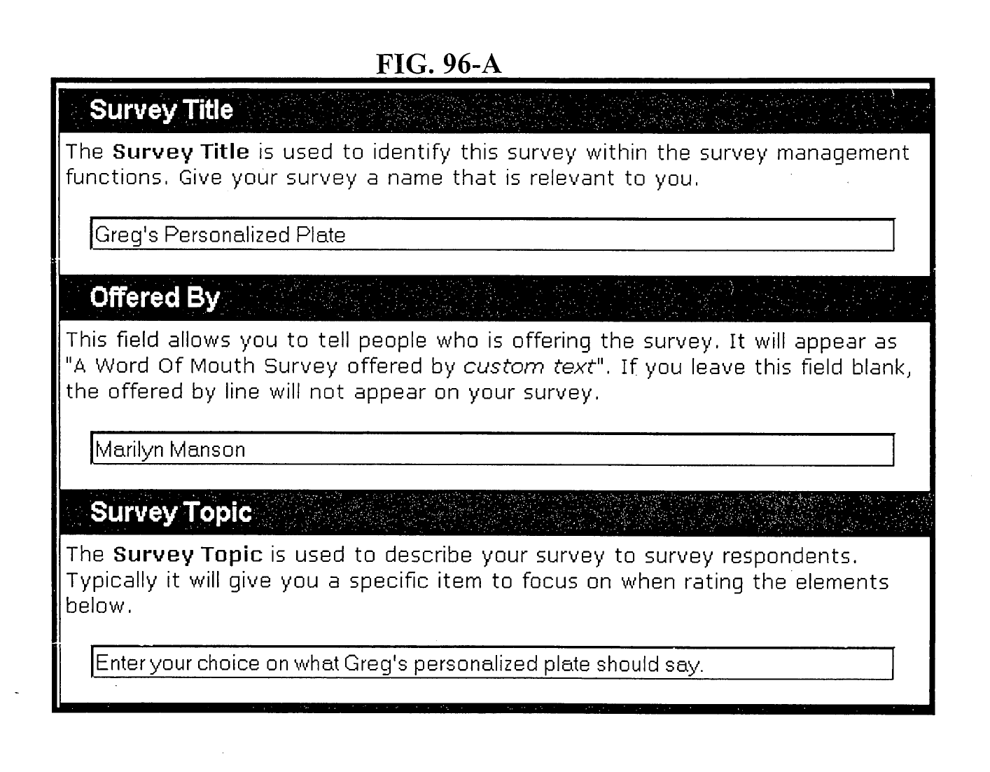

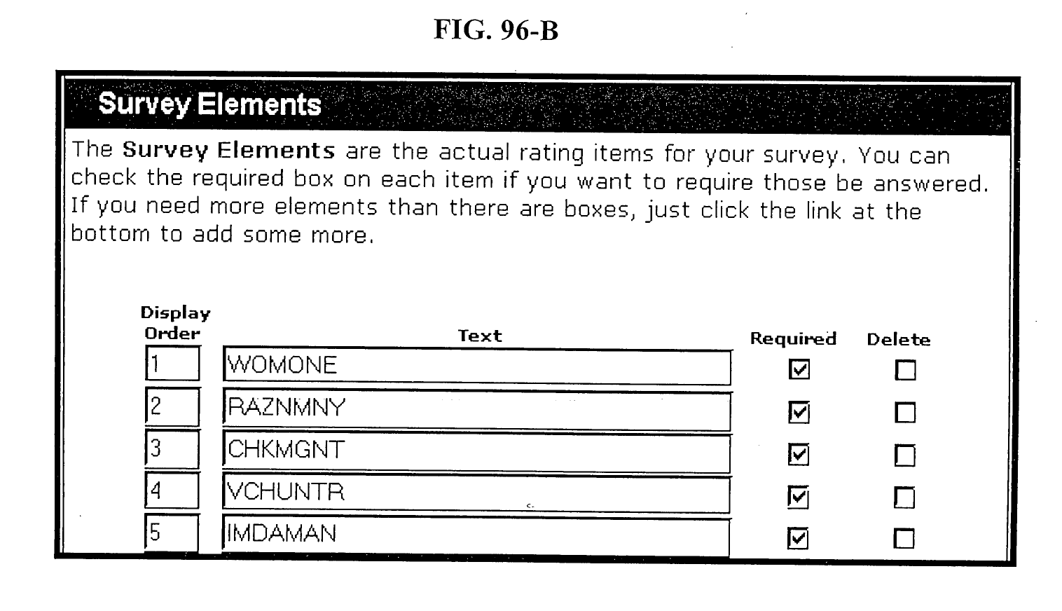

The following is a description of how to create and manage surveys with the Survey tool. FIGS. 95A-B shows an example survey of the type generated by the Survey tool. Note that it features word/term/item ratings similarly to the instant above-described system. To create a survey, from the Surveys home page, click a “Learn more” link in the center at such home page to get to a page with a short introduction that describes the process of creating a survey. When the user is finished, he/she clicks the “Create a Survey” button at the bottom of the page and gets a page returned like that shown in FIGS. 96A-B. The user fills out the four pictured fields: Survey Title, Offered by (the survey's author), Survey Topic and Survey Elements. In the Survey Topic field, the author types the question or statement to which the participants will respond. In the Survey Elements fields, the author types the items that the participants will rate. Each of the elements has a “required” checkbox next to it. If the author would like to require each user to rate a particular element, the “required” box should be checked. If the author will allow participants not to rate certain elements, the “required” box should remain unchecked for those elements.

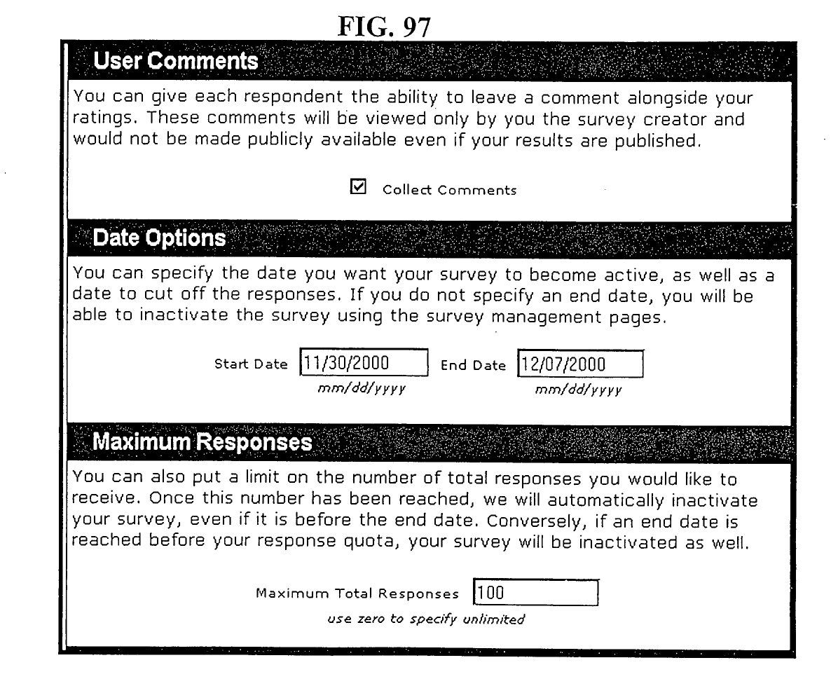

Ten fields for Survey elements are provided. If more are needed, the author clicks the “get more elements” link above the “Next” and “Cancel” buttons to get more fields. When all elements are complete, the author clicks the “Next” button and gets a screen like that of FIG. 97. In Step 2, the survey author will make the following determinations:

User Comments: Here, the author decides whether to allow the participant to leave a written comment after taking the survey. If so, the author checks the “Collect Comments” box. If not, the box is left blank. If the author chooses to collect comments, those comments will only be viewable by the author him/herself (not survey participants).

Date Options: In these fields, the author determines the start and end date of the survey. Participants will be permitted to take the survey between those dates only.

Maximum Responses: The author has the option of putting a limit on the number of responses to the survey. If he/she wants to limit the responses, the author types the maximum number in the field; if no limit is desired, he/she enters “0” in the field.

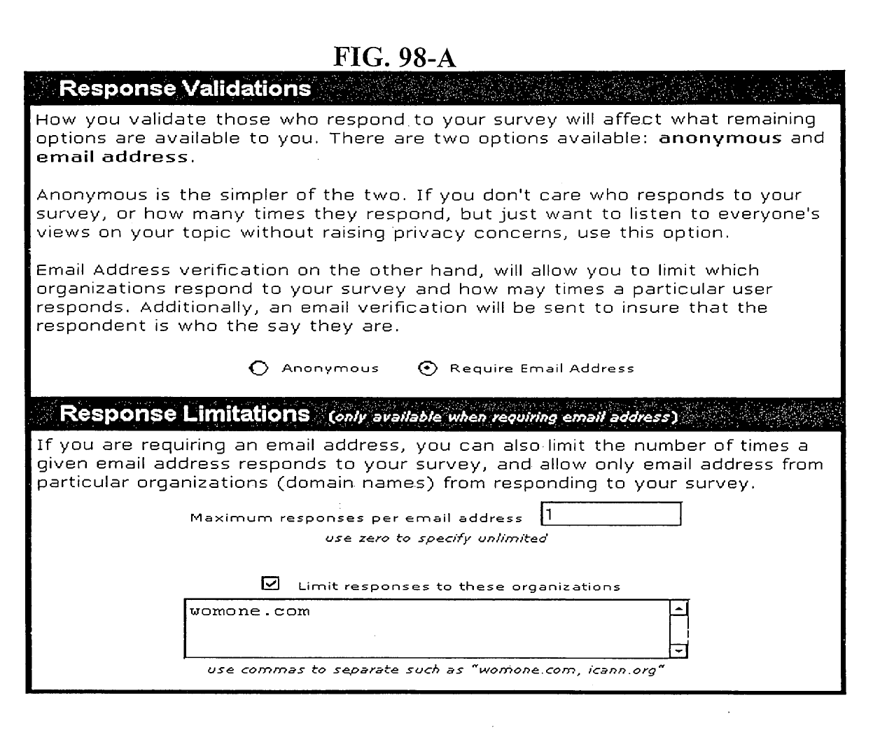

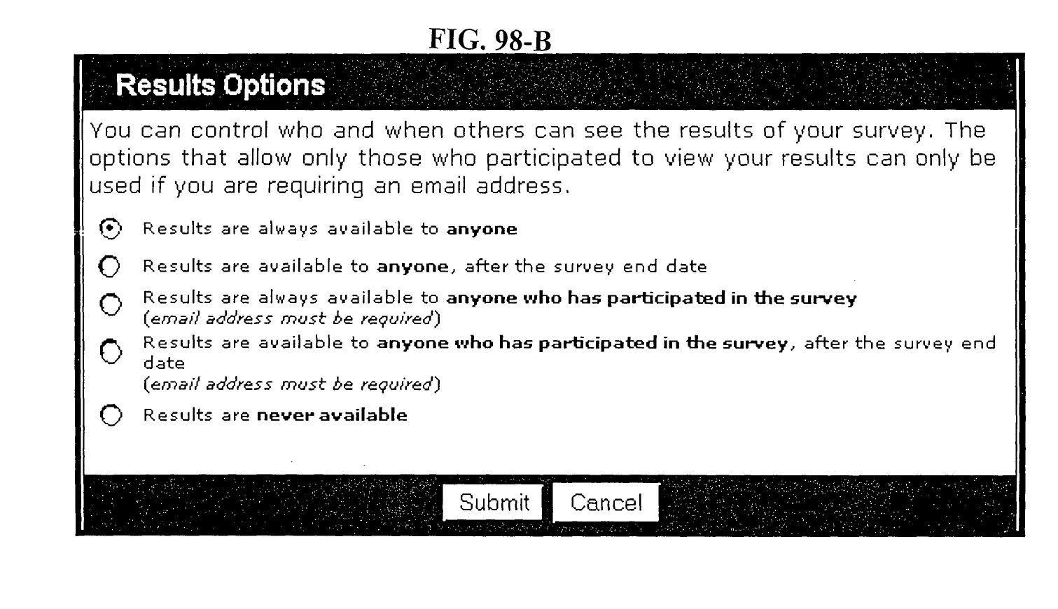

FIGS. 98A-B illustrate the bottom half of the Step 2 page:

Response Validations: The author may choose “Anonymous” or “Require Email address.” If the author doesn't care who responds to the survey and how many times a person responds, he/she clicks “Anonymous.” If the author would like to control who and how many times a user responds, “Require Email Address” must be selected.

Response Limitations: This is only available if “Require Email Address” is selected in the “Response Validations” field. In the “Maximum responses per e-mail address” field, the author types in the number of times a participant is allowed to respond to the survey. If the author would also like to restrict participation in this survey to people from a certain organization, he/she may do so by checking the box that reads “Limit responses to these organizations” and listing the domain names of those organizations (e.g., ibm.com, generalmills.com, etc.) in the box below it. If the author does not wish to restrict who may respond to the survey, the checkbox should be left unchecked, and the large text box should be ignored.

Results options: The survey author has five choices about who and when people may see the results:

Results are available to anyone at any time

Results are available to anyone after the survey ends

Results are always available to anyone who has participated in the survey

(Only available for surveys that require an email address for participation)

Results are available to anyone who has participated in survey after survey ends

(Only available for surveys that require an email address for participation)

Results are never available

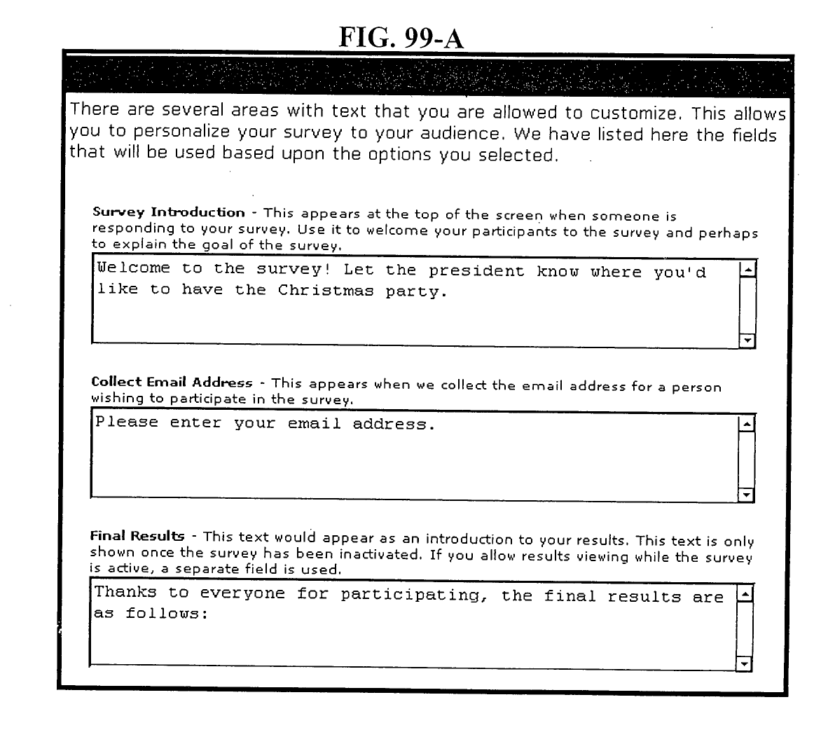

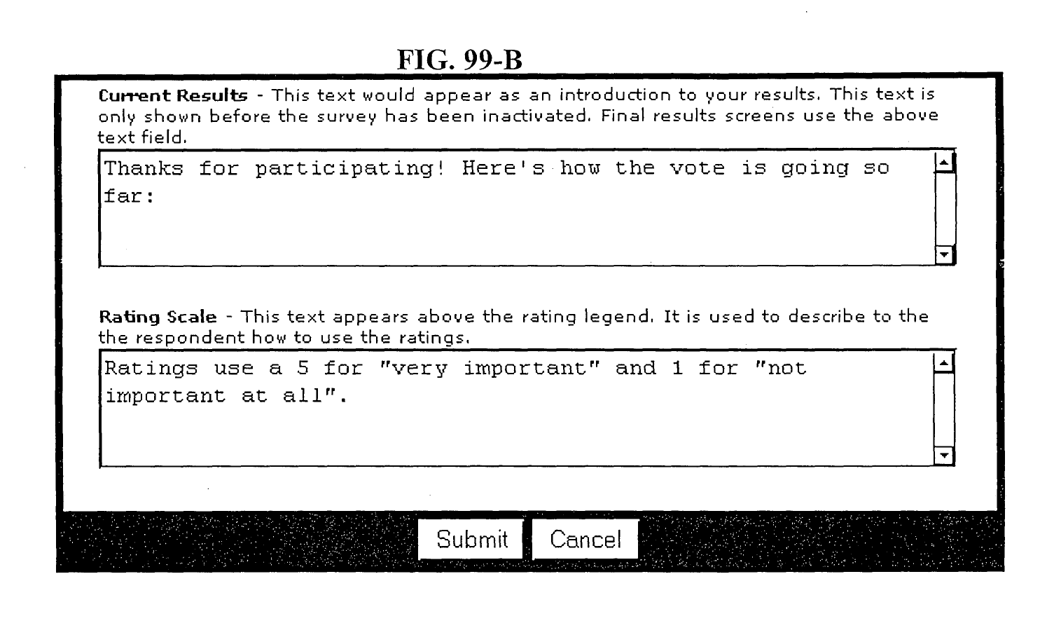

Once the author has selected all the variables on this page, he/she clicks “Next” for the final page of the survey creation process (illustrated by FIG. 99). On the final page of the survey creation process, the author adds customized text in these fields:

Survey Introduction: This short message welcomes your respondents and tells them how to proceed. Example: “Welcome! Tell us where you'd like to have the holiday party!”

Collect Email Address: This text instructs participants to instruct to enter their email address and (perhaps) explains why it is being collected. Example: “Enter your email address below (for tracking purposes only).”

Final Results: This text appears above the final results of the survey. Example: “Thanks for participating! This is how the results turned out.”

Current Results: This text appears above the current results that participants see before the survey has ended. Example: “Your vote has been counted. Here's how results are shaping up so far.”

Rating Scale: This is the text that will appear above the rating legend. It will explain to survey participants what the rating scale means, and how to choose accordingly. Example: “The rating scale varies from a 5 for “Very Important” to a 1 for “Not Important at all.”

Some remaining Custom Text fields are shown in the following illustration:

Comment Heading: This is the title that will display above the Comments box.

Example: “Leave Your Comments”

Comment Text: This is the introductory text that accompanies the Comments box. Example: “Something to say? Leave your comments in the box below.”

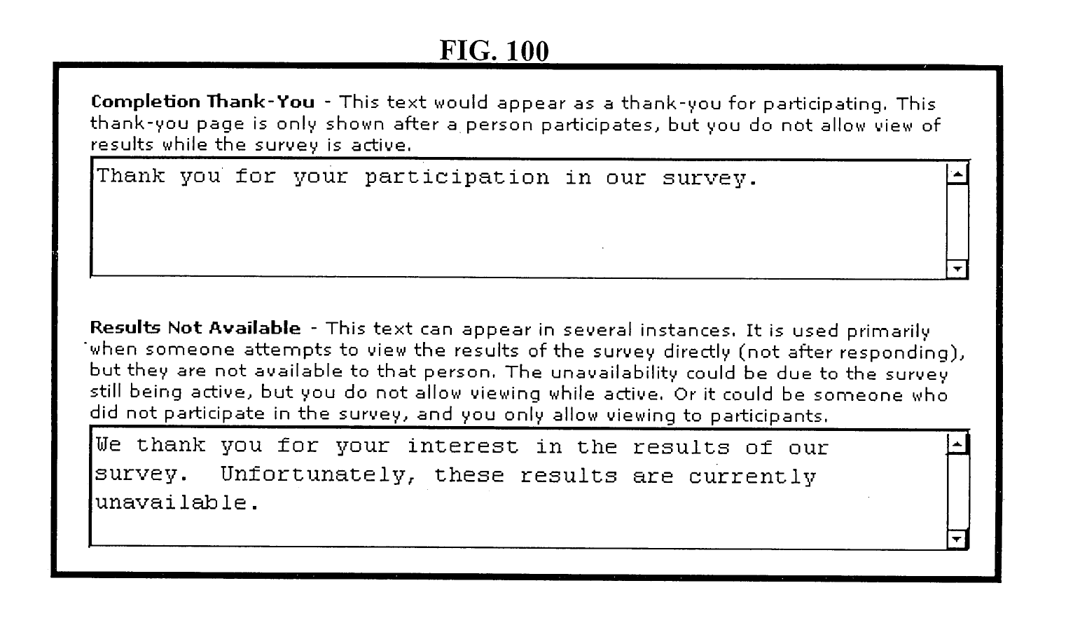

Note: When a survey is created that does not allow participants to see results until after the end date of the survey has passed, two more custom text fields appear as illustrated by FIG. 100:

“Completion Thank You”: In a survey where results may not be viewed until after the survey end date has passed, text entered in the Completion Thank You field will appear in place of the current results.

“Results Not Available.”: Text in the Results Not Available field appears when a participant clicks the Unique Results URL. It can also appear—if the author has specified that only participants may see the results—when someone who has not taken the survey tries to view the results.

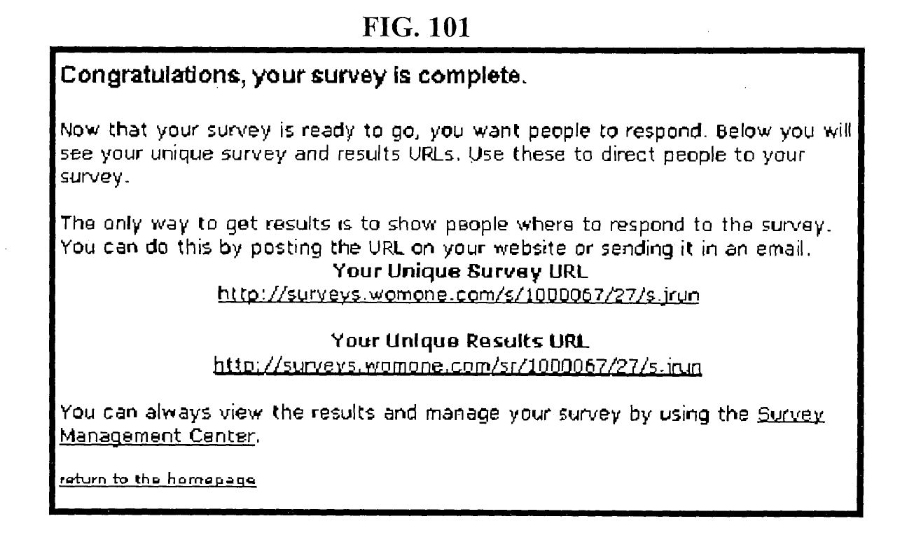

When the variables have all been selected, the survey can be created. If the author is a registered user and logged in, he/she will be taken right to the “Congratulations” page as illustrated by FIG. 101. If the author is creating his/her first survey and is not yet a registered user—or if the author is a repeat user and simply has not logged in—he/she will receive a prompt to register/log in. Authors who already registered users can type in their username and password in the appropriate fields and then click “Login.” Those who are not yet registered must click the “Sign up” button after which they will go to a sign-up screen. After filling out the fields, the new author clicks “Submit” and is taken to the “Congratulations” page (FIG. 101). On this screen are the two important URLs that the program generates. The first URL is “Your Unique Survey URL.” This is the URL that the author sends to participants so they can take the survey, and uses to link the survey from any Web page. The second URL is the “Your Unique Results URL.” This is the URL that holds the current results to the survey. If the survey is no longer open (if the end date has passed), the final results can be found at this URL. If the survey hasn't yet begun, a screen saying the results are unavailable will return. In the sentence below the unique results URL is a link to the Survey Management Center—the area where the author can review and manage this survey. Here may be found a summary of the Survey: its title, author, topic, elements, Survey URL and Results URL. To make changes to any of the text, the author clicks the “Edit” link to the right of the survey title and gets a page where the author can change the Survey title, author name, topic and elements. Elements can also be deleted from this screen, and the “required” status for each element can be changed. When all of the appropriate changes are made, the author scrolls to the bottom of the page and clicks the “Next” button and returns to the Survey Management Center page, which contains all the current settings for a survey, and links to areas where those settings may be viewed and changed. Under an “Actions” heading, the author can click the View Comments link to see a list of all the comments participants have left. Preferably, three other links under “Actions”—“Refresh Count,” “Close Survey” and “Delete Survey”—are ways that the author can update the Survey. “Refresh Count” collects the most recent results of the Survey. “Close Survey” closes it, and “Delete Survey” deletes the survey. After performing each of these actions, the author may preferably use additional provided screens to do custom editing, etc.

Finally, an author may, at some point, wish to make changes to his/her account and billing information and view the history of the account. He/she may do so using the User Profile Manager. Clicking the “User Profile” link in the green navigation bar at the top of any page, the user is taken to a page showing the author's current account information: username, account number, email address, physical address, phone number and credit card information. To change anything under the Account Information heading, the author simply clicks “edit” modes at appropriate headings text at the right of that heading.

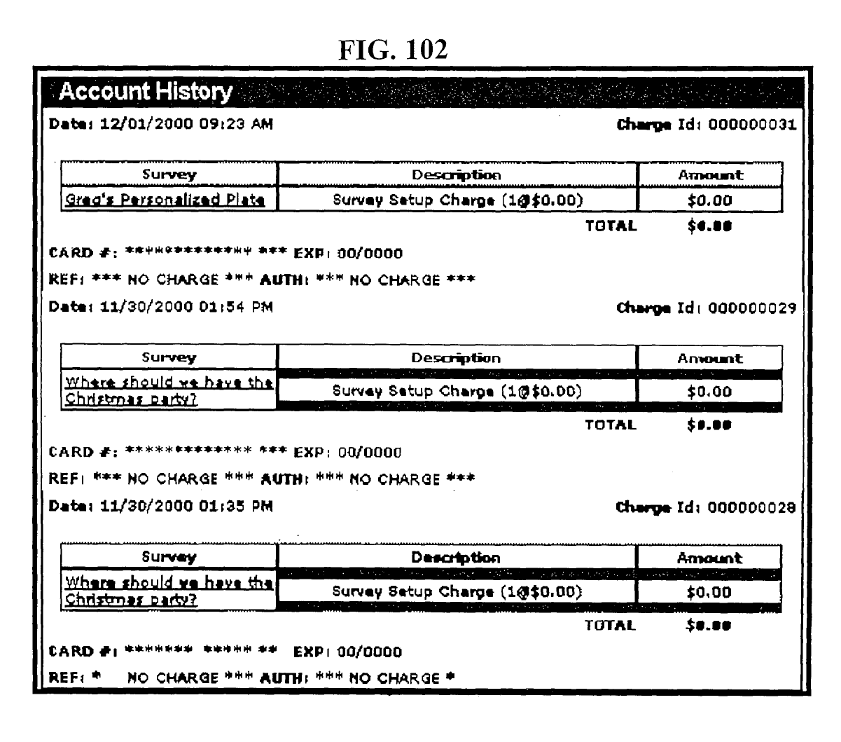

The main Survey Management Center page preferably has a “User Account History” link that takes the author to a page with detailed information about all surveys the author has performed, in addition to the billing information associated with them. An example of the User Account History page is shown by FIG. 102. The Account History page shows each Survey created by the author, the charges for each and a description of those charges. It also shows the date and time each survey was created, the credit card each to which each survey was charged, and the reference and authorization numbers for each.

Second Described Preferred System Details

According to a second described preferred embodiment of the present invention, a method and system (software) is described for creating and maintaining a database of subject material primarily related to sales and sales related activities, knowledge and success stories. Additionally, in a second described preferred embodiment of the present invention users are provided the opportunity to search the database and to identify subject matter relevant to the user's needs either through a key word search or category browsing. Additionally, users may preferably search for experts with particular knowledge relevant to their needs. Users may also search for and review success stories. When users cannot find required knowledge they may also submit questions which will be answered by designated experts. Additionally all questions and related answers are added to the database and become additional subject matter available for search and review.

It is especially noted that, in order to help sell such systems, the developer, in the software system design, should preferably limit the operator's labor of management and other responsibilities. The instant system, in the specific manners described herein, is a second described preferred embodiment of such a system, needing essentially no operator management—the software itself motivates and rewards the user community sufficiently to keep them doing the sorts of duties otherwise befalling an operator.

Second Described Preferred System Operational Overview

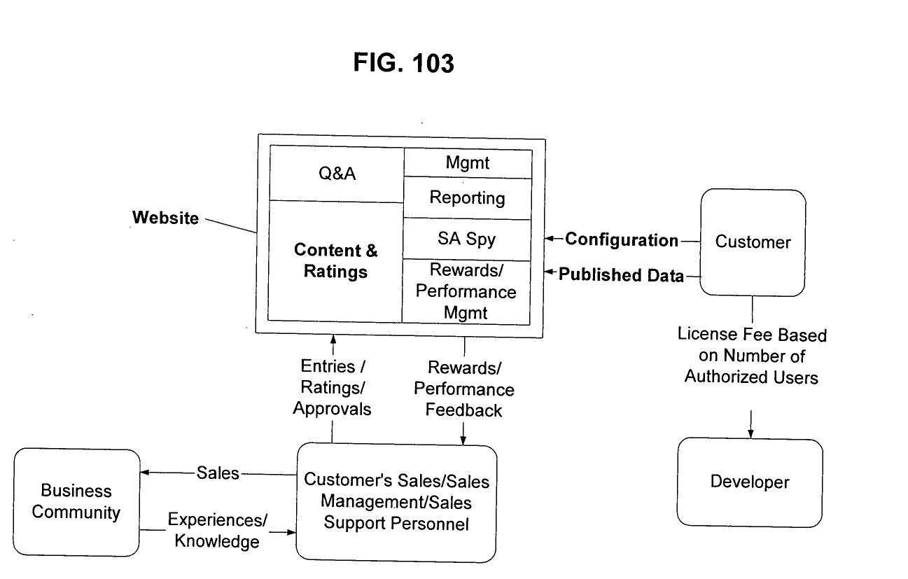

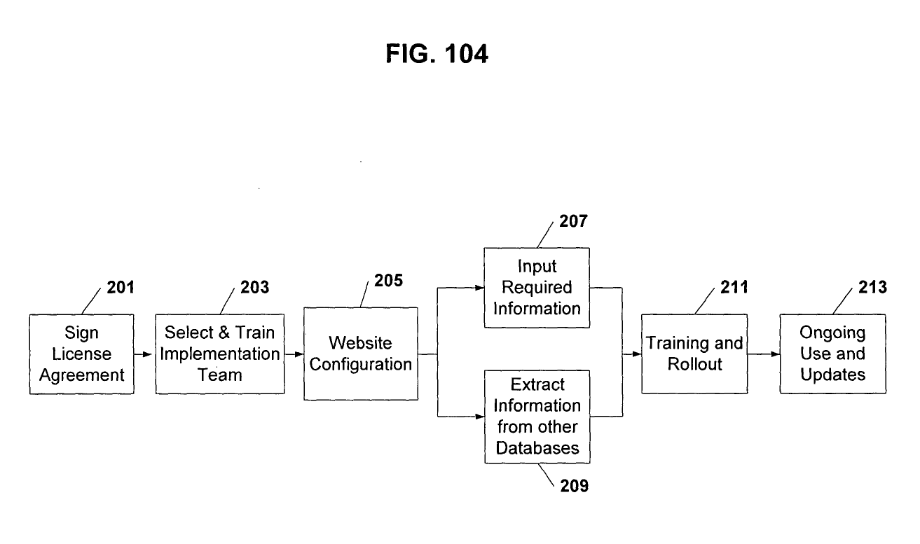

In a second described preferred embodiment of the present invention, the preferred business methods and operational processes are functionally demonstrated by FIG. 103 and FIG. 104.

Referring to FIG. 103, the Website preferably comprises components and associated programming of: Questions and Answers, Content & Ratings (of usefulness in one ore more steps of a licensee defined sales cycle), Management, Reporting, SA Spy and Rewards/Performance Management. As shown, many differences between the prior art and the second described preferred embodiment of the present invention are present. The Website interaction between the User Community (typically sales and sales related personnel) and the Website comprises not only rewards, but also performance feedback with regard to usage and contribution levels. Preferably, in addition to the Entries inputted by Users the Website accepts content through interface software from Customer's various existing systems, providing users a much broader and deeper set of Content available in a single database.

The User Community may also obtain required information through the Question and Answer process which provides methods for experts to respond to questions posed by Users and make the questions and responses available to the User Community in the same manner as all other Entries. Additionally, Users may request automatic desktop notification of new Entries in their areas of interest through configuration and installation of the SA Spy module. A variety of reports are also available to the User Community which provide summary information and permit “drill down” to successively greater levels of detail. Also, the User Community now provides to the Website not merely Entries and Overall Ratings, but instead Entries, Usefulness Ratings and where in the sales cycle the Entry is most useful. Some key features in the second described preferred embodiment of the present invention are that the Website essentially does not require Management by a Developer/Operator/Site Manager and that the software of the Website performs management functions substantially automatically. Also, the Website substantially automatically interacts with the User Community to establish and maintain breadth, quality and currency of the Content.

Preferably Customers license the web site software from the developer based on the expected number of persons who will be granted access.

Referring to FIG. 104, a preferred typical implementation process is shown. After deciding to use the website software to improve and support the Customer's sales effort, the first step for the Customer is sign the licensing agreement 201 for use of the website software. Preferably, the website software may be installed on Customer's website servers or operated from Developer's website servers. While pricing for the two options differs the website software functions in the same manner. Preferably, once the license agreement is signed Developer works with the Customer to select and train the implementation team 203. In the site configuration step 205, preferably the Customer's implementation team works with the other members of the Customer's sales, sales management, sales support, product management and other groups within the Customer's organization to define categories of information, any information which may be available from existing databases and how best to convert it for use in the website databases, identify the website users and their levels of responsibility. When the implementation team has completed the configuration step 205, the next two steps, Input Required Information 207 and Extract Information from other Databases 209, are preferably undertaken substantially in parallel. In the Input Required Information 207 step the implementation team requests selected groups of Users to begin adding content in their particular areas of expertise. The implementation team may establish special incentives and rewards to encourage active and timely participation in the initial content entry work. At the same time, preferably Customer software personnel will be implementing interface processes for both one-time and ongoing extracts for data from existing databases for inclusion in the Website database.

Preferably, when the Input Required Information 207 and Extract Information from other Databases 209 steps are completed the implementation team begins the Rollout and Training 211 step to introduce the website to the remaining members of the Customer's sales, sales management, sales support, product management and other groups within the Customer's organization who will make up the user community. This step preferably follows completion the Input Required Information 207 and Extract Information from other Databases 209 steps because it is critical that a significant amount of content is available before general usage. A significant amount of useful content initially encourages Users to access the website frequently and then to continue to update and maintain the quality and depth of the content.

Preferably, the final step is Ongoing Use and Updates 213 of the website database. Users are encouraged to submit new content, rate the usefulness of existing content, attach documents or point to attachments, and to actively use the website database as their source of information. Customer management may also preferably use Rewards and Performance Management to encourage participation and direct it to areas most useful to the Customer.

Second Described Preferred System Screens and Operation Details

Login

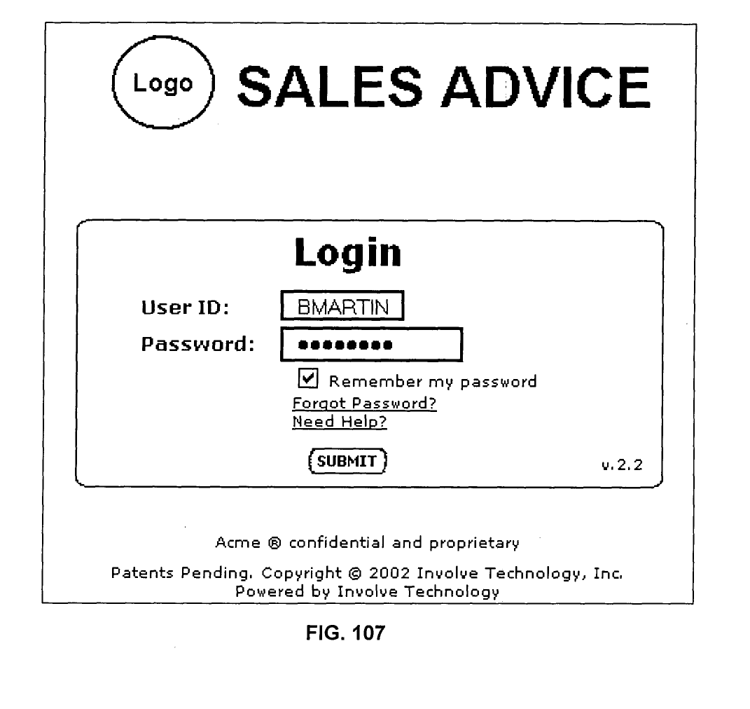

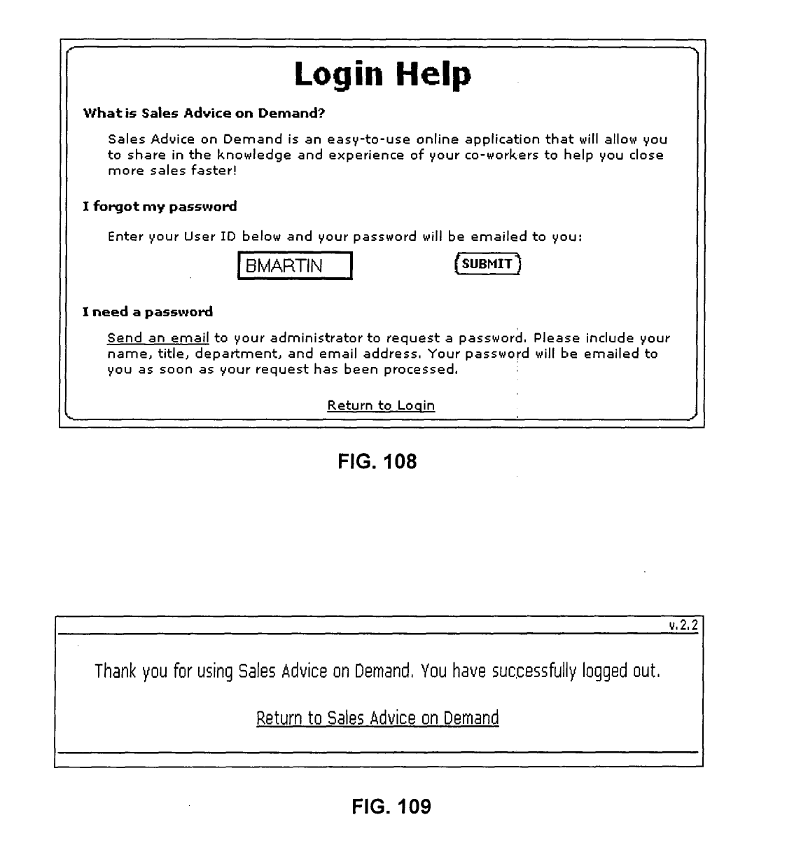

In a second described preferred embodiment of the present invention, the preferred login process is functionally demonstrated by FIG. 107, FIG. 108, and FIG. 109 where each user of the system is preferably required to login using an assigned ID and password to gain access to the system. As shown in FIG. 107, preferably each user must provide their user id and password to gain access to the database. The methods by which users may obtain their forgotten password are shown. Upon request the website software will automatically generate an email to the email address on file for the user. On logout, each user is presented with a confirmation of being logged out, as presented in FIG. 109.

Home Page

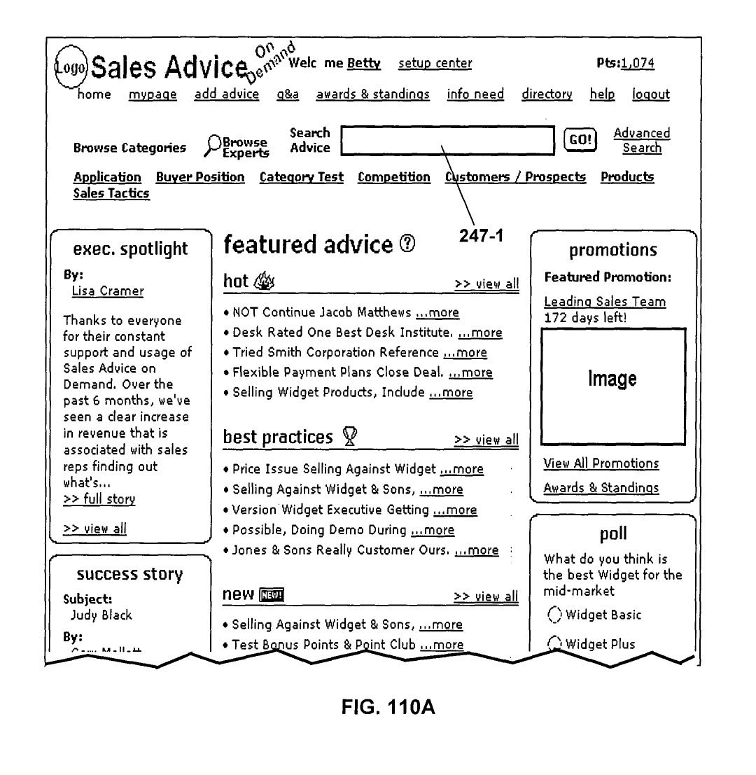

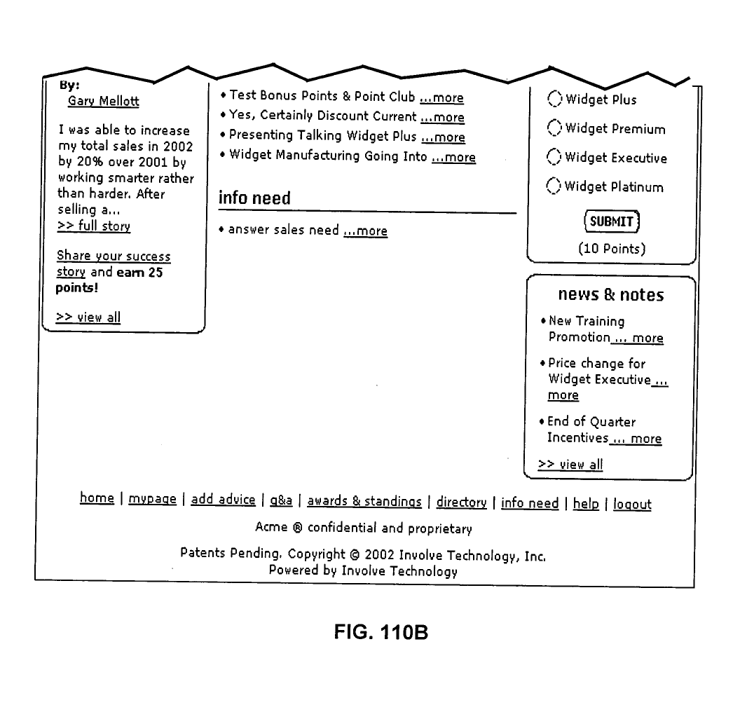

In a second described preferred embodiment of the present invention, after login each user is preferably taken to the Home Page similar to that illustrated in FIG. 110A and FIG. 110B. From the Home Page the user may preferably access all the other functions of the system to which the user has been granted permission. Additionally, the user may preferably begin a search of the database using either a keyword search using the entry box 209-1. Additionally, the user may preferably search the database for a subject using one of the displayed categories, for example as shown: “Application”, “Buyer Position”, “Competition”, “Customers/Prospects”, “Products” or “Sales Tactics”. As will be discussed later, each of these categories may be defined by the licensee to best fit their needs. Preferably, selecting “Browse Experts” allows the user to quickly find a person with the required expertise.

The Home Page preferably also presents selected key information to the user. Preferably, this information may include: Executive Spotlight, Promotions, Success Stories, a poll of user if desired by licensee, and News and Notes. Additionally, key subjects may be highlighted as either “Hot” (very current information of interest to most users), “Best Practices” (actions and information proven to be successful), “New” (subjects recently added to the database) or “Info Need” (recent requests for information and related responses from the Q&A process). More details on each of these areas may be viewed by selecting the indicated text link (underlined word or phrase).

Search

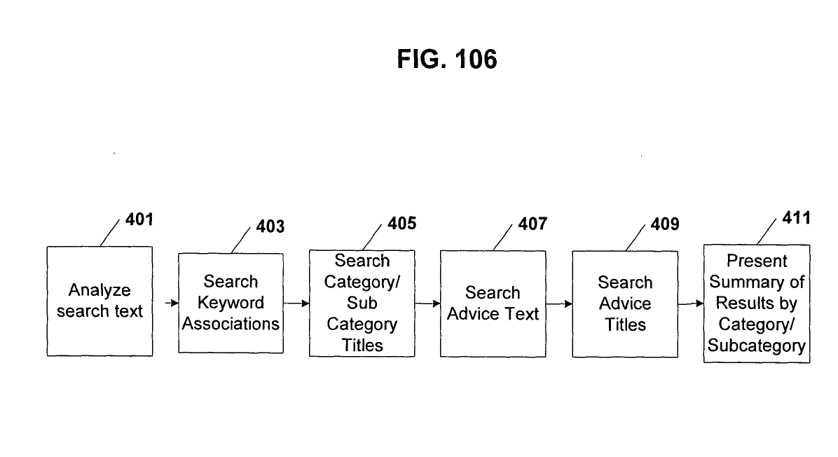

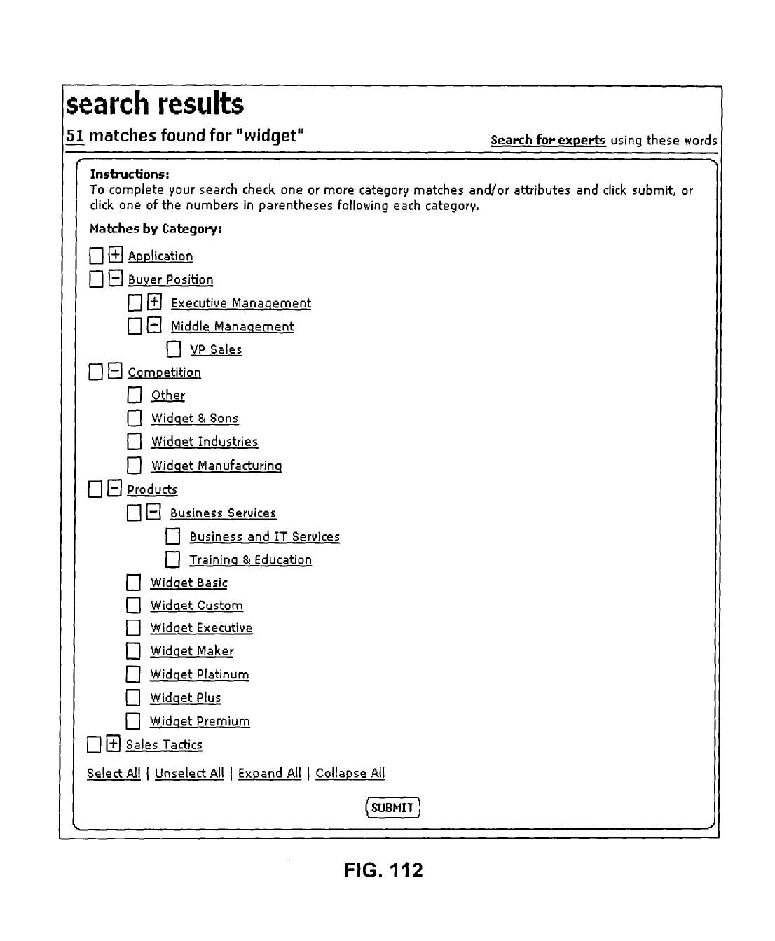

In a second described preferred embodiment of the present invention, after login each user may preferably access the database by searching for subjects by keyword or a predefined category. Although not shown in most figures, preferably each screen of the system provides the opportunity for a user to search by either method or to browse for an expert. When searching by keyword several areas of the database are searched to identify all possible matches for the selected keyword. As illustrated in FIG. 106, in the first step Analyze Search Text 401 the keyword search routines first remove any common words such as “the”, “an” and other words that occur commonly in everyday language and common words used in the licensee's environment as defined as part of system configuration. Additionally, the search routines identify root words where plurals and other variations of the search words have been used. The resulting search words or phrases are then used to search keywords associated with the subject entries in the next step Search Keyword Associations 403. Each entry associated with a matched keyword will be displayed on the results list. In the next step, Search Category/Sub-category Titles 405, the search routines search the text of all category and sub-category titles for search word matches. All entries associated with any matched category/sub-category titles are also added to the results list. Next, the search routines evaluate any potential matches the complete text of each advice entry in the step Search Advice Text 407, again all matches are added to the results list. In the final search step, Search Advice Titles 409 the routines evaluate all advice titles for possible matches with the search text and add matched advice entries to the results list. Finally, when all search steps are complete the results list is presented to the user in step 411. An example of the search results list is illustrated in FIG. 112.

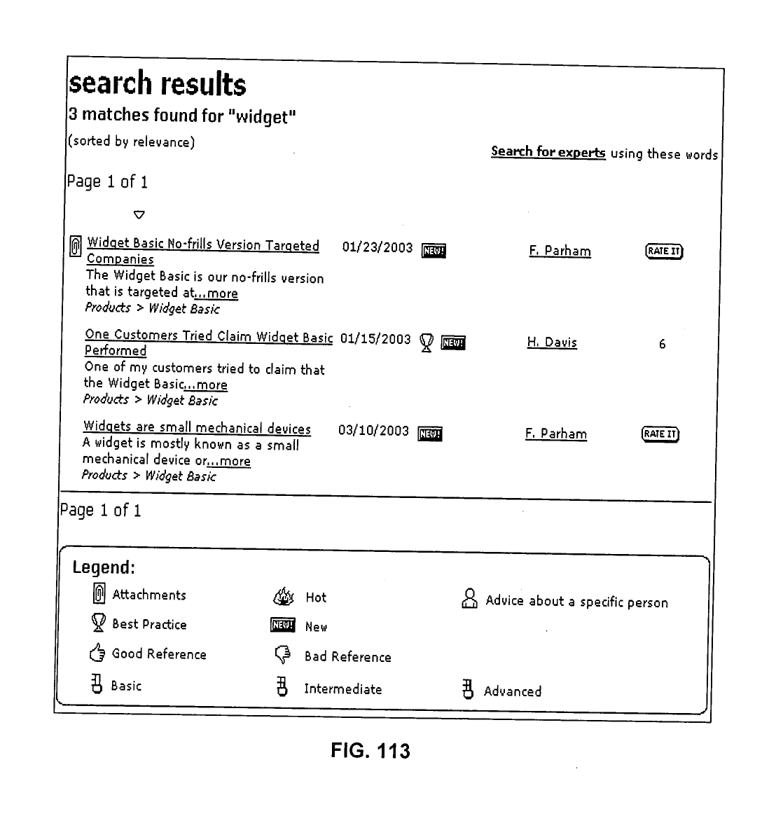

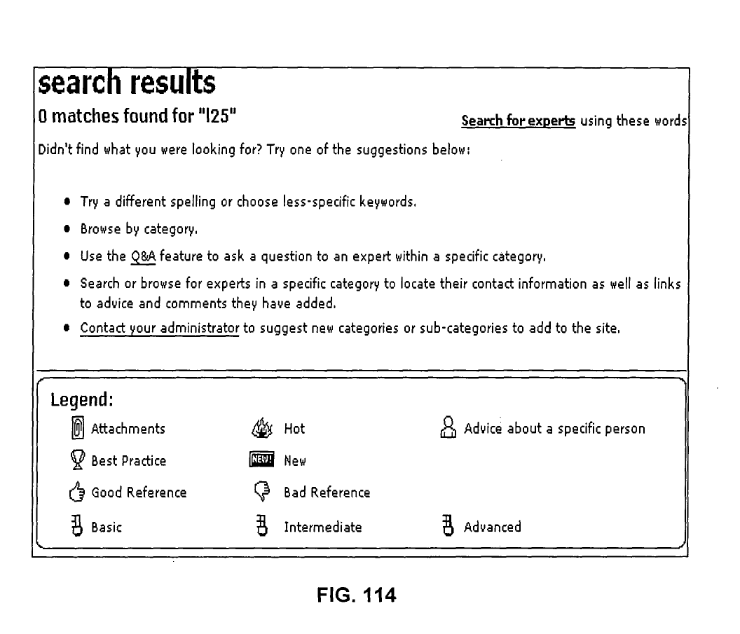

Preferably, after selecting a keyword such as “widget” the user may preferably further filter the search result by selecting one or more of the categories or sub-categories where relevant subject entries were found. The preferred keyword search result category filtering mechanism is illustrated in FIG. 112. When subjects are found matching the criteria used in either search method they are preferably displayed as shown in FIG. 113. When no subjects are found matching the criteria used in either search method they are preferably displayed as shown in FIG. 114 which provides suggestions to users as to how to improve their search results.

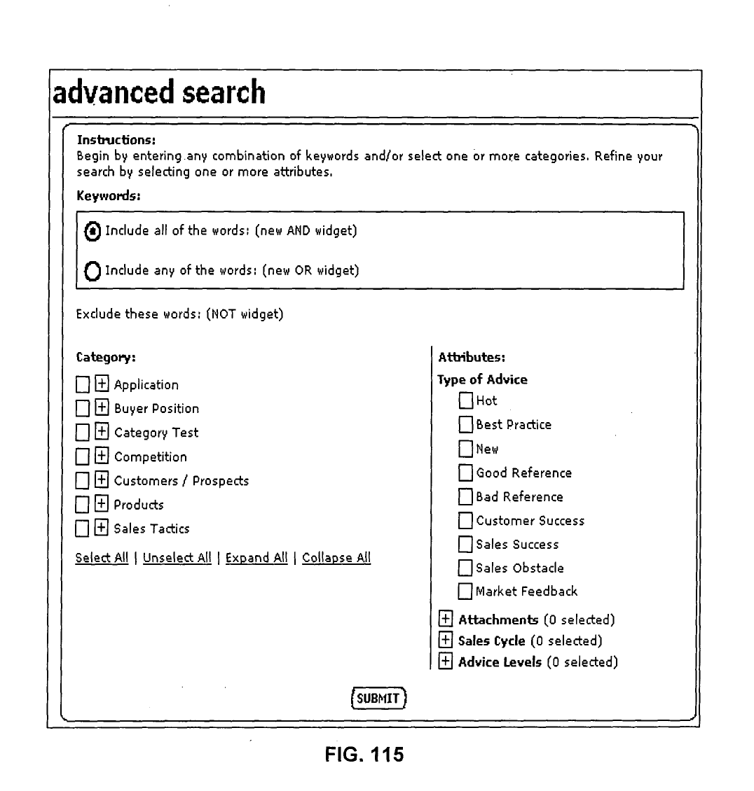

Additional preferred filtering may also be used if the results are excessive or are too broad. The user may choose to use Advanced Search to narrow search results using categories and sub-categories, and/or type of advice (content), attachments, sales cycle, or advice level. The preferred functionality for this is shown in FIG. 115.

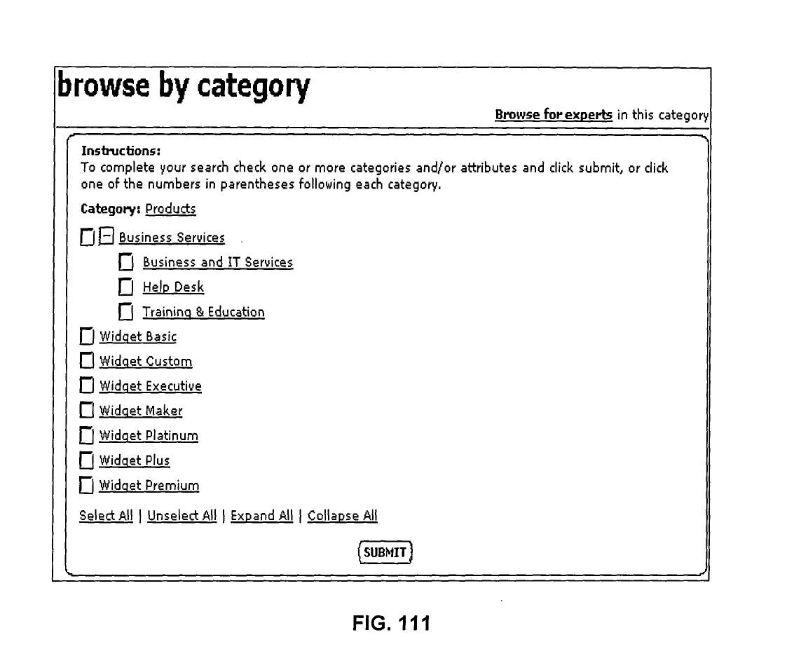

Preferably, after selecting a category the user may further filter the search result by selecting one or more sub-categories which most relevant to the user's area of interest as. The preferred browse by category filtering functionality is illustrated in FIG. 111.

Preferably, regardless of search method used, users are presented with a list of subjects matching the search criteria, ordered based on relevancy to the search criteria. An example of the search results list is provided in FIG. 113. As with all other text links, each list entry may be selected by a user to view the details of the subject. The specific content of each subject entry will be discussed later.

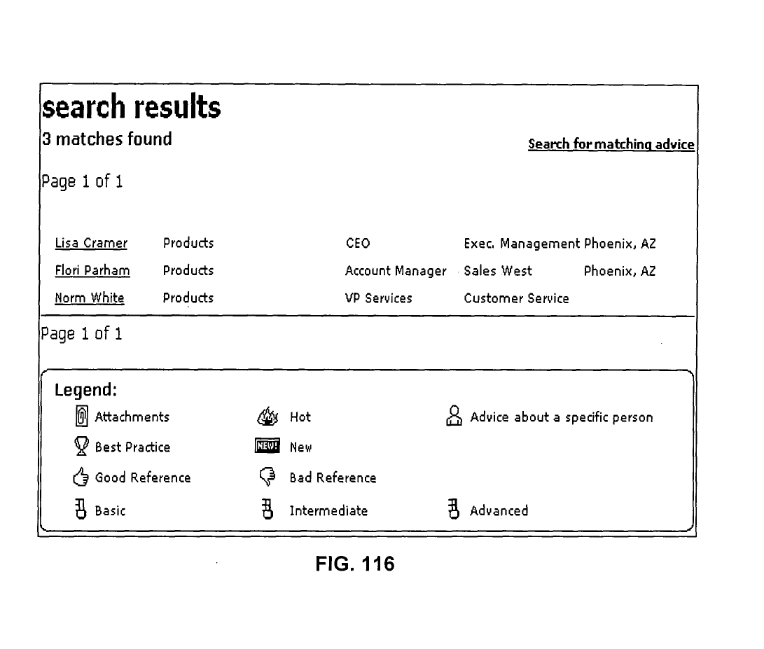

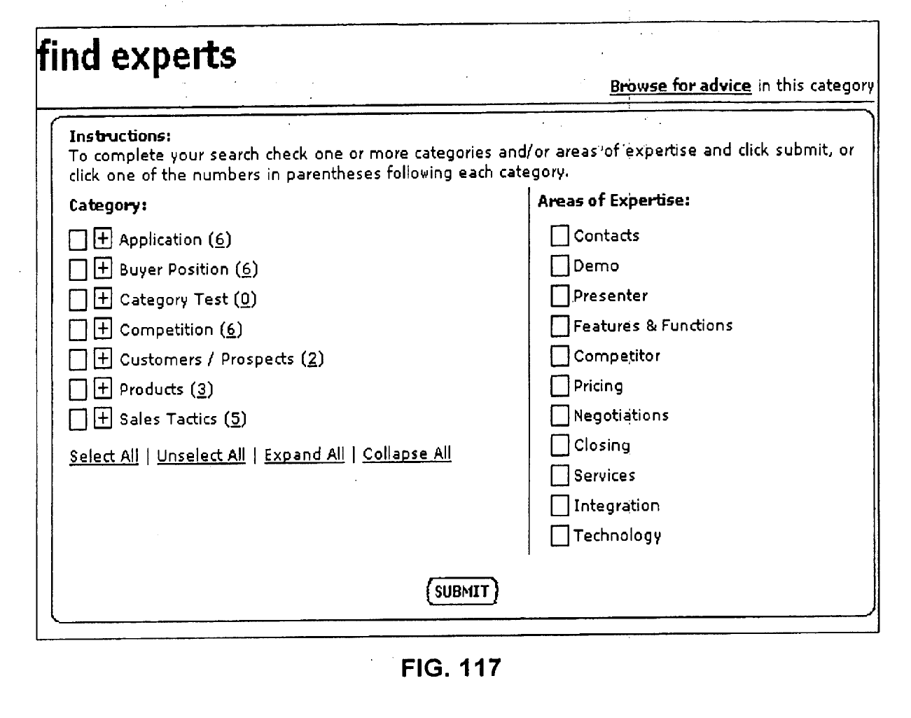

Preferably users may also search for experts when support is needed that cannot be found through review of database entries. Selecting the “Browse Experts” link takes the user to the Find Experts screen as shown in FIG. 117. Here users may select criteria to narrow the search to experts in the areas of interest. Preferably the search may be narrowed by subject categories and sub-categories and/or by categories of expertise, such as demos, presentations or feature/product comparisons and so on as shown. The preferred presentation of the search results is shown in FIG. 116. Selecting the text link for any of the experts displayed on the Search Results screen will provide users access to the expert's profile which describes their areas of expertise in more detail, and which includes contact information.

View Advice/Comments/Ratings

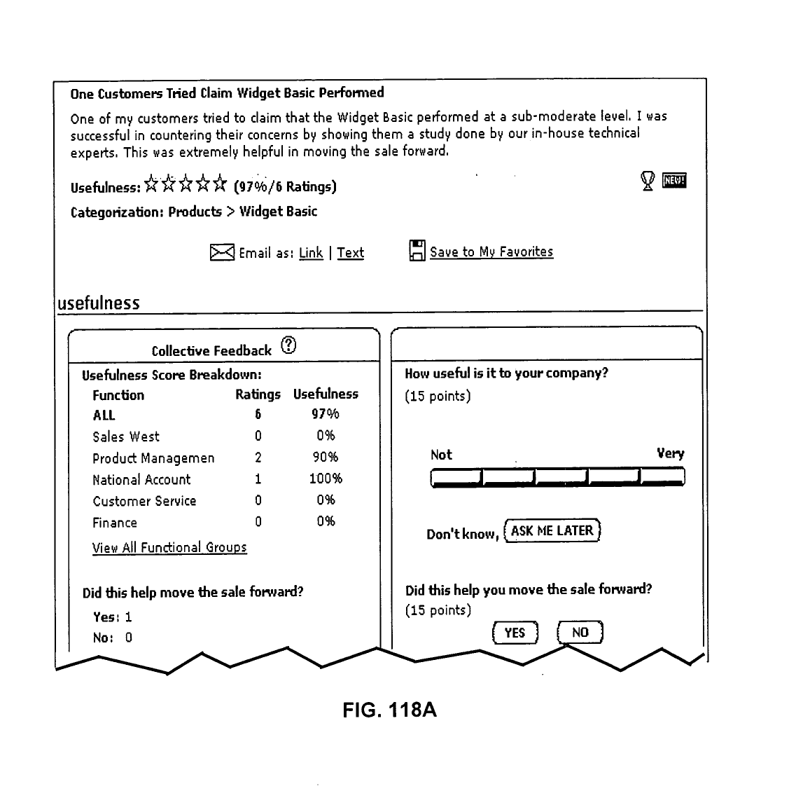

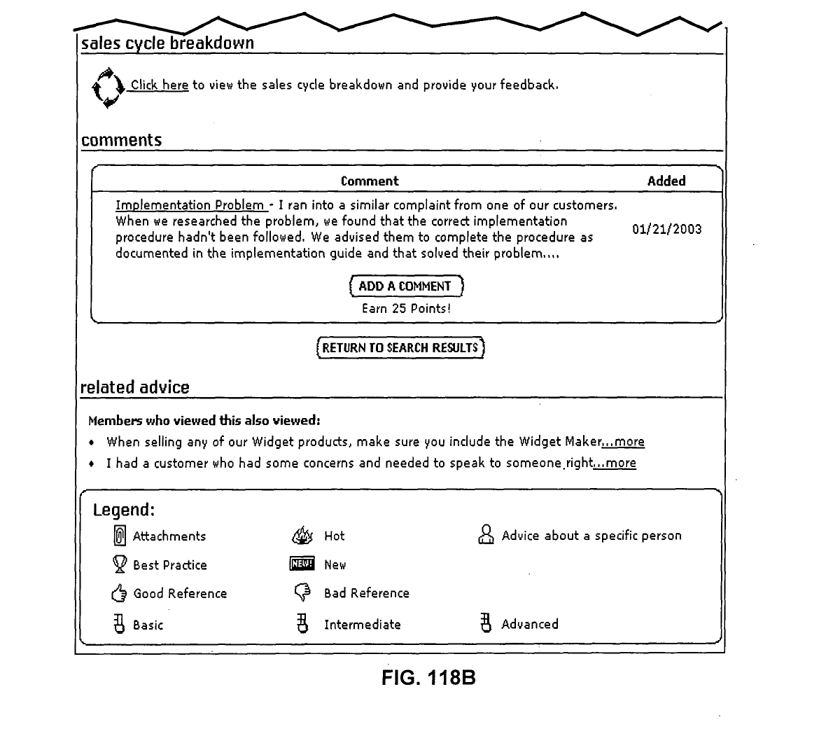

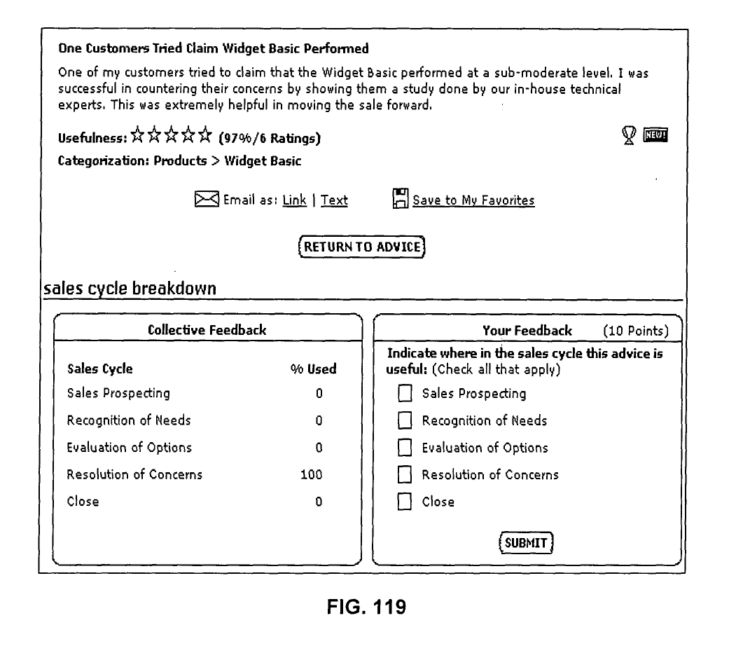

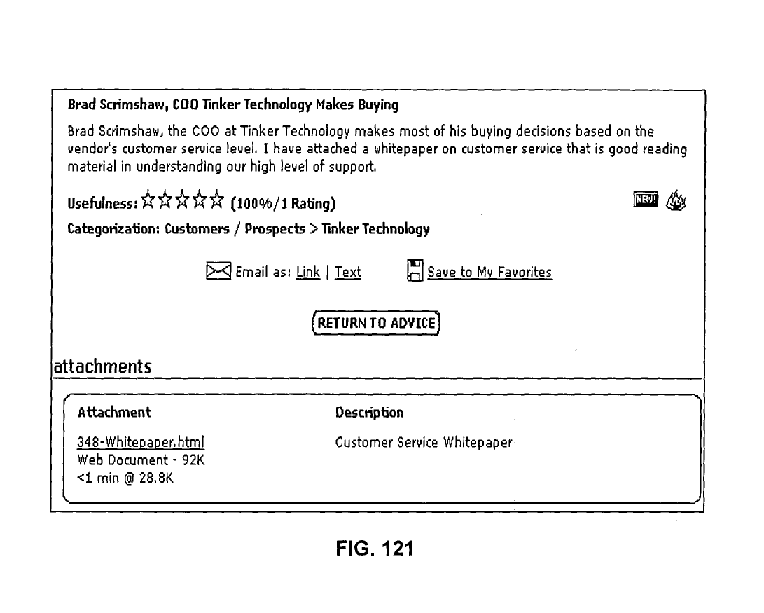

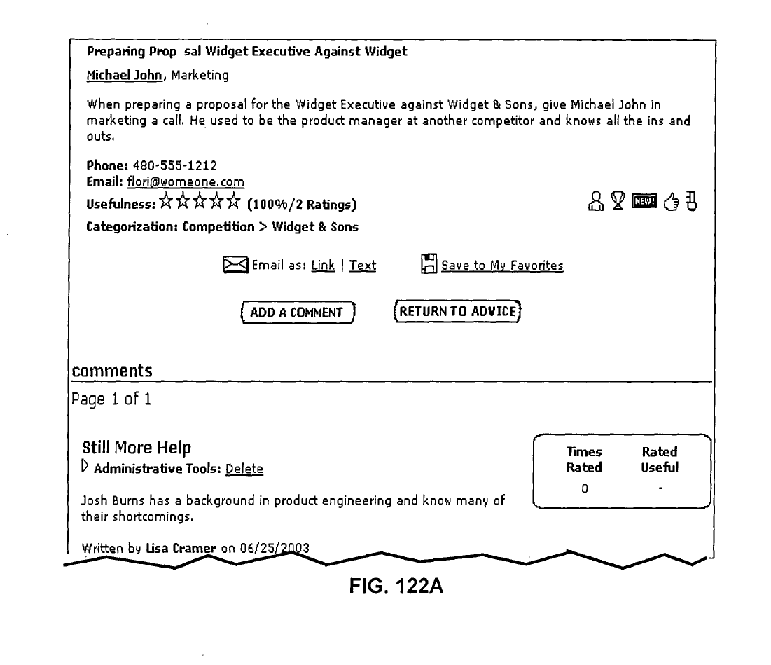

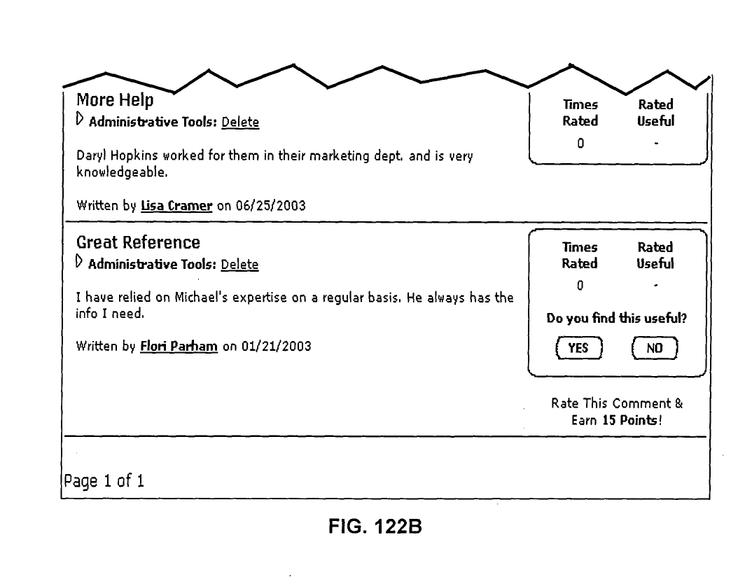

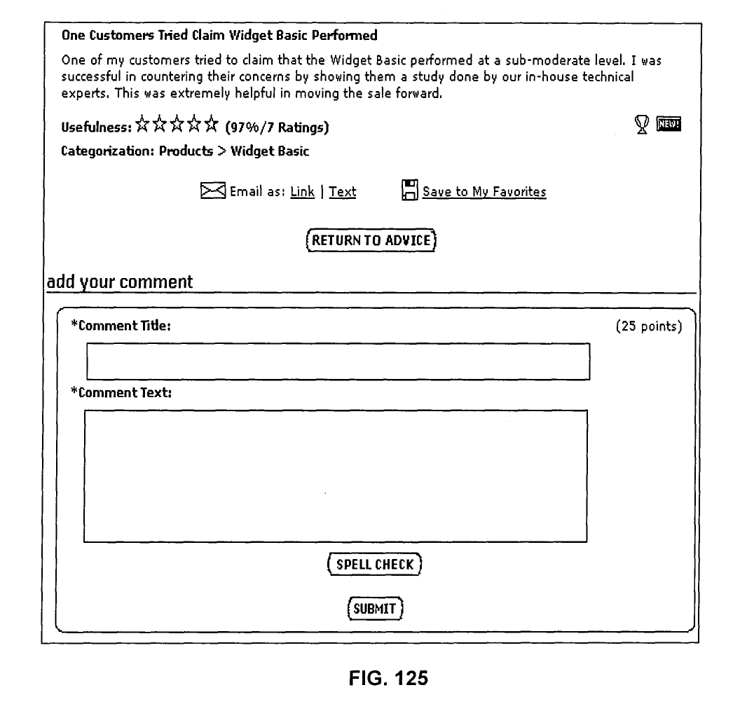

In a second described preferred embodiment of the present invention, preferably when users select an entry displayed on the search results, as shown in FIG. 113, the subject detail information is displayed on a primary screen, as illustrated in FIG. 118A and FIG. 118B. this primary page preferably also provide summary information about a variety of attributes associated with a particular entry. These attributes may preferably include: Categorization, Overall Usefulness Ratings, Sales Cycle usefulness, associated comments, related advice, and attachments. For example, the user may preferably choose to view information regarding in which step of the sales the subject has been most been most useful by preferably selecting the “click here” text link under the sale cycle breakdown heading. Preferably the sales cycle usefulness breakdown information is presented to the user in a manner as shown in FIG. 119. While on this screen preferably users may indicate in which step of the sales cycle they found the information most useful. Checking the applicable boxes and selecting “Submit” will result in each user's feedback being accumulated in the summary totals presented on the left. After providing sales cycle feedback the user is presented with a confirmation screen. A user may also choose to review specific types of documents or other relevant information which are related to the subject by selecting View Attachments. The presentation of this information is presented in FIG. 121. Additionally, users may preferably view comments submitted by other users about any subject in the database by selecting the text link for any visible single comment displayed on the primary subject screen, as shown in FIG. 118B. A preferred presentation of user submitted comments associated with a particular subject is illustrated by FIG. 122A and FIG. 122B. Users may also add their own comments about a particular subject and rate the subject by selecting “Add A Comment”. The preferred process is illustrated in FIG. 125. Each time users view comments they are preferably given the opportunity to rate the usefulness of the comments and illustrated in FIG. 122B.

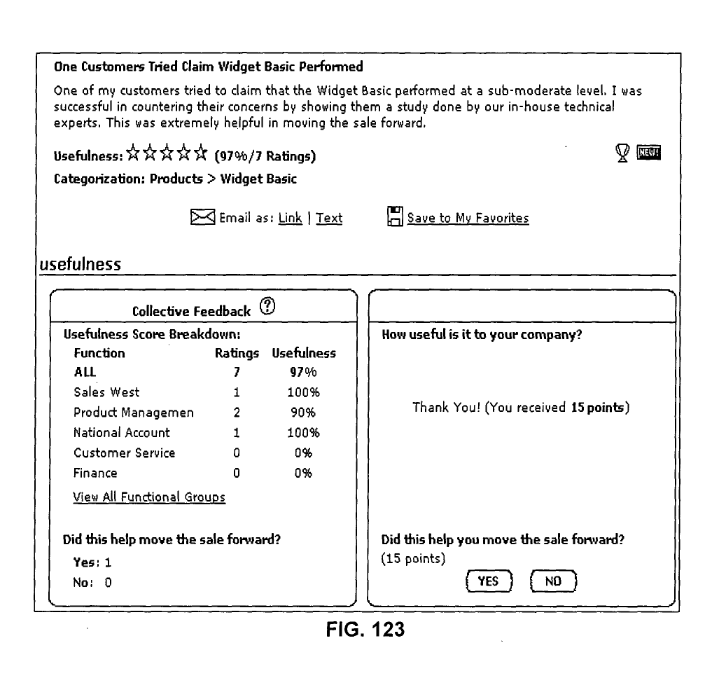

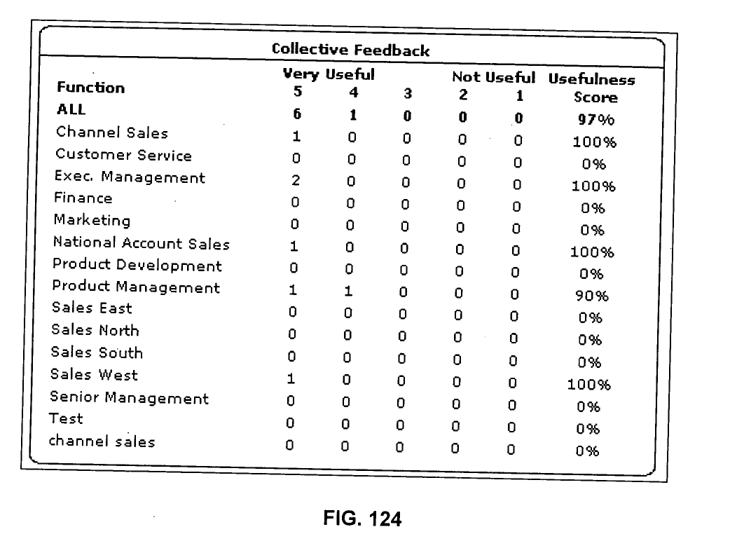

Preferably, users may rate the “usefulness” of each subject while viewing it. Preferably, selecting the appropriate bar segment in the “How useful is it to your company?” section of the primary subject detail screen, as shown in FIG. 118A, results in the user's opinion of usefulness being added to other user's ratings. If the subject's “usefulness” is rated by a user they may preferably by rewarded points as shown in FIG. 123. Users may preferably view a summary of the feedback provided by all users who have rated the subject by selecting the “View All Functional Groups” text link. The resulting pop up screen is illustrated in FIG. 124.

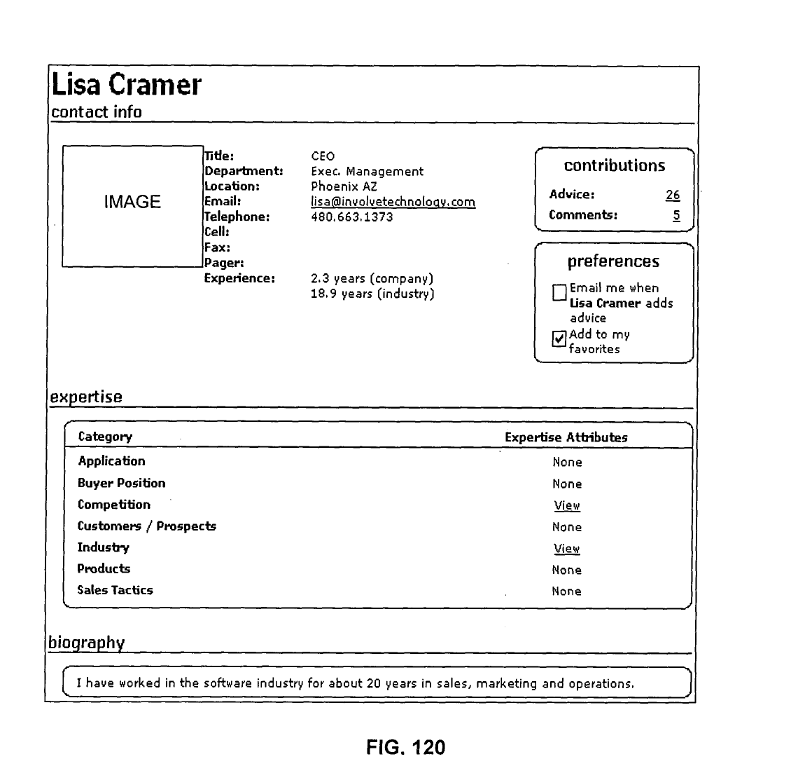

Preferably, a wide variety of types of information including, but not necessarily limited to, experiences, persons with special skills or knowledge and answered questions may preferably be included in the knowledge base. An example of how information about a person that may preferably be included and presented is shown in FIG. 120.

Add Advice

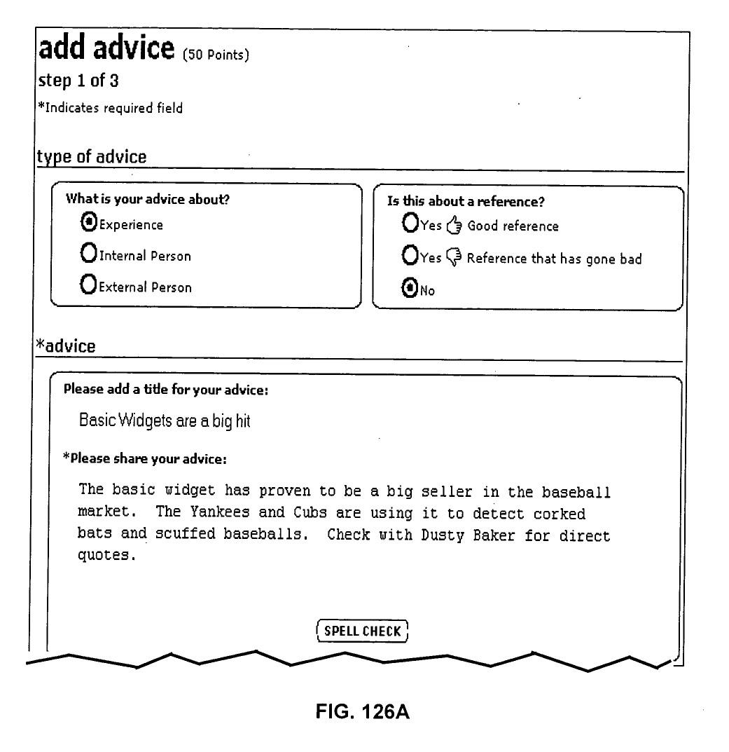

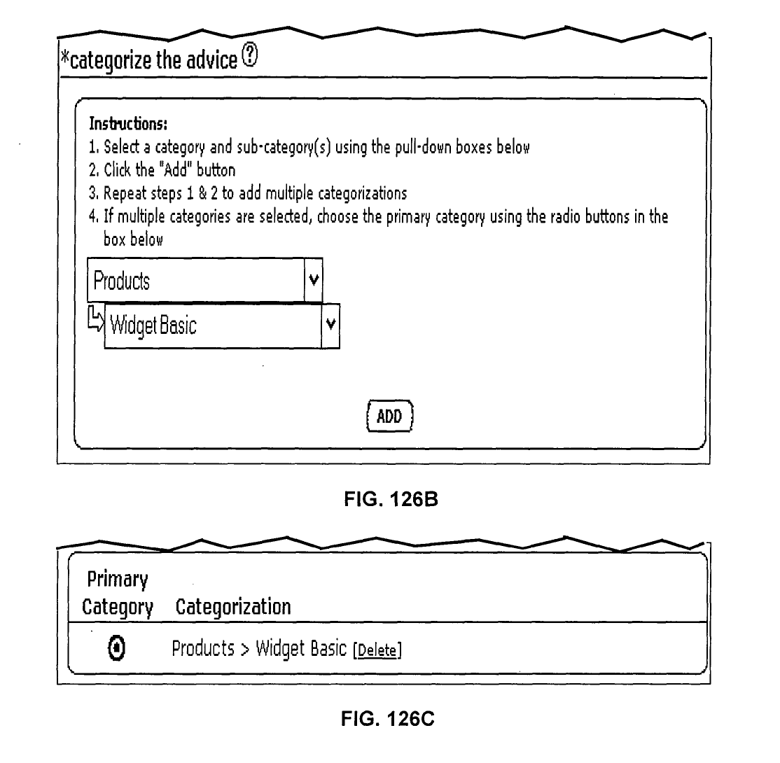

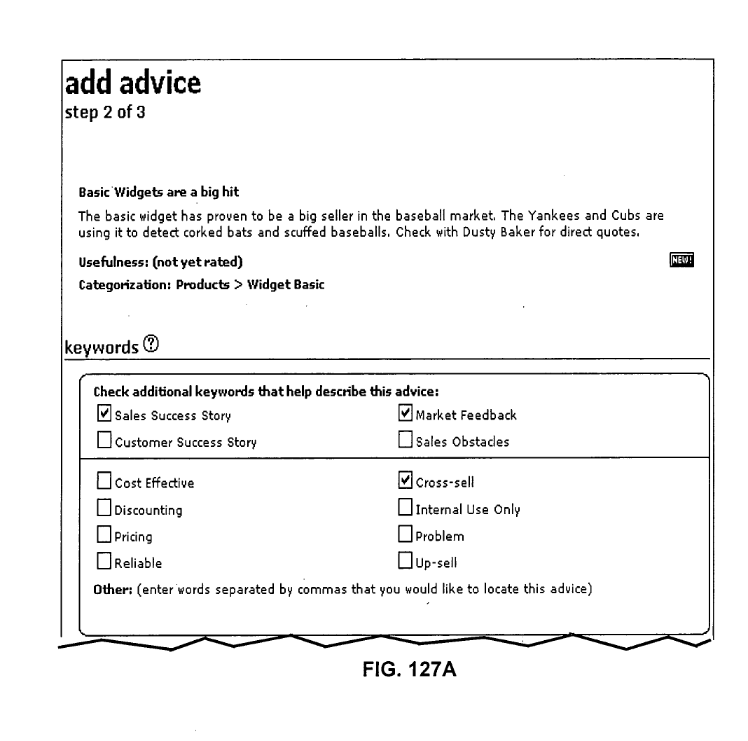

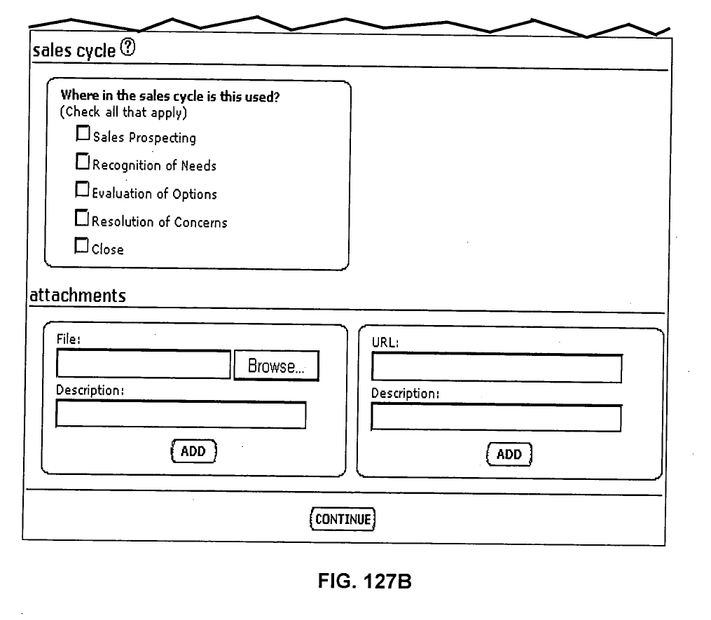

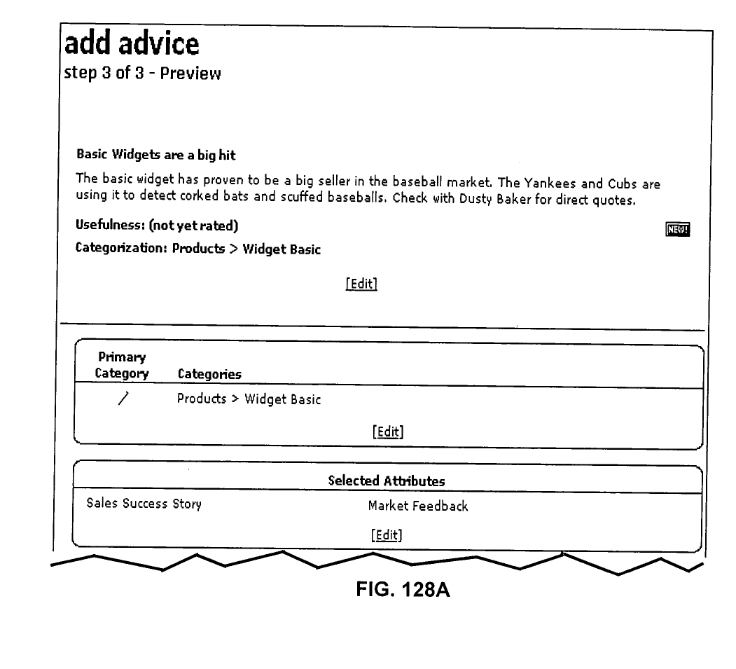

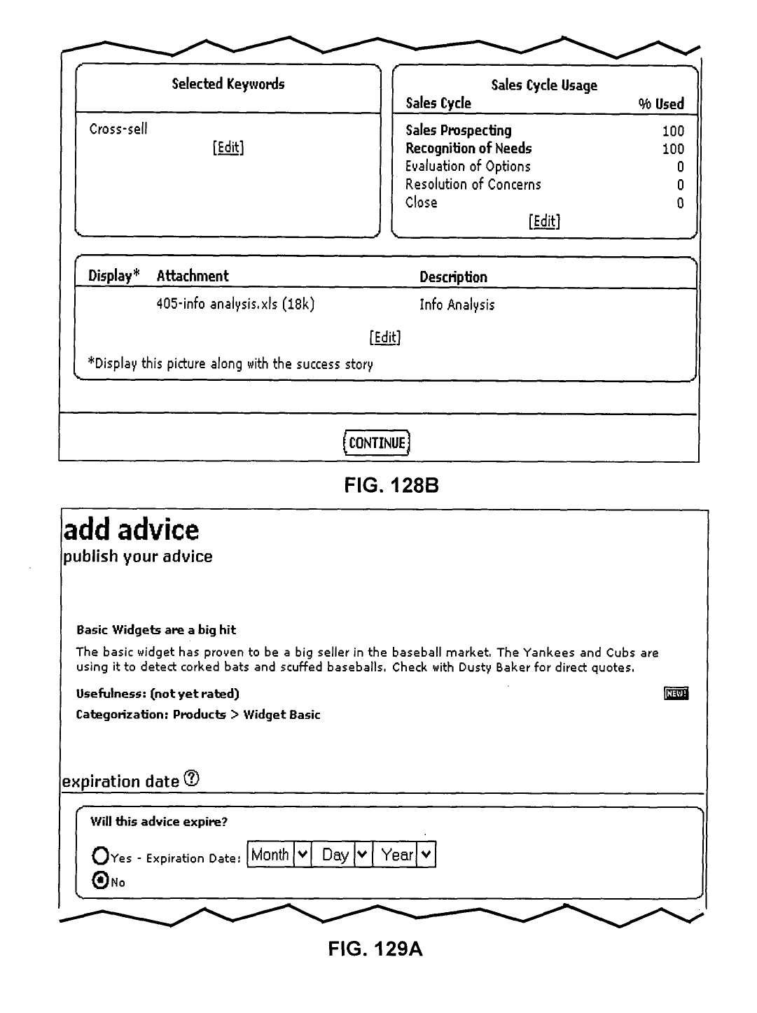

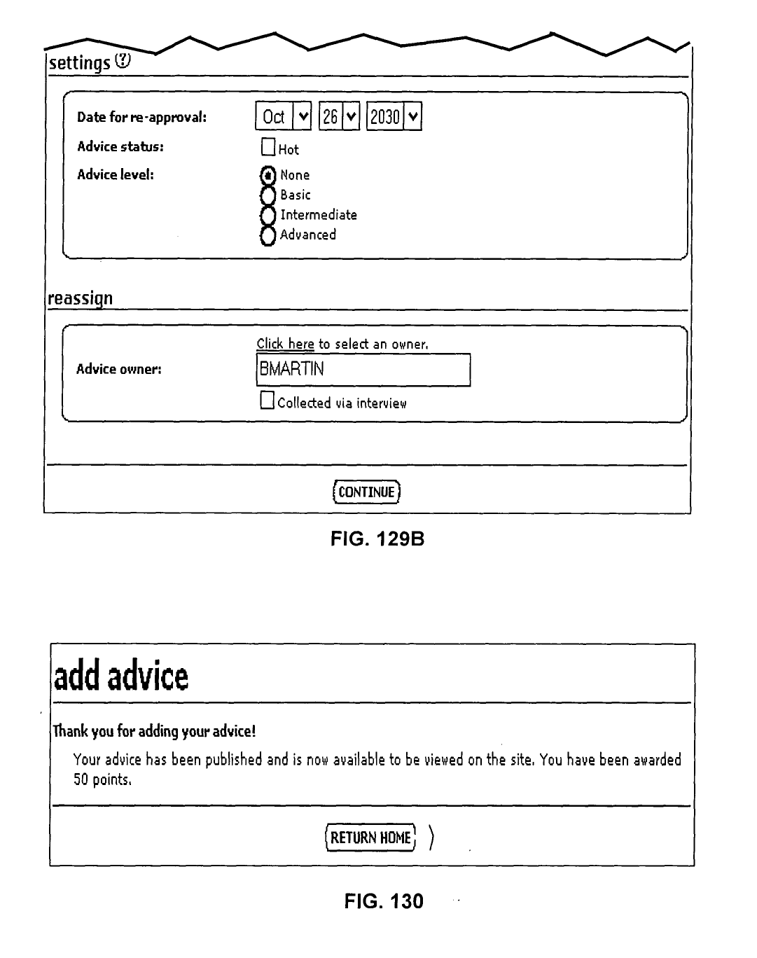

In a second described preferred embodiment of the present invention, each user is encouraged to submit their experiences for inclusion in the knowledge base. Users may preferably access the add process from any screen by selecting the “Add Advice” text link. Preferably the add process includes three primary steps and a publishing step. The first preferred step includes entering the type of subject, internal person, external person or experience, whether the information is related to a reference and entering the text of the information to be shared as illustrated in FIG. 126A. Preferably users are required to select a category and optionally a sub-category which best classifies the sales advice entry as shown in FIG. 126B. Once the category and sub-category are entered the choices are confirmed to the user as illustrated in FIG. 126C on the bottom of the first step screen. The preferred second step preferably requires the user to first input the most relevant keywords, and to add any keywords not shown, but that the user believes would be useful in helping to locate the current entry, as illustrated in FIG. 127A. Next, as shown in FIG. 127B, users preferably indicate which step of the sales cycle to which the information is most relevant and identify any attachments or links which may be helpful. The third add step preferably provides the user an opportunity to review all of the information inputted thus far and the make any changes before final submission. This review step is illustrated in FIG. 128A and FIG. 128B. Preferably after the review is complete the publish step gives the user the opportunity to provide several publication criteria including an expiration date, a re-approval date, the level of user experience which could be expected to benefit most from the experience and to reassign the owner (person responsible for the entry) if it is different than the user inputting the information. The publication information is shown in FIG. 129A and FIG. 129B. Confirmation of successful submission of a new entry is shown in FIG. 130. Preferably at the licensee option some users may be permitted to publish an entry without approval, while others may be required to have their submissions reviewed and approved by a designated user(s).

All submissions are preferably checked for duplicates in the database after completion of the first step in the add process if desired by licensee since this is a configuration decision. The author may continue to the second step, if no duplicates are found, or add comments and ratings to the existing entry and abandon the entry started in first step.

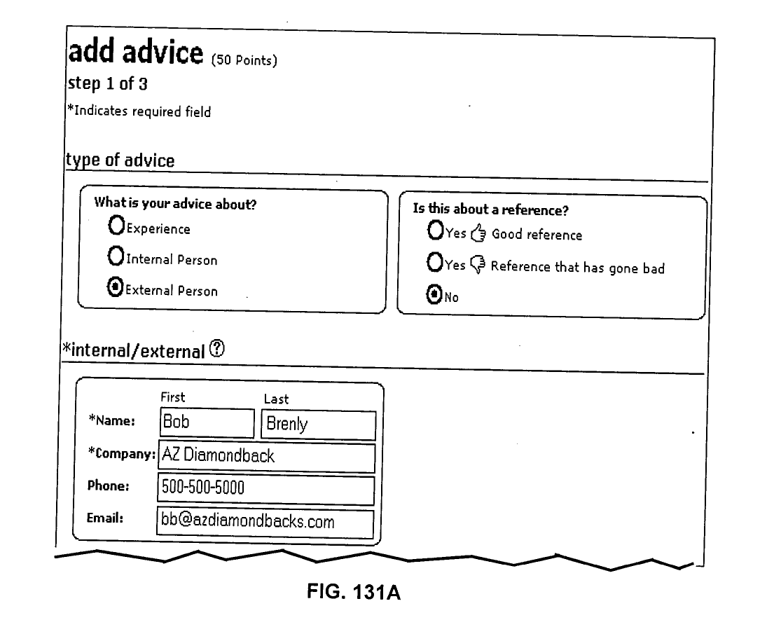

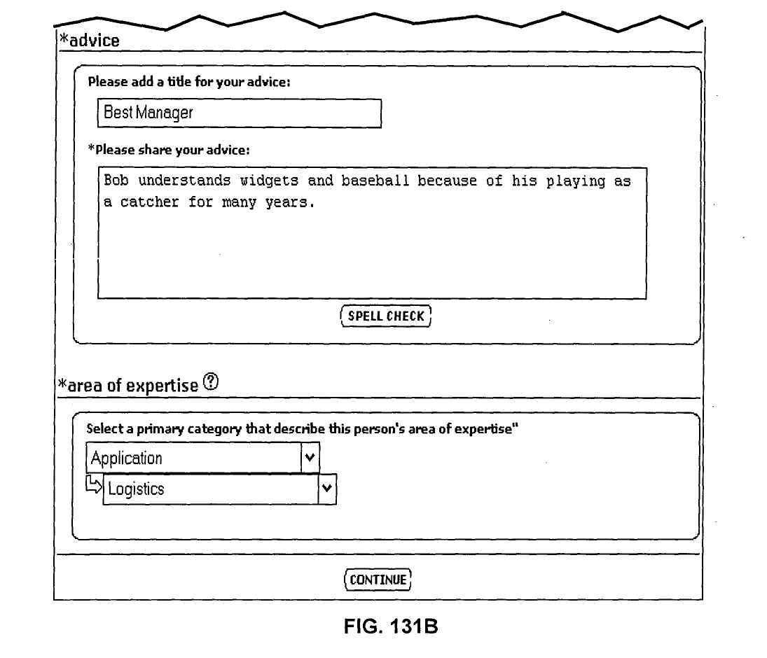

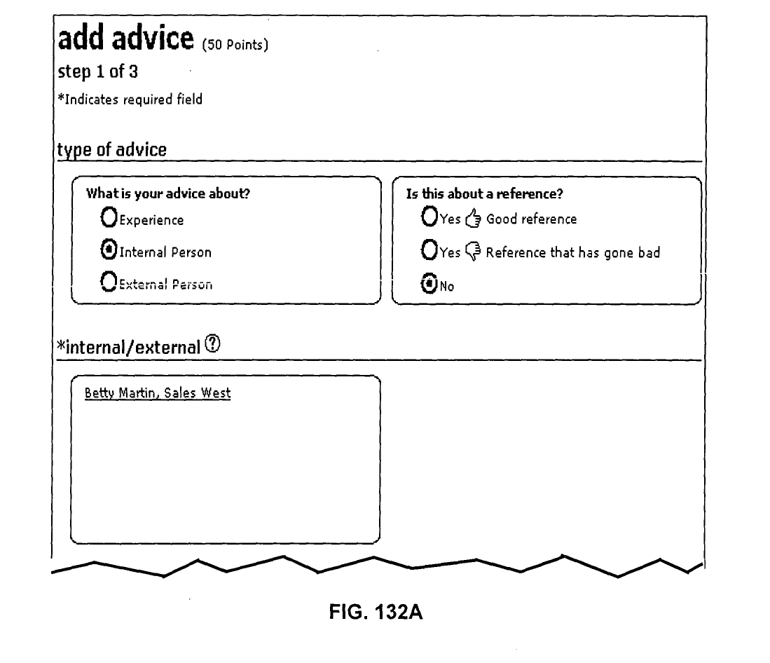

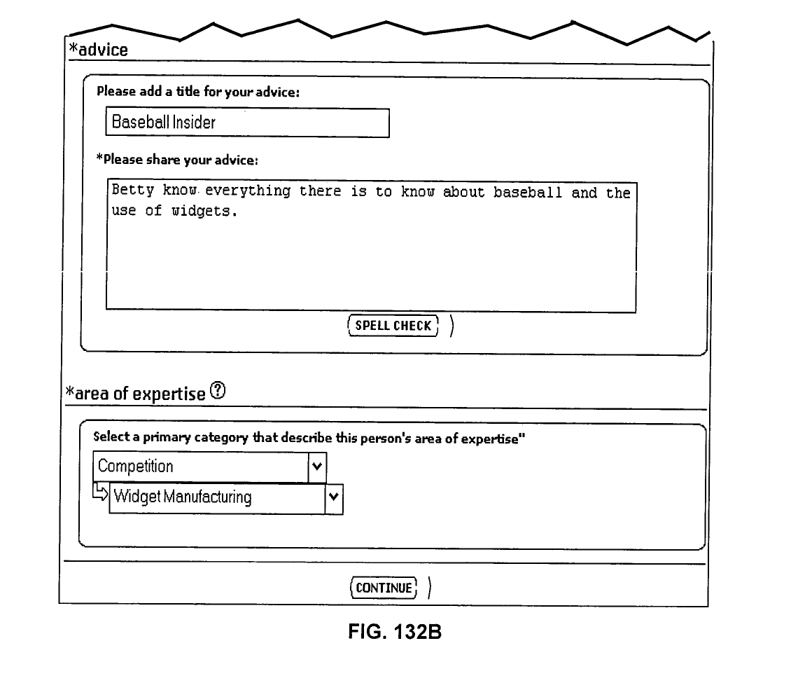

Preferably a user may add an entry for a person who has particular skills or knowledge by using a screen format for step one of the “Add Advice” method tailored to meet the special requirements. The entries as shown in FIG. 131A and FIG. 131B illustrate the preferred screens configured of entry of information about an external person. FIG. 132A and FIG. 132B demonstrate a preferred method for inputting information for an internal person.

My Page/Contributions/Favorites/Interests

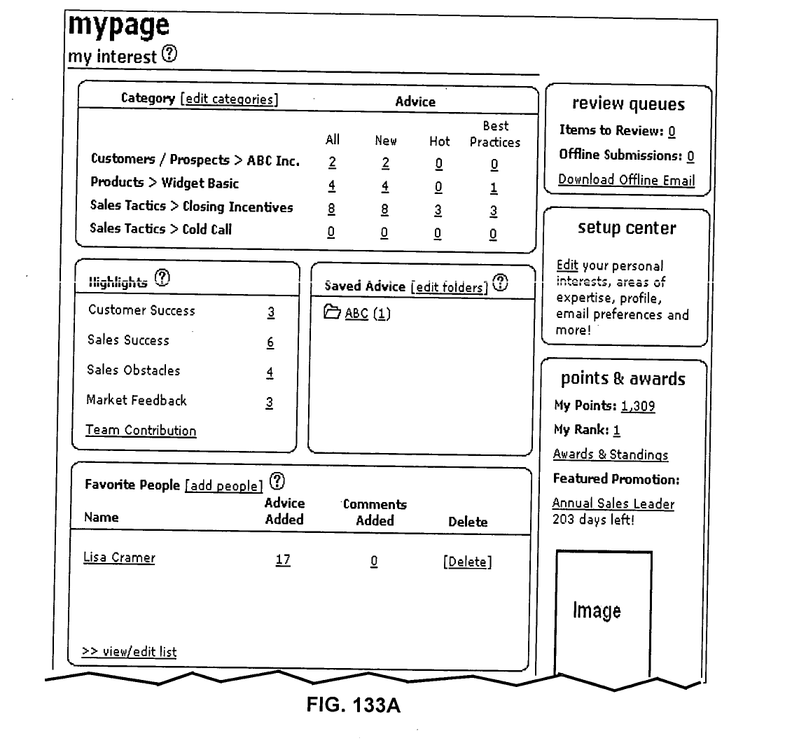

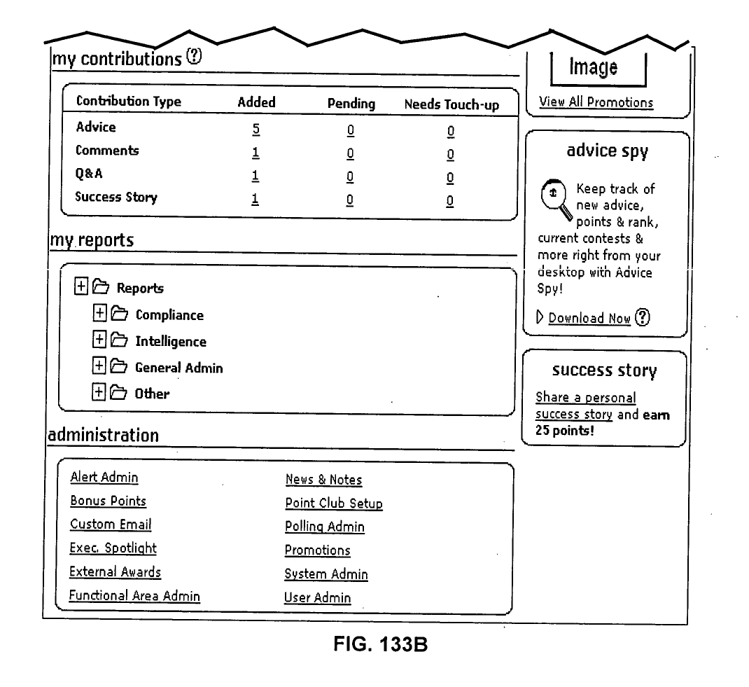

In a second described preferred embodiment of the present invention, each user of the system may preferably access a page in the system which presents information which is preferably unique to each user. Each user is presented a summary page referred to as “mypage”, as illustrated in FIG. 133A and FIG. 133B. In summary, the intent of “mypage” is to provide single location for users to maintain links to particular entries, and to access status of all their submissions, and a location where their status in promotional programs. For example, users may view a summary of subject entries in categories selected by the user which are of particular interest, and preferably each user may bookmark particular entries on people and experiences which may be organized by folders of the user's choosing. Preferably each user is also presented with a section which summarizes the user's contributions in four broad areas; experiences, comments, questions and answers and success stories. For users with responsibility for review and approval of submitted entries and comments are preferably given the opportunity to view a summary and by selecting the appropriate text link view the details and take the necessary actions. Preferably, authorized expert users will also access questions submitted through the Q&A process for response. Additionally, preferably, users authorized to access to selected reports are presented the opportunity to view them from this page. Additionally, preferably, users authorized to access to selected administration functions are presented the opportunity to access those functions from this page. All system administration functions are presented although user access to any one, or all, may preferably be selectively permitted.

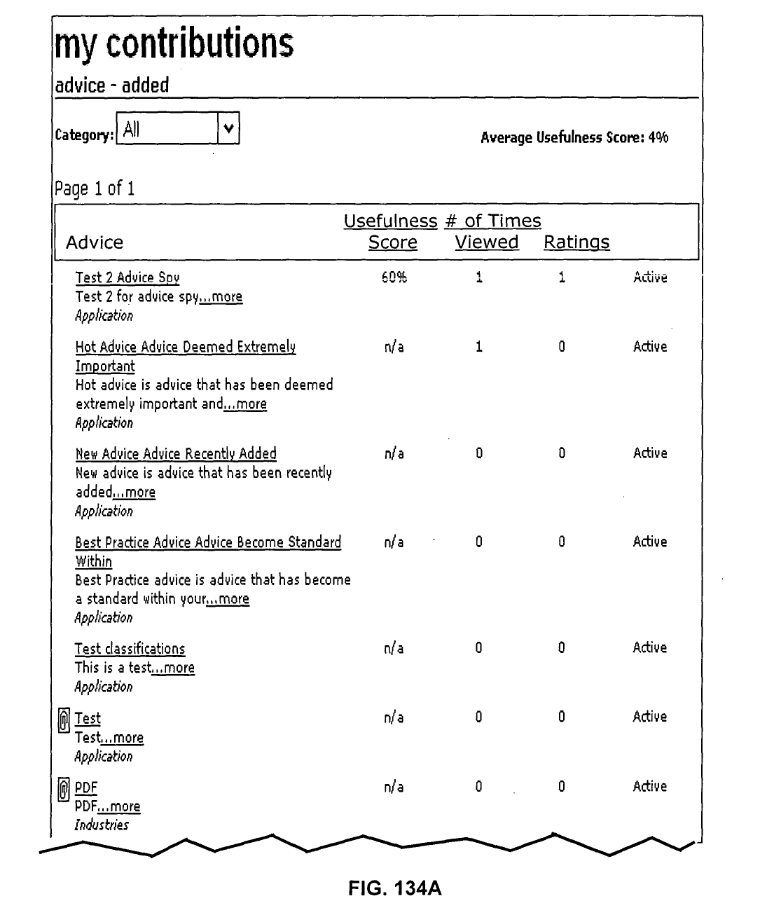

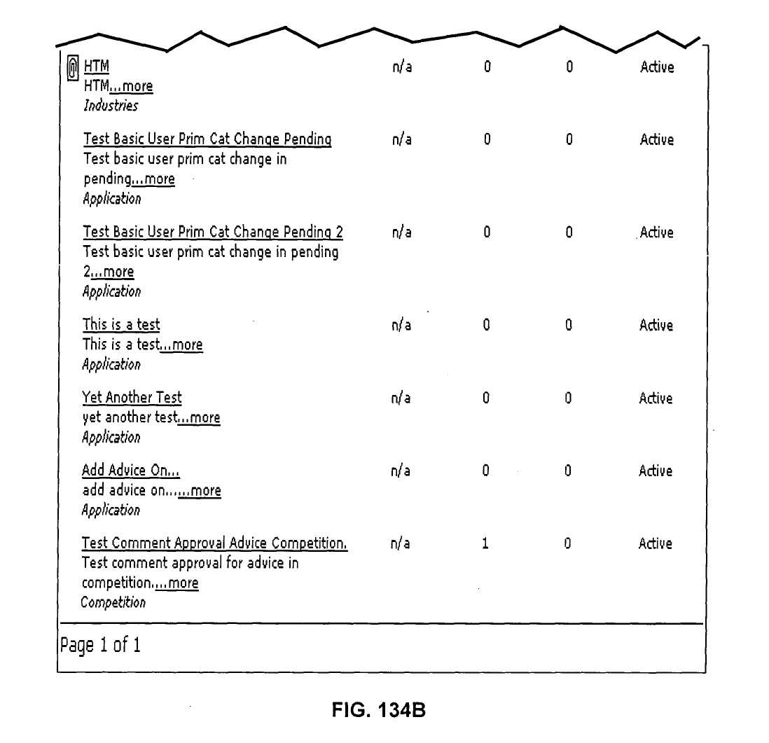

Preferably the status of contributions by a user may be reviewed by selecting the value for each contribution area under each of the status columns; Added, Pending and Needs Touch-up. Preferably the user will be presented with a list of contributions which comprise the number shown. FIG. 134A and FIG. 134B are examples of these preferred lists. The format, style and usage of lists presented for comments submitted by the user, for subject submissions, for question and answer submissions submitted by the expert who answered the questions, and success stories submitted by a user are alike with only the nature of the content changing. Those with ordinary skill in this art will appreciate that minor differences in screen text, design and background are variations not critical to the instant inventions.

Preferably, each user may view a list of entries book marked as “my favorites” by selecting either the displayed entry or the folder containing multiple entries. Preferably when an entry is selected the subject is displayed as illustrated in FIG. 118A and FIG. 118B. If a folder of multiple entries is selected a list of the entries is displayed in the same manner as illustrated in FIG. 134A and FIG. 134B. By selecting the Save to My Favorites text link on the subject detail screen (FIG. 118A and FIG. 118B) a user my save the subject entry to a particular “my favorites” folder. To view all people entries which have been book marked a user selects the View All text link in the People section of My Page as illustrated in FIG. 133A and FIG. 133B. Preferably, a user may create, rename or delete the folders used to organize book marked subject entries selecting the edit folders text link in the Advice area. Selecting a person from the list will preferably display the person's profile which is illustrated in FIG. 120. Selecting the text link Sales Advice in the Contributions section will preferably display a list of the subject entries added by the person preferably in the same manner as shown in FIG. 134A and FIG. 134B. Selecting the text link Comments in the Contributions section will preferably display a list of comments added by the user preferably in the same manner as shown in FIG. 134A and FIG. 134B.

Preferably, a user may select any of the numeric text links in the “my interests” section of my page to view a list of subjects fitting the category and classification of the subjects. The resulting summary list of entries is preferably presented to the user in the same manner as shown in FIG. 134A and FIG. 134B.

Those with ordinary skill in this art will appreciate that minor differences in screen text, design and background are variations not critical to the instant inventions.

My Profile

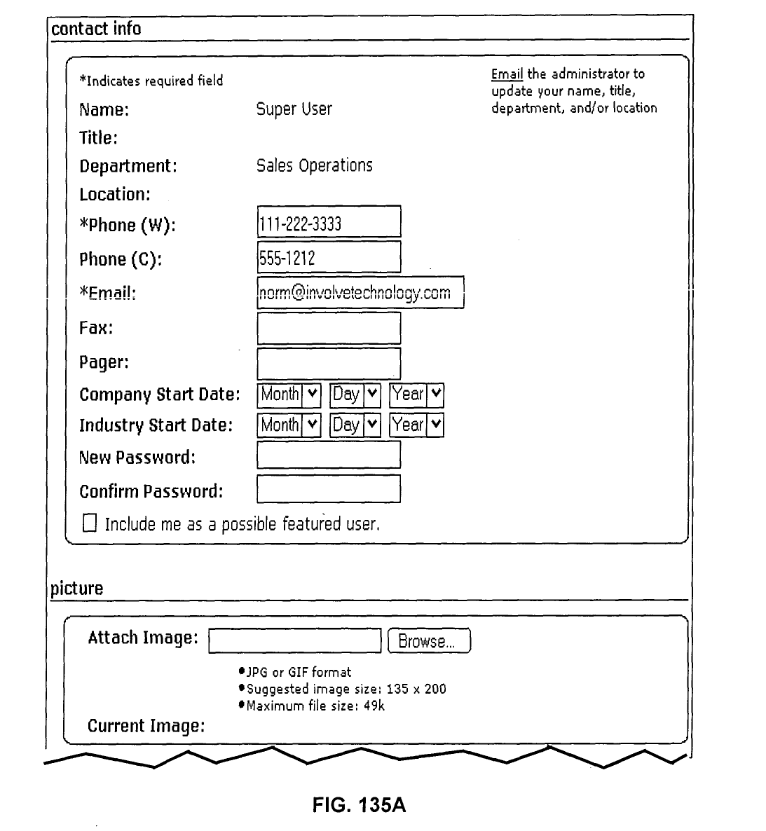

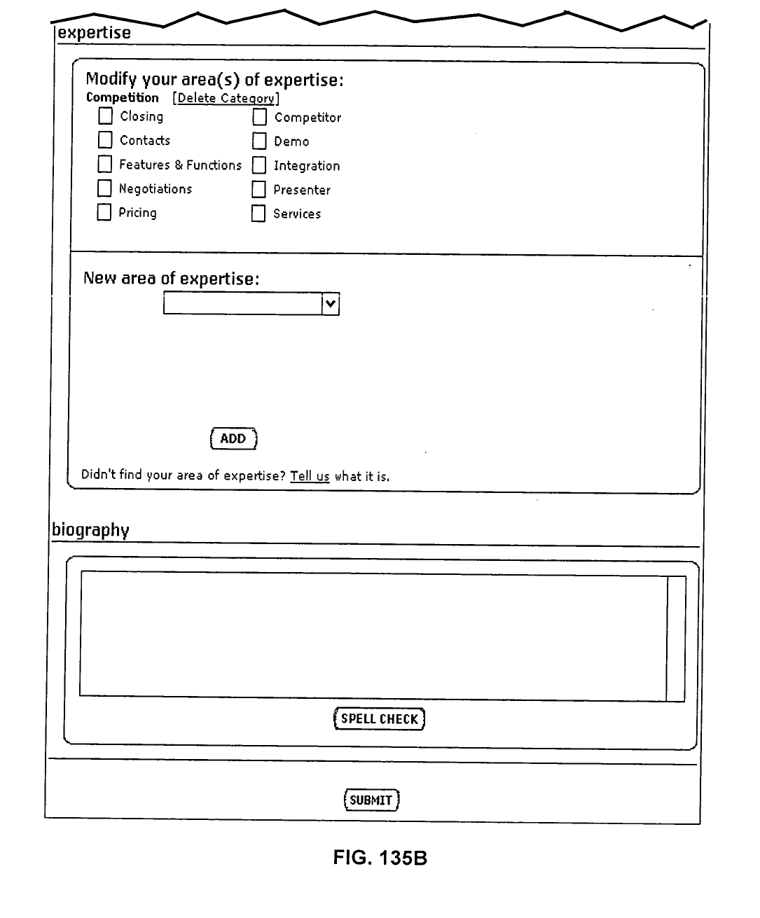

In a second described preferred embodiment of the present invention, each user may preferably prepare a profile of the user's background and preferences for reference by other users of the system. Preferably, each profile contains demographic and contact information, optionally an image of the user, a summary of the user's areas of expertise as it relates to the defined categories, and a short autobiographical description of skills and experience, an example profile is shown in FIG. 120. FIG. 135A and FIG. 135B illustrate a preferred screen for editing a user's profile. A user may edit all portions of the profile except name, title, department and location. Additionally, a user may edit the user's interests by selecting the text link my interests on the edit preferences screen.

Q&A

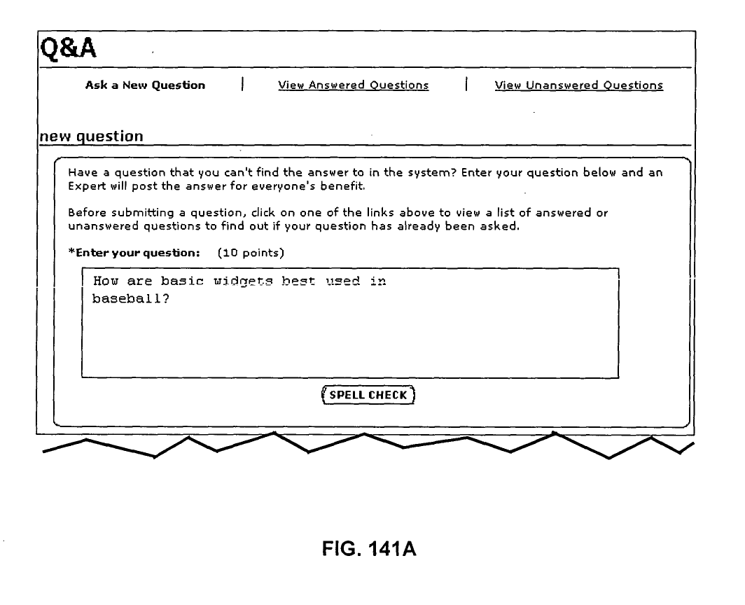

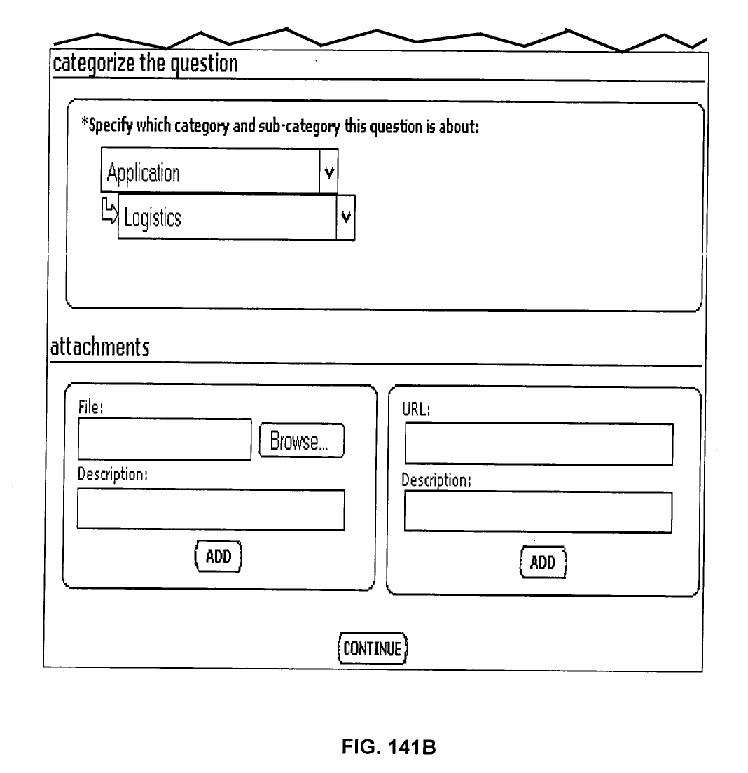

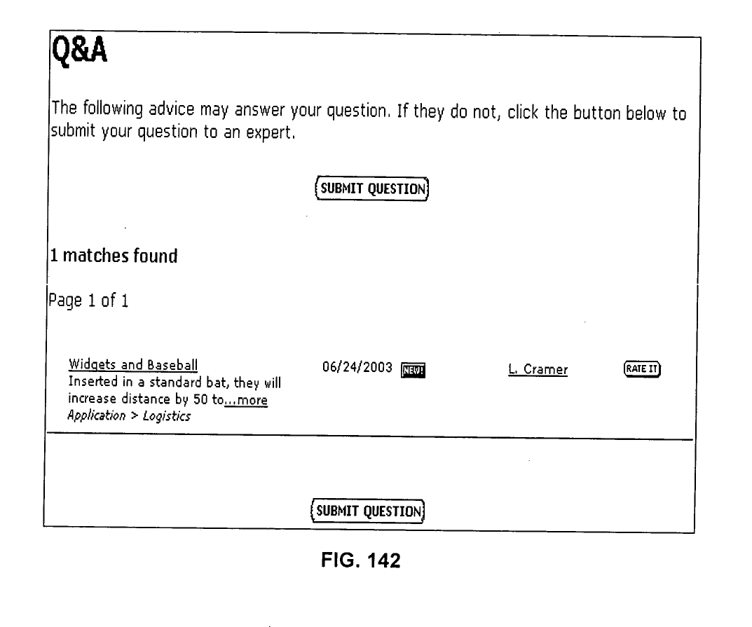

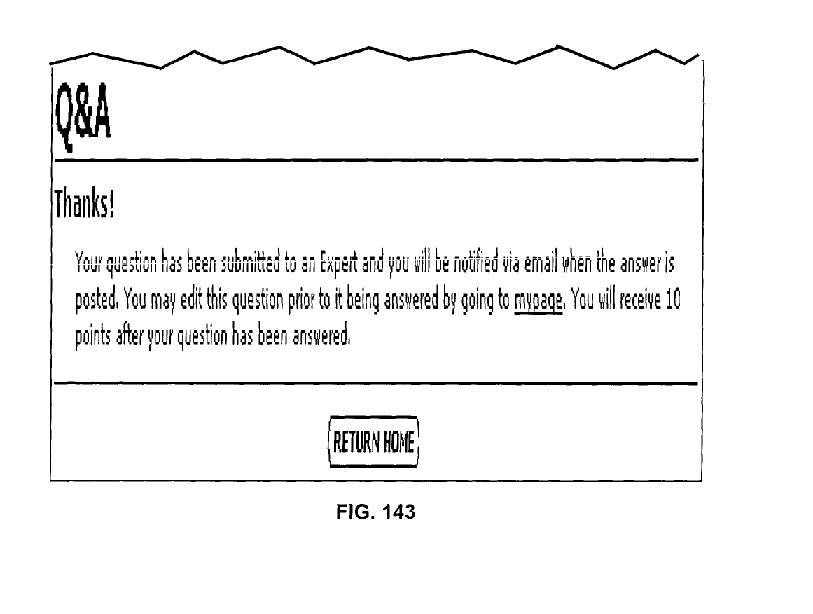

In a second described preferred embodiment of the present invention, users wishing to submit a question preferably may select the “Q&A” text link available on any screen of the system. The first screen of the question process preferably allows the user to formulate the question, spell check it and select the most appropriate category and sub-category as shown in FIG. 141A and FIG. 141B. A question edit process, which functions the in the same manner as the entry process illustrated by FIG. 141A and FIG. 141B, is preferably available if changes are required. Submission of the question will result in the system searching for like questions and subjects in the database. The resulting list of the search is a list, as shown in FIG. 142, and the user may continue and submit the question or use a subject from the list to resolve the issue and therefore abandon the question. If the question is submitted, preferably the system will confirm successful submission as shown in FIG. 143.

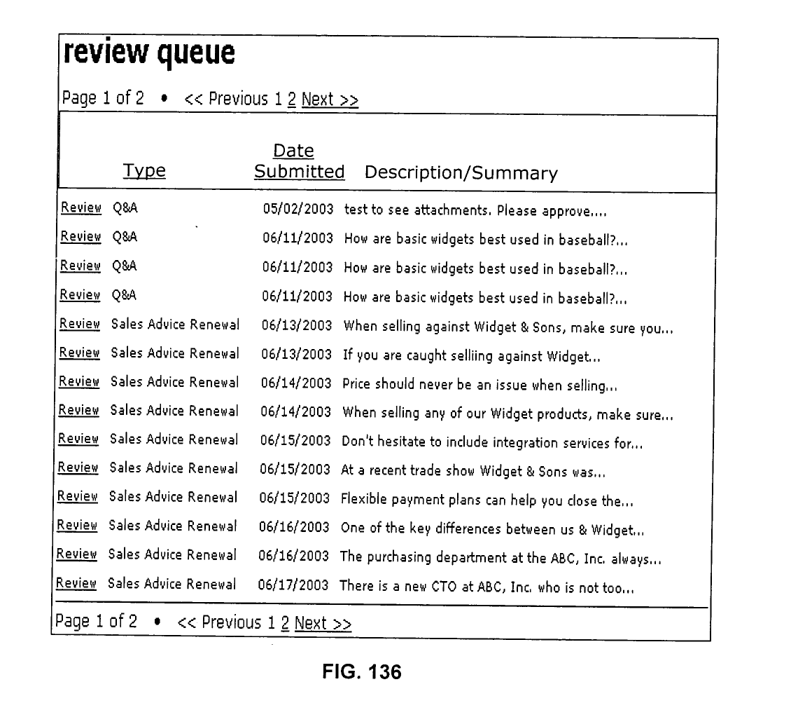

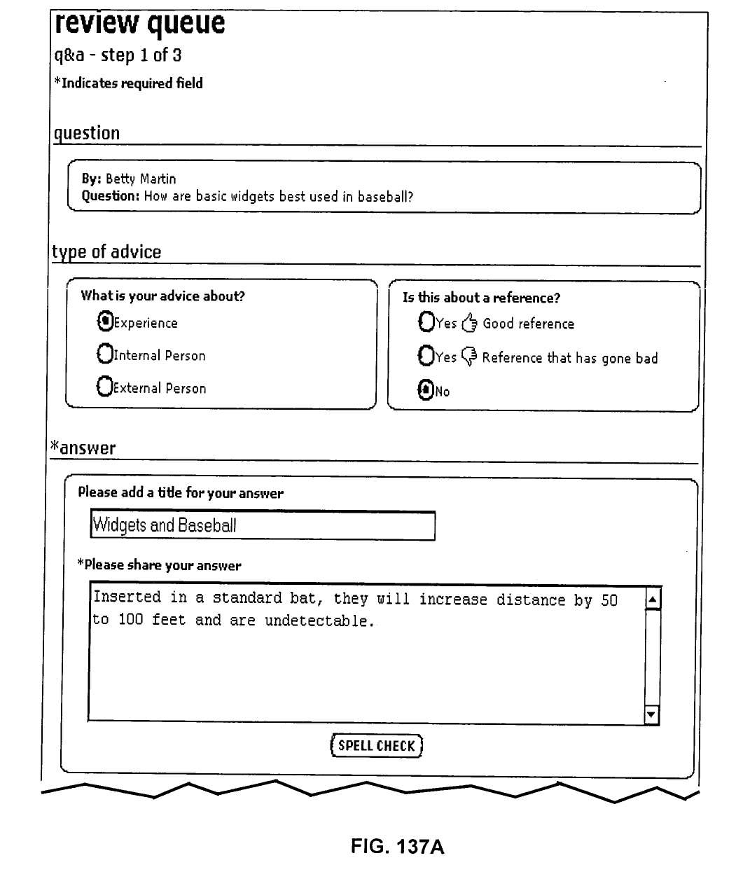

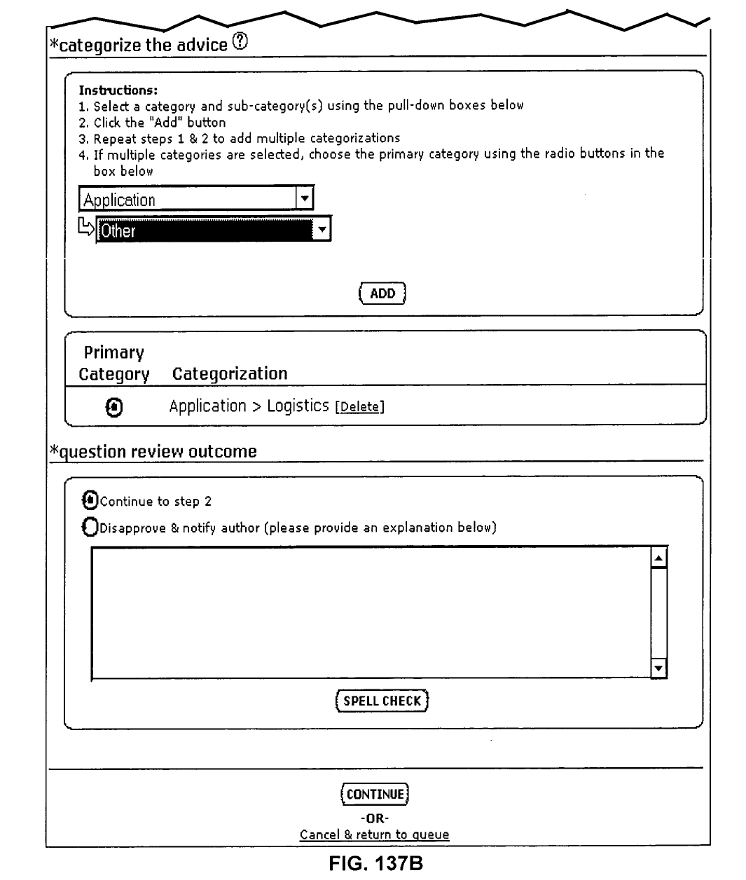

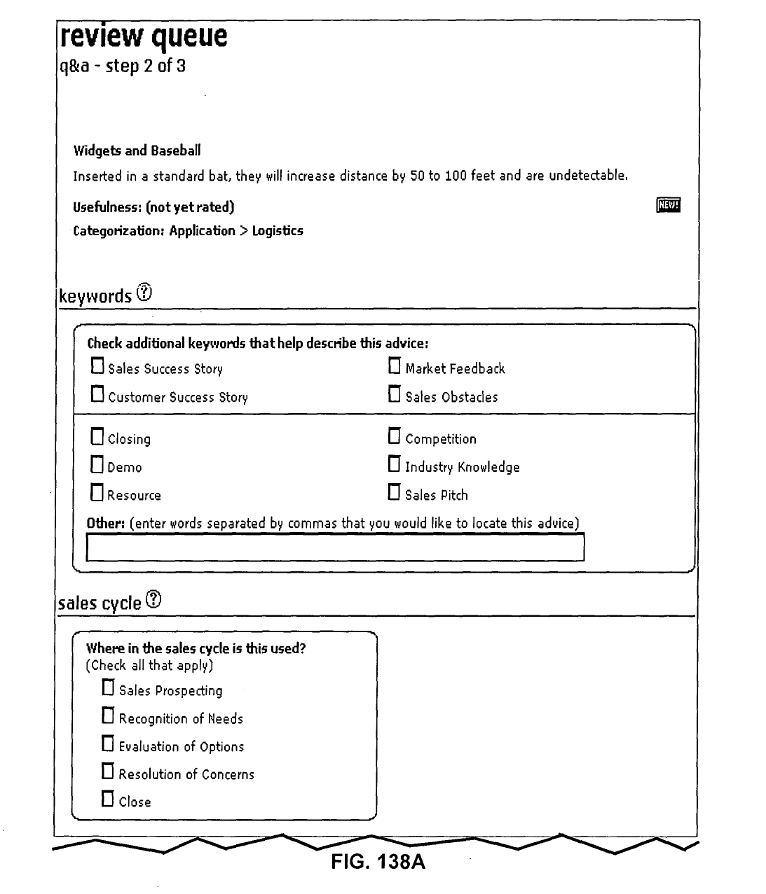

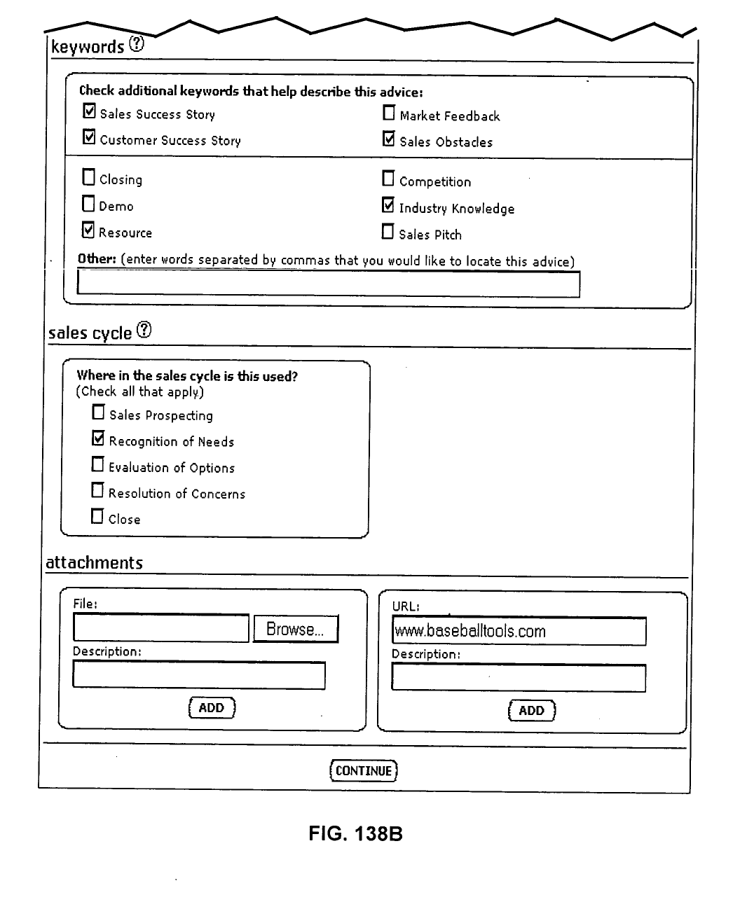

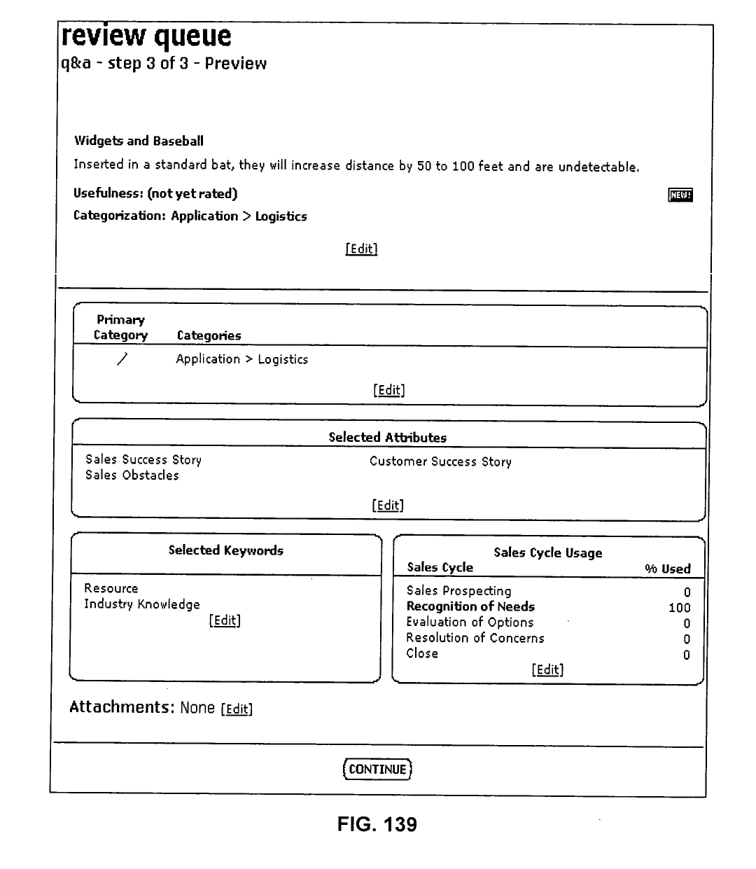

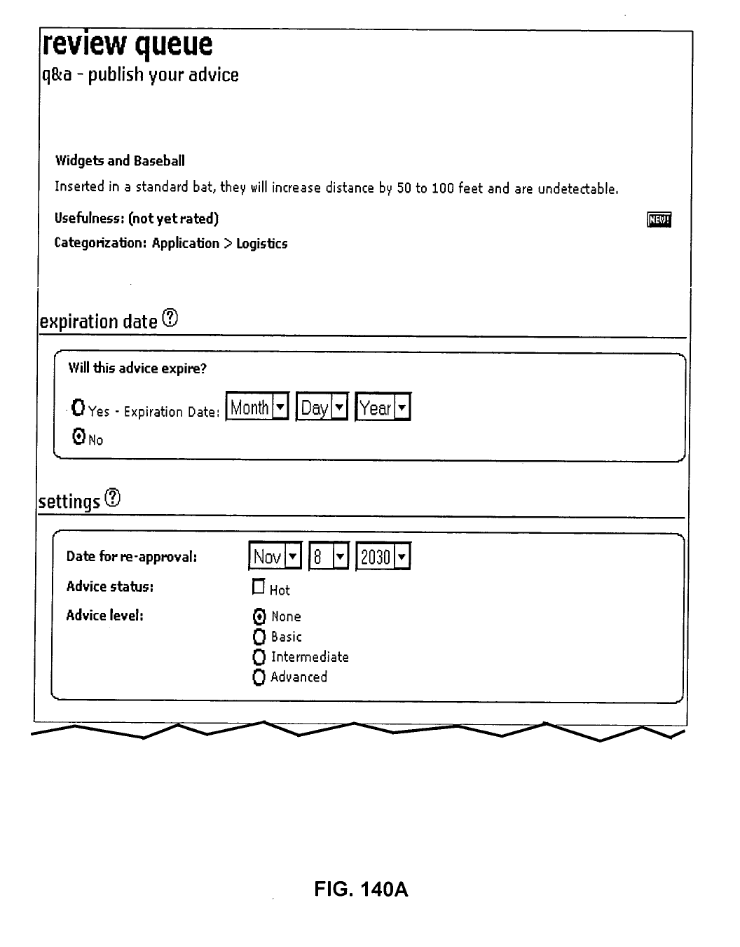

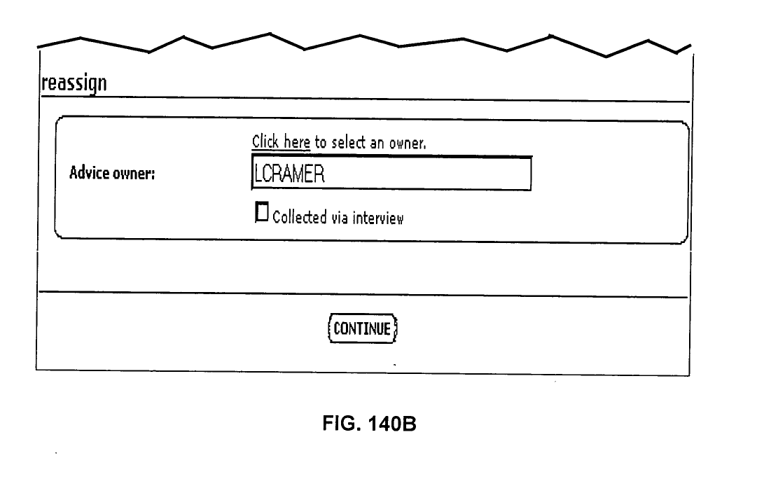

In a second described preferred embodiment of the present invention, as illustrated in FIG. 136 the “review queue” contains “Q&A” items which are questions directed to a group of experts awaiting answers as well as other submissions by users which are awaiting review and approval. Completion of the answer process will result in the combination of the question and answer being added to the knowledge base for use by other users. The question answering process requires three steps. Step one, as illustrated by FIG. 137A and FIG. 137B, preferably includes completing the answer to the question and selecting the appropriate category and sub-category. Step two includes selection of other descriptive information about the question preferably similar to the information added in step two of the subject add process. Step two preferred requirements are demonstrated in FIG. 138A and FIG. 138B. Step three of the process is a preview of the completed “Q&A” entry and is presented in FIG. 139. Confirmation of successful submission of the “Q&A” entry is presented to the reviewer as shown in FIG. 140A and FIG. 140B.

My Page/Review Queue

In a second described preferred embodiment of the present invention, selected users are authorized to review and approve submissions of other users to ensure quality and accuracy of the information contained in the database. Preferably, users authorized by management to review and approve submissions are able to access the queues of submissions awaiting review and approval from the “review queues” section of “my page” by clicking on the text link for the number of items to review (refer to FIG. 133A and FIG. 133B). FIG. 136 demonstrates a preferred list of the submissions awaiting review presented when the text link is selected. As can be seen, all types of submissions are preferably presented for selection by the authorized user. Selecting an entry in the list will present the user with a different screen designed specifically for each type of entry, sales advice, comments, questions and answers, pictures, experts or success stories. Preferably, all areas subject to review operate in essentially the same manner. The process is described and demonstrated with reference to FIG. 137 through FIG. 140 which illustrates the review and approval process for submitted questions and answers. Those with ordinary skill in this art will appreciate that minor differences in screen text, design and background are variations not critical to the instant inventions.

Preferably review and approval of submitted comments on particular subjects in the database may be required before they are published and made available to all users. On approval the comment will be posted to the database and available to users, however, on rejection the comment is returned to author for correction and re-submission or deletion.

Preferably subject entries may include expiration dates which require an action by an authorized user to renew the entry, delete the entry or cancel and return the entry to the queue for later action.

Preferably review and approval of subject entries may be required prior to being made available to the general population of users, in particular this preferably permits an authorized user to review all aspects of the submitted entry and modify all values except the original text. At the completion of the review preferably the authorized user may approve the submitted entry or disapprove it. If the authorized user chooses, no action may be taken and the submitted entry may be returned to the review queue for action in the future.

Preferably success stories may also be reviewed prior to posting to the database. As with other submissions, success stories are included in the review queue and are available to authorized users for review and approval. As provided, an authorized user may choose to cancel and return the submitted success story to the queue. If a success is disapproved the authoring user will receive feedback as to the reason for rejection. Expired success stories may be reviewed for renewal or removal from the database.

Submissions by users of personal pictures and profile information on areas of expertise may also preferably subject to review and approval by authorized users.

Info Need

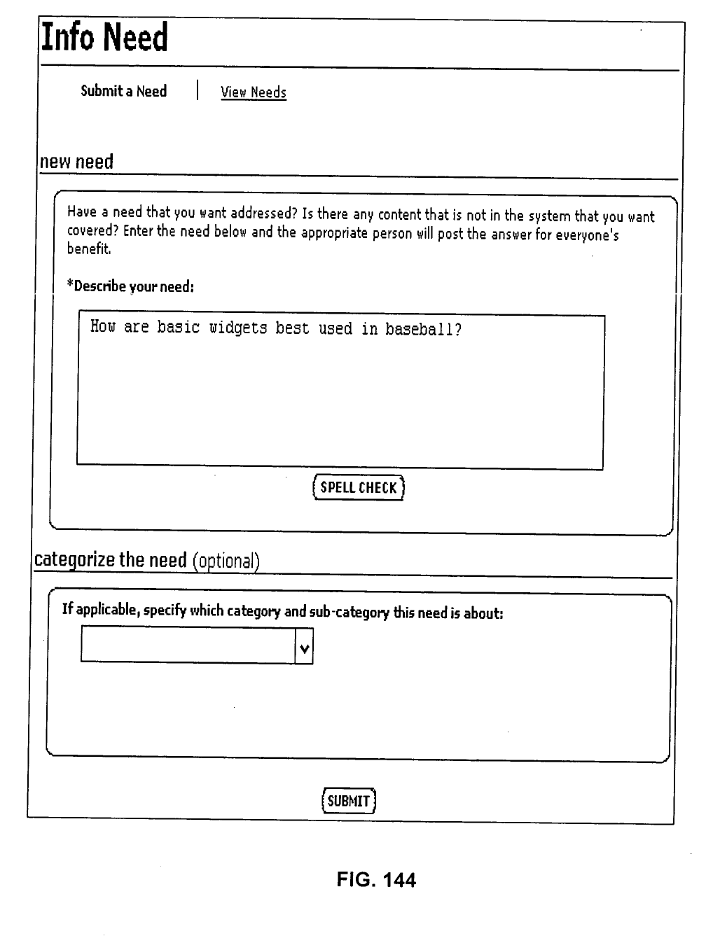

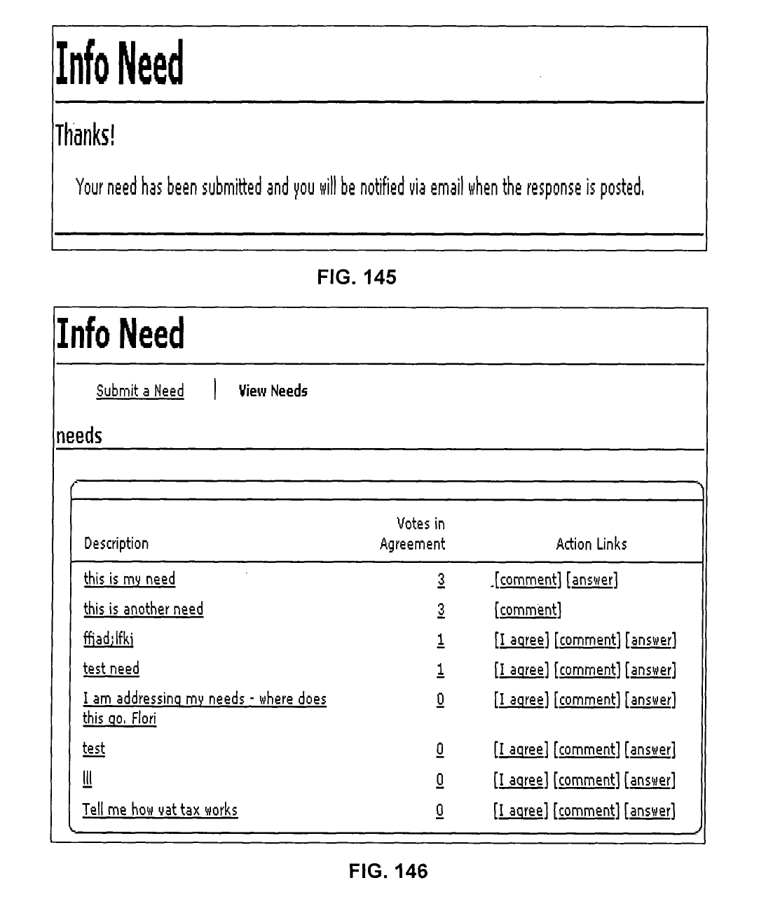

In a second described preferred embodiment of the present invention, a user may use the “Info Need” process to forward an identified need or training request to management. Referring to FIG. 146, illustrating a listing of previously identified “Info Needs” a user by review the list and 1) indicate their agreement with the identified need, comment on the identified need or answer the need. If a user doesn't find their particular need listed they may add it to the list by selecting the “Submit a need” text link. FIG. 144 illustrates the method by which a user may enter and submit an “info need”. The user will preferably receive confirmation of successful submission of the need as shown in FIG. 145.

Success Stories

In a second described preferred embodiment of the present invention, users may submit entries which are preferably anecdotes of situations and events in which they were successful in completing a sale or resolving a problem. Success stories may be featured on the home page, as shown in FIG. 110 and FIG. 110B. A preferred display of a success story may include an uploaded picture. Preferably, a user may choose to add a success story by selecting the “Share your success story” text link wherever it appears. After successful submission of a success story the user will preferably receive a confirmation and a number of points as set by licensee.

Awards & Standings/Points/Contests

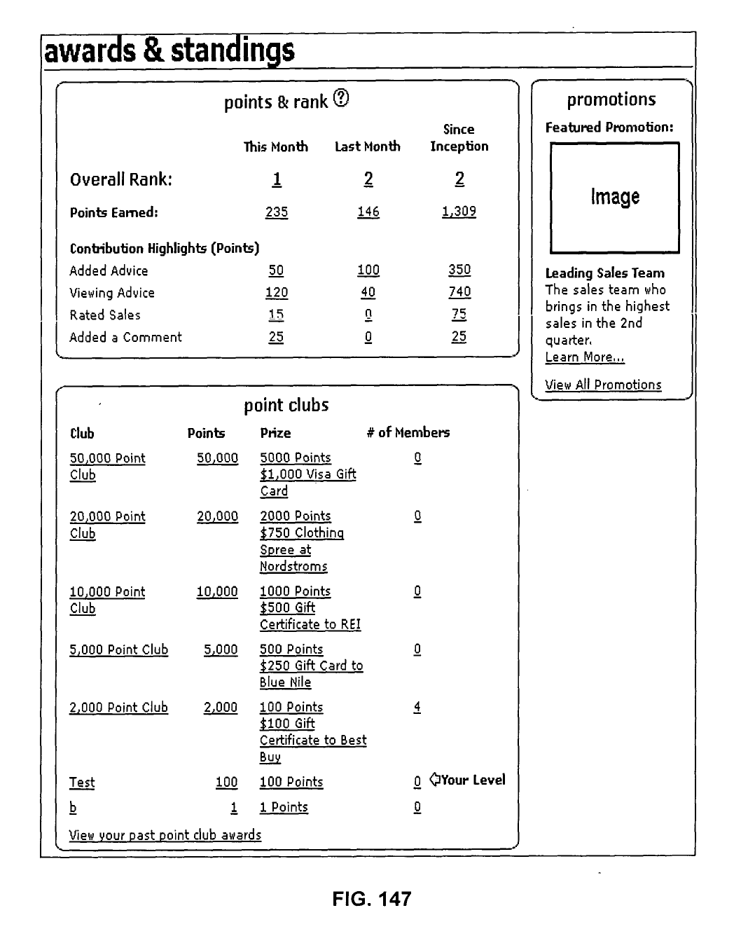

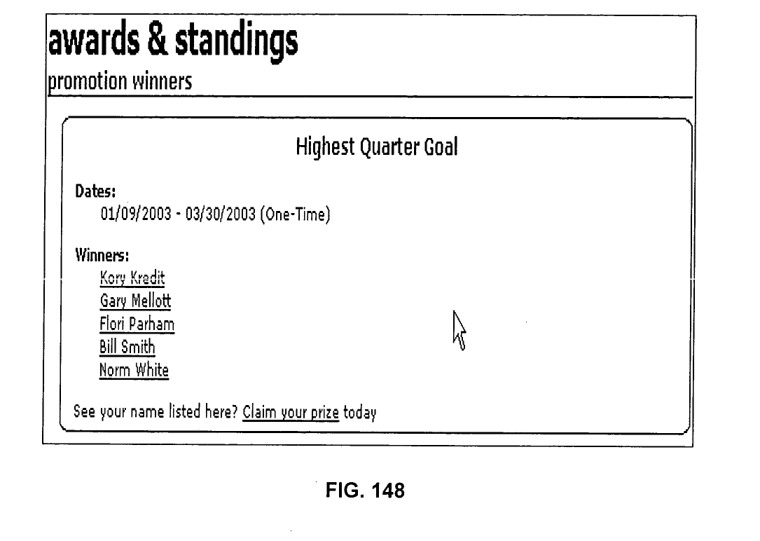

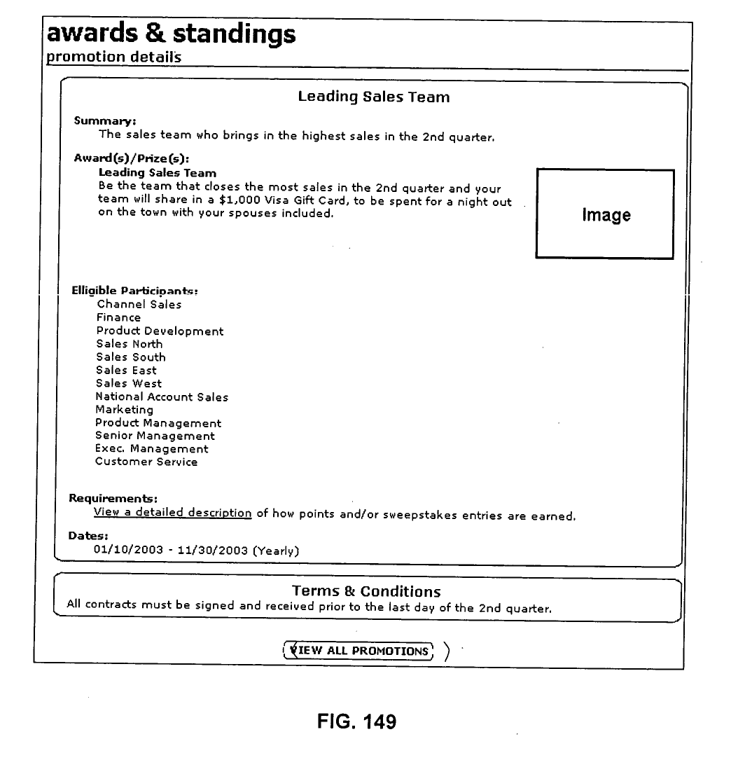

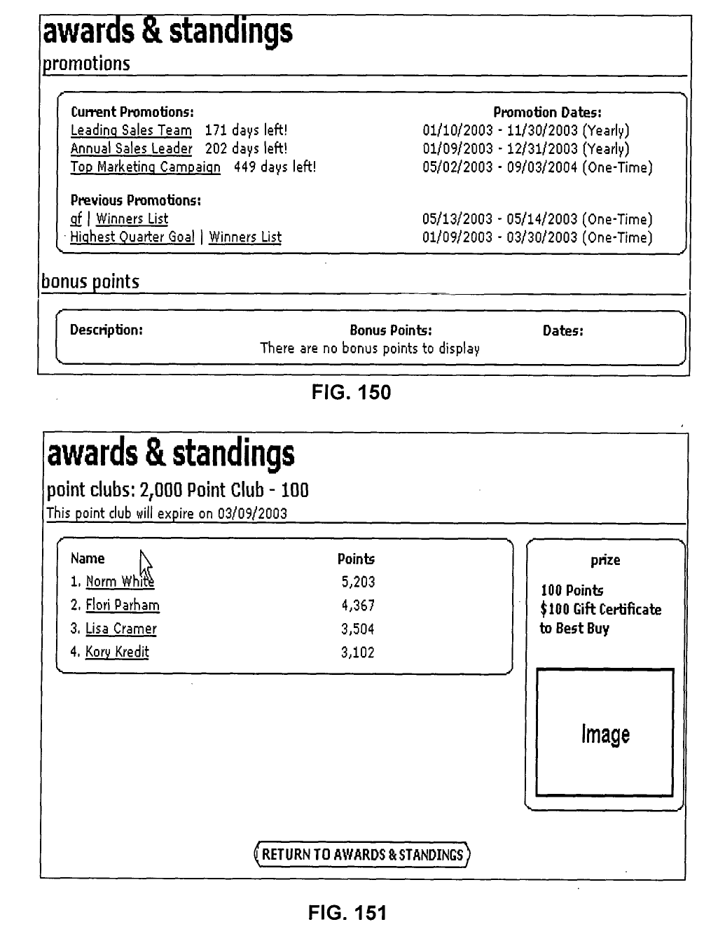

In a second described preferred embodiment of the present invention, awards and contests are preferably intended to encourage and reward users for using the system appropriately and completing the content management tasks of submitting content and review and approval of content. Overall, preferably the awards and contests are based on points earned by users for the completion of a variety of tasks such as submitting a subject for inclusion in the knowledge base. Preferably, the points awarded for the completion of any task may be adjusted from time to time to either encourage or discourage user behavior. Preferably, the points earned by users then are used as the basis for participation in awards and contests, which may further encourage desired user behaviors. An example of a contest description which may be established is provided in FIG. 147 as shown within the bounded area labeled promotions. This page is available to users from the text link “awards & standings” in the header of all system pages. Additionally, users may review the terms and conditions of each contest, as shown in FIG. 149, by selecting the text link “Terms and Conditions” on the contest description page. Further, a user may select the text link “View a detailed description” from the terms and conditions page to view the particular actions and the bonus points that may be awarded during the contest period. FIG. 150 presents and preferred method for presenting the point awards. From this page a user may review contest winners by selecting the “Winners List” text link which preferably displays a page as shown in FIG. 148. If the user's name appears on the list the user may select the text link “claim your prize” to select the particular prize they desire. After submitting the prize selection the user is preferably provided a confirmation that their selection was successfully submitted.

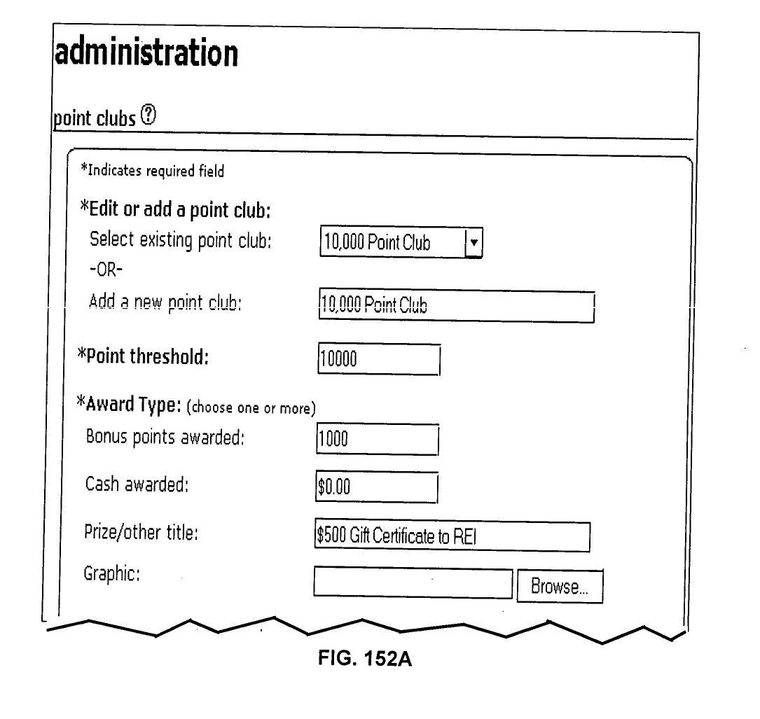

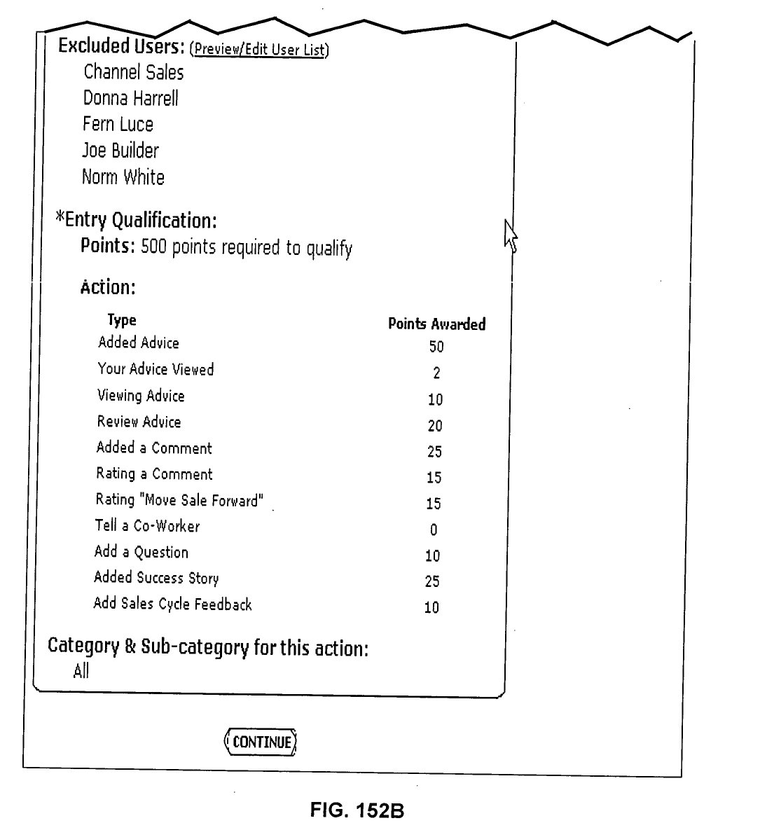

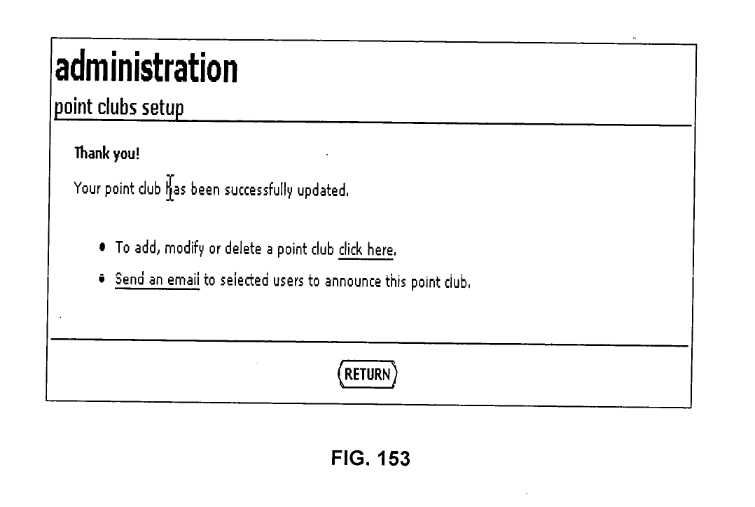

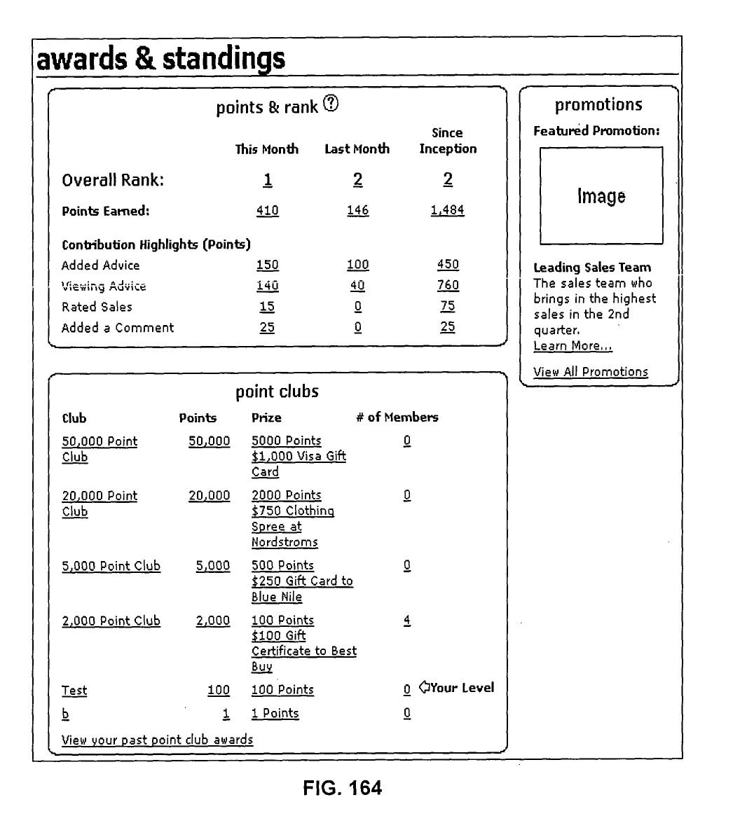

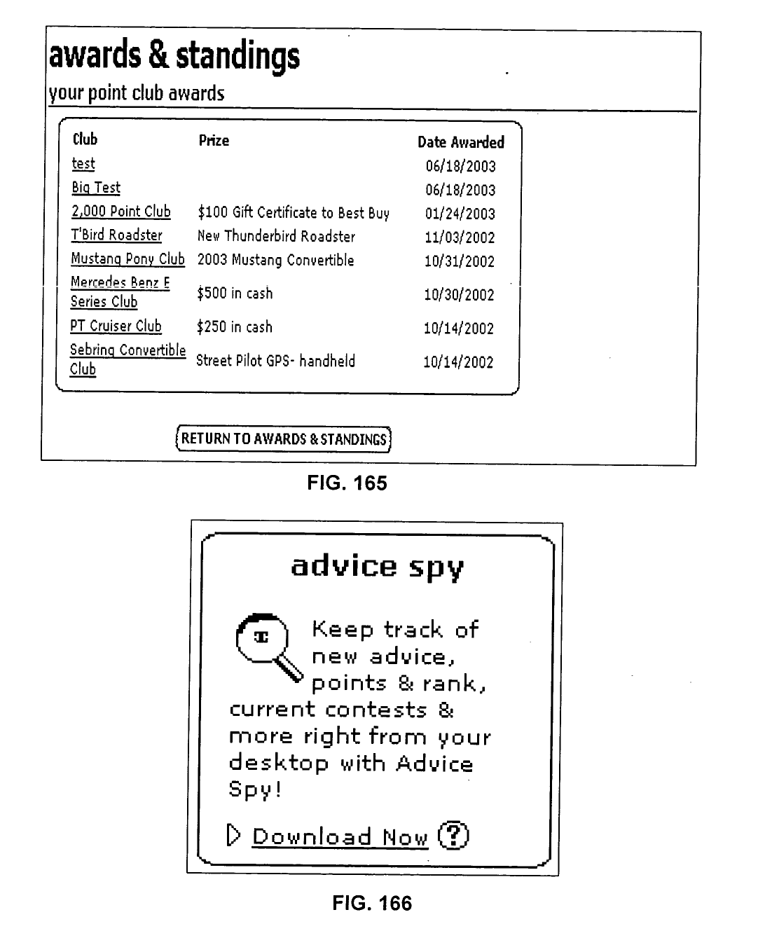

Point Clubs, in which users with the highest accumulated point totals for a given period are awarded prizes, may also be established. FIG. 152A and FIG. 152B presents a preferred example of how a point club may be established in the system and how a point club may be modified. Preferably, each time a point club is established or changed and submitted a confirmation is returned to the user as shown in FIG. 153. Users may preferably view their awards and standings by selecting the text link “awards & standings” from any page or from “my page”; the preferred display is shown in FIG. 164. Users may view their status with regard to each active point club contest as shown in FIG. 151 by selecting the text link for the point club in which they are interested. Additionally, users may view past club awards by selecting the text link “View your past point club awards” which preferably presents the display as illustrated in FIG. 165.

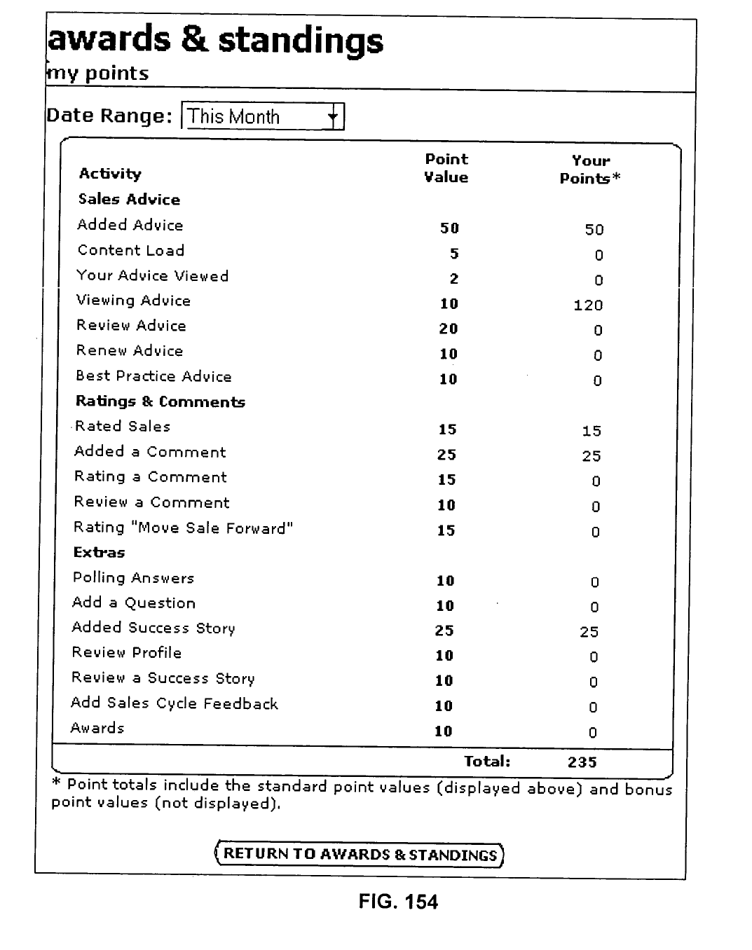

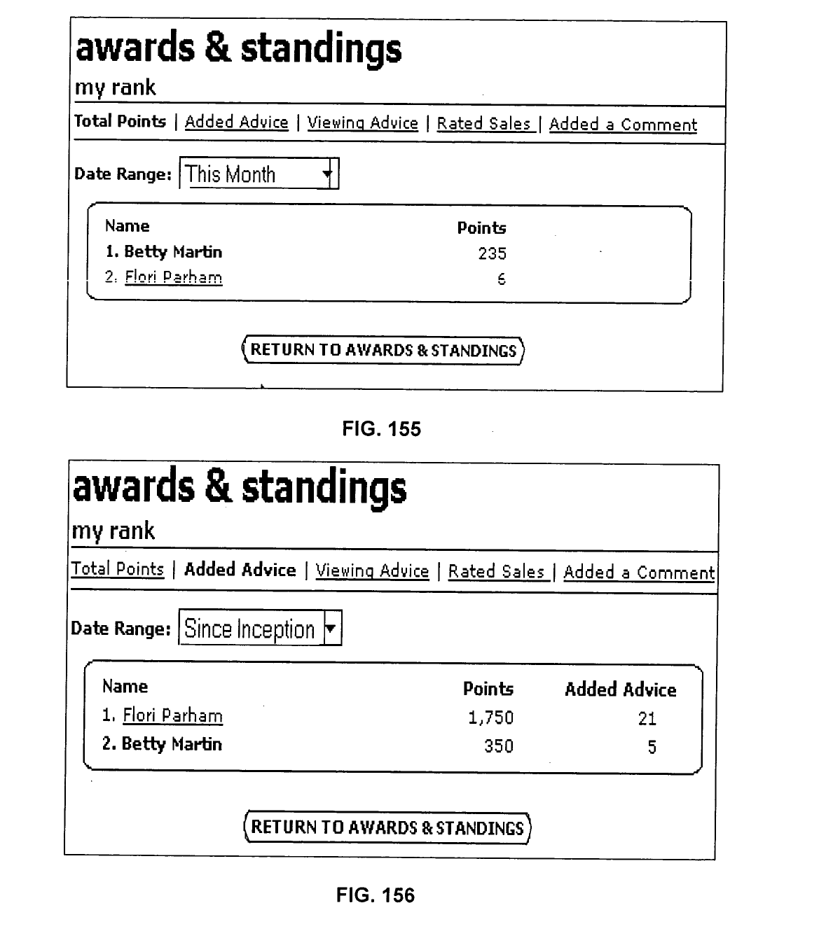

Each user is preferably presented with the user's total accumulated points and overall ranking on each page of the system as well as on “my page”. This information is presented in each place as a text link. A user may the select total points to view a summary of points accumulated for a specified period for each task for which points are awarded. A preferred display for this page is shown in FIG. 154. Selecting overall ranking value a user is preferably able to view how their point total compares to others in their functional group, as shown in FIG. 155. Preferably, each user may view the user's ranking by total points as shown, or by primary areas of tasks. By selecting a task area such as “Advice Added”, which is a text link, the display is changed to present the user's ranking with respect to points earned only in that task area. An example of a preferred display is shown in FIG. 156.

Awards & Standings/Set Up

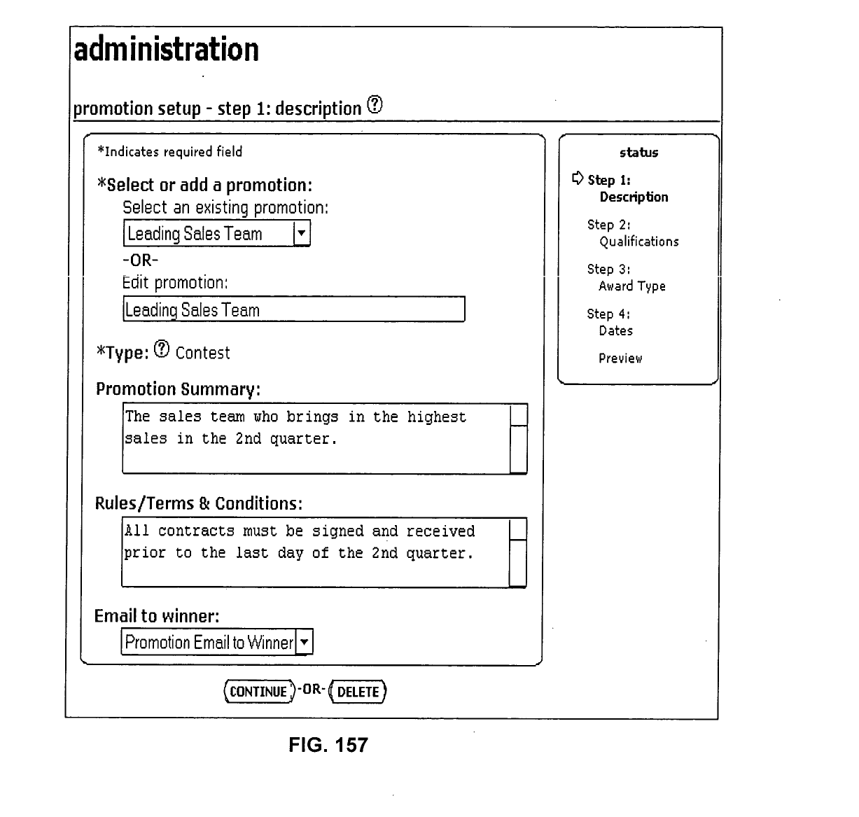

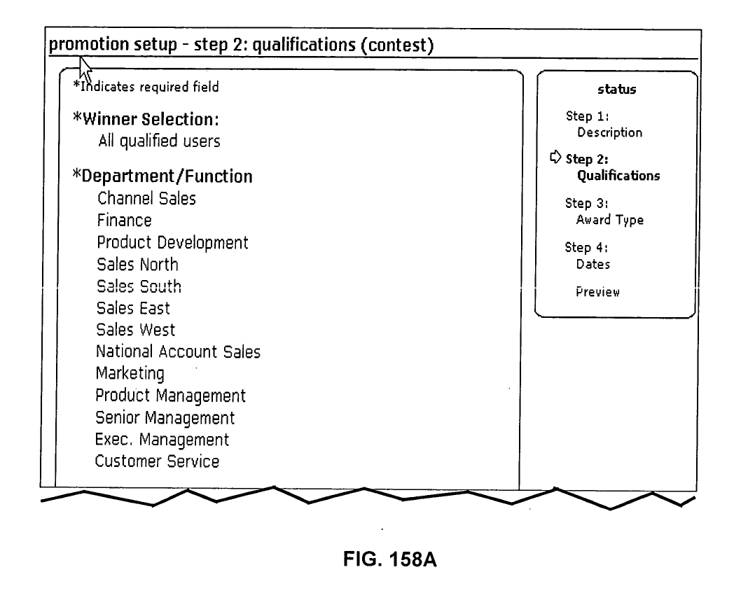

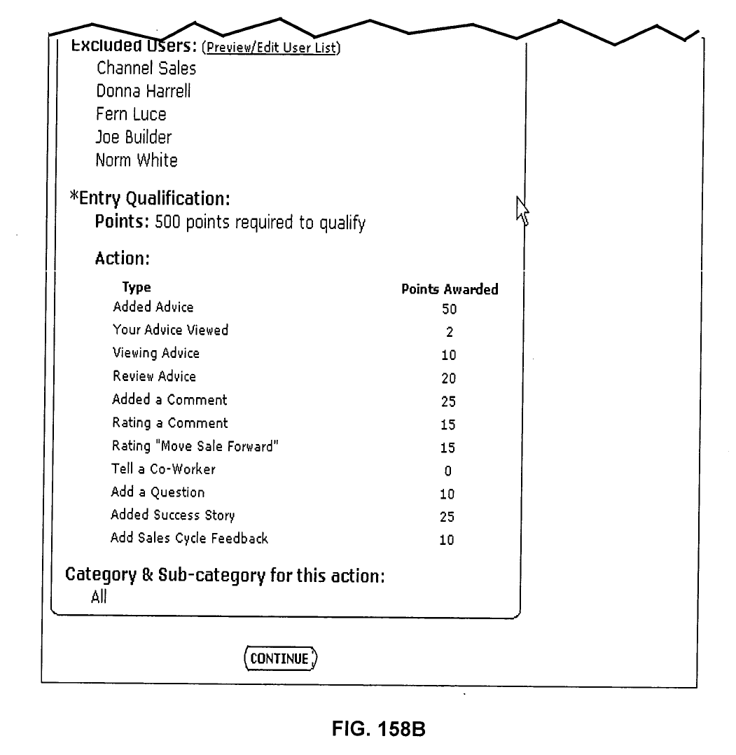

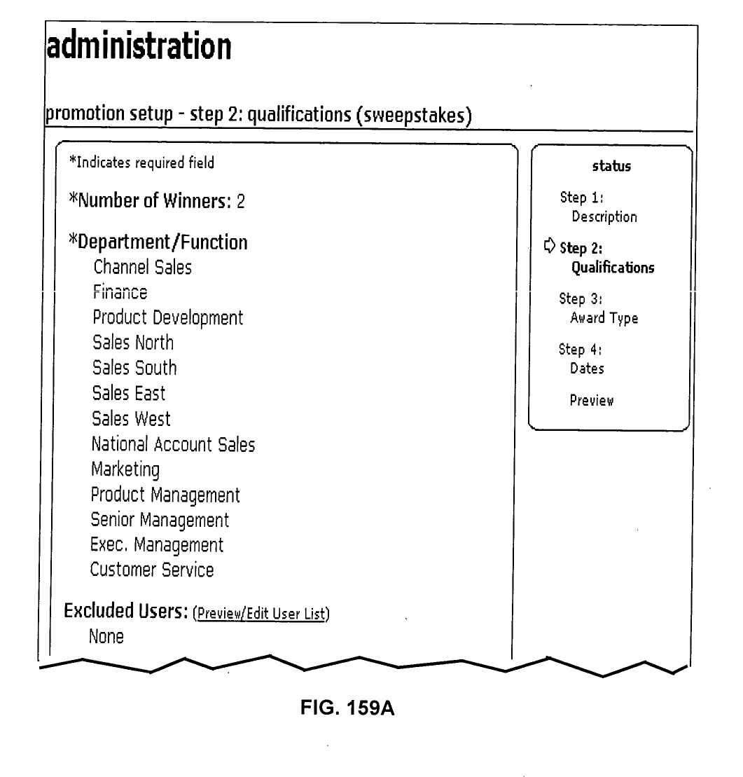

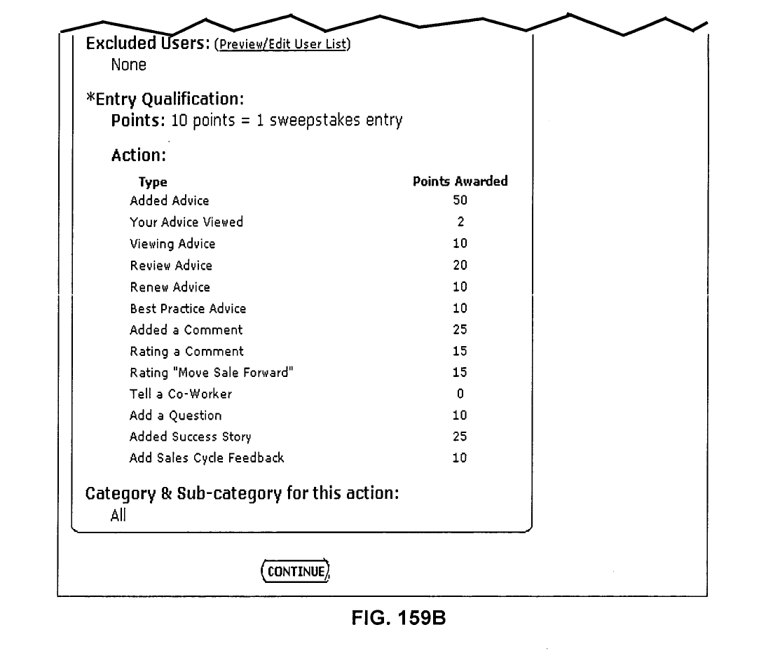

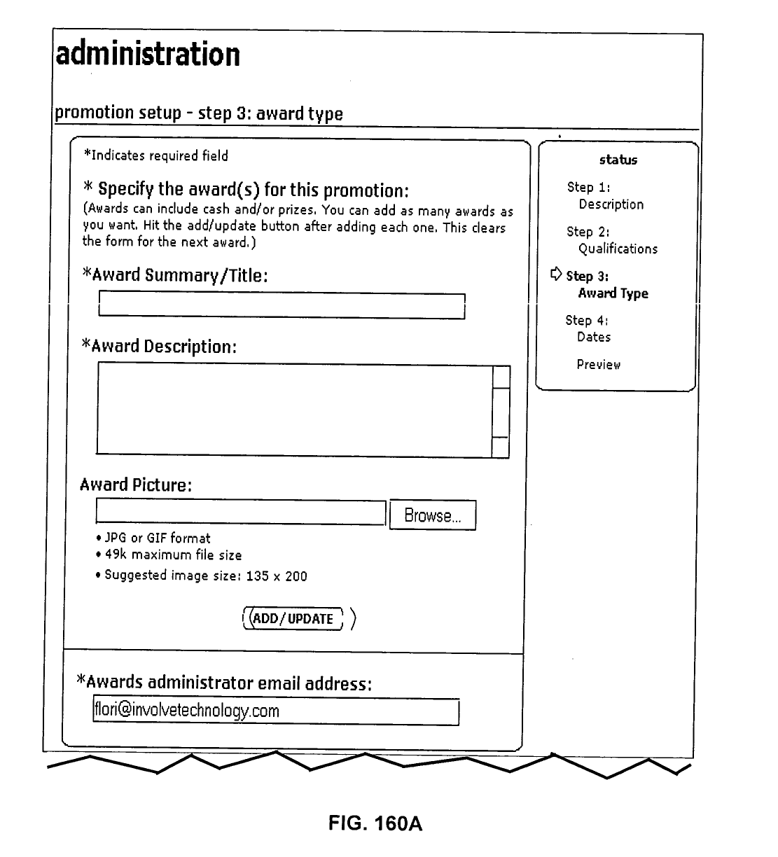

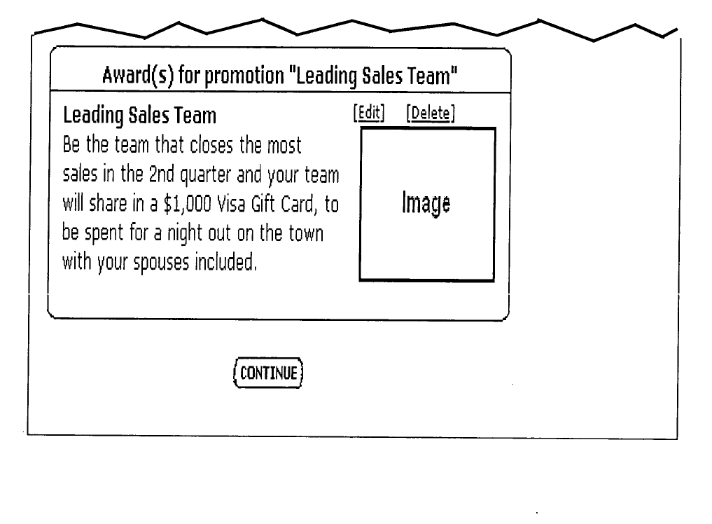

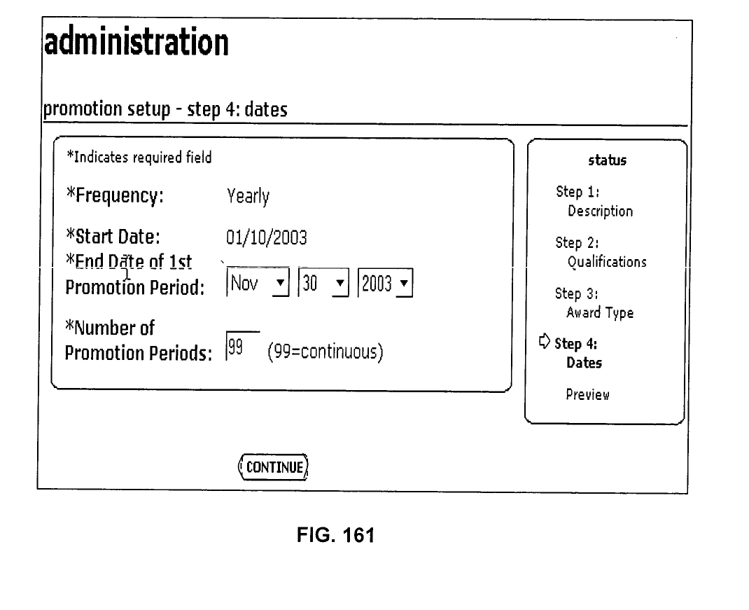

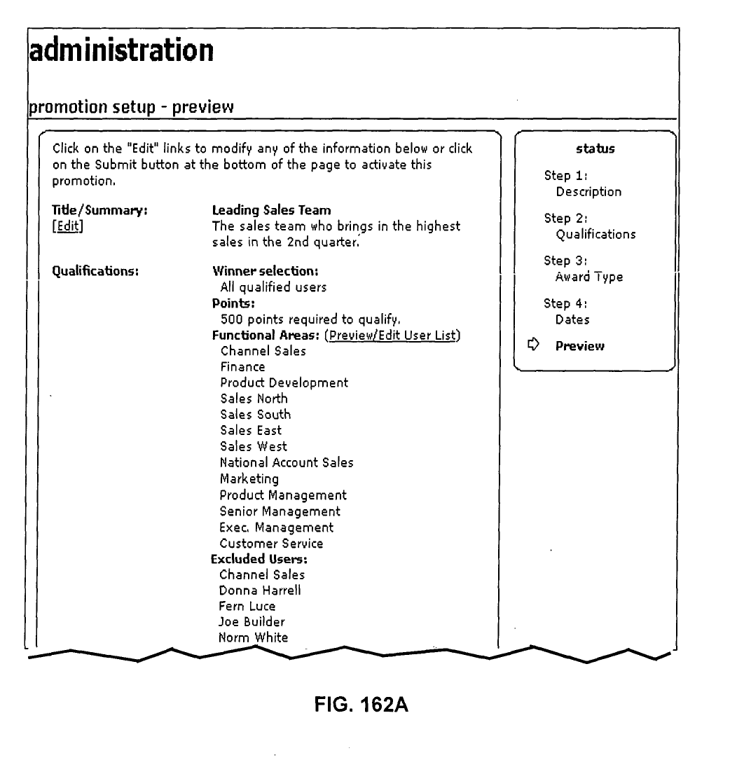

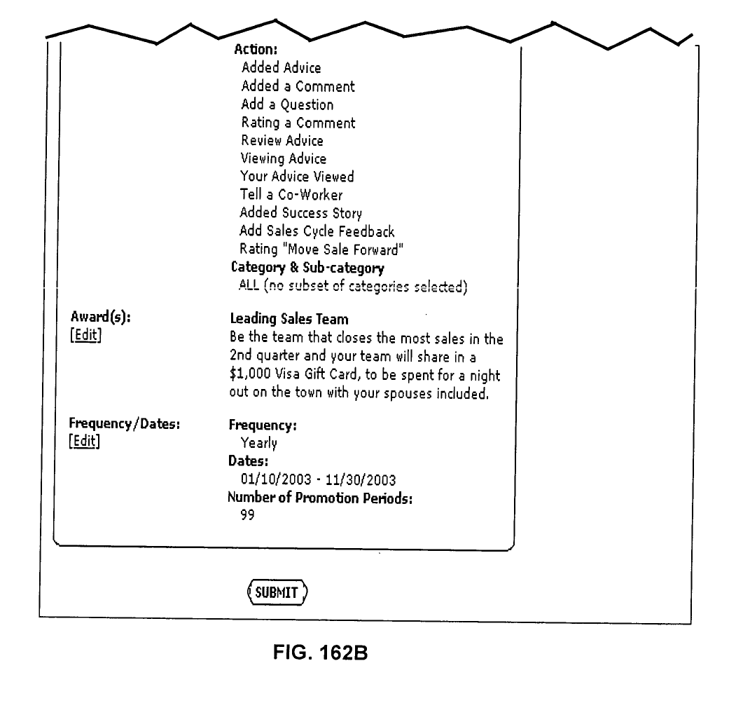

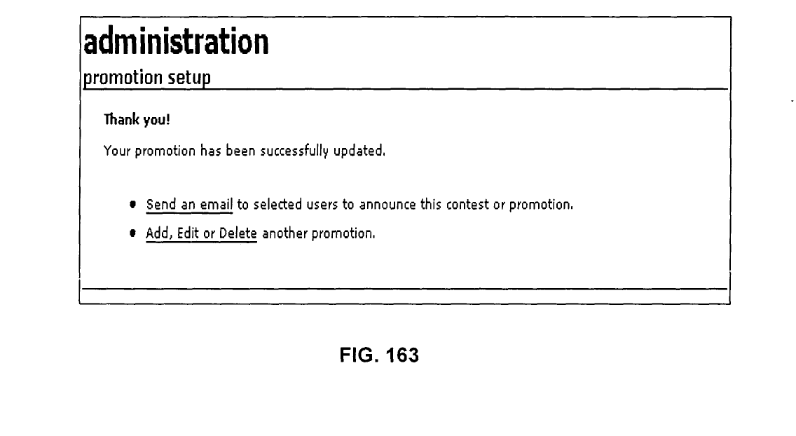

Contests and promotions are preferably set up by authorized users. Authorized users may access the contest/promotions administration modules by selecting the “promotion” text link in the administration section of “my page”. The preferred set up process requires five steps: 1) description of the contest/promotion, 2) qualifications, 3) award type, 4) dates, and 5) preview. Each of these steps is preferably accomplished by completing the information required on a screen associated with each step. Step 1, as illustrated by FIG. 157, requires completion of the contest/promotion descriptive information and terms and conditions and selection of the type of contest/promotion. Step 2 preferably requires the authorized user to establish which actions will be used and the points to be awarded for a contest/promotion, as illustrated in FIG. 158A and FIG. 158B. User can determine how many or what percentage of users win, what functional departments are qualified to participate, which individuals from these functional departments might be excluded, how many points are necessary to qualify to win, what actions and what points associated with those actions count, and what categories or subcategories these actions would take place in that would count. If the contest/promotion is a contest, as also illustrated by FIG. 158A and FIG. 158B, the requirements to be completed by the user include qualifications to be a winner and which organizational departments or functions are eligible to participate. For a sweepstakes type of contest/promotion the preferred requirements are illustrated in FIG. 159A and FIG. 159B. Step 3 is preferably completed only for contests and sweepstakes types of contests/promotions and preferably allows authorized users to identify the planned prizes as shown in FIG. 160A and FIG. 160B. Step 4, as illustrated in FIG. 161, preferably is used to set the start and end date of the contest/promotion as well as its frequency. Step 5 is preferably a review of all the information entered to set up the contest/promotion in step 1 through step 4. If changes are required the user may edit any segment by selecting the edit text link displayed within each segment of the pages. The preferred review screen for contests and sweepstakes is shown in FIG. 162A and FIG. 162B. After submission of contest/promotion information the user is provided a confirmation as illustrated in FIG. 163.

User Directory

In a second described preferred embodiment of the present invention, the system preferably provides the facility to include all user's names, organization departments and city and state locations in the knowledge base. Each user may preferably access the directory by selecting the “directory” text link in the header area of each screen in the system. Those with ordinary skill in this art will appreciate that minor differences in screen text, design and background are variations not critical to the instant inventions.

Advice Spy

In a second described preferred embodiment of the present invention, the system preferably provides the facility to provide users of the system to be informed of changes in database content in an automated fashion without the need to start or use a browser program. Once Advice Spy is initiated it runs continuously and unobtrusively on the user's personal computer allowing quick access to key information.

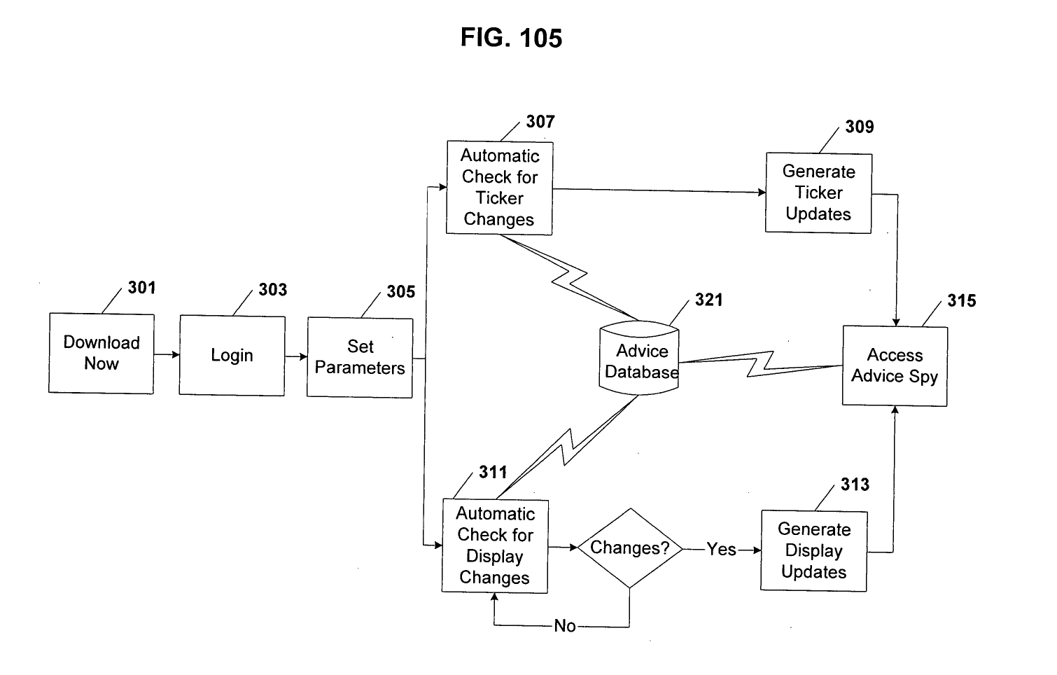

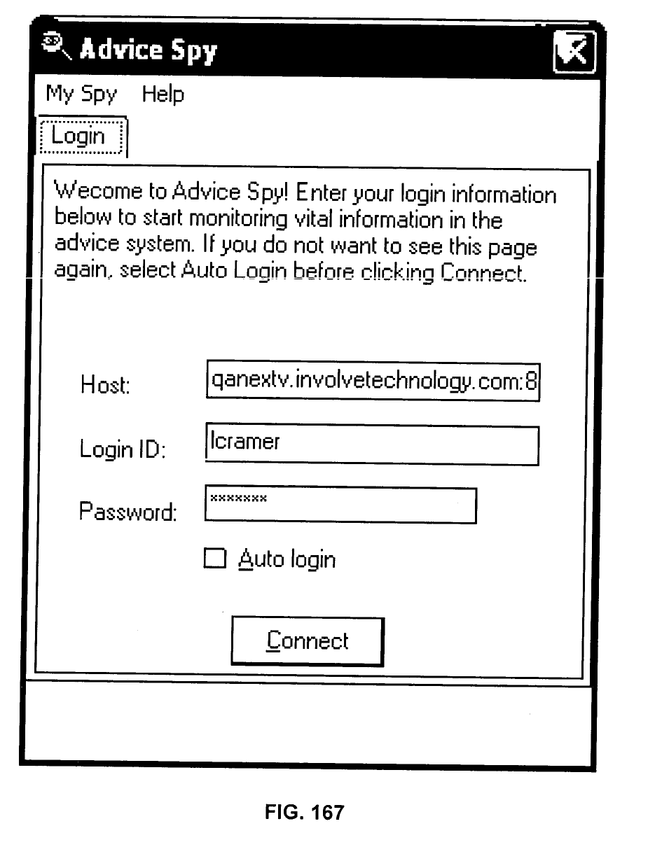

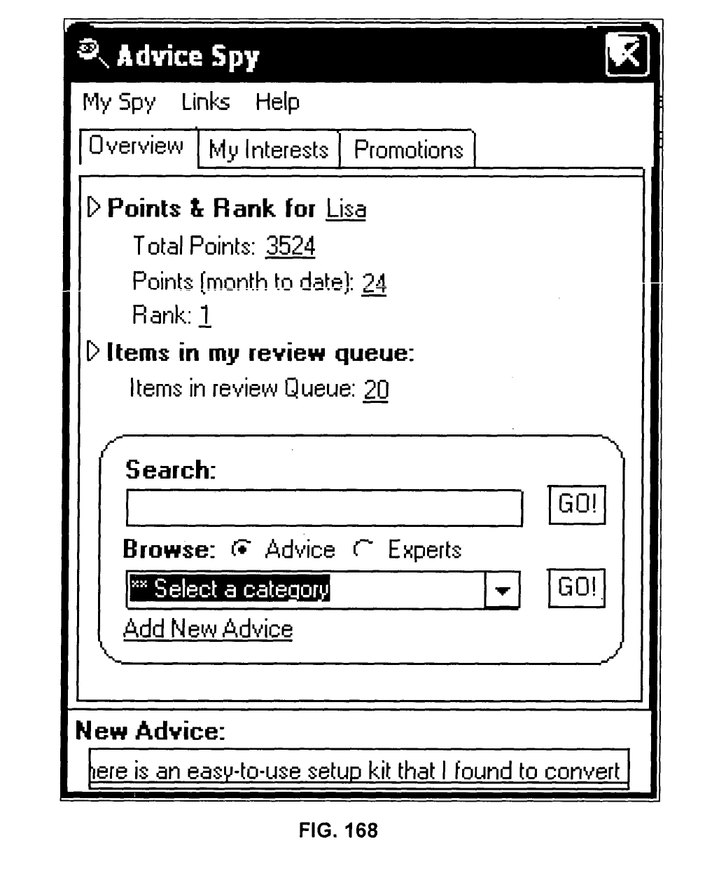

Referring to FIG. 105, preferably, each user may initiate the installation of the Advice Spy module from “mypage” by selecting the text link “download now” 301 located in the advice spy section as illustrated in FIG. 133B. Preferably, after completion of installation of the module, the user may configure the Advice spy module by first setting up the login and host information as shown in FIG. 167. After successful login 303, the user is presented with a summary view of their mypage information using their mypage preferences as set on through the browser. As shown in FIG. 168, preferably the first presentation is a summary of the points and rank status and items to be reviewed and options for searching or browsing the database. Additionally, a ticker display is provided at the bottom to provide immediate notice of new advice added to the database.

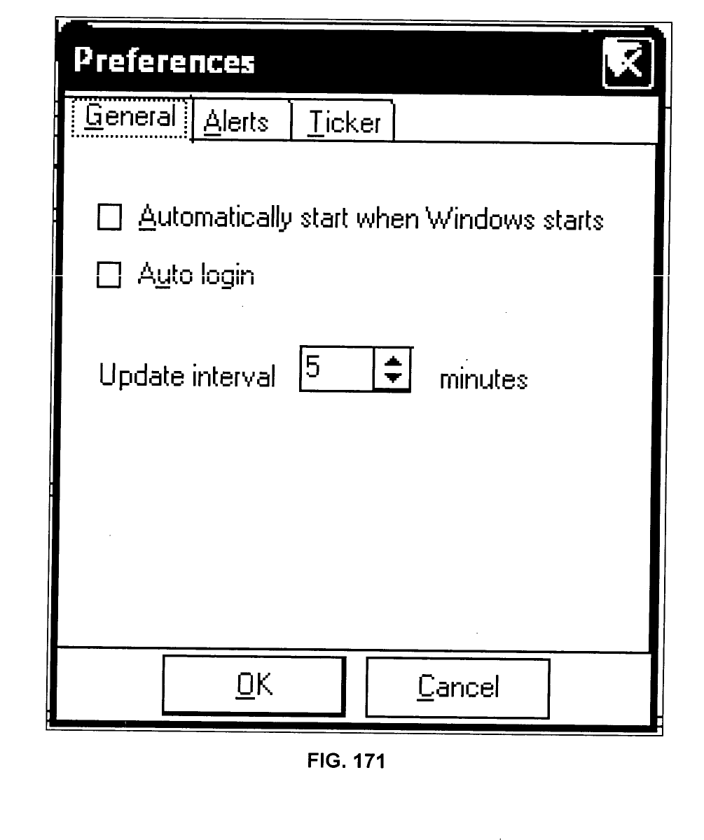

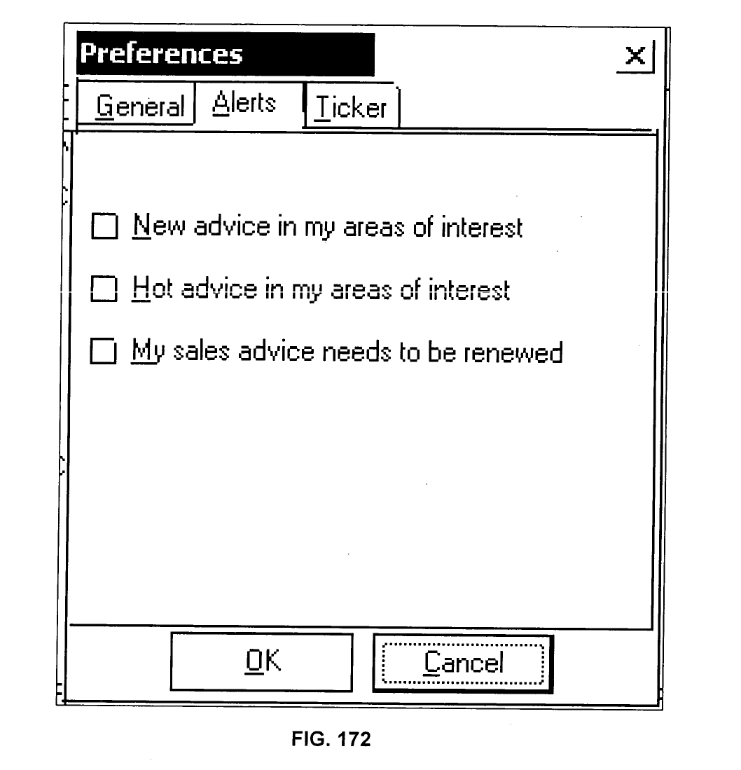

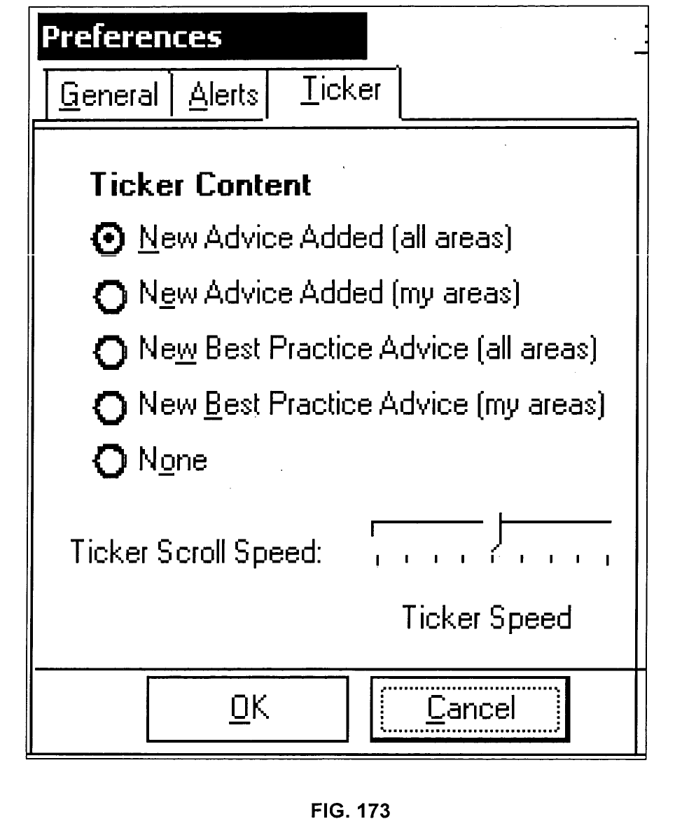

Selecting the “My Spy” item on the menu bar provides the user to set parameters 305 to set a variety of Advice Spy behavior options. As can be seen FIG. 171, the user may choose to have Advice Spy start on Windows startup, automatically login and set the time interval in which Advice Spy will query the database to obtain updated counts and new ticker display information. Additionally, the user may preferably request alerts be sent whenever new advice is added to the user's areas of interest, likewise for any “hot” advice is added in the user's areas of interest, or when entries added by the user are due for review and renewal. FIG. 172 illustrates the preferred screen for setting the types of alerts desired by users. Finally, selecting the Ticker tab presents the ticker display options available to the user. Particularly, the user may preferably optionally set the types of advice information to be displayed on the ticker display, shown in FIG. 173. Once these parameters are set Advice Spy will preferably automatically perform an Automatic Check for Ticker Changes 307 by reading the Advice Database 321 on the time interval set by the user. Similarly, Advice Spy will perform an Automatic Check for Display Changes 311 by reading the Advice Database 321. If changes in ticker display content are detected after checking for new subjects since the last check, preferably Advice Spy will Generate Ticker Updates 309 for presentation to the user. If changes in display content are detected after checking for new subjects since the last check, preferably Advice Spy will Generate Display Updates 313 for presentation to the user. As a result, preferably the most current information is presented each time the user switches to Advice spy, in the Access Advice Spy 315 step.

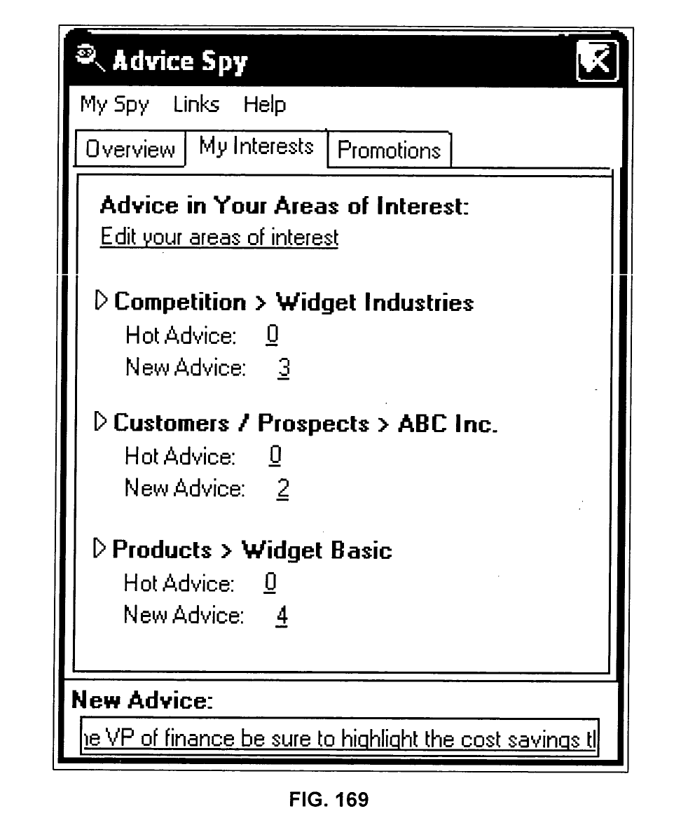

Preferably, the user may select the My Interests tab to view details of new advice added in the user's area of interest as well as advice that has been designated as “hot” when it was published to the database, as illustrated in FIG. 169. Preferably, selecting the text link associated with the count in each classification will start the user's browser and present a list of the subjects with the particular classification, as example of the listing of subjects is provided in FIG. 113. As can be seen, the ticker display remains present even though the user may select a different Advice Spy display. Finally, preferably the user may select the text link “Edit your areas of interest” which will initiate the user's browser and permit the user to make any desired changes in the areas of interest section of the user's mypage.

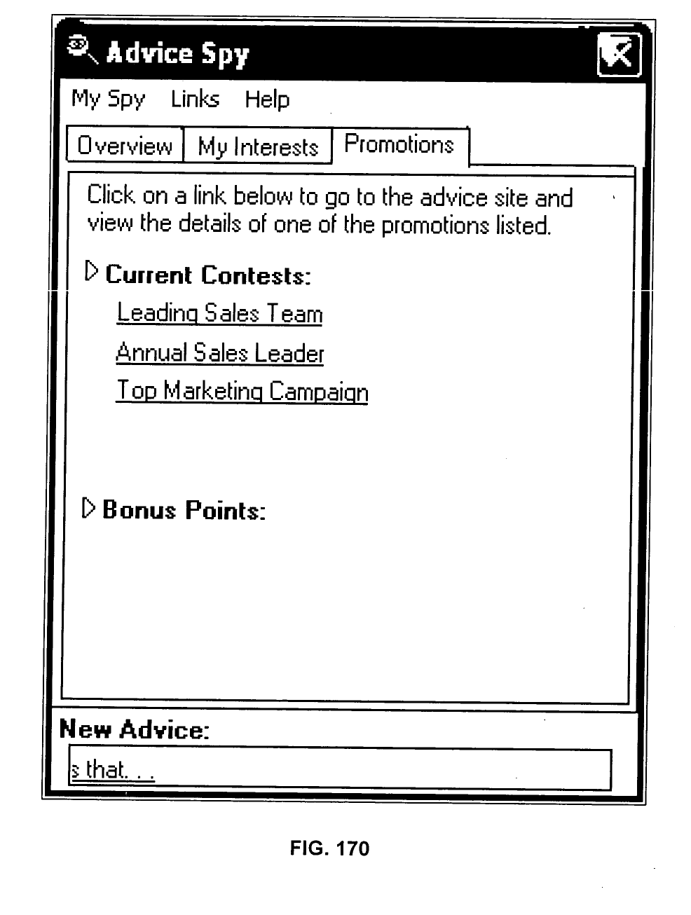

Preferably, the user may also keep track of the user's status with regard to current contests and bonus points earned by selecting the promotions tab, as shown in FIG. 170. As shown each contest is displayed as a text link to the database which allows the user to quickly view their standing in any current contest. Similarly, preferably the user may select a bonus point value to understand the user's how the points were earned and the user's rank as compared to others.

Reporting

In a second described preferred embodiment of the present invention, reporting will be available to users based their on security permission levels. Reporting preferably is browser based and initiated on request by the user. Each user is preferably granted access to some number of reports. This access authorization is further described in the description of the administration and configuration section below. Preferably all reports provided are created in fashion that allows the user to “drill down” on particular value or area up to five levels of detail, until the individual or a specific advice is viewable. Preferably, the system accumulates a variety of information to support the reporting, including points awarded to each user, usage counts, etc., for advice entries. Usage information captured and accumulated also includes details regarding the user, date and time and other tracking variables necessary to support the desired reporting levels. Those with ordinary skill in this art will appreciate that minor differences in screen text, design and background are variations not critical to the instant inventions.

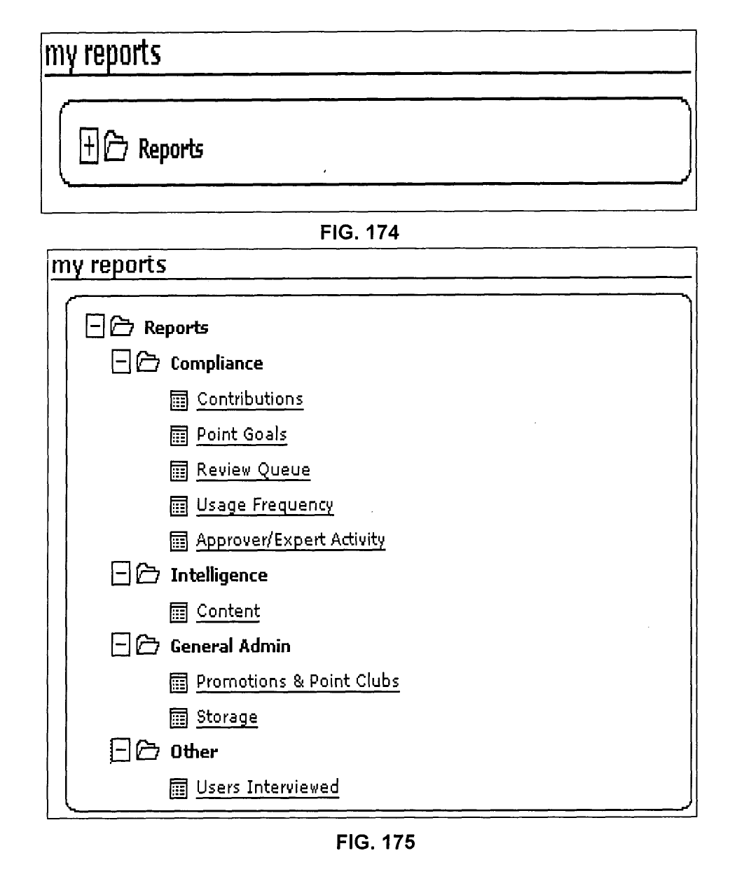

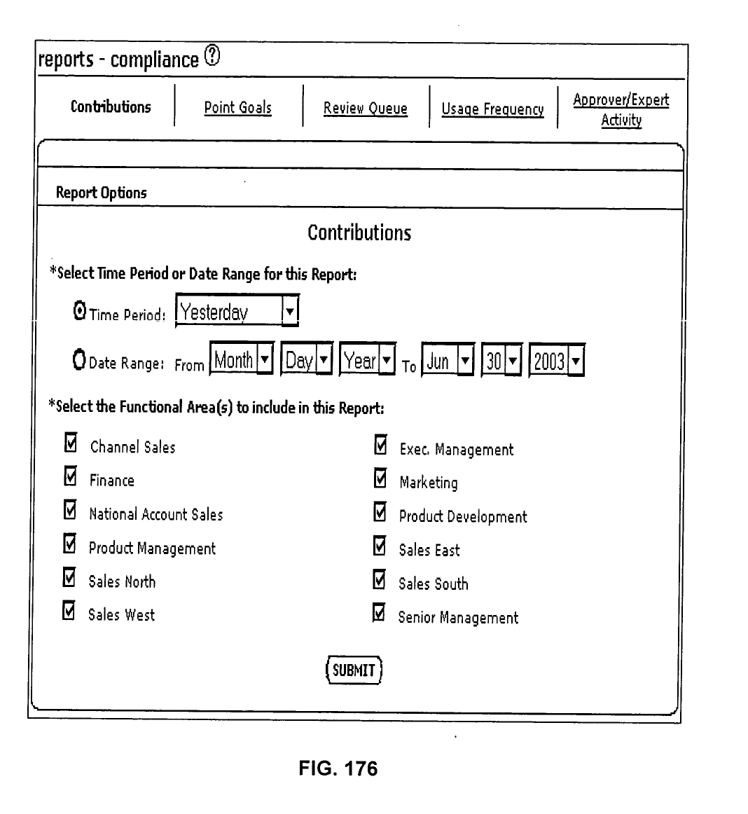

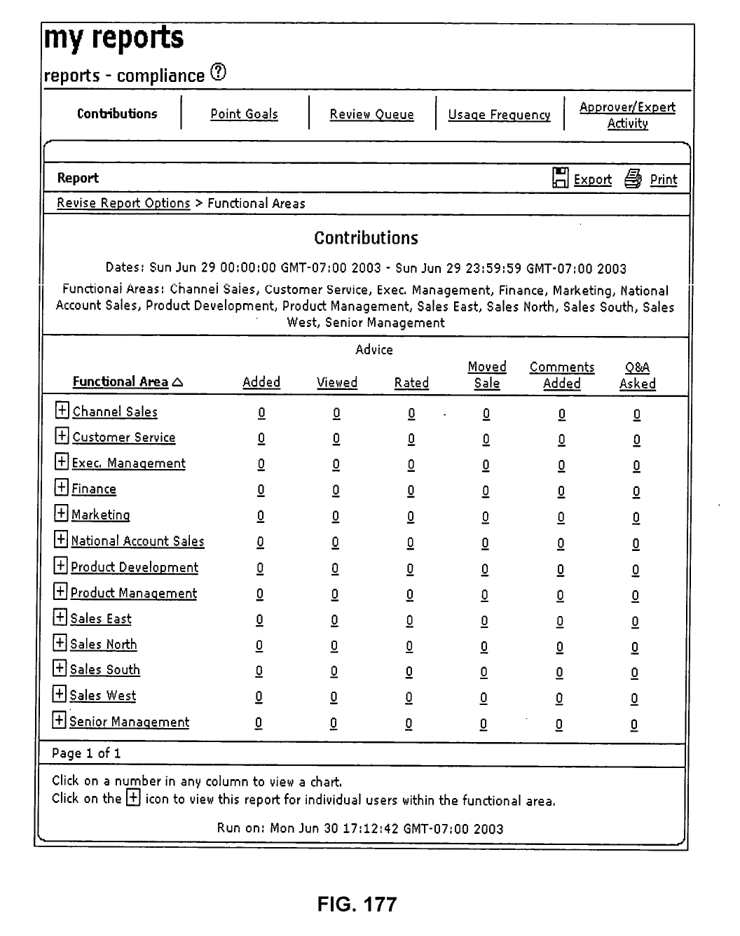

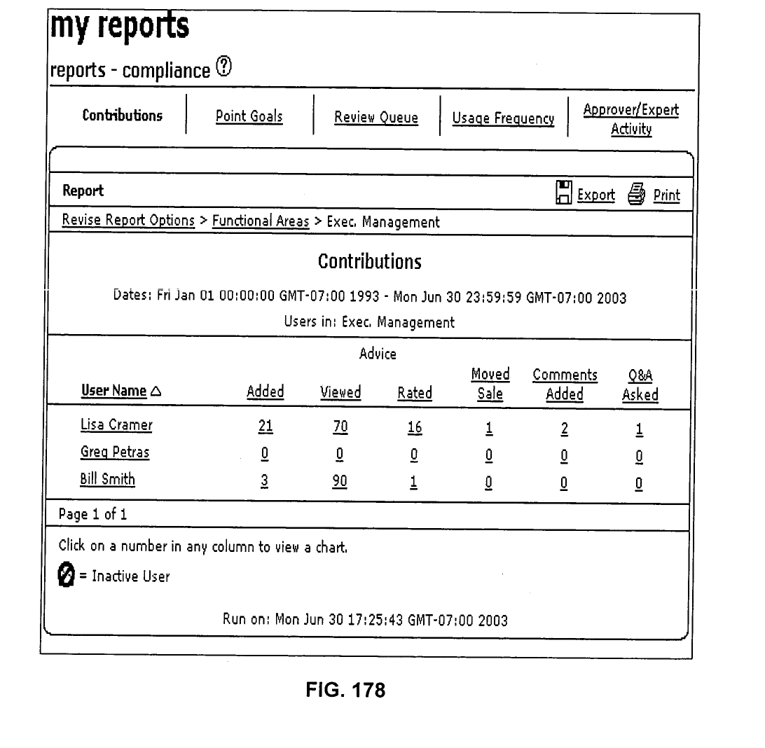

Preferably, each user may access their authorized reports as illustrated by FIG. 174 from their mypage (FIG. 133A and FIG. 133B). Selecting the “+” in front of reports presents listing of the reports a user is authorized to view, as shown in FIG. 175. Each authorized report may be viewed by selecting the text link report name. FIG. 176 illustrates the report parameters which the user may optionally set in order to view the desired information. After selecting the desired parameters and selecting the submit button the highest level of summarization for the chosen report is presented to the user, as shown in FIG. 177. Selecting the “+” in front of each functional area will provide additional levels of detail about the total with any subsidiary functional areas. Additionally, selecting any value in the columnar portion of the report will preferably provide detail as to the individuals whose actions, in combination, account for the summary total as shown in FIG. 178. This represents a third level of drill down into the information.

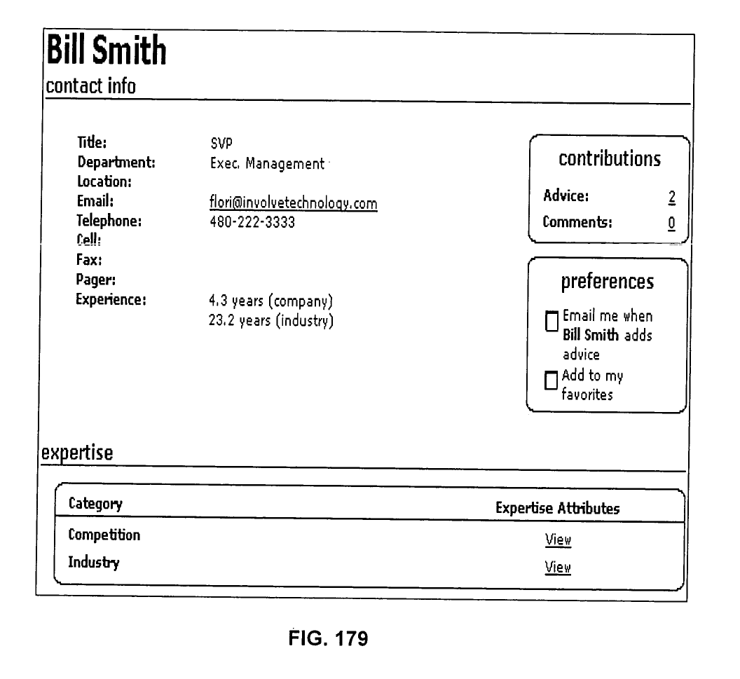

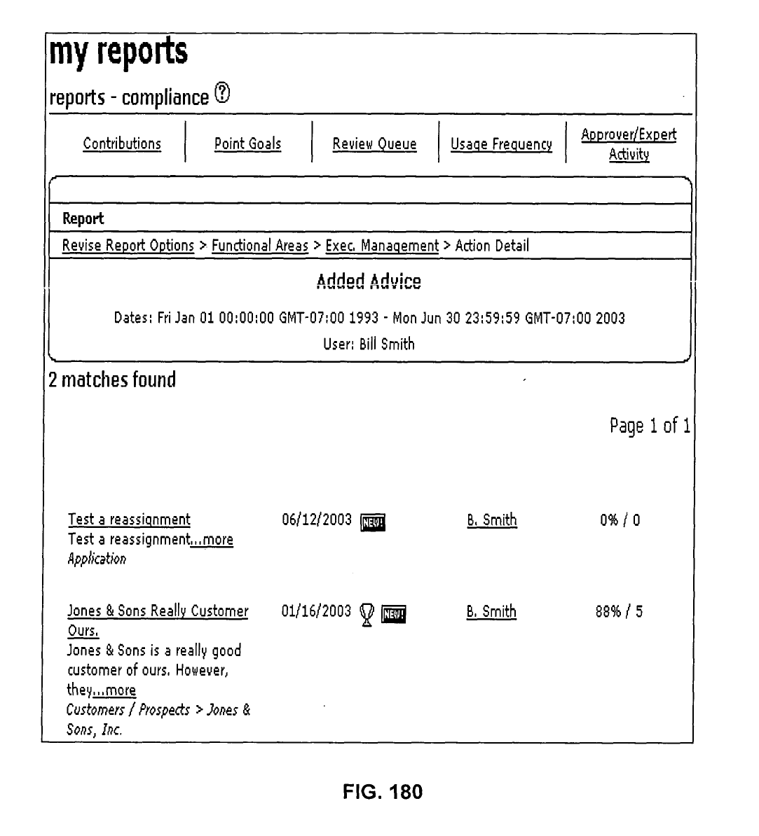

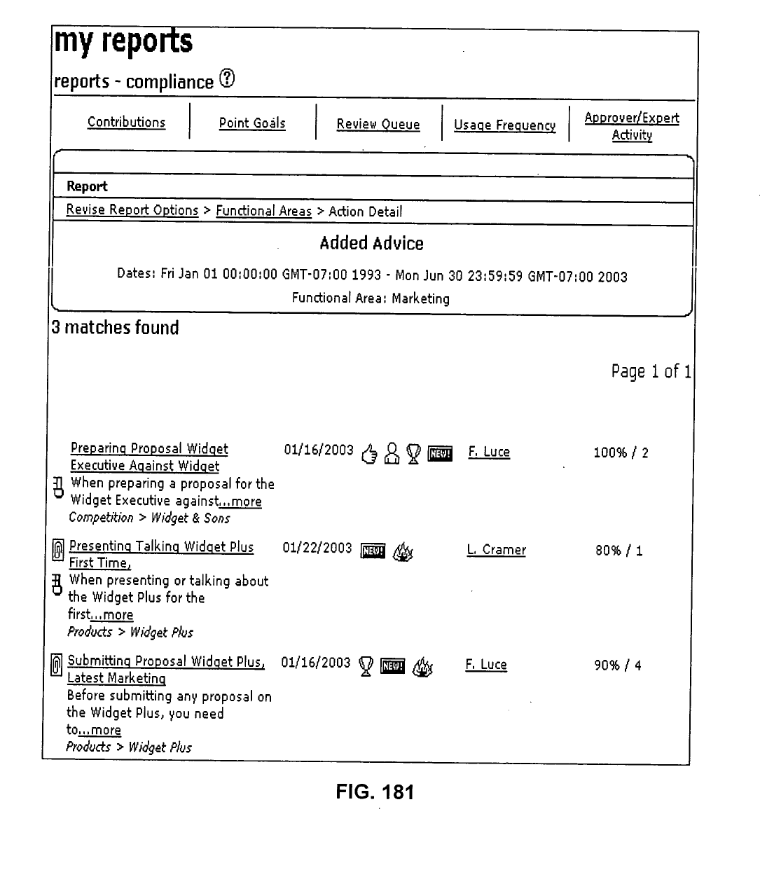

Selecting the person's name text link will preferably provide an additional level of detail, in this case information about the individual as shown in FIG. 179. A fourth level of detail can be obtained by preferably selecting a columnar value text link as illustrated in FIG. 180 and FIG. 181. Finally, the user may select, in this case the advice title text link and view the details of the advice which was added by the person that resulted in points. This display is preferably equivalent to the advice detail shown in FIG. 118A and FIG. 118B.

System Configuration and Management

In a second described preferred embodiment of the present invention, several functions may be accessed from “my page” (as shown in FIG. 133A and FIG. 133B) by authorized users. These functions may preferably include: Alert Admin, Bonus Points management, Custom Email management, Executive Spotlight management, External Awards management, Functional Area Admin, News & Notes management, Point Club Setup, Polling Admin, Promotions management, System Administration and User Administration. Text links for each of these areas preferably are present on the user's “my page” if the user is authorized to access the functional area. Those with ordinary skill in this art will appreciate that minor differences in screen text, design and background are variations not critical to the instant inventions.

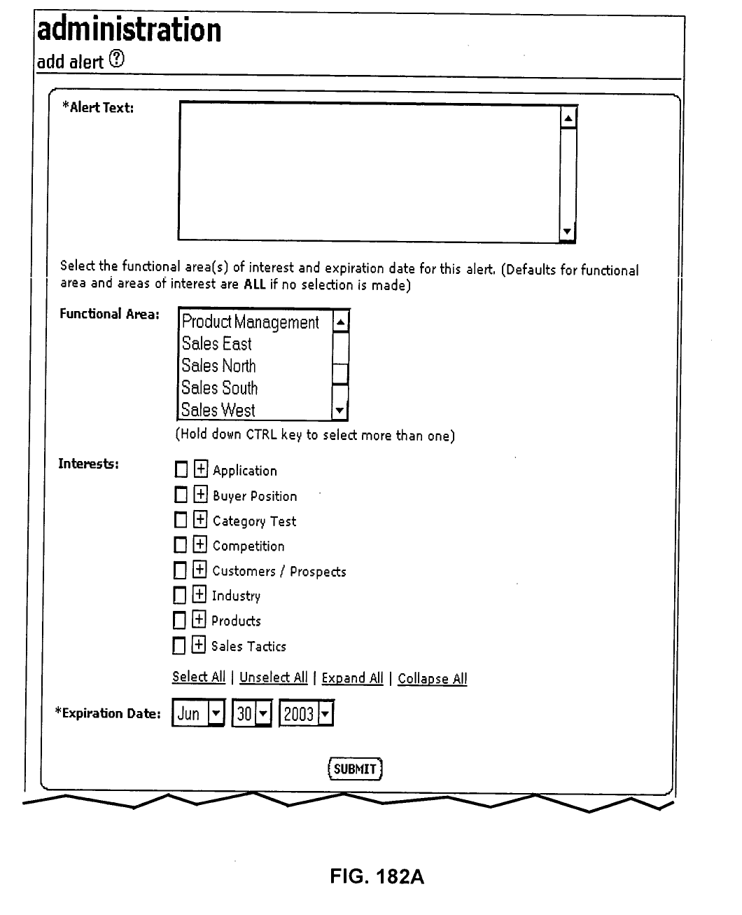

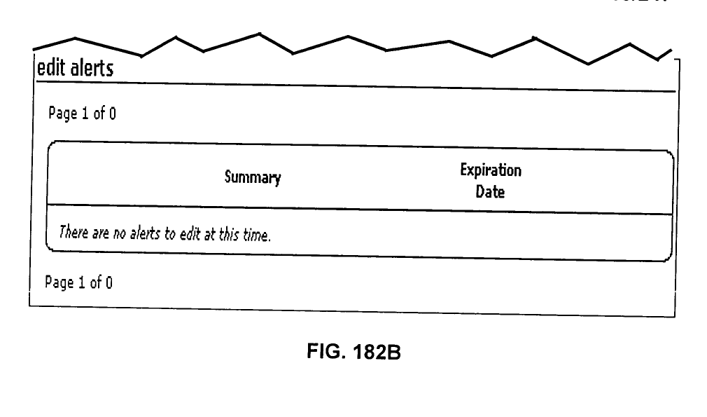

Preferably, authorized users may create and manage alerts, which are typically urgent messages displayed on the home page on initial login. An example of alert setup and management is provided in FIG. 182A and FIG. 182B. As can be seen, alerts may preferably be available to any or all users depending on the functional areas selected as well as areas of interest.

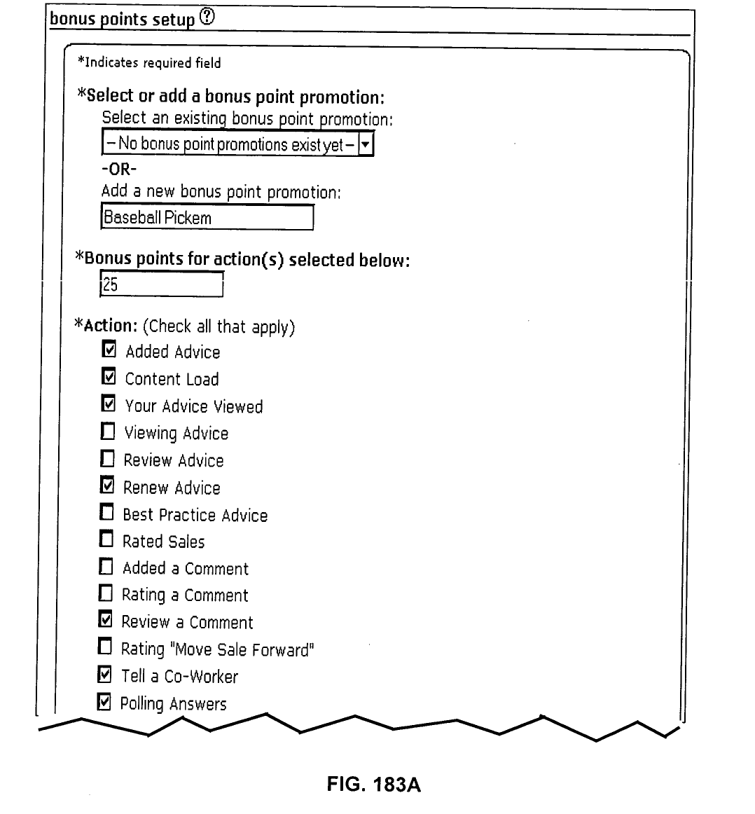

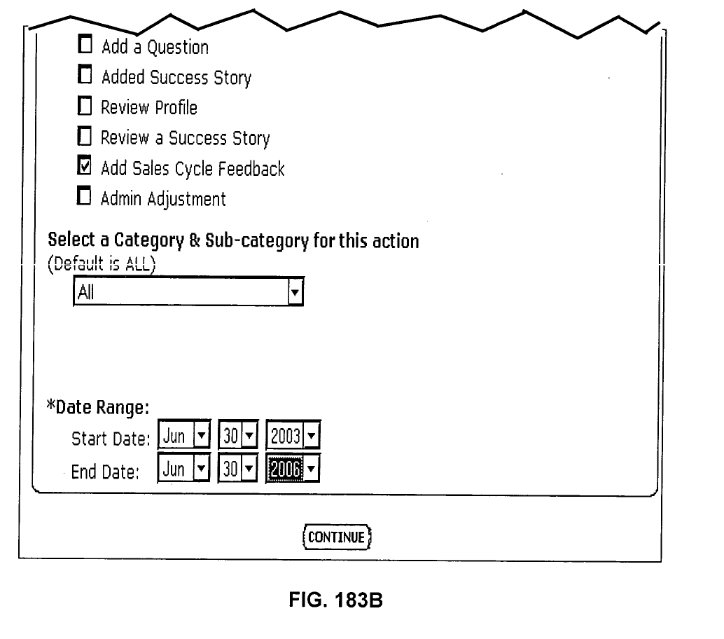

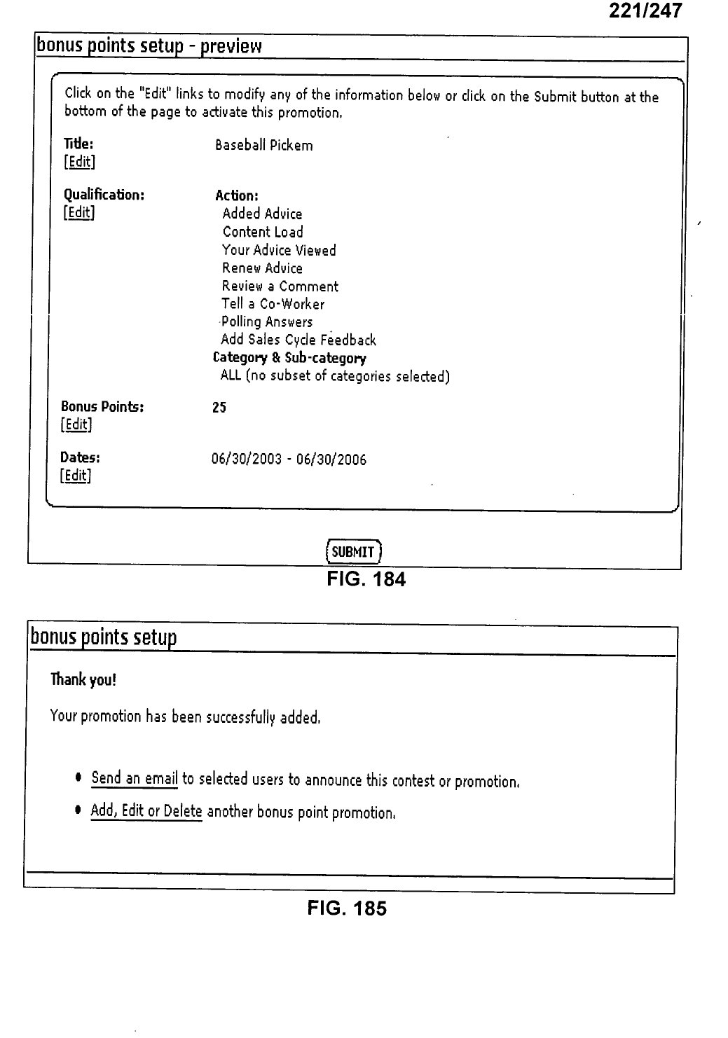

Referring to FIG. 183A and FIG. 183B, authorized users may set up bonus points plans to encourage users to utilize the system and complete desired actions, in particular adding advice in desired areas. As can be seen bonus points may preferably be assigned for a variety of actions and for certain categories. Preferably, the program can be set to run for a specified period of time. After submitting the bonus point plan, the system provides an opportunity to preview and make any changes as shown in FIG. 184. On final submission the system preferably confirms that bonus point program has been set up, as illustrated in FIG. 185.

Preferably the system provides functionality to support to general classes of email; custom (distributed once as a single message), and system (distributed periodically and containing standard, or pre-set, information). Preferably, system email distribution may be managed from a single screen by defining email types, type of distribution and frequency which will preferably apply to particular emails. Additionally, all email is preferably managed with a set of parameters which manage the actual delivery of the messages. Preferably, system emails may be prepared and edited from a single screen.

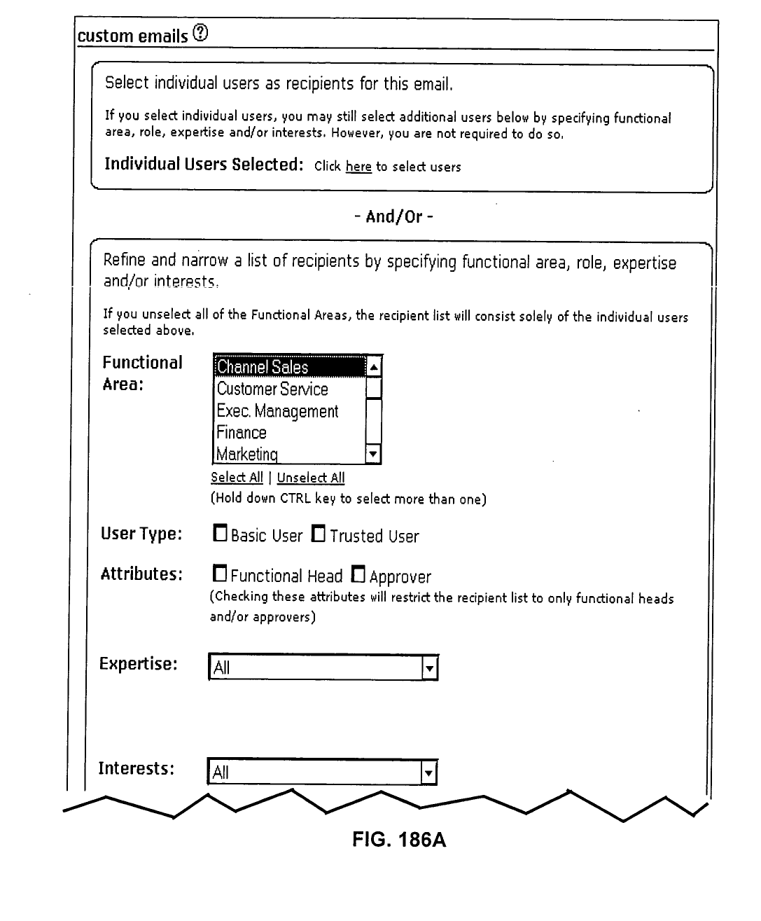

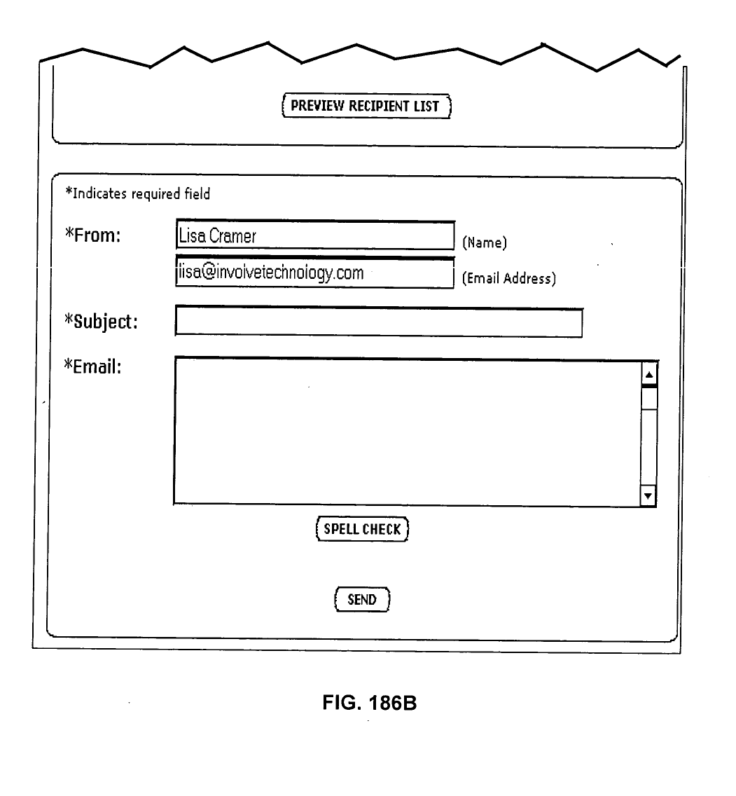

Preferably, custom emails may be prepared and circulated to selected users based on any combination of their functional area, user type, expertise in a particular category/sub-category and category/sub-category area of interest. The preferred custom email setup screen is illustrated in FIG. 186A and FIG. 186B. Those with ordinary skill in this art will appreciate that minor differences in screen text, design and background are variations not critical to the instant inventions.

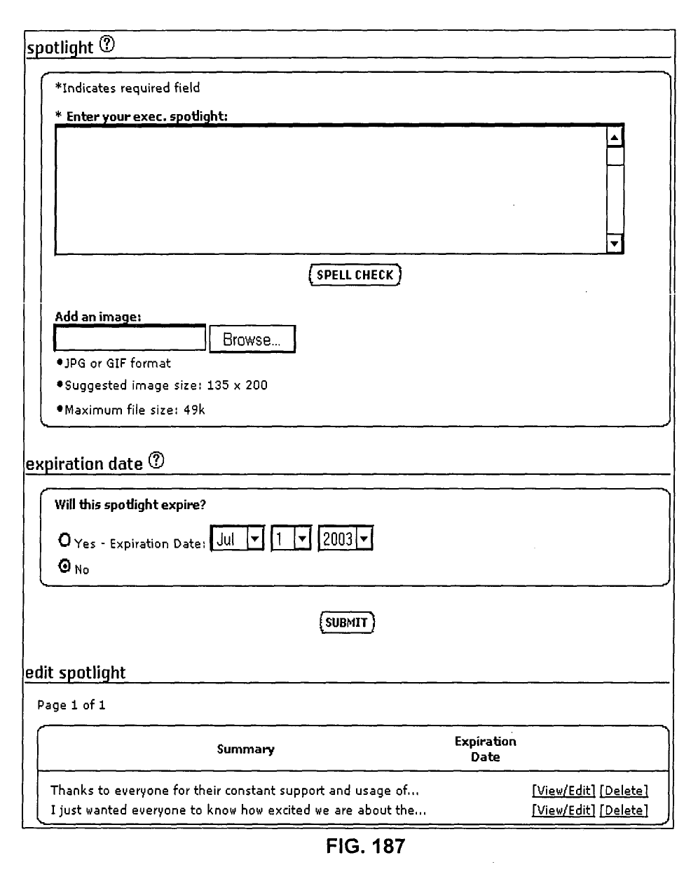

In a second preferred embodiment of the present invention, authorized users may preferably create, edit and delete the entries used in the Executive Spotlight section of the home page (FIG. 110A and FIG. 110B). Referring to FIG. 187, preferably authorized users create an entry, include a picture and set the date range it will be displayed. Existing executive spotlight entries may also be edited as depicted as the bottom of the screen.

In a second preferred embodiment of the present invention, functional area administration preferably encompasses all the settings associated with functional areas defined to the system. These settings preferably include setup, category access, user access, functional area report access, expertise keywords, and intro page. Each of these will be further described below.

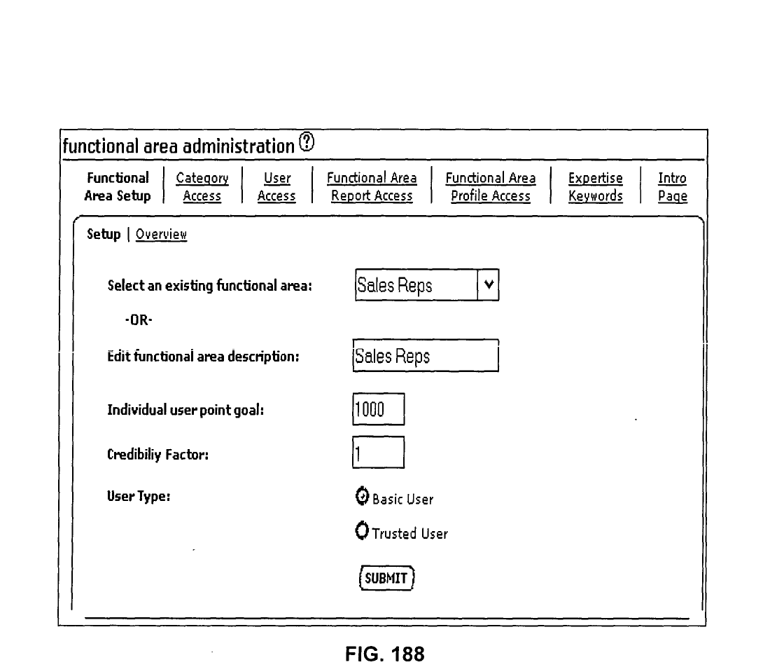

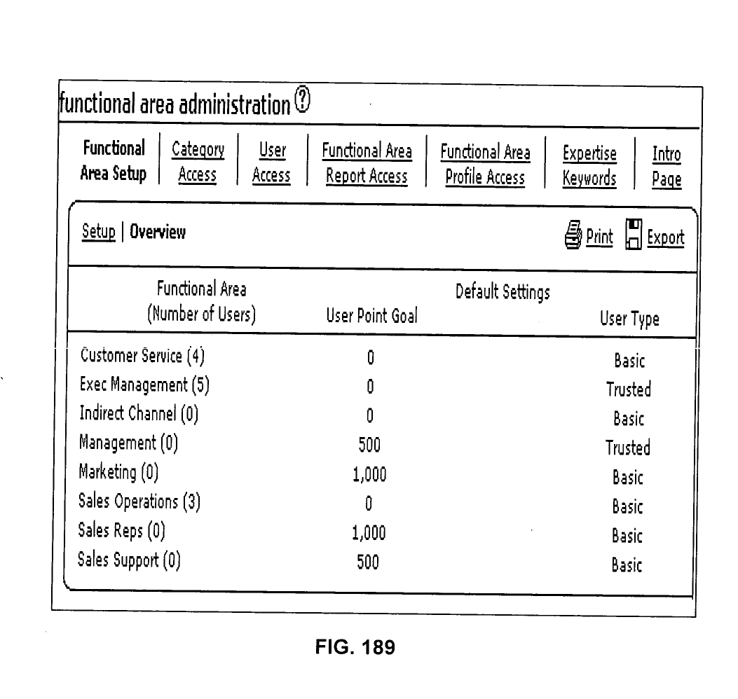

Preferably, authorized users may preferably use the functional area setup screens to define the basic characteristics of each functional area. As can be seen in FIG. 188 each functional area can be defined in terms of the credibility factor, a value used to weight a user's comments and ratings, the typical user type and expected point goal. After submission the parameters are provided for review and confirmation is provided of system acceptance. Selecting the “overview” text link will preferably provide a summary display of all functional areas and their related characteristics as shown in FIG. 189.

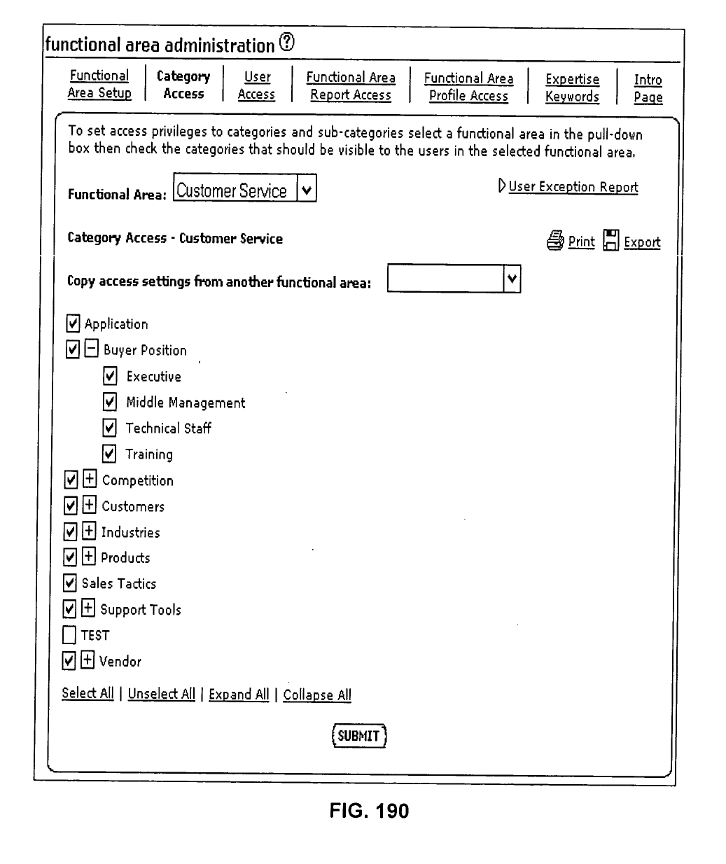

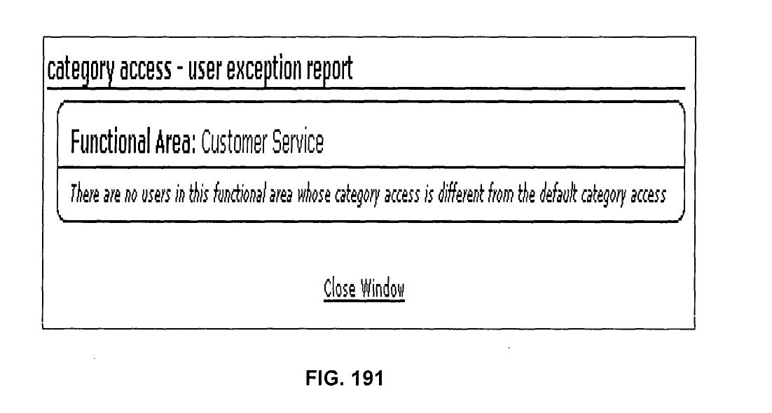

Referring to FIG. 190, preferably authorized users may define which categories may be accessed by members of each functional area by checking the appropriate categories. This preferably provides a means to prevent access to categories of information to selected groups. Selecting the “user exception report” text link will preferably create the report as shown in FIG. 191, which identifies individuals whose functional level access has been overridden.

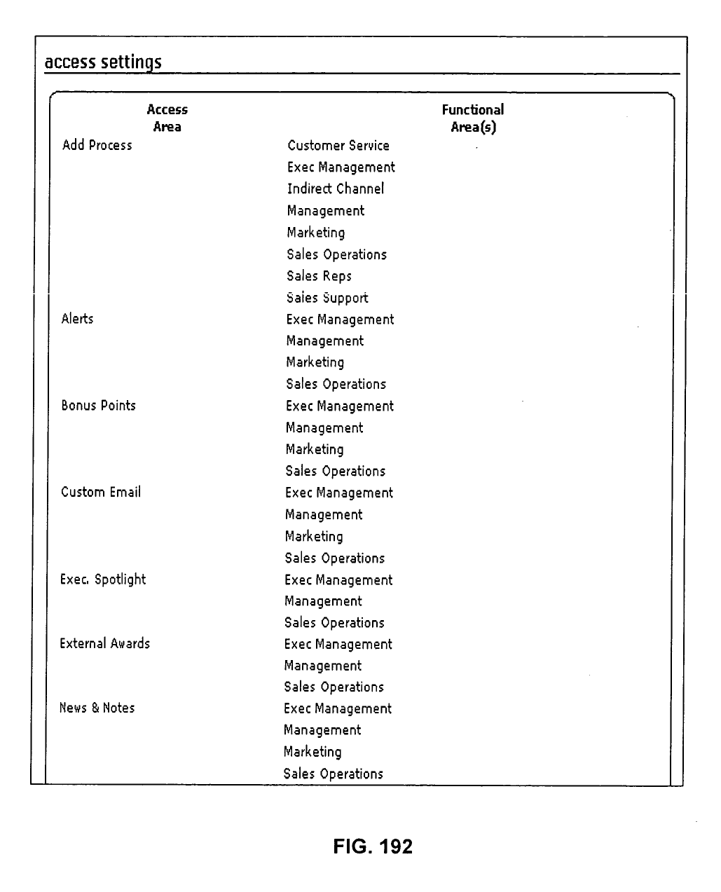

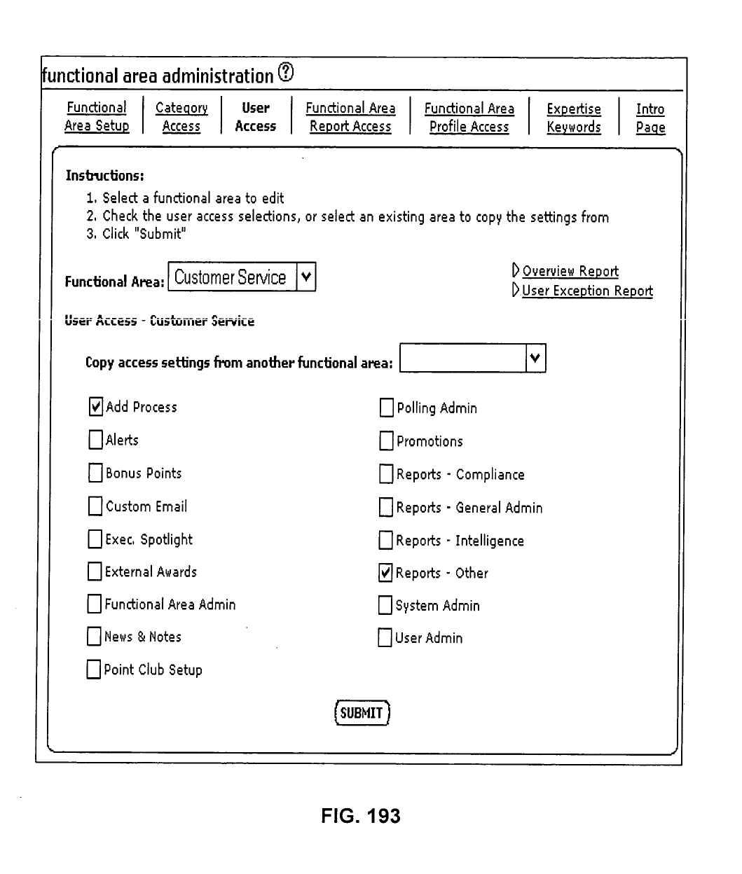

Referring to FIG. 193, preferably authorized users may select which actions are available to each functional area. It is of benefit in specific situations to limit access to certain actions, such as a functional area which includes non-employees being restricted in their ability to add or change content. As with other administration areas it is possible to override the functional area restrictions on an individual-by-individual basis. Referring to FIG. 192, a display is provided of authorized actions for each functional area which preferably aids a user in reviewing authorizations for changes and additions. This display is access by selecting the text link “Overview Report” as shown in FIG. 193.

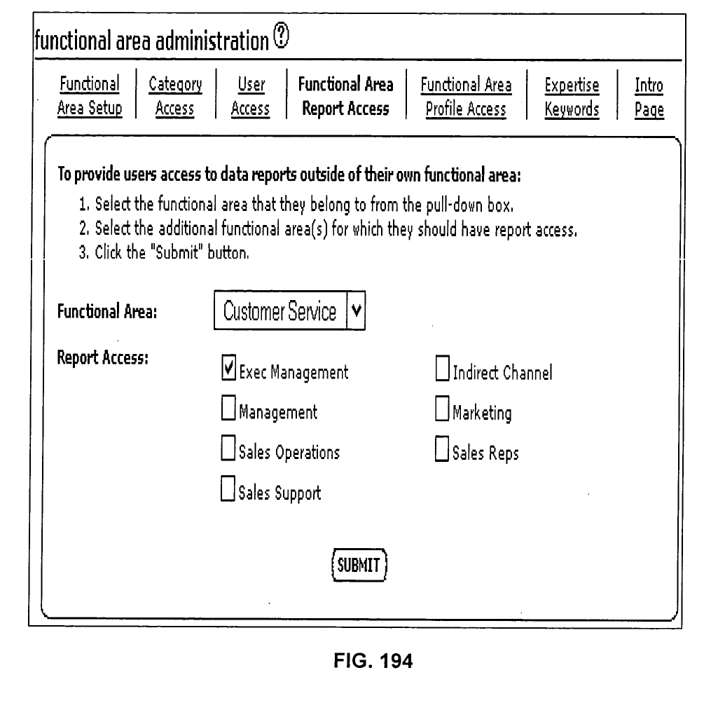

Referring to FIG. 194, preferably authorized users may limit access to a particular segment of reports, such as preventing a functional area which includes non-employees from viewing executive management reports. Preferably, limiting access to a segment of reports, does not limit a user's ability to drill down within the reports authorized for the user.

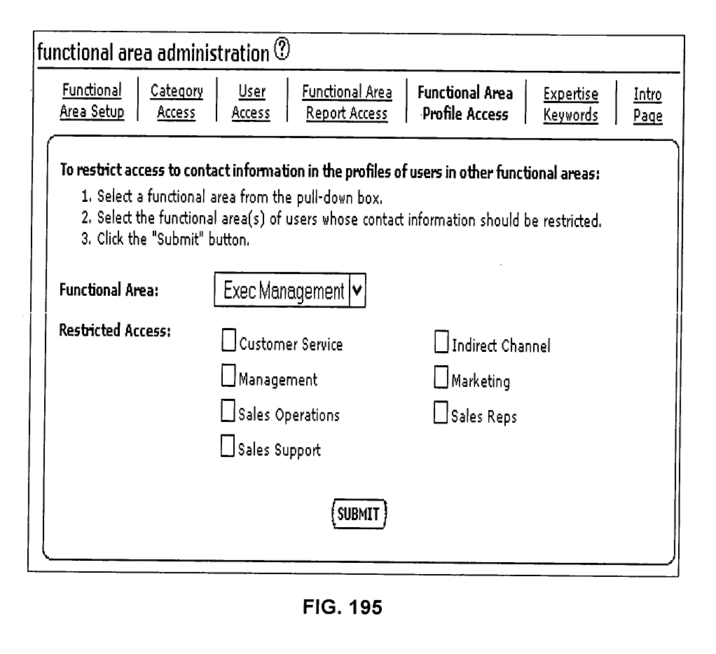

Referring to FIG. 195, preferably authorized users may limit the ability to access profile information for members of a selected functional. This will preferably limit the ability of some groups to gain access to information about individuals within another functional group. This may be appropriate where different groups (functional areas) of non-employees should be limited in their ability to view information about other users outside of their own groups (functional areas).

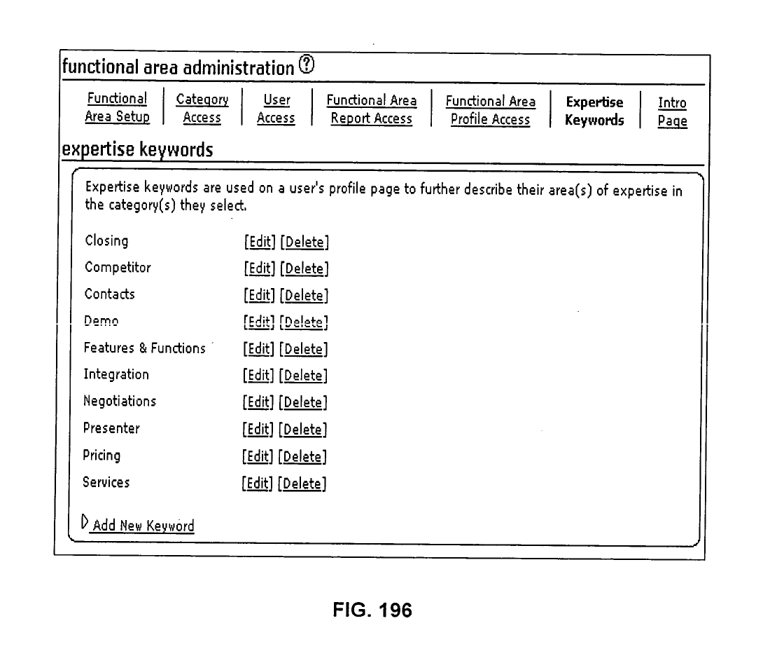

Referring to FIG. 196, preferably authorized users may add, edit or delete keywords which may be associated with experts. This preferably ensures consistent use of terms when describing experts which results in more consistent search results for users.

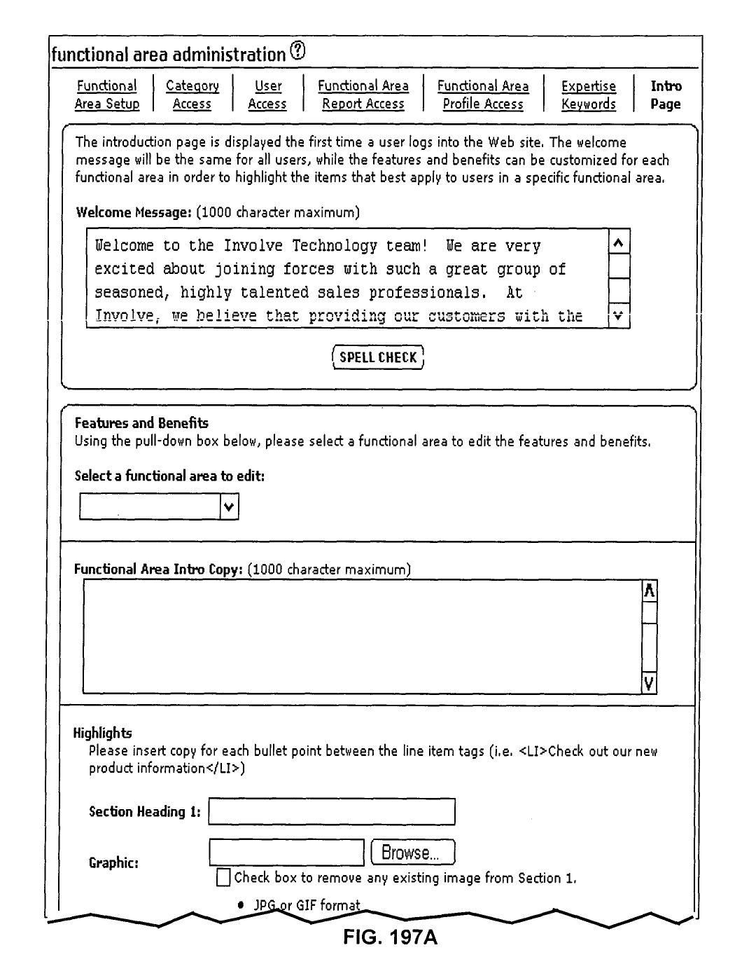

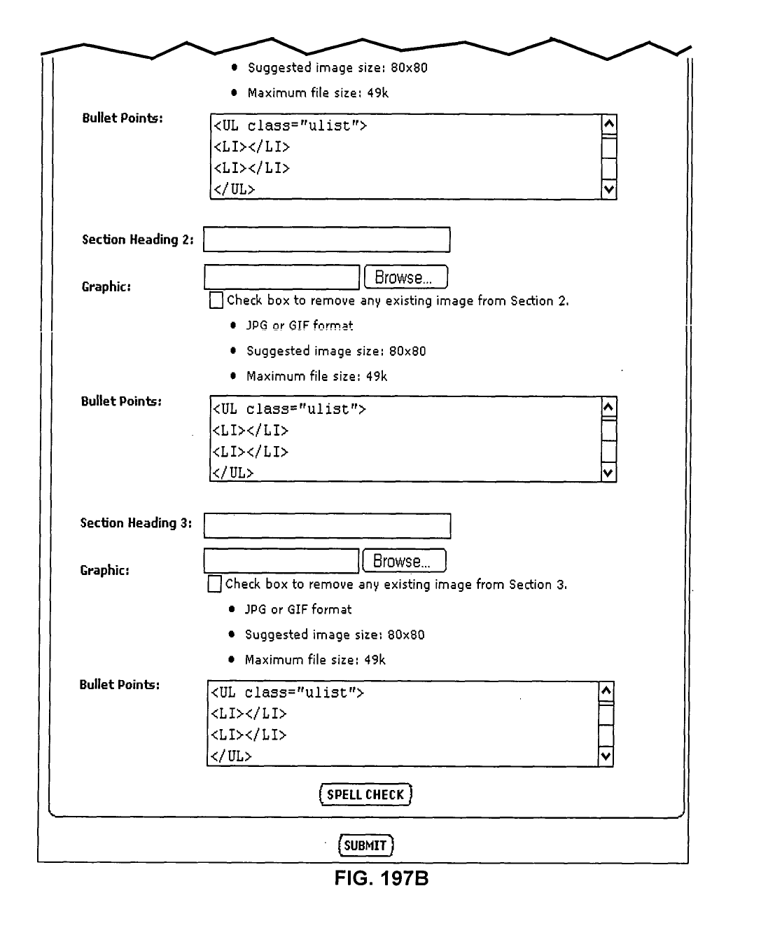

Preferably, authorized users may establish an “introduction” message for display on the first login by a user. This message is preferably used to help familiarize new users with the system, provide guidance on what should be done first and to give an overview of the benefits of the system. As illustrated in FIG. 197A and FIG. 197B, preferably authorized users may set up the universal welcome message and also provide tailored messages to any or all new members based on the user's assigned functional area. As shown, preferably, each functional area message may contain up to an introduction area and three separately titled sections.

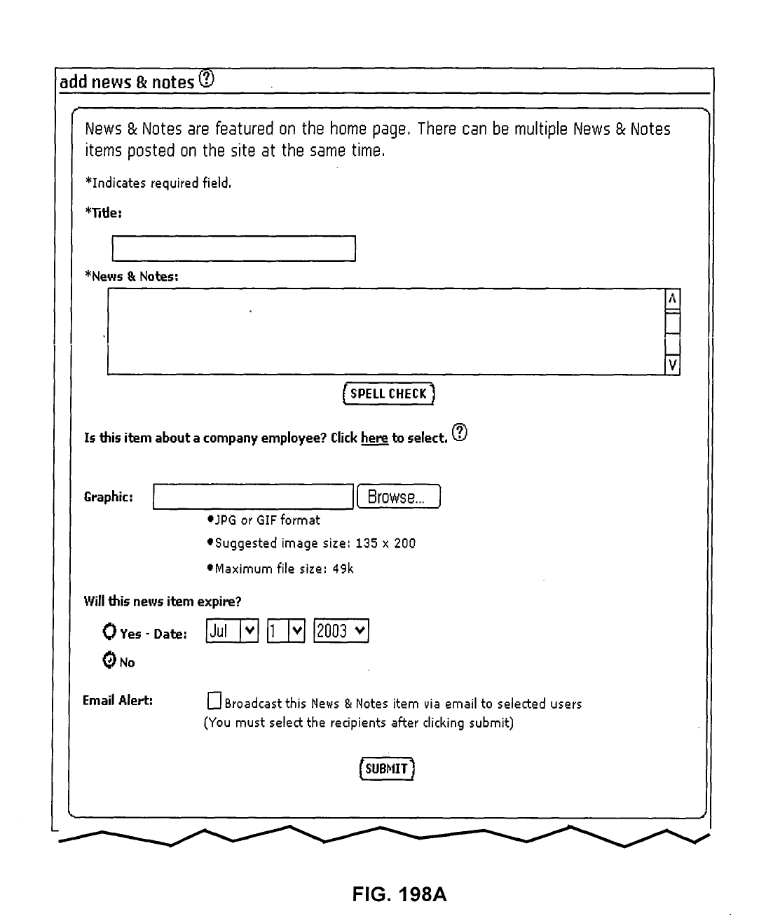

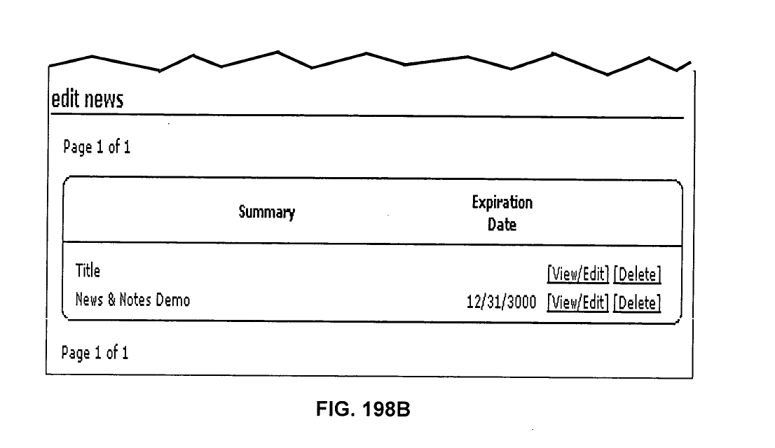

Preferably, authorized users may create the News & Notes section which is displayed on the system home page (as shown in FIG. 110A and FIG. 110B). As with the other administrative functions it is preferably accessed from the authorized user's “my page”. Each News & Notes story may be created and edited including the expiration date and any graphics or links associated with each story. The preferred screens for News & Notes are illustrated in FIG. 198A and FIG. 198B.

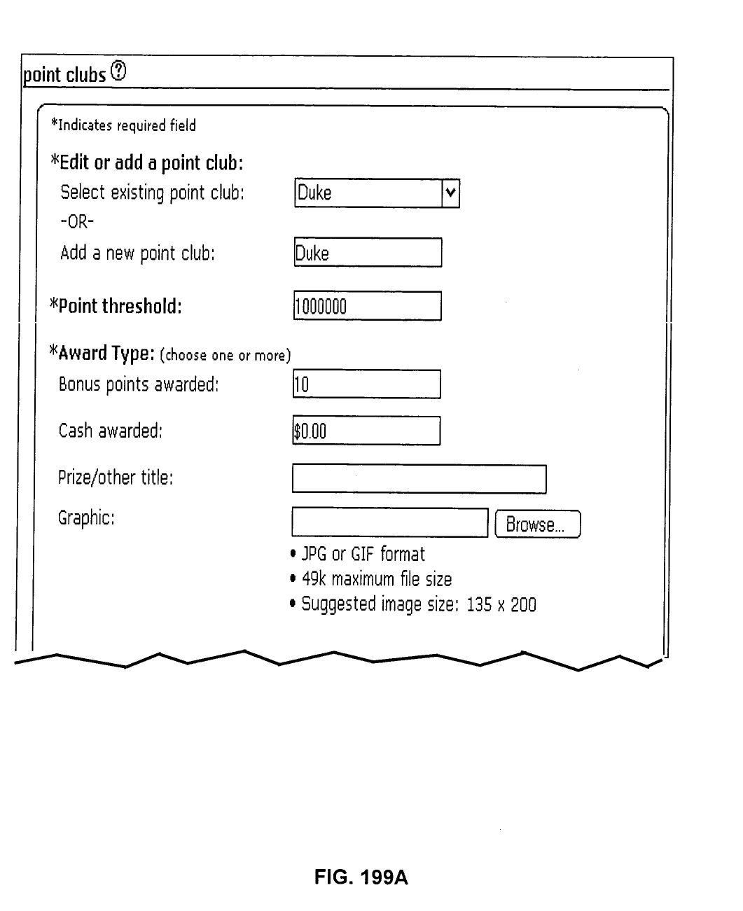

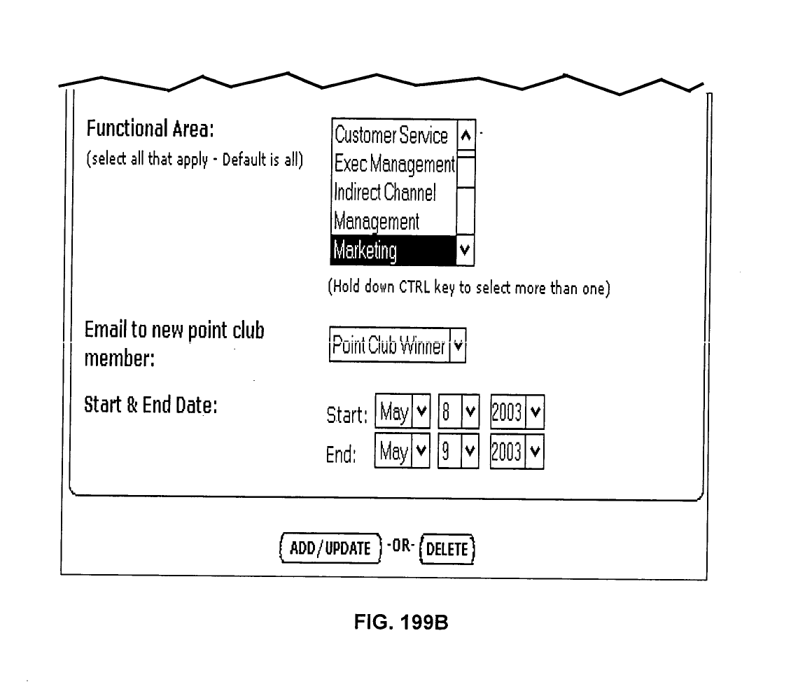

Preferably, authorized users may create Points Clubs which are preferably used to influence user's system usage behavior. As with the other administrative functions it is preferably accessed from the authorized user's “my page” (as shown in FIG. 133A and FIG. 133B). Each Points Cub may be created and edited including the expiration date and any graphics, prizes, required level of points accumulation and functional areas eligible for the prizes. The preferred screens for Points Club management are illustrated in FIG. 199A and FIG. 199B.

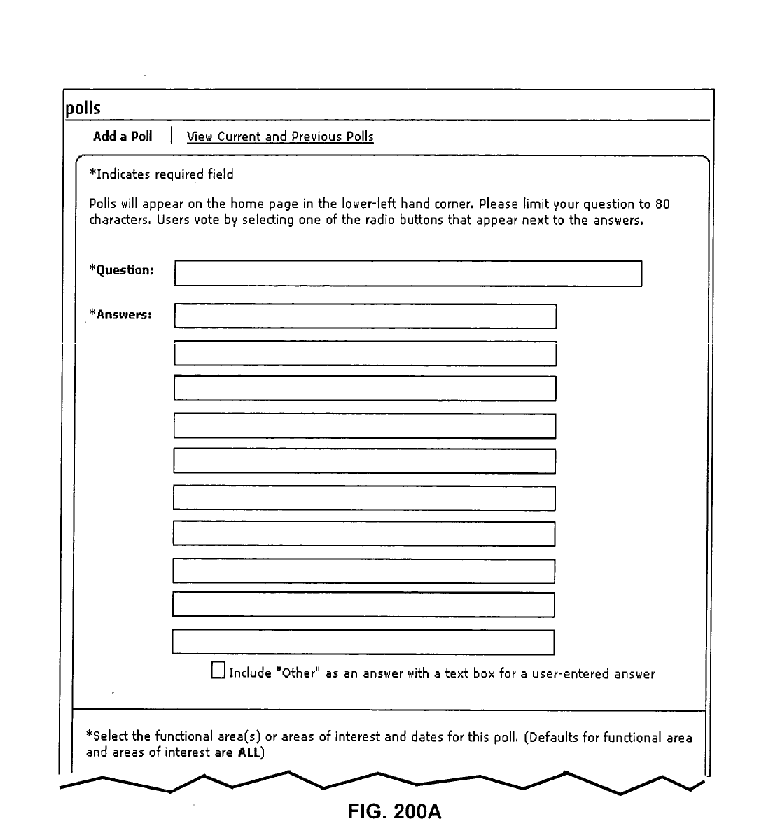

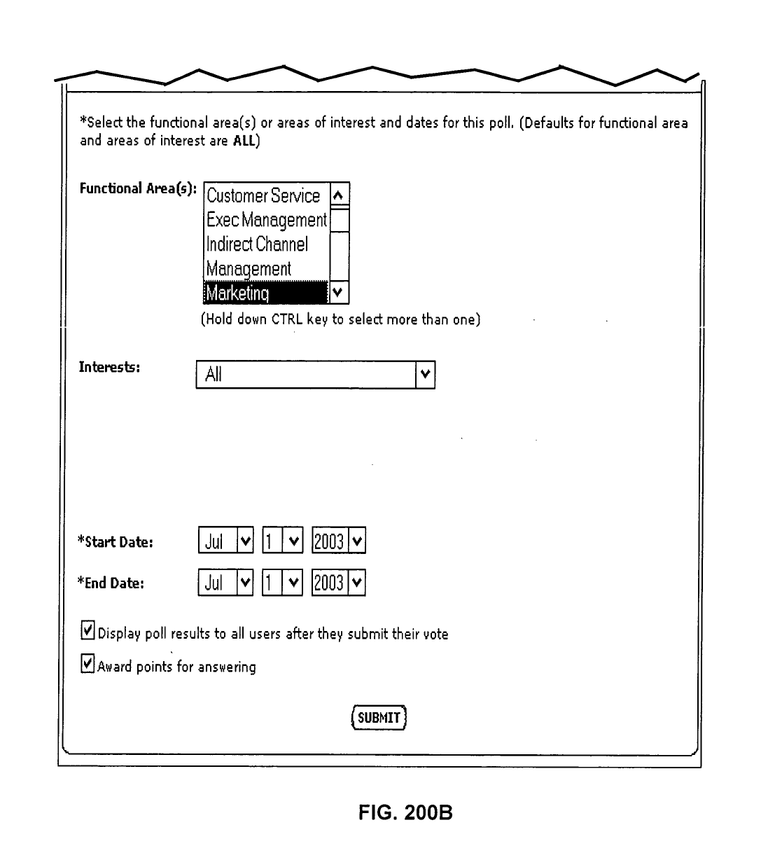

Preferably, authorized users may create user Polls which are preferably used to record user's preferences regarding any topic. Active Polls are displayed on the home page (as shown in FIG. 110A and FIG. 110B). As with the other administrative functions it is preferably accessed from the authorized user's “my page” (as shown in FIG. 133A and FIG. 133B). Each Poll may be created and edited including the question and up to ten possible answers, its expiration date and the functional areas to which it will be presented. The preferred screens for Polling management are illustrated in FIG. 200A and FIG. 200B.

Preferably, authorized users may access the System Administration functions from my page (as shown in FIG. 133A and FIG. 133B). System Administration preferably encompasses a variety of system parameters and configurations settings used to control overall system behavior and by the Gepetto (batch) automated management modules used for system maintenance.

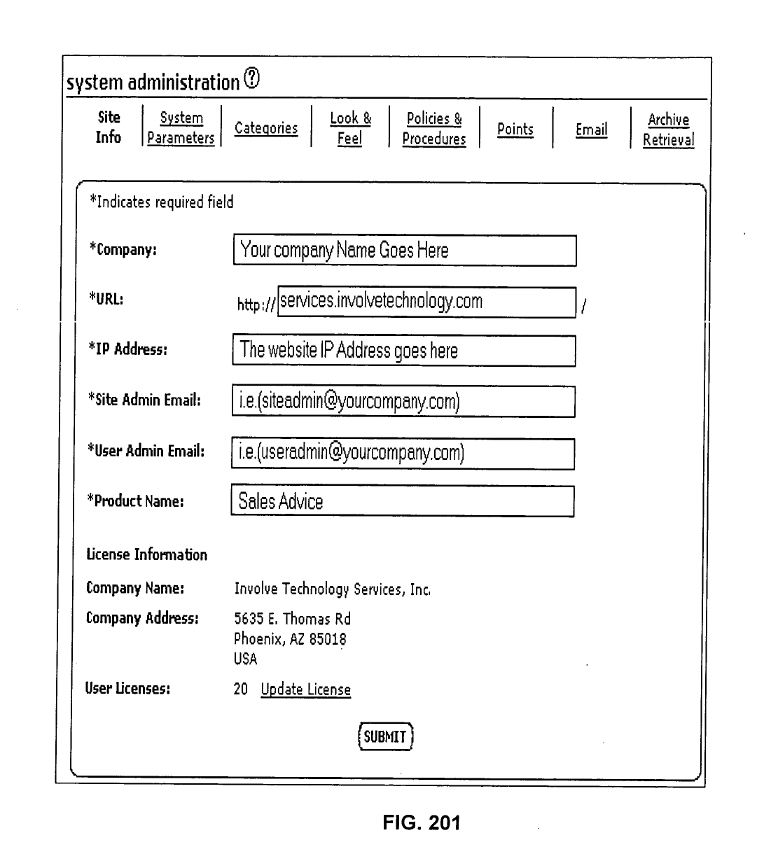

Referring to FIG. 201, preferably authorized users may establish the fundamental information necessary for establishing the system for usage. As shown in FIG. 201, a number of other functions can be accessed including:

Site Info—key information preferably required includes the URL of the licensee's website and the related IP address for the software;

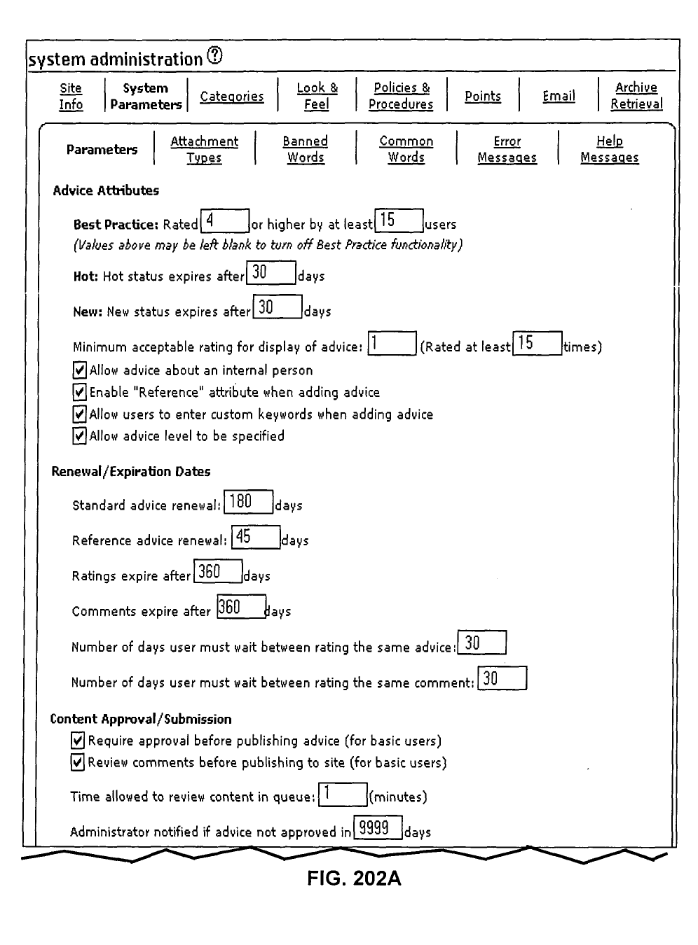

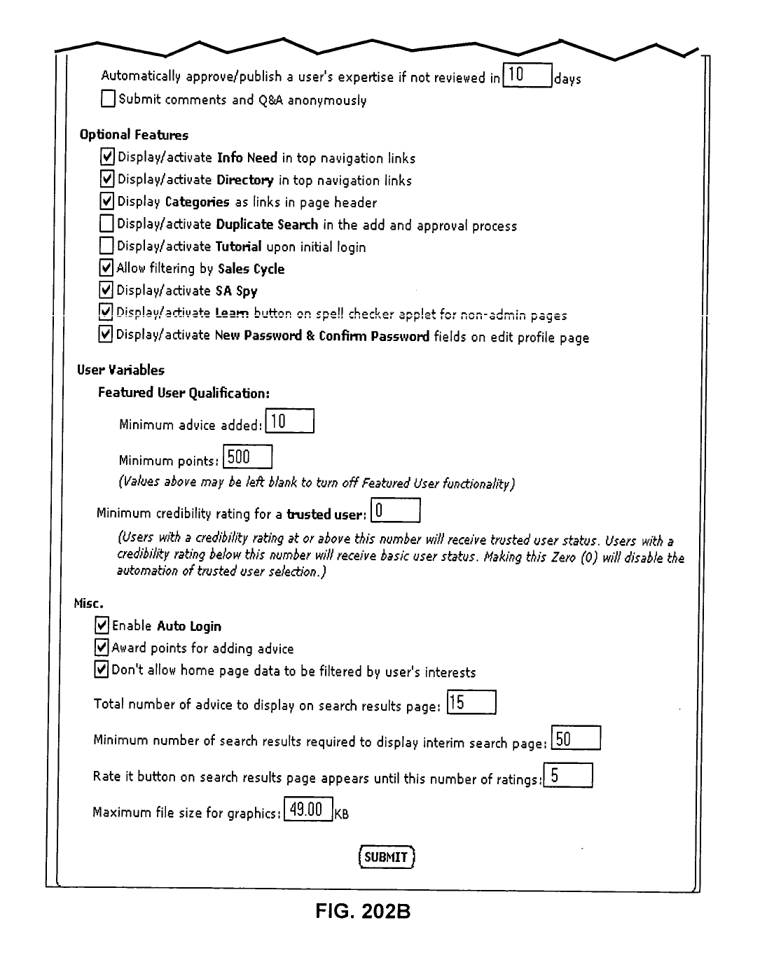

System parameters—refer to discussion below related to FIG. 202A and FIG. 202B;

Categories—creating, maintaining the categories and sub-categories used in the system;

Look and Feel—setting colors and motifs of the screens, and areas within each screen;

Policies and Procedures—Defining policies and procedures for review and agreement by system users;

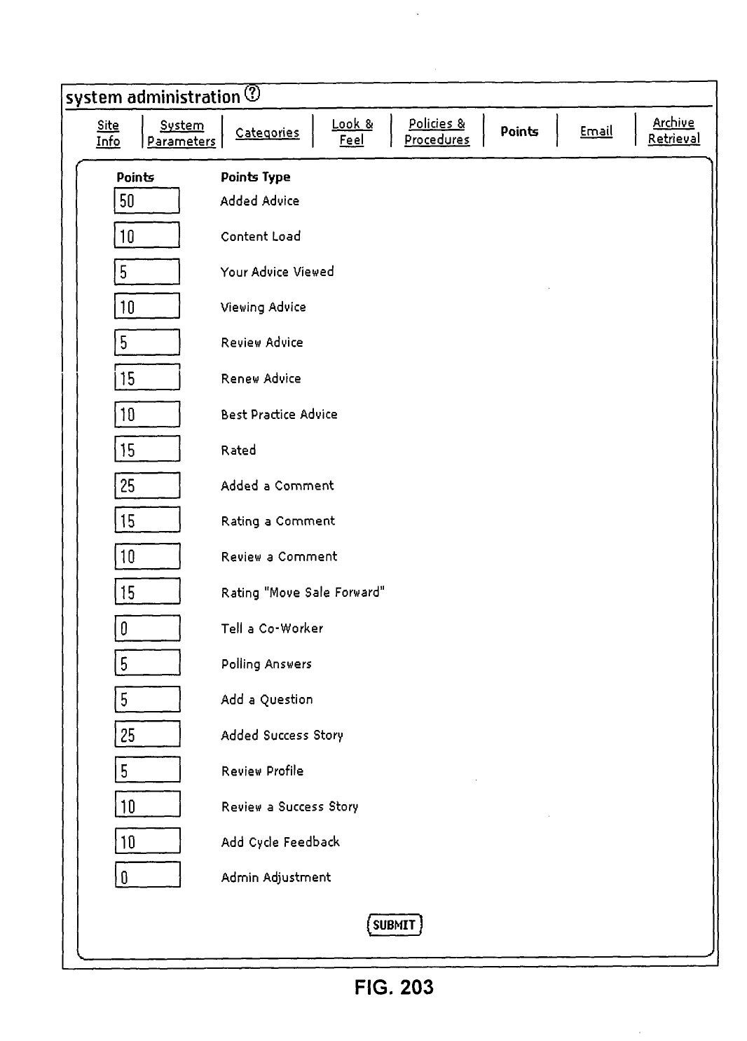

Points—referring to FIG. 203, authorized users may preferably set the basic point value for every action tracked in the system. Each user completing any action defined by this list will preferably be awarded the defined number of points;

Email—setting up and maintaining the email settings and content for standard system generated email;

Archive Retrieval—archiving advice and retrieving advice from archive.

Referring to FIG. 202A and FIG. 202B, authorized users may preferably set or modify each value in key areas of the system, including: Advice Attributes; Renewal/Expiration Dates; Content Approval/Submission; Optional Features; User Variables; and Miscellaneous Variables. Setting these variables preferably configures much of the system's behavior characteristics. Additionally, preferably each of the following functions is also preferably available to authorized users for creation and maintenance:

Attachment Types—preferably allows authorized users to define the acceptable type of attachments that be associated with advice entries;

Banned Words—preferably allows authorized users to identify words which may not be used anywhere in the system,

Common Words—preferably allows authorized users to identify common words used in the licensee's environment and therefore ignored in the keyword search routines;

Error Messages—preferably allows authorized users to define error message content to assist users in understanding reported problems;

Help Messages—preferably allows authorized users to define help messages for access by users throughout the system.

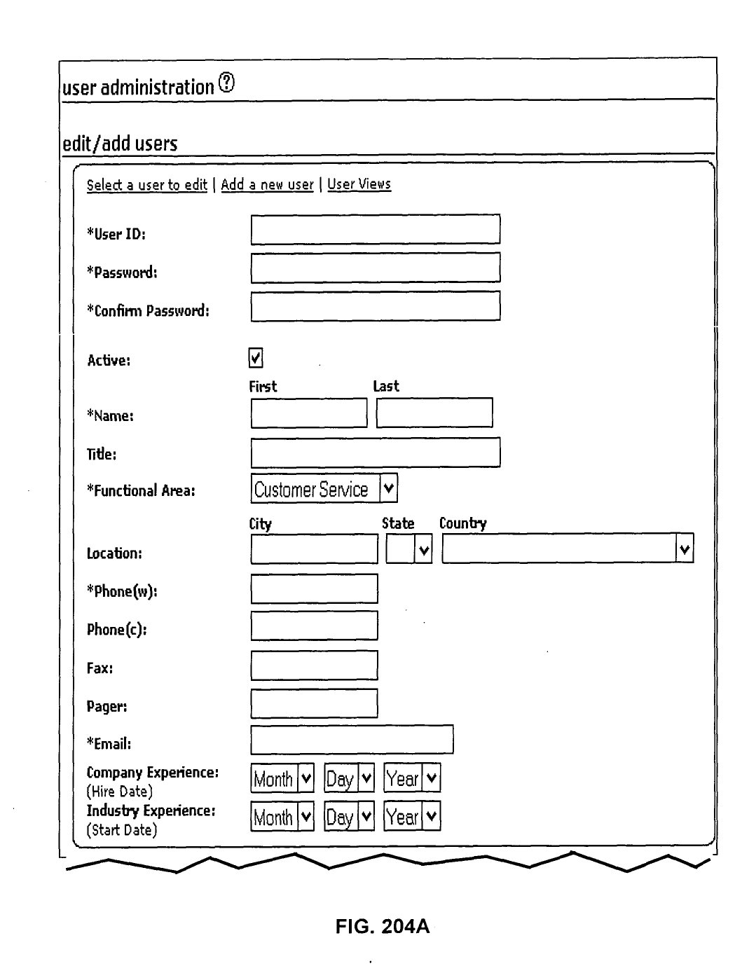

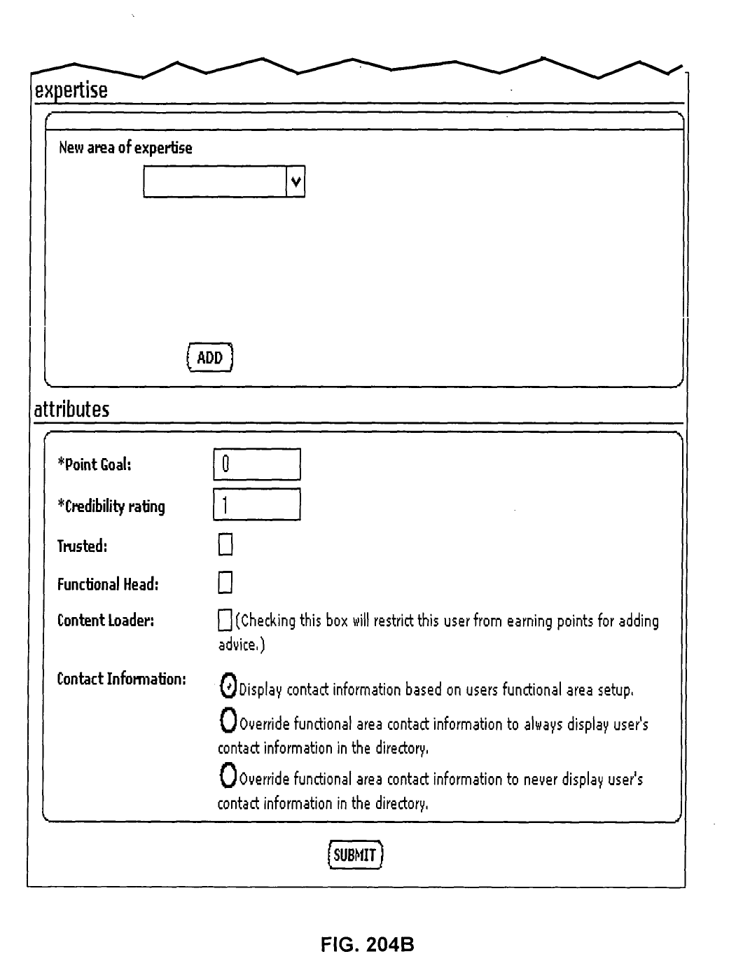

Preferably, authorized users may establish new users of the system or edit existing user's profile, expertise, assigned attributes and assigned approval categories. Credibility rating is used in ratings calculations to give more weight to ratings by experts and others with high levels of experience. In other words, a credibility rating of “1” is neutral while a credibility rating of “5” would preferably influence the overall rating toward the expert's opinion. This is functionally similar to the weighting used in the first described preferred embodiment of the present invention. The preferred screen for these functions is shown in FIG. 204A and FIG. 204B.

Web Site Automated Management

The functions of Gepetto in this second described preferred embodiment of the present invention are similar in nature and function to those described in the first described preferred embodiment of the present invention. For example, the Gepetto Module will preferably: Remove subjects (advice) with overall ratings below threshold; Remove subjects whose expiration date has passed with poor word ratings (optional); Calculate each members weighting value for ratings; Remove old ratings and recalculate ratings; and Remove old comments. Those with ordinary skill in this art will appreciate that minor differences in screen text, design and background are variations not critical to the instant inventions.

Standardized Design Elements

In a second described preferred embodiment of the present invention, many of the key aspects of page design and common functionality are included as standard modules within the system. Examples of these standard functions include page header and footer process which are performed in essentially the same manner on every page in the system. In addition, standard templates are preferably used to ensure minimal deviation in each page's look and feel to the user.

Although applicant has described applicant's preferred embodiments of this invention, it will be understood that the broadest scope of this invention includes such modifications as diverse shapes and sizes and materials. Such scope is limited only by the below claims as read in connection with the above specification. Further, many other advantages of applicant's invention will be apparent to those skilled in the art from the above descriptions and the below claims.

What is claimed is:

1) A system for creating and maintaining information in a database of subjects, available to a population of users, comprising:
a) describing a database subject using a plurality of natural-language terms, each of such plurality of natural-language terms having relevance to the subject according to an involved subset of such population of users;
b) rating the degree of relevance of each of such plurality of natural-language terms to such database subject according to each of such involved subset of such population of users;
c) associating, in such database, such respective natural-language terms and respective degrees of relevance with each such database subject; and
d) computing, for such involved subset of such population of users, in such database, an overall degree of relevance of each of such plurality of natural-language terms to such database subject.

2) The system according to claim 1, further comprising:
a) associating with a particular user a set of particular-user-preferred such natural-language terms from such plurality of natural-language terms;
b) using such particular user's preferred such set of particular-user-preferred such natural-language terms, searching such database for database subjects associated with such set of particular-user-preferred such natural-language terms;
c) determining a set of relevant such database subjects as are correlated with a high aggregate degree of relevance among such respective overall degrees of relevance of such set of respective particular-user-preferred such natural-language terms; and
d) presenting to such particular user information about such relevant database subjects.

3) The system according to claim 1 further comprising:
a) presenting to a particular user information about a particular such database subject and such associated respective relevant natural-language terms with such respective overall degrees of relevance;
b) collecting, from such particular user, such particular user's opinions about respective degrees of relevance to such particular database subject of such respective presented natural-language terms;
c) adding such particular user to such involved subset of such population of users and adding such particular user's opinions to such database; and
d) updating, in association with such particular database subject, in such database, such overall degree of relevance of each of such plurality of natural-language terms associated with such particular database subject.

4) The system according to claim 2 further comprising:
a) presenting to a particular user information about a particular such database subject and such associated respective relevant natural-language terms with such respective overall degrees of relevance;
b) collecting, from such particular user, such particular user's opinions about respective degrees of relevance to such particular database subject of such respective presented natural-language terms;
c) adding such particular user to such involved subset of such population of users and adding such particular user's opinions to such database; and
d) updating, in association with such particular database subject, in such database, such overall degree of relevance of each of such plurality of natural-language terms associated with such particular database subject.

5) The system according to claim 4 further comprising:
a) providing a software management system to directly manage such database and such population of users essentially without outside management; and
b) providing for variables in such software management system to be configurable without affecting such direct management operations;
c) wherein such software management system comprises:
i) soliciting of sufficient information from such users for automatic role qualification enhancing software selection and maintenance of a management sub-community;
ii) measuring management efforts of each of such management sub-community;
iii) queuing of qualified users for a next opening in such management sub-community;
iv) setting of goals for each of such management community; and
v) managing a reward system to reward management efforts of each of such management sub-community.

6) The system according to claim 1 further comprising:
a) collecting, from each user of such involved subset of such population of users, information about such user's knowledge of and experience with such database subject;
b) assessing, based at least in part upon such information, a relative weight to be given to such user's opinions about such database subject; and
c) for the purposes of computing, for such involved subset of such population of users, in such database, an overall degree of relevance of each of such plurality of natural-language terms to such database subject, applying a respective such relative weight for each respective such user's such rating of such degree of relevance in such manner that a more-knowledgeable such user's such rating counts for more in such “overall” computing than does a less-knowledgeable such user's such rating.

7) The system according to claim 6 further comprising:
a) determining first such user's role as member or contributor;
b) assigning a multiplier-value based on such first determining;
c) determining second whether such user has personally experienced the subject;
d) assigning a multiplier-value based on such second determining;
e) determining third such user's self-reported qualification to judge such subject;
f) assigning a multiplier-value based on such third determining;
g) determining fourth other users' overall ratings of subjects added by such user;
h) assigning a multiplier-value based on such fourth determining;
i) determining fifth other users' degree of agreements with comments added by such user;
j) assigning a multiplier-value based on such fifth determining; and
k) multiplying together all such multiplier-values to determine such relative weight.

8) The system according to claim 1 further comprising:
a) rating the relative overall value of each such database subject according to the opinion of each of such involved subset of such population of users;
b) collecting comments about each such database subject according to the opinion of each of such involved subset of such population of users; and
c) associating, in such database, respective such ratings of relative overall value and respective such collected comments with respective such database subjects.

9) The system according to claim 3 further comprising:
a) accumulating, storing, and analyzing all associations, including subject categorizations, of all such overall degrees of relevance of all of such plurality of natural-language terms associated with all such database subjects;
b) determining preferred such natural-language terms, according to such population of users, for selected categories of subjects.

10) The system according to claim 2 wherein such determining a set of relevant such database subjects as are correlated with a high aggregate degree of relevance among such respective overall degrees of relevance of such set of respective particular-user-preferred such natural-language terms comprises determining an ordered set of relevant such database subjects as are correlated with a highest aggregate degree of relevance among such respective overall degrees of relevance of such set of respective particular-user-preferred such natural-language terms.

11) The system according to claim 10 wherein such presenting to such particular user information about such relevant database subjects includes presenting to such particular user an ordered set of relevant such database subjects as are correlated with a highest aggregate degree of relevance among such respective overall degrees of relevance of such set of respective particular-user-preferred such natural-language terms.

12) An Internet website client-server computer system, for use to determine a level of subject interest for each one of a population of users by capturing other users' (of such population of users) opinions about the degree of relevance of each of a respective set of natural language descriptive terms to each of a respective set of subjects, comprising:
a) a server database system of subjects, each associated with a set of relevant natural-language terms for describing each such subject;
i) wherein each of a respective subset of such terms has been assigned, by each of a subpopulation of such population of users, a degree of relevance with respect to a respective such subject;
b) a client interface system arranged so that such one user may select a set of preferred such natural-language terms which, to such one user, best describe preferred “subjects of interest” to such one user;
c) a server computer processor system connected with said server database system and said client interface system; and
d) a server computer software system, operational with said server computer processor system, arranged to provide search processing using such server database system to:
i) determine an overall, according to such population of users, degree of relevance of each such preferred natural-language term to each such associated subject of such server database system, and
ii) determine a set of search-return “subjects of interest” each having at least a specified aggregate degree of relevance considering each such overall degree of relevance of each such preferred natural-language descriptive term to each associated such subject; and
iii) return such set of search-return “subjects of interest” to such client interface system of such one user.

13) The system according to claim 12 wherein such set of search-return “subjects of interest” is ordered according to relative such aggregate degree of relevance.

14) A business system, for a developer of web computer systems of the type involving supporting a community of users searching for particular subject information, to achieve additional revenue from customers using such computer systems, comprising the steps of:
a) providing for such computer systems to operate essentially without customer website management;
b) providing for such computer systems to directly motivate and automatically manage the direct collection of sponsor revenue from respective entities desiring to sponsor a respective particular item of such subject information; and
c) charging such customer, for use of such computer systems, an amount comprising a portion of such sponsor revenue.

15) The business system according to claim 14 wherein such particular item of such subject information comprises an exceptional user experience, thereby motivating location-based such entities and a product-based such entities to paying for a plurality of sponsorships.

16) A business system, for a developer, for use by customers having websites, of web computer systems of the type involving supporting a community of users interacting with a database searching for particular subject information, comprising:
a) providing for such computer systems to comprise software management systems to directly manage such database and such community of users essentially without customer website management; and
b) providing for variables in such software management systems to be configurable by such customer without affecting such direct management operations;
c) wherein such software management systems comprise
i) soliciting of sufficient information from users for automatic role qualification enhancing software selection and maintenance of a management sub-community,
ii) measuring management efforts of each of such management sub-community,
iii) queuing of qualified users for a next opening in such management sub-community,
iv) setting of goals for each of such management community, and
v) managing a reward system to reward management efforts of each of such management sub-community.

17) A business system, supplied by a developer, for use by customers having websites comprising web server computer systems of the type involving supporting a community of users, having client computer systems, interacting with a database searching for particular subject information, comprising providing, for website use:
a) computer software means for direct automatic management of such database and such community of users essentially without customer website management;
b) computer software means for permitting such customer to configure a large set of variables in such computer software means for direct automatic management of such database and such community of users without affecting full operation of such direct automatic management;
c) wherein such computer software means for direct automatic management of such database and such community of users essentially without customer website management comprises
i) computer software means for soliciting of sufficient information from such users for automatic role qualification enhancing automatic selection and automatic maintenance of a management sub-community,
ii) computer software means for automatically measuring management efforts of each of such management sub-community,
iii) computer software means for automatically providing queuing of qualified users for a next opening in such management sub-community,
iv) computer software means for automatic setting of goals for each of such management community, and
v) computer software means for automatically managing a reward system to reward management efforts of each of such management sub-community.

18) The business system according to claim 17, wherein such computer software means for direct automatic management of such database and such community of users essentially without customer website management further comprises:
a) computer software means for describing a database subject using a plurality of natural-language terms, each of such plurality of natural-language terms having relevance to such subject according to an involved subset of such community of users;
b) computer software means for rating the degree of relevance of each of such plurality of natural-language terms to such database subject according to each of such involved subset of such community of users;
c) computer software means for associating, in such database, each respective natural-language term of each such plurality of natural-language terms and such associated respective degree of relevance with each such database subject; and
d) computer software means for computing, for such involved subset of such community of users, in such database, an overall degree of relevance of each of such plurality of natural-language terms to such database subject.

19) The business system according to claim 17, wherein such computer software means for direct automatic management of such database and such community of users essentially without customer website management further comprises:
a) computer software means for automatically assisting such management sub-community to solicit subject sponsors; and
b) computer software means for permitting such subject sponsors automatically to send website materials and pay fees.

20) The business system according to claim 17, wherein such computer software means for automatically managing a reward system to reward management efforts of each of such management sub-community comprises:
a) a computer software system for measuring and storing each contribution, including users' comments, to the database of each of such management sub-community; and
b) computer software means for making available to each of such management sub-community a contributor record of how many views other users have made of such contributions, including how many users agreed with such contributor's comments.

21) The business system according to claim 20 wherein such contributor record is associated with the phrase, “lives touched”.

22) The business system according to claim 17 wherein such computer software means for automatically managing a reward system to reward management efforts of each of such management sub-community comprises a computer software system configurable to automatically allocate percentage rewards to a particular one of such management sub-community as a percentage of a settable pool.

23) The business system according to claim 22 wherein such percentage rewards from such pool may be paid only to a settable percentage of such management sub-community.

24) The business system according to claim 17 wherein such computer software means for direct automatic management of such database and such community of users essentially without customer website management further comprises:
a) computer software means for automatically aggregating all user-proposed items for database adds, changes, and deletions into a review queue to which such management sub-community has access; and
b) computer software means for automatically requiring at least one of such management sub-community to review and approve any such item before website publication is implemented.

25) The business system according to claim 24, wherein:
a) such review queue is multi-level based essentially on item “aging”; and
b) escalating rewards are offered to at least a set of such management sub-community for disposal of “older” items.

26) The business system according to claim 25 wherein such computer software means for automatically managing a reward system to reward management efforts of each of such management sub-community comprises a computer software system wherein each of such management community may be motivated to perform highly specific actions to further business objectives of such business system by automatically awarding more or less rewards for specific actions to influence behavior.

27) The business system according to claim 25 wherein such computer software means for automatically managing a reward system to reward management efforts of each of such management sub-community may be configured “on the fly”.

28) A business system, supplied by a developer, for use by customers having websites comprising web server computer systems of the type involving supporting a community of users, having client computer systems, interacting with a database searching for particular subject information, comprising providing, for website use:
a) computer software means for direct automatic management of such database and such community of users essentially without customer website management; and
b) computer software means for permitting such customer to configure a large set of variables in such computer software means for direct automatic management of such database and such community of users without affecting full operation of such direct automatic management;
c) wherein such computer software means for direct automatic management of such database and such community of users essentially without customer website management comprises
i) computer software means for soliciting of sufficient information from such users for automatic role qualification enhancing automatic selection and automatic maintenance of a management sub-community,
ii) computer software means for automatically measuring management efforts of each of such management sub-community,
iii) computer software means for automatically providing queing of qualified users for a next opening in such management sub-community,
iv) computer software means for automatic setting of goals for each of such management community,
v) computer software means for automatically managing a reward system to reward management efforts of each of such management sub-community,
vi) computer software means for automatically assisting such management sub-community to solicit subject sponsors,
vii) computer software means for permitting such subject sponsors automatically to send website materials and pay fees,
viii) computer software means for automatically aggregating all user-proposed items for database adds, changes, and deletions into a review queue to which such management sub-community has access, and
ix) computer software means for automatically requiring at least one of such management sub-community to review and approve any such item before website publication is implemented,
x) wherein
(i) such review queue is multi-level based essentially on item “aging”, and
(ii) escalating rewards are offered to at least a set of such management sub-community for disposal of “older” items,
xi) wherein such computer software means for automatically managing a reward system to reward management efforts of each of such management sub-community comprises a computer software system configurable to automatically allocate percentage rewards to a particular one of such management sub-community as a percentage of a settable pool, and
xii) wherein such percentage rewards from such pool may be paid only to a settable percentage of such management sub-community.

29) The business system according to claim 28 wherein such computer software means for direct automatic management of such database and such community of users essentially without customer website management further comprises:
a) computer software means for describing a database subject using a plurality of natural-language terms, each of such plurality of natural-language terms having relevance to such subject according to an involved subset of such community of users;
b) computer software means for rating the degree of relevance of each of such plurality of natural-language terms to such database subject according to each of such involved subset of such community of users;
c) computer software means for associating, in such database, each respective natural-language term of each such plurality of natural-language terms and such associated respective degree of relevance with each such database subject; and
d) computer software means for computing, for such involved subset of such community of users, in such database, an overall degree of relevance of each of such plurality of natural-language terms to such database subject.

30) A computer system, usable by a large population of Internet users, for creating and maintaining information in a searchable database of defined categories of subjects, comprising, in combination:
a) storage means for storing a large corpus of natural language terms for describing such subjects;
b) relevancy storage means for storing, associated with each such defined category, at least a respective subset of such terms most relevant, according to said population, to such subject within such respective defined category;
c) processing means for updating such relevancy storage means;
d) processing means for presenting to one such user, in association with one such subject, a plurality of such terms most relevant to such subject;
e) interface processing means for assisting such user to choose from such plurality of such presented terms a plurality of such-user-preferred most-relevant such terms to such subject;
f) interface processing means for assisting such user to rate on a predefined scale the relative degree of relevance of each such most-relevant term to such one subject;
g) storage means for storing such respective ratings of such respective most-relevant terms for such respective subject according to each of a subpopulation of such respective users;
h) processing means for computing, for such subpopulation, a pre-selected type of overall degree of relevance to each respective such subject of each respective such most-relevant term;
i) interface processing means for assisting a particular user to base a subject search at least upon a chosen set of particular-user-preferred such natural language terms;
j) processing means for, using such particular user's preferred such set of particular-user-preferred such natural-language terms, searching such database for database subjects associated with such set of particular-user-preferred such natural-language terms;
k) processing means for determining a set of relevant such database subjects as are correlated with a determined specified high aggregate degree of relevance among such respective overall degrees of relevance of such set of respective particular-user-preferred such natural-language terms; and
l) interface processing means for presenting to such particular user information about such determined set of such relevant database subjects which might be of interest to such particular user.

31) The computer system according to claim 30 wherein such predefined scale, for a system for which English is the natural language comprises essentially at least three of the following levels of modifiers: “slight”, “somewhat”, “important”, “very”, “extremely”.

32) The computer system according to claim 30 wherein such processing means for computing, for such subpopulation, a pre-selected type of overall degree of relevance to each respective such subject of each respective such most-relevant term comprises:
a) storage means for dating each such user ratings of such degree of relevance of such natural-language term; and
b) processing means for removing such user ratings of more than a selected age from being used in such computing of such overall degree of relevance.

33) The computer system according to claim 30 wherein such processing means for updating such relevancy storage means comprises:
a) computer means for determining which of such natural-language terms have been used most in such defined category—as top words;
b) computer means for determining percentage breakdown of top words by first alphabet letter of all such natural-language terms in such defined category;
c) computer means for finding the selected number of such natural-language terms to be displayed in each display process;
d) computer means for, for each set of first-alphabet-letter words and each such selected number, grabbing the specified percentage of top words; and
e) computer means for applying the above four steps once each selected timeframe to update such relevancy storage means.

34) The computer system according to claim 30 wherein such interface processing means for assisting a particular user to base a subject search at least upon a chosen set of particular-user-preferred such natural language terms further comprises:
a) interface processing means for assisting such particular user to select other search options on which to co-base such subject search;
b) wherein such other search options are selected from the class which consists essentially of
i) a defined category of subjects
ii) a defined subcategory of subjects
iii) a defined location of subjects
iv) a defined subject
v) a defined organization name
vi) a defined sum of money to spend
vii) a defined amount of time to spend.

35) An Internet website client-server computer system, for use to determine by e-mail survey a level of subject approval for each one of a population of survey participants by capturing each such participant's opinions about the degree of relevance of each of a respective set of natural language terms to each of a respective set of subjects, comprising:
a) a client interface system arranged so that a survey taker may indicate at least
i) a defined question for the survey,
ii) a such set of subjects to be evaluated,
iii) a such set of natural-language terms to be rated as to relevancy to each subject,
iv) a participant audience, and
v) a time-frame for response;
b) a server computer processor system connected with said client interface system; and
c) a server computer software system, operational with said server computer processor system, arranged to provide survey processing comprising
i) compiling a survey file and survey document in accordance with survey taker input,
ii) communicating such survey document to such participant audience, and
iii) receiving and tabulating responses.

36) The system according to claim 35 further comprising displaying survey results at a publicized URL.

37) The system according to claim 1 in which: such subjects consist essentially of exceptional experiences; and such natural-language terms are essentially evaluative.

38) The system according to claim 12 in which: such subjects consist essentially of exceptional experiences; and such natural-language terms are essentially evaluative.

39) The system according to claim 30 in which: such subjects consist essentially of exceptional experiences; and such natural-language terms are essentially evaluative.

40) The system according to claim 1 in which: such subjects consist essentially of exceptional experiences; and such natural-language terms are essentially evaluative and essentially indicate approval.

41) The system according to claim 12 in which: such subjects consist essentially of exceptional experiences; and such natural-language terms are essentially evaluative and essentially indicate approval.

42) The system according to claim 30 in which: such subjects consist essentially of exceptional experiences; and such natural-language terms are essentially evaluative and essentially indicate approval.

43) An Internet client-server system for assisting at least one group of users having at least one common goal to capture and search, in a single database, offered knowledge, relevant to such at least one common goal, of a plurality of such users for the benefit of at least one of such users, comprising:
a) individually capturing for such database at least one experience of at least some of such plurality;
b) storing in such database such experience;
c) user-searching, using at least one natural-language word, to select at least one desired kind of stored experience;
d) performing such user-searching; and
e) presenting search results.

44) The Internet client-server system according to claim 43 further comprising searchably capturing for such database at least one item of such knowledge selected from the group consisting essentially of
a) user-advice
b) opinions of experts
c) people who can help
d) miscellaneous such knowledge of users.

45) The Internet client-server system according to claim 43 further comprising a substantially automatic website management system.

46) The Internet client-server system according to claim 45 further comprising automatically rewarding assisting users for website management assistance.

47) The Internet client-server system according to claim 45 further comprising:
a) providing a software management system to directly manage such database and such population of users essentially without outside management; and
b) providing for variables in such software management system to be configurable without affecting such direct management operations;
c) wherein such software management system comprises
i) measuring management efforts of each of at least one management sub-community,
ii) setting goals for each of such management community, and
iii) managing a reward system to reward management efforts of each of such management sub-community.

48) The Internet client-server system according to claim 43 further comprising searchably capturing for such database such knowledge of users concerning useful knowledge sources outside such group of users.

49) The Internet client-server system according to claim 44 further comprising searchably capturing for such database such knowledge of users concerning useful knowledge sources outside such group of users.

50) The Internet client-server system according to claim 44 further comprising:
a) providing at least one capability for at least one user to complete on-line at least one multiple choice poll; and
b) providing at least one reward for such at least one user to completing such at least one multiple choice poll.

51) The Internet client-server system according to claim 45 wherein:
a) such common goal is sales-oriented,;
b) such group of users comprises sales personnel; and
c) those receiving such benefit comprise sales personnel.

52) The Internet client-server system according to claim 43 wherein such step of user-searching, using at least one natural-language word, to select at least one desired kind of stored knowledge, further comprises:
a) selecting, if any, such at least one kind of stored experience associated with chosen such at least one natural language word;
b) selecting, if any, such at least one kind of stored experience in which the text of such at least one stored experience contains the chosen such at least one natural-language word;
c) selecting, if any, such at least one kind of stored experience in which the category of such at least one stored experience contains the chosen such at least one natural-language word; and
d) selecting, if any, such at least one kind of stored experience in which the title of such at least one stored experience contains the chosen such at least one natural-language word.

53) The Internet client-server system according to claim 43, further comprising automatically managing a reward system to reward efforts of such at least one user.

54) The Internet client-server system according to claim 53, further comprising:
a) automatically measuring and storing each experience contribution, including users' comments made by each such at least one user;
b) assigning points to be accumulated for each such experience contribution;
c) automatically accumulating assigned points for each such experience contribution by each such at least one user;
d) automatically reporting such points accumulated for each such experience contribution;
e) defining at least one criteria for awarding prizes based on such accumulated points; and
f) automatically awarding prizes to such at least one user with accumulated points meeting such at least one criteria.

55) The Internet client-server system according to claim 45 further comprising
a) managing such database and such group of users essentially without customer website management;
b) permitting at least one customer to configure a plurality of variables in such computer software for such managing of such database;
c) automatically setting goals for each such user participating in at least one management community; and
d) automatically managing a reward system to reward management efforts of each of such at least one user of such at least one management community.

56) The Internet client-server system according to claim 43 further comprising:
a) rating the relative overall value of each such at least one item of such experience according to the opinion of each of such involved subset of such population of users;
b) collecting comments about each at least one item of such experience according to the opinion of each of such involved subset of such population of users; and
c) associating, in such database, respective such ratings of relative overall value and respective such collected comments with respective such at least one item of such experience.

57) The Internet client-server system according to claim 43 further comprising automatically accumulating system operation data.

58) The Internet client-server system according to claim 57 wherein such system operation data comprises:
a) data about compliance with such set of performance goals for each of at least one involved subset of such population of users;
b) data about each type of such stored experience;
c) data about such reward system; and
d) data about interviews of each of such involved subset of such population of users.

59) The Internet client-server system according to claim 58 further comprising permitting such at least one user to view successively more detailed levels of such automatically accumulated system operation data.

60) The Internet client-server system according to claim 43 further comprising:
a) requesting installation of at least one independent database access module onto the personal computer of such at least one user;
b) permitting selection, using such independent database access module, of at least one category of such knowledge for display by such at least one user;
c) automatically searching, using such at least one independent database access module, such database, without need of a browser, for at least one selected category of such knowledge from such database; and
d) displaying, using such at least one independent database access module, found knowledge from such at least one pre-determined category of such knowledge from such database to such at least one user.

61) The Internet client-server system according to claim 60 further comprising:
a) displaying continuously at least one selected type of such pre-determined information from at least one pre-determined category of such knowledge from such knowledge stored in such database to such at least one user; and
b) scrolling a display of at least one selected type of such pre-determined information from at least one pre-determined category of such knowledge from such knowledge stored in such database to such at least one user.

62) The Internet client-server system according to claim 61 further comprising:
a) making specific requests for information from information stored in such database by such at least one user.

63) The Internet client-server system according to claim 43 further comprising:
a) receiving at least one request for information from such at least one user;
b) storing such at least one request for information;
c) notifying designated other such at least one user with particular expertise about such at least one request for information;
d) storing such at least one request for information and at least one response by such at least one user with particular expertise as such at least one experience; and
e) notifying such at least one user, requesting information, of such at least one experience containing such at least one request and such at least one response.

64) An Internet client-server system for assisting a group of users with at least one common goal to capture and search, in a single database, offered knowledge, relevant to such at least one common goal, of a plurality of such users for the benefit of at least one of such users, comprising:
a) interface means for individually capturing for such database at least one experience of at least some of such plurality;
b) database means for storing such experiences;
c) interface means for user-searching, using at least one natural-language word, to select at least one desired kind of stored experience;
d) processor means for performing such user-searching; and
e) interface means for presenting search results.

65) The Internet client-server system according to claim 64 further comprising computer means for searchably capturing for such database at least one item of such knowledge selected from the group consisting essentially of:
a) user-advice
b) opinions of experts
c) people who can help
d) miscellaneous such knowledge of users.

66) The Internet client-server system according to claim 65 further comprising computer means for substantially-automatic website managing.

67) The Internet client-server system according to claim 65 further comprising computer means for automatically rewarding assisting users for website management assistance.

68) The Internet client-server system according to claim 65 further comprising computer means for searchably capturing for such database such knowledge of users concerning useful sources outside such group of users.

69) The Internet client-server system according to claim 65 further comprising computer means for providing at least one capability for at least one user to automatically take a desired survey among a selected subgroup of such users.

70) The Internet client-server system according to claim 66 wherein such interface means for user-searching, using at least one natural-language word, to select at least one desired kind of stored experience, further comprises
a) computer means for selecting, if any, such at least one kind of stored experience associated with chosen such at least one natural language word;
b) computer means for selecting, if any, such at least one kind of stored experience in which the text of such at least one stored experience contains the chosen such at least one natural-language word;
c) computer means for selecting, if any, such at least one kind of stored experience in which the category of such at least one stored experience contains the chosen such at least one natural-language word; and
d) computer means for selecting, if any, such at least one kind of stored experience in which the title of such at least one stored experience contains the chosen such at least one natural-language word.

71) The Internet client-server system according to claim 66 further comprising computer means for automatically managing a reward system to reward efforts of such at least one user.

72) The Internet client-server system according to claim 71 further comprising:
a) computer means for automatically measuring and storing each experience contribution, including users' comments made by each such at least one user;
b) computer means for assigning points to be accumulated for each such experience contribution;
c) computer means for automatically accumulating assigned points for each such experience contribution by each such at least one user;
d) computer means for automatically reporting such points accumulated for each such experience contribution;
e) computer means for defining at least one criteria for awarding prizes based on such accumulated points; and
f) computer means for automatically awarding prizes to such at least one user with accumulated points meeting such at least one criteria.

73) The Internet client-server system according to claim 65 further comprising
a) computer means for managing of such database and such group of users essentially without customer website management;
b) computer means for permitting at least one customer to configure a plurality of variables in such computer software for such managing of such database;
c) computer means for automatically setting goals for each such user participating in at least one management community; and
d) computer means for automatically managing a reward system to reward management efforts of each of such at least one user of such at least one management community.

74) The Internet client-server system according to claim 66 further comprising:
a) computer means for rating the relative overall value of each such at least one item of such experience according to the opinion of each of such involved subset of such population of users;
b) computer means for collecting comments about each at least one item of such experience according to the opinion of each of such involved subset of such population of users; and
c) computer means for associating, in such database, respective such ratings of relative overall value and respective such collected comments with respective such at least one item of such experience.

75) The Internet client-server system according to claim 66 further comprising computer means for automatically accumulating system operation data.

76) The Internet client-server system according to claim 75 wherein such system operation data comprises:
a) data about compliance with such set of performance goals for each of at least one involved subset of such population of users;
b) data about each type of such stored experience;
c) data about such reward system; and
d) data about interviews of each of such involved subset of such population of users.

77) The Internet client-server system according to claim 76 further comprising computer means for permitting such at least one user to view successively more detailed levels of such automatically accumulated system operation data.

78) The Internet client-server system according to claim 64 further comprising:
a) computer means for requesting installation of at least one independent database access module onto the personal computer of such at least one user;
b) computer means for permitting selection, using such independent database access module, of at least one category of such knowledge for display by such at least one user;
c) computer means for automatically searching, using such at least one independent database access module, such database, without need of a browser, for at least one selected category of such knowledge from such database; and
d) computer means for displaying, using such at least one independent database access module, found knowledge from such at least one pre-determined category of such knowledge from such database to such at least one user.

79) The Internet client-server system according to claim 78 further comprising:
a) computer means for displaying continuously at least one selected type of such pre-determined information from at least one pre-determined category of such knowledge from such knowledge stored in such database to such at least one user; and
b) computer means for scrolling a display of at least one selected type of such pre-determined information from at least one pre-determined category of such knowledge from such knowledge stored in such database to such at least one user.

80) The Internet client-server system according to claim 79 further comprising:
a) computer means for making specific requests for information from information stored in such database by such at least one user.

81) The Internet client-server system according to claim 66 further comprising:
a) computer means for receiving at least one request for information from such at least one user;
b) computer means for storing such at least one request for information;
c) computer means for notifying designated other such at least one user with particular expertise about such at least one request for information;
d) computer means for storing such at least one request for information and at least one response by such at least one user with particular expertise as such at least one experience; and
e) computer means for notifying such at least one user, requesting information, of such at least one experience containing such at least one request and such at least one response.

82) The Internet client-server system according to claim 66 wherein:
a) such common goal is sales-oriented,;
b) such group of users comprises sales personnel; and
c) those receiving such benefit comprise sales personnel.

83) The Internet client-server system according to claim 70 wherein:
a) such common goal is sales-oriented,;
b) such group of users comprises sales personnel; and
c) those receiving such benefit comprise sales personnel.

84) The Internet client-server system according to claim 74 wherein:
a) such common goal is sales-oriented,;
b) such group of users comprises sales personnel; and
c) those receiving such benefit comprise sales personnel.

85) The Internet client-server system according to claim 78 wherein:
a) such common goal is sales-oriented,;
b) such group of users comprises sales personnel; and
c) those receiving such benefit comprise sales personnel.
